(19) United States
(12) Patent Application Publication
(10) Pub. No.: US 2026/0067343 A1
(43) Pub. Date: Mar. 5, 2026

(54) METHODS AND SYSTEMS FOR MULTIMEDIA COMMUNICATION WHILE ACCESSING NETWORK RESOURCES

(71) Applicant: Hovr Inc., Lansdale, PA (US)

(72) Inventors: Jason Tyler Craparo, Lansdale, PA (US); Andrew Dale Colagreco, Phoenixville, PA (US); Rachel Ann Costantino, Evanston, IL (US); Peter Yim, Puyallup, WA (US)

(21) Appl. No.: 19/386,199

(22) Filed: Nov. 11, 2025

Related U.S. Application Data
(63) Continuation-in-part of application No. 18/676,356, filed on May 28, 2024.
Application No. 18/676,356 is a continuation of application No. 18/301,950, filed on Apr. 17, 2023, now Pat. No. 12,003,555.
Application No. 18/301,950 is a continuation-in-part of application No. 18/059,927, filed on Nov. 29, 2022, now Pat. No. 11,962,630.
Application No. 18/059,927 is a continuation of application No. 17/663,633, filed on May 16, 2022, now Pat. No. 11,522,927.
Application No. 17/663,633 is a continuation-in-part of application No. 17/457,115, filed on Dec. 1, 2021, now abandoned.
Application No. 17/457,115 is a continuation of application No. 17/178,934, filed on Feb. 18, 2021, now Pat. No. 11,201,900.
(60) Provisional application No. 63/125,894, filed on Dec. 15, 2020.

(51) Int. Cl. H04L 65/4038; H04L 65/1016; H04L 65/1069; H04L 65/1089; H04L 65/1093

(52) U.S. Cl. CPC H04L 65/4038; H04L 65/1016; H04L 65/1069; H04L 65/1089; H04L 65/1093

(57) ABSTRACT

Systems and methods are configured to access a webpage, analyze the webpage, use the analysis to generate keywords reflective of content of the webpage, and determine an amount of text and of images on the webpage. The keywords are used to identify relevant moment content. A moment content suggestion comprising the identified relevant moment content is generated and provided for display on a user device. The determined amount of text and images are used to identify a suitable anchor. An anchor suggestion is provided for display on the user device. In response to receiving a user selection of suggested relevant moment content and a suggested suitable anchor, the user-selected anchor is caused to be displayed via the webpage on a device. In response to an interaction with the webpage, comprising the user-selected identified suitable anchor, a rendering of the user-selected relevant moment content is performed.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### COPYRIGHT NOTICE

A portion of the disclosure of this patent document contains material which is subject to copyright protection. The copyright owner has no objection to the facsimile reproduction by anyone of the patent document and/or the patent disclosure as it appears in the United States Patent and Trademark Office patent file and/or records, but otherwise reserves all copyrights whatsoever.

### BACKGROUND OF THE INVENTION

### Field of the Invention

The present disclosure generally relates to enabling users accessing a network resource to communicate with each other.

### Description of the Related Art

Users accessing a network resource, such as a website, often do so in isolation. To the extent that a website may enable users to collaborate, such collaboration often necessitates prior scheduling among participants. Further, each website that offers such collaboration conventionally requires its own collaboration system, each with their own user experience, making it challenging for users to adapt to and adequately utilize such collaboration and associated communication tools. Further, conventional collaboration tools lack many desirable communication features.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An aspect of the present disclosure relates to a communication system configured to enable users to communicate with each, the communication system comprising: a network interface; at least one processing device operable to: detect, via data received from a first user device over a network using the network interface, when a first user is accessing via a first browser a third party website operated a first entity different than the entity operating the communication system; detect, via data received from a second user device using the network interface, when a second user is accessing via a second browser the third party website concurrently with the first user accessing the third party website; transmit data to the first user device configured to cause, at least in part, an interface to be displayed on the first user device indicating that the second user is currently accessing the third party website and enabling the first user to initiate, via a first communication control, a transmission of a text, image, and/or video communication to the second user device; transmit data to the second user device configured to cause, at least in part, an interface to be displayed on the second user device indicating that the first user is currently accessing the third party website and enabling the second user to initiate a transmission of a text, image, and/or video communication to the first user device; at least partly in response to the first user activating the first communication control, cause, at least in part, a communication channel to be established between the first user device and the second user device and enable the first user and the second user to communicate using the communication channel established between the first user device and the second user device; detect, via data received from a third user device using the network interface, when a third user is accessing via a third browser a second website operated a second entity different than the entity operating the communication system and different than the first entity; detect, via data received from a fourth user device using the network interface, when a fourth user is accessing via a fourth browser the second website concurrently with the third user accessing the second website; transmit data to the third user device configured to cause, at least in part, an interface to be displayed on the third user device indicating that the fourth user is currently accessing the second website and enabling the third user to initiate, via a third communication control, a transmission of a text, image, and/or video communication to the fourth user device; transmit data to the fourth user device configured to cause, at least in part, an interface to be displayed on the fourth user device indicating that the third user is currently accessing the second website and enabling the fourth user to initiate a transmission of a text, image, and/or video communication to the third user device; and at least partly in response to the third user activating the third communication control, cause, at least in part, a communication channel to be established between the third user device and the fourth user device and enable the third user and the fourth user to communicate using the communication channel established between the third user device and the fourth user device.

An aspect of the present disclosure relates to a computerized method, the method comprising: detecting at a computer system, via data received from a first user device over a network, when a first user is accessing via a first browser a third party website operated a first entity different than the entity operating the computer system; detecting using the computer system, via data received from a second user device over the network, when a second user is accessing via a second browser the third party website concurrently with the first user accessing the third party website; transmitting data using the computer system to the first user device configured to cause, at least in part, an interface to be displayed on the first user device indicating that the second user is currently accessing the third party website and enabling the first user to initiate, via a first communication control, a transmission of a text, image, and/or video communication to the second user device; transmitting data using the computer system to the second user device configured to cause, at least in part, an interface to be displayed on the second user device indicating that the first user is currently accessing the third party website and enabling the second user to initiate a transmission of a text, image, and/or video communication to the first user device; and at least partly in response to the first user activating the first communication control, enabling the first user and the second user to electronically communicate over the network.

An aspect of the present disclosure relates to a non-transitory computer readable memory having program instructions stored thereon that when executed by a computer system device cause the computer system to performing operations comprising: detect, via data received from a first user device, when a first user is accessing, via a first browser, a third party website; detect, via data received from a second user device, when a second user is accessing via a second browser the third party website concurrently with the first user accessing the third party website; transmit data to the first user device configured to cause, at least in part, an interface to be displayed on the first user device indicating that the second user is currently accessing the third party website and enabling the first user to initiate, via a first communication control, a transmission of a text, image, and/or video communication to the second user device; transmit data to the second user device configured to cause, at least in part, an interface to be displayed on the second user device indicating that the first user is currently accessing the third party website and enabling the second user to initiate a transmission of a text, image, and/or video communication to the first user device; and at least partly in response to the first user activating the first communication control, enable the first user and the second user to electronically communicate.

An aspect of the present disclosure relates to a system comprising a network interface; at least one processing device operable to: receive an indication that an anchor is to be positioned at a first location on a first webpage; receive a content specification associated with the anchor; receive an interaction rule associated with the anchor, wherein the interaction rule comprises a rule that content specified by the content specification is to be displayed at least partly in response to the first webpage being scrolled to a first position; receive a timing rule associated with the anchor; render a preview of the first webpage with the anchor at the first location of the previewed first webpage; automatically generate code configured to cause the anchor to be visible in accordance with the timing rule at the first location of the first webpage when accessed by a user browser; and at least partly in response to activation of a publication control, enable the code to be embedded in the first webpage, wherein the first webpage is a preexisting webpage; wherein, at least partly in response to a first user browser of a first user device accessing the first webpage, and the first user scrolling the webpage to the first position, the content specified by the content specification is rendered. Optionally, the automatically generated code comprises a script id and an src. Optionally, the first location comprises an HTML element. Optionally, the first location is offset in a specific direction by a specific amount from an HTML element. Optionally, the operations further comprise: automatically generating second code configured to be embedded in a second webpage, the automatically generated code configured to display a user interface in conjunction with the second webpage, the user interface providing: access to a first content library defined by a first entity; a notification regarding a timing of a real-time audio-video broadcast; a view of the real-time audio-video broadcast; an identification of other users viewing the real-time audio-video broadcast; and a communication interface enabling the user to engage in real time communication with one or more of the other users viewing the real-time audio-video broadcast. Optionally, the operations further comprise: enabling a user interface to be displayed in conjunction with a second webpage, the user interface providing: a notification regarding a timing of a real-time audio-video broadcast; a view of the real-time audio-video broadcast; an identification of other users viewing the real-time audio-video broadcast; and a communication interface enabling the user to engage in real time communication with one or more of the other users viewing the real-time audio-video broadcast. Optionally, the operations further comprise: enabling a user interface to be displayed in conjunction with a second webpage, the user interface enabling: a host to conduct a real-time audio-video broadcast, wherein the real-time audio-video broadcast is configured to be broadcast to a plurality of receiving devices; the host to view users associated with the plurality of receiving devices; the host to designate at least one of the users associated with the plurality of receiving devices as a co-host; and enable the co-host to unmute the co-host's microphone and to stream, within the real-time audio-video broadcast, speech of the co-host.

An aspect of the present disclosure relates to a computerized method, the method comprising: receiving an indication that an anchor is to be positioned at a first location on a first webpage; receiving a content specification associated with the anchor; receiving an interaction rule associated with the anchor, wherein the interaction rule comprises a rule that content specified by the content specification is to be displayed at least partly in response to the first webpage being scrolled to a first position; rendering a preview of the first webpage with the anchor at the first location of the previewed first webpage; automatically generating code configured to cause the anchor to be visible at the first location of the first webpage when accessed by a user browser; and at least partly in response to activation of a publication control, enabling the code to be embedded in the first webpage; wherein, at least partly in response to a first user browser of a first user device accessing the first webpage, and the first user scrolling the webpage to the first position, the content specified by the content specification is rendered. Optionally, the automatically generated code comprises a script id and an src. Optionally, the first location comprises an HTML element. Optionally, the first location is offset in a specific direction by a specific amount from an HTML element. Optionally, the method further comprises: automatically generating second code configured to be embedded in a second webpage, the automatically generated code configured to display a user interface in conjunction with the second webpage, the user interface providing: access to a first content library defined by a first entity; a notification regarding a timing of a real-time audio-video broadcast; a view of the real-time audio-video broadcast; an identification of other users viewing the real-time audio-video broadcast; and a communication interface enabling the user to engage in real time communication with one or more of the other users viewing the real-time audio-video broadcast. Optionally, the method further comprises: enabling a user interface to be displayed in conjunction with a second webpage, the user interface providing: a notification regarding a timing of a real-time audio-video broadcast; a view of the real-time audio-video broadcast; an identification of other users viewing the real-time audio-video broadcast; and a communication interface enabling the user to engage in real time communication with one or more of the other users viewing the real-time audio-video broadcast. Optionally, the method further comprises: enabling a user interface to be displayed in conjunction with a second webpage, the user interface enabling: a host to conduct a real-time audio-video broadcast, wherein the real-time audio-video broadcast is configured to be broadcast to a plurality of receiving devices; the host to view users associated with the plurality of receiving devices; the host to designate at least one of the users associated with the plurality of receiving devices as a co-host; and enable the co-host to unmute the co-host's microphone and to stream, within the real-time audio-video broadcast, speech of the co-host.

An aspect of the present disclosure relates to a non-transitory computer readable memory having program instructions stored thereon that when executed by a computer system device cause the computer system to performing operations comprising: receiving an indication that an anchor is to be positioned at a first location on a first webpage; receiving a content specification associated with the anchor; receiving an interaction rule associated with the anchor, wherein the interaction rule comprises a rule that content specified by the content specification is to be displayed at least partly in response to the first webpage being scrolled to a first position; rendering a preview of the first webpage with the anchor at the first location of the previewed first webpage; automatically generating code configured to cause the anchor to be visible at the first location of the first webpage when accessed by a user browser; and at least partly in response to activation of a publication control, enabling the code to be embedded in the first webpage; wherein, at least partly in response to a first user browser of a first user device accessing the first webpage, and the first user scrolling the webpage to the first position, the content specified by the content specification is rendered. Optionally, the automatically generated code comprises a script id and an src. Optionally, the first location comprises an HTML element. Optionally, the first location is offset in a specific direction by a specific amount from an HTML element. Optionally, the operations further comprise: generating second code configured to be embedded in a second webpage, the automatically generated code configured to display a user interface in conjunction with the second webpage, the user interface providing: access to a first content library defined by a first entity; a notification regarding a timing of a real-time audio-video broadcast; a view of the real-time audio-video broadcast; an identification of other users viewing the real-time audio-video broadcast; and a communication interface enabling the user to engage in real time communication with one or more of the other users viewing the real-time audio-video broadcast. Optionally, the operations further comprise: enabling a user interface to be displayed in conjunction with a second webpage, the user interface providing: a notification regarding a timing of a real-time audio-video broadcast; a view of the real-time audio-video broadcast; an identification of other users viewing the real-time audio-video broadcast; and a communication interface enabling the user to engage in real time communication with one or more of the other users viewing the real-time audio-video broadcast. Optionally, the operations further comprise: enabling a user interface to be displayed in conjunction with a second webpage, the user interface enabling: a host to conduct a real-time audio-video broadcast, wherein the real-time audio-video broadcast is configured to be broadcast to a plurality of receiving devices; the host to view users associated with the plurality of receiving devices; the host to designate at least one of the users associated with the plurality of receiving devices as a co-host; and enable the co-host to unmute the co-host's microphone and to stream, within the real-time audio-video broadcast, speech of the co-host.

### BRIEF DESCRIPTION OF THE DRAWINGS

Embodiments will now be described with reference to the drawings summarized below. These drawings and the associated description are provided to illustrate example aspects of the disclosure, and not to limit the scope of the invention.

FIG. 1A illustrates an example architecture.

FIGS. 1B-1D illustrate example process flows.

FIGS. 1E-1F illustrate example multimedia communication architectures.

FIGS. 2A-3P illustrate example user interfaces.

FIGS. 4A-4E2 illustrate various aspects of systems, applications, and processes.

FIGS. 5A-12E illustrate additional example user interfaces.

FIG. 13 illustrates an example process for defining and automatically generating a communication widget.

FIGS. 14A-14CC illustrate additional example user interfaces.

FIGS. 15A-15B illustrate an example table of information that may be utilized to locate a webpage element.

FIGS. 16-23B illustrate example processes.

FIGS. 24A-30D illustrate example user interfaces and webpage rendition.

FIGS. 31A-32P illustrate example user interfaces.

FIGS. 33-37 illustrate example processes.

FIGS. 38A-38C illustrate example processes.

FIGS. 39A-39J illustrate example user interfaces.

FIGS. 40-41 illustrate example processes.

FIGS. 42-43 illustrate example user interfaces.

### DETAILED DESCRIPTION

An aspect of the present disclosure relates to enhancing network resource (e.g., website) real time engagement, content streaming, navigation, communication, and online communities.

As described herein, optionally a customizable web experience can be defined by an administrator or other authorized entity without manual coding. An aspect of the present disclosure relates to improving user registration rates to thereby further enhance such real time engagement, navigation, content streaming, and communication. An aspect of the present disclosure relates to generating analytics using registration data (e.g., age, location, income, education, other demographic data, user specified subject preferences, brand preferences, and/or other user preferences), user engagement data, user navigation data, and/or user communication data. For example, such analytics may include time on webpage, time on website, number of page views, purchase intent, retention, brand affinity, and/or the like.

An aspect of the present disclosure relates to a user interface that may optionally be accessed by a given third party website via the insertion/embedding of code (e.g., automatically generated code). Such code may be used to generate other user interfaces and provide functionality described herein. The user interface may be accessed by an end user device (e.g., a desktop computer, laptop computer, smart phone, networked television, networked game console, networked wearable device, and/or the like) via a webpage of the website, where the webpage may be accessed and presented by a browser hosted on the user device. Such a user interface enables the third party to stream live and/or prerecorded video, audio, and/or text via the user interface to a user accessing a preexisting webpage, optionally without having to manually write any new code). The content may be pushed to the user via a user notification (e.g., a pop-up, scrolling text, highlighting of content, and/or otherwise) and/or via an automatic presentation of the content to the user. Optionally, a natural language machine learning engine may analyze chat sentiment in a community chat and use such sentiment to select and push relevant content.

Such push operation may optionally be performed in response to the user scrolling to/through a visible or non-visible anchor specified by an authorized entity or any user if so permitted by the website operator. Optionally, a given anchor (sometimes referred to herein as a breadcrumb or digital breadcrumb) may be associated with an application programming interface (API) which pulls data from a content source, such as a social media site, microblogging site, video content sharing site, audio content sharing site, or other source specified by the authorized entity.

Optionally, an anchor may have a specified start time and/or end time, wherein the associated content will only be pushed and/or be accessible within the specified start time and end time, or if an end time is not specified, any time after the specified start time unless such anchor is removed. Such anchor may ensure that the pushed content is provided in a useful context, such as ensuring the pushed content is directly related to webpage content currently being displayed to the user. Such context will enhance the user experience and make it more likely the user will further engage with the webpage and website.

Optionally, an anchor may be associated with one or more rules which may control which content is displayed to which viewer. Hence, a given user may be provided with a customized engagement experience when accessing a webpage. For example, a rule may specify that a given item of content is to be pushed to a user having certain subject and/or brand preferences and optionally not to other users. In addition or instead, a rule may specify that a given item of content is to be pushed to a user having certain demographics (e.g., a certain age range, certain locations, certain estimated income, certain family situation, etc.) and optionally not to other users.

Optionally, an anchor may be displayed (e.g., as a graphic, text, photograph, a highlighting of webpage text or graphic/image content, or otherwise) on a webpage, optionally independent of a user's interaction with the webpage. Optionally, an anchor may be displayed in response to a user hovering a cursor over or clicking on/selecting a specified area (e.g., where the anchor is positioned) or webpage HTML element. Optionally, more than one anchor may be defined for and displayed by a given webpage.

Optionally, a user interface may be provided which enables an entity setting the anchor to specify a location on a webpage at which the anchor is to be located. Optionally, the user interface enables a user to drag and drop an anchor from an anchor menu to any desired location on the webpage. Optionally, the user interface may enable the user to drop the anchor on a webpage HTML element (e.g., an element defined by a start tag, some content, and an end tag). Optionally, the user interface may enable the user to drop the anchor on a webpage HTML element with a specified left, right, top, or bottom offset, wherein the anchor may be placed in accordance with the specified offset(s) from the HTML element.

Optionally access may be provided to a search engine. A user interface search field may be provided to a user device via which a user can enter a search term to search for an item of content. The search engine may compare the search term with tags associated with items of content (e.g., in a content library) to identify matches. The matching items of content may be displayed on the user device via a search results user interface in ranked order. The user may then associate an anchor on a webpage with a selected item of content identified in the search results by activating a corresponding control (e.g., a control that causes the anchor to be linked to the selected item of content). The selected item of content may then be displayed in context as discussed above.

Optionally, the anchor may be caused to be displayed in a webpage via automatically generated code that is embedded in the webpage.

An aspect of the present disclosure relates to a content library that may be accessed via a user interface overlaying a website webpage. The user interface may be generated by the embedded automatically generated code discussed herein. For example, the user interface may overlay a webpage presented by a browser on an end user device. Optionally, a live content presentation (e.g., a video, audio, and/or text content presentation) may be archived and tagged and included in a library of content associated with the third party. Optionally, a library user interface may be provided on/overlaying the webpage via which the user can scroll through the content library and/or search the content library, and access and play back a selected item of content from the content library. For example, the content library may be specified by the owner of the website or of a brand.

Optionally, a control may be provided that enables a user to share an item of pushed content (e.g., via email, short messaging, social media, or otherwise)

An aspect of the present disclosure relates to a system that tracks which users currently are accessing, via their respective user devices, a given item of such pushed content. A user interface (e.g., generated using the embedded code) may be displayed on a given user device that indicates how many and/or which other users are currently accessing the content. For example, the user interface may display names, aliases, photographs, and/or avatars of other users currently having the content streamed to their devices and/or of content speakers and moderators. A user interface (e.g., generated using the embedded code) is optionally provided that identifies who is on a speaker panel for a given item of content. A chat user interface (e.g., generated using the embedded code) is optionally provided via which users can view and/or engage in chat with other content consuming users and/or with a speaker/moderator. Optionally, controls are provided (e.g., generated using the embedded code) via which a user can rate (e.g., on a scale of 1-5) or provide a like or dislike indication regarding an item of content. Optionally, such rating and/or indication may be displayed on other users currently accessing the content or to later users (e.g., accessing a content library in which the rated content is stored).

Optionally, the user interface(s) provided via the automatically generated code are displayed on a user device even as the user navigates to different webpages of the website.

An aspect of the present disclosure relates to an activity feed user interface via which users may communicate with each other (e.g., via video, audio, and/or text communications, such as via direct messaging) and/or share existing (e.g., prerecorded) video, audio, and/or text content. Optionally, a control may be provided via which an administrator may enable or disable inter-user communication (e.g., via direct messaging) and/or a control may be provided via which an end user may inhibit or enable other end users to communicate with (e.g., send a direct message) to the end user.

An aspect of the present disclosure relates to enabling an authorized entity to specify custom user interface tiles to be displayed via the user interface overlaying the website webpages. For example, tiles may be specified via the custom tiles user interface that provide advertisements, coupons, how-to content, news content, and/or other content from a specified source. The content may be dynamic content and/or static content (such as an RSS (Really Simple Syndication) feed, content that refers to (e.g., links to) other content which will be displayed via the activity feed). The custom tile user interface enables the administrative user to edit and/or change cards that are in a content carousel, can specify a carousel rotation timing, to view all cards in the carousel at the same time (e.g., in a pop-up window or another pane). Optionally, a control may be provided via which the user may specify that an artificial intelligence learning engine is to be used to select content for a given tile or carousel based on the number of clicks on content, the number of views of content, user demographic data, user preferences and interests (e.g., hobbies, preferred types of literature, preferred clothing brands, preferred clothing styles, preferred movies, preferred sports, preferred sports teams, etc.), links (e.g., URLs) to one or more social networks presences/pages of the given user, user interaction or failure to interact with content or controls, and/or other data (e.g., which may be used to authenticate a user, to identify a user to other users, to determine a user's interests, and/or for other purposes).

An aspect of the present disclosure relates to systems and processes configured to identify when two or more users are accessing the same or similar network resources. By way of non-limiting example, the network resource may be a static or dynamic online document, such as a webpage, or webpages associated with the same second level domain of a website (although the webpages may be at different subdirectories or different sub domains). The identification that two or more users are accessing the same or similar network resources may be performed by a remote and/or different system (which may be at times referred to herein as a multimedia communication system) than the web server hosting the website being accessed by the users. The multimedia communication system may be operated by a different entity than the entity that operates the website.

The multimedia communication system may instantiate an application, such as a widget application, on a network resource.

Upon detecting that two or more users are concurrently accessing the same network resource (e.g., a website or a specific webpage on a website), the multimedia communication system may cause the widget on a given user device to display to the given user identifiers associated with the other users. The given user may access profile information associated with the other users, may direct message with the other users, may interact with other users view threaded conversations, and perform other functions described herein. As will be described, although a widget application may be used to provide certain functionality, other techniques may be used, such as a browser extension or direct integration into a website.

Optionally, upon detecting that two or more users are accessing the same network resource (using respective user devices, such as a desktop computer, laptop computer, smart phone, networked television, networked game console, networked wearable device, and/or the like), the multimedia communication system may transmit a communication to the users (e.g., via the widget application instantiated on respective user devices) requesting permission to inform the other users accessing the network resource of the concurrent access and requesting permission of a given user to enable communications with other users concurrently accessing the network resource. Optionally, a given user may prospectively grant permission to notify selected users or all users (e.g., during an account creation process or via a terms of use interface, which may include a corresponding opt-in interface) when they are concurrently accessing a network resource with the given user of such concurrent access and may grant permission to enable communications with the given user.

Where the multimedia communication system enables a given user to selectively specify which other users are to be informed that the given user is concurrently accessing a network resource (as opposed to all users), the system optionally may enable the given user to upload identification, contact and/or other data of other users for which such permissions are being granted. The uploaded data may include a unique identifier generated by or on behalf of the multimedia communication system, where the multimedia communication system may transmit respective unique identifiers to the corresponding users. The users may in turn share their unique identifier with other users, who may utilize received unique permissions to grant the foregoing permissions.

Optionally, a given user may grant such permissions to other users that the given user is connected to (e.g., friends with, linked to, etc.) on or more specified social media or content sharing websites. For example, a given user may grant the multimedia communication system access to the given user's connections on one or more platforms, and the multimedia communication system may access and utilize such connections in determining who may be informed that the given user is concurrently accessing a network resource.

Optionally, when a user accesses a network resource, the user may be prompted to grant the foregoing permissions with respect to any other users concurrently accessing the network resource.

Once permission has been granted (where permission may be affirmatively granted as discussed above or granted by simply accessing the network resource or the communication services), the multimedia communication system may enable corresponding users concurrently accessing a network resource to communicate via one or more communication channels using interfaces provided via a widget application. Such communication channels may include video, audio, text, and/or screen sharing. For example, users may be enabled by the multimedia communication system to initiate and conduct video chat conferences with multiple selected other users, where an audio/video feed (e.g., of the user's voice and face) from a microphone and camera of a user device (e.g., a front facing phone, laptop, tablet, or desktop computer) may be streamed to devices of other users for video and/audio playback. In addition or instead, users may be enabled to communicate via text and/or graphics (e.g., emojis) and/or just with voice. Further, users may be enabled to share content (e.g., documents, such as text documents, video content, audio content, still images, links, etc.) with each other.

Optionally, each user concurrently accessing a common network resource is provided (e.g., via the widget application) identity information for the other users (where the identity information may include a corresponding user name, alias, photograph, avatar, email address, phone number, device name, and/or the like). Such identification information may be transmitted to the user devices and presented in a list (e.g., using a widget interface).

Optionally, a user can be prompted to view content or to register to enable user communication widget features based on one or more criteria. The prompt may be triggered based on user characteristics and/or user navigation behavior.

Examples of navigation triggers may be detecting the a user has been on a certain webpage for at least a threshold period of time (e.g., 3 seconds, 5 seconds, 10 seconds, 30 seconds, or other threshold period of time), that the user has scrolled at least to a first position in the webpage, that the user is exiting the webpage or website, that the user has clicked on (or otherwise selected) a content item on the webpage, a previous site or webpage visited by the user, and/or the like.

Example user characteristics may include whether the user is a registered user of the website operator or is not a registered user of the website operator. Further example user characteristics may include the user's physical location. By way of example, the user's location which may be determined: using a geolocation application programming interface (API) where the user is prompted to provide the user's location; the user's Internet Protocol (IP) address; by detecting the user's time zone using a JavaScript Intl API; and/or otherwise. Other user characteristics may include determined demographic data (e.g., age, income, education) and interests.

By way of illustration, in response to a detected trigger, a pop-up or other notification may be presented, indicating that a person (e.g., a celebrity, an actor, an athlete) that is determined to be of possible or likely interest to the user (which interest may be determined based on the user's characteristics) will be conducting a text, audio, or audio/video online chat with users of the communication widget of the website at a specified time (e.g., in the next 5 minutes). The notification may include a countdown timer which counts down to the chat event. The chat event may be accessible via the communication widget for the website. Optionally, the user may be prompted to or required to become a registered user in order to access and participate in the chat.

Other examples of content that may be provided include pre-recorded or live one-way text, audio, and/or audio video content.

The detection of a user's access of a website may be performed using access detection and communication code (e.g., JavaScript) embedded in a website's webpage. For example, optionally the same operational access detection and communication code may be embedded in different webpages of different websites operated by different, unrelated entities (although the code may be modified for each website to include a unique identifier associated with the website) and may optionally provide a functionally common interface with respect to the different websites (although each website may optionally have its own branding and may disable or enable certain functions).

Optionally, in addition or instead, a browser extension may be added to a user's browser (e.g., by the user accessing and installing the extension from a browser extension library or otherwise) that detects when a user is accessing a given website or webpage and that enables user communication over one or more channels and other functionality described herein. Optionally in addition or instead, a dedicated application (which may be referred to as an app) may be downloaded (e.g., from an app store) to a user device that detects when a user is accessing a given website or webpage and that enables user communication over one or more channels and other functionality described herein. Optionally, the functionality may be integrated into a given website.

Advantageously, to further enhance security, optionally the third party website may be inhibited from accessing authentication data associated with the multimedia communication system, and the multimedia communication system may be inhibited from accessing the authentication data associated with a third party website.

In order to further enhance and promote communication among users concurrently accessing a network resource, such as a website, user profile information may be shared. Optionally, a user profile may be generated which may include user identification data (e.g., first name, last name; first name and just first letter of last name; an alias; an avatar or photograph, etc.), a user's mobile/cell phone number, user biographical information (e.g., career data, educational institutions attended, etc.), background data, location, demographic data (e.g., gender, age, income, level of education, marital status, number of children, etc.), user preferences and interests (e.g., hobbies, preferred types of literature, preferred clothing brands, preferred clothing styles, preferred movies, preferred sports, preferred sports teams, etc.), links (e.g., URLs) to one or more social networks presences/pages of the given user, and/or other data (e.g., which may be used to authenticate a user, to identify a user to other users, to determine a user's interests, and/or for other purposes). The user may specify which user profile data may be shared with other users as a public profile.

When a given user accessing a network resource is detected, some or all of the given user's data may be presented to other users concurrently accessing the network resource (e.g., all users, those permitted by the given user to access the given user's data, those that have opted in to receive such data, etc.). For example, initially, an identifier of the given user (e.g., first name and first letter of last name, alias, etc.) may be displayed on respective devices of other users. A user viewing such identifier may indicate that additional information is desired (e.g., by pointing at the identifier, such as my touching the identifier if the identifier is displayed via a user device touch display, or by hovering over or clicking the identifier using a cursor being navigated using a mouse, trackpad, stylus, or other pointing device). For example, such additional information may include biographical data, background data, location data, interest data, and/or the like. The additional information may include some or all of the profile data in the public profile defined by the given user. Optionally a user may request that the given user permit access to specified other data of the given user (e.g., location information or when the given user intends to access a given network resource), which the given user may grant or deny.

Optionally, rather than storing user profile information and the like, a user may provide the multimedia communication system with a link to such information accessible on a third party site (e.g., a publicly accessible social media page of the user). The multimedia communication system may then share the link with other users concurrently accessing a network resource, via which such other users may access and view the user profile information.

Optionally, a user or system generated password is not used to authenticate a user (e.g., when accessing the given user's account, creating or editing the given user's profile, etc.). Instead, the given user's mobile phone number may be used to authenticate the given user.

Optionally, when users concurrently accessing a network resource want to share content, rather than passing actual content (e.g., documents) to each other, users can share a link to such content (e.g., where such content is hosted on a cloud system or elsewhere).

Thus, security may be enhanced by optionally avoiding the storage of very sensitive user information (such as user or system generated passwords) on the multimedia communication system. Further, rather than storing user documents and/or user profile information, the multimedia communication system may transmit links to such user documents and user profile information stored on third party systems (e.g., social networking systems, cloud-based document sharing systems, etc.), thereby further enhancing security. Thus, even if a hacker gained improper access to the multimedia communication system, the hacker would not find user or system generated passwords, documents, and/or user profile information stored on the multimedia communication system.

As will be described, the multimedia communication system may enable users to establish preferred network connections with selected other users, where non-public data may be shared amongst preferred network connections. Further, as will be described, threaded communication channels may be established for different subjects that enable users to post messages and access such posted messages.

Certain aspects will now be discussed with reference to the figures.

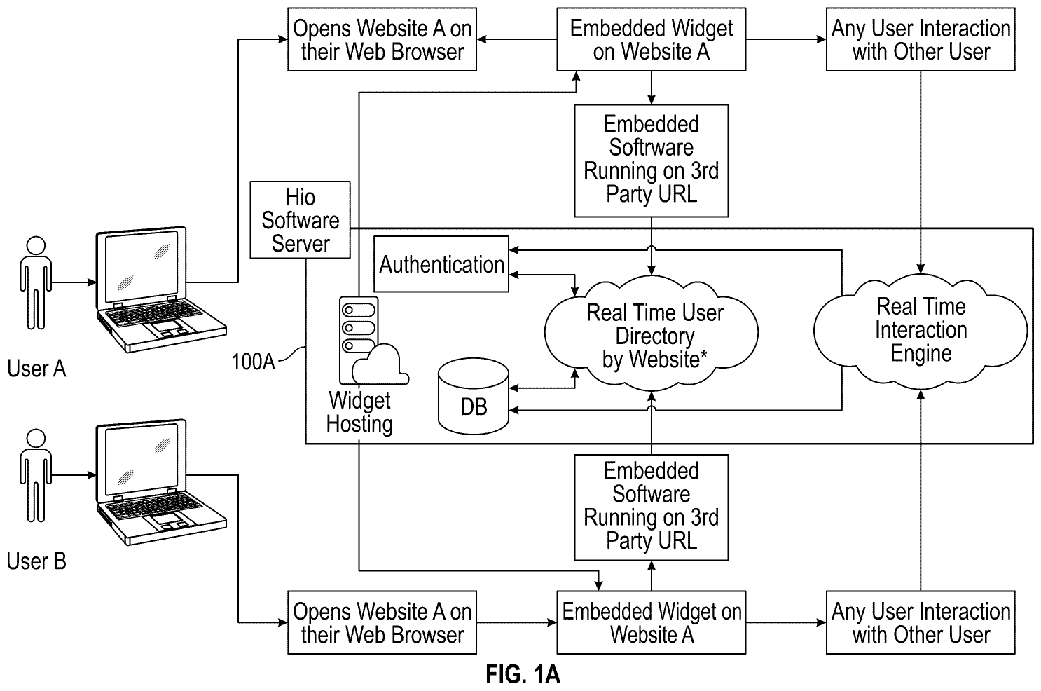

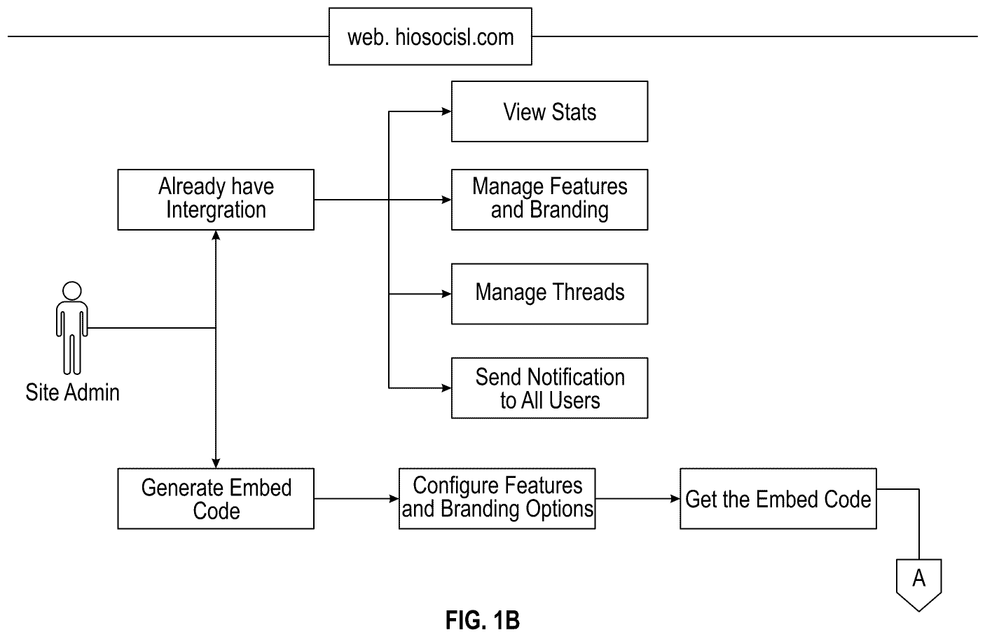

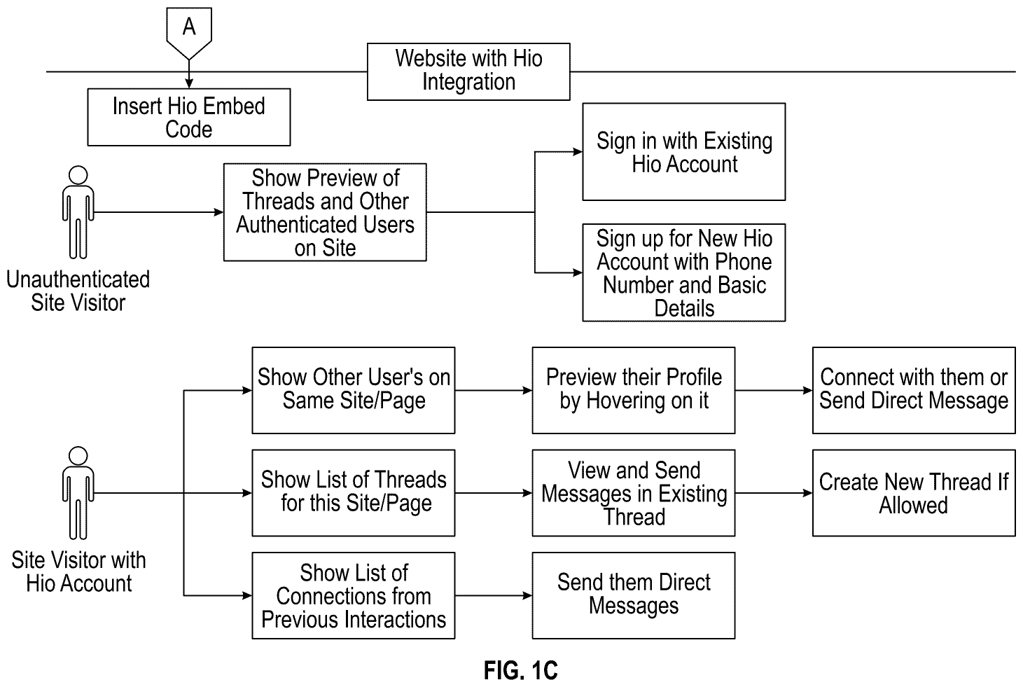

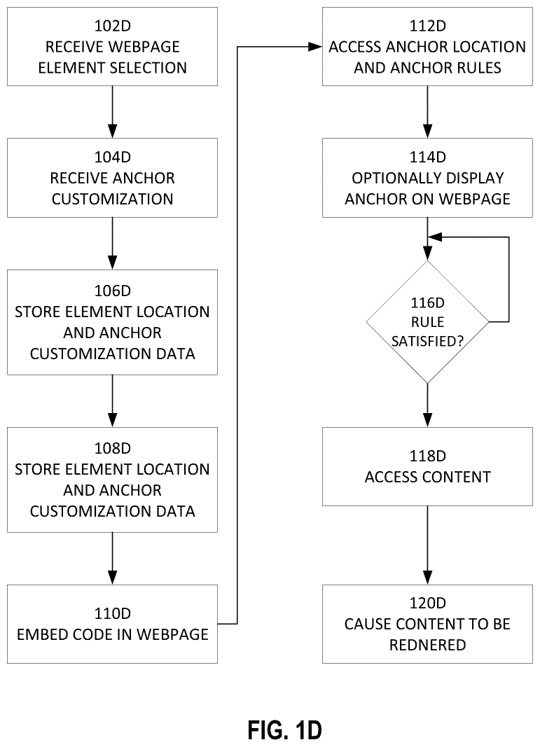

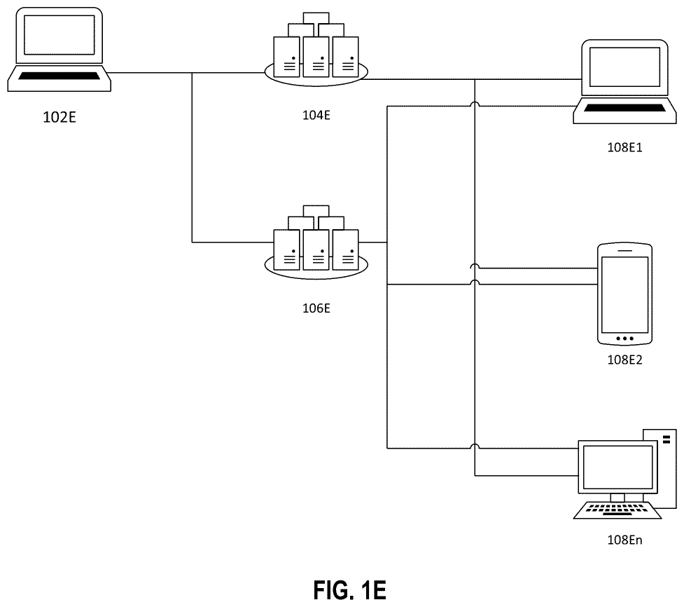

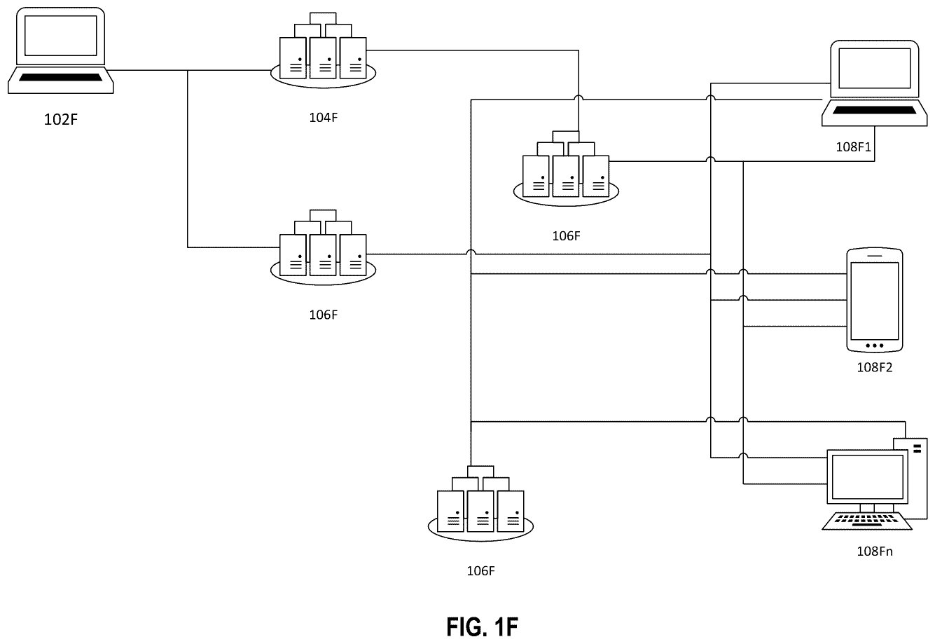

FIG. 1A illustrates an example architecture. A multimedia communication server system 100A may include a widget hosting service that hosts the widget code discussed elsewhere herein that provides services and user interfaces described herein. When a user accesses a third party website webpage (associated with a corresponding URL) via a client on a user device, the user may be authenticated and the corresponding widget may be embedded on the accessed third party webpage to provide the user interfaces and functionality described herein. The embedded widget may also communicate with embedded software running on the third party URL. A real time third party user directory may identify users that are concurrently accessing the website and/or the specific webpage. Such a user directory may be used to indicate to a given user other users that are concurrently accessing the website and/or the specific webpage, and may identify which of such other users are “connected” to the given user. The real time directory may access data discussed herein from a database and/or may store data in the database.

A real time interaction engine may detect users' interactions with the widget and widget user interfaces (such as those described herein), and take appropriate action, such as the actions described herein. For example, the real time interaction engine may detect and act on requests by one user to be connected to another user, may communicate direct messages from one user to another user, may post a user's message to a thread specified by the user, may access and provide archived messages in response to a user request, may access and provide user profile information is response to the given user pointing at a corresponding user profile, and/or the like. The real time interaction engine may access data discussed herein from a database and/or may store data in the database.

The multimedia communication server system 100A may be implemented as a cloud-based system and the processes described herein may be performed in whole or in part by a secure hosted computing environment that includes a collection of physical computing resources that may be remotely accessible and may be rapidly provisioned as needed (sometimes referred to as a “cloud” computing environment). The multimedia communication system 100A may include additional or fewer components than illustrated in FIG. 1A. The database may optionally be hosted in a data store, such as a hosted storage environment that includes a collection of physical data storage devices that may be remotely accessible and may be rapidly provisioned as needed (sometimes referred to as “cloud” storage).

The multimedia communication server system 100A may communicate over a network with one or more user devices and third party websites. The network may include any wired network, wireless network, or combination thereof. For example, the network may be a personal area network, local area network, wide area network, over-the-air broadcast network (e.g., for radio or television), cable network, satellite network, cellular telephone network, or combination thereof. As a further example, the network may be a publicly accessible network of linked networks, possibly operated by various distinct parties, such as the Internet. The network may be a private or semi-private network, such as a corporate or university intranet. The network may include one or more wireless networks, such as a Global System for Mobile Communications (GSM) network, a Code Division Multiple Access (CDMA) network, a Long Term Evolution (LTE) network, or any other type of wireless network. The network can use protocols and components for communicating via the Internet or any of the other aforementioned types of networks. For example, the protocols used by the network may include Hypertext Transfer Protocol (HTTP), HTTP Secure (HTTPS), Message Queue Telemetry Transport (MQTT), Constrained Application Protocol (CoAP), and the like. The communication channels may be securely encrypted using private and public keys and/or other encryption techniques.

Although the embodiment illustrated in FIG. 1A utilizes a widget in providing user interfaces and certain services to a user, optionally in addition or instead, a browser extension may be added to a user's browser that detects when a user is accessing a given website or webpage and that enables communications between users, that enables posting to and access of subject threads, that provides profile information, and/or that performs other functions described herein. Optionally in addition or instead, a dedicated application may be downloaded (e.g., from an app store) to and installed on a user device that detects when a user is accessing a given website or webpage and that enables communications between users, that enables posting to and access of subject threads, that provides profile information, and/or that performs other functions described herein. Optionally, the functionality may be integrated into a given website.

FIGS. 1B-1C illustrate an example process flow. An authorized user of the multimedia communication system (e.g., an administrator) may determine for a given third party site whether the site is already integrated with functionality described herein. If not, then communication code may be generated to be embedded in the site's website (e.g., in the HTML code of one or more web pages) to enable functionality described herein. The code may be used to access widget code configured with one or more feature options.

For example, an operator of a website may enable or disable the making of user connections, enable or disable one or more (e.g., all) chat channels (e.g., video chat, text chat, etc.), enable or disable the provision of subject threads, define and name subject threads, post updates and offers (e.g., operational features, coupons, discounts, etc.), and/or the like.

As discussed elsewhere herein, the multimedia communication may optionally generate and provide code (which may be as little as one line of code) to be included on webpages of a given website. The code may include a unique identifier associated with the website. When an authenticated user accesses the website via a user device, the code may be used to initiate a message from the user device to the multimedia communication system, the message including the unique website identifier. A larger code set (e.g., widget application code) may be accessed which may be configured in accordance with the feature options and branding website. The code set may then be downloaded to the user device, and the interfaces and branding will be accordingly configured by the user device and may be presented via a widget application. Optionally, different websites may use the same or essentially the same corresponding widget code set, with each configured to operate and provide widget interfaces in accordance with their corresponding feature option configuration. Thus, different websites operated by different entities may utilize at least a subset of functionally the same user interfaces provided via the multimedia communication system, but each may have their own branding to make the user interfaces appear even better integrated with the website.

If the third party website is integrated with functionality described herein (e.g., already has the communication code embedded), the administrator may view various statistics for any actions performed using the functionality provided and tracked via the multimedia communication system.

For example the statics may relate to overall aggregate statistics or statistics for a specific period of time (e.g., a specific start/stop date and/or time) for visiting users that have been authenticated by or have accounts with the multimedia communication system, such as: how many visiting users are accessing the website concurrently or overall, the amount of time a given visiting user was accessing the website for a given browsing session, the average amount of time visiting users were accessing the website for a given browsing session, the number and type (e.g., video messages, text messages, direct messages, public/group messages, etc.) of messages transmitted between users concurrently accessing the website, the average length of video call chats, common profile characteristics of users having similar communication patterns, peak visit times, peak communication/messaging times, how many connection requests were transmitted, how many connection requests were accepted, demographic information for visiting users, and/or other such information.

In addition, the administrator may manage which features are to be activated or deactivated for the website, and branding for the user interfaces for the website, as similarly discussed elsewhere herein. For example, user interfaces may be provided that enable a user to quickly and accurately specify which features discussed herein are activated or deactivated. Further, user interfaces may be provided that enables a user to configure the operations of features. By way of illustration, the user may specify the website URL, branding, HTML/hex color codes for a primary color and/or colors, what type of user networking is enabled, whether there is to be a single or multiple forum threads, and/or other functions and features. The system may then automatically generate code enabling/disabling and configuring the features and appearance accordingly. The generated code may then be embedded on the website/webpage and provide and execute the features accordingly via a customized widget. The disclosed technology may advantageously reduce the amount of computer process, memory, and network resources that would otherwise be necessary if each website operator had to develop their own widget.

Visiting users accessing the third party website may be unauthenticated (e.g., do not have an account with the multimedia communication system or are not identified as having an account) or may be authenticated (e.g., logged into their account or otherwise identified). If a visiting user is not authenticated, the visiting user may sign into their existing account, if they have one, or may sign up for a new account. For example, in creating their account, the user may be prompted to provide their phone number, and a code may then be transmitted to the phone number. The user may be prompted to enter the code, and if the user enters the code, the user is authenticated, and the account may be created.

The user may also be prompted to provide certain information for their profile, which may then be stored in the user's account. For example, a user may provide information, such as hobbies, preferred types of literature, preferred clothing brands, preferred clothing styles, preferred movies, preferred sports, preferred sports teams, preferred websites, preferred shopping destination, links (e.g., URLs) to one or more social networks presences/pages of the user, other profile data described herein, and/or other data.

If the visiting user has an account with the multimedia communication system, the user may cause a preview of communication threads on one or more subjects to be presented and may identify other users concurrently visiting the site (e.g., causing their names and/or other identifiers to be displayed). In response to the user pointing at a given user identifier (such as my touching the identifier if the identifier is displayed via a user device touch display, or by hovering over or clicking the identifier using a cursor being navigated using a mouse, trackpad, stylus, or other pointing device), profile data for the given user may be presented. Optionally, the profile data may be limited to profile data that the given user has agreed to share with other users (e.g., a public profile for non-connected users and a private profile for connected users). A messaging interface may be provided that enables the user to communicate with the given user via a direct message using a selected communication channel (e.g., text, video, audio).

In addition or instead, the user may connect with the given user. For example, a user may send another user (who may be referred to as the recipient) that is concurrently accessing a website a connection request. By way of illustration, the user may be presented in a list of users concurrently accessing the website, and the user may select the recipient from the list, and activate a connection request control. The multimedia communication may receive the selection and connection request control activation, and may transmit the connection request to the recipient.

The recipient may elect to accept or deny the connection request. If the recipient accepts the connection request, profile information designated by the requesting users as shareable with connections (where such profile information is not to be shared with non-connections and which may be referred to as non-public data or a private profile, which may include location information, phone number, email address, social media links, demographic information, and/or other information) may then be shared with the recipient that accepted the connection request. If the recipient refuses the connection request, then the recipient will not be provided with access to such private profile of the requester.

For example, a given user may point at an identifier of another user that is a connection, in one of the user interfaces described herein, and some or all of the foregoing non-public profile information of the connection may be presented. In addition, a user may specify that certain content (e.g., documents, videos, audio recordings, photographs, content links, etc.) may be shared with connections, but not with non-connections.

Optionally, the acceptance of a connection is one-way, in that if the request is accepted, the requester's private profile may be shared with the recipient, but the recipient's private profile is not shared with the requester. Thus, in order for the requester to have access to the recipient's private profile, the recipient may be required to affirmatively grant such access. For example, the recipient may send a reply connection request to the original requester, and if the original requester accepts the reply connection request, then the recipient's private profile may be shared with the original requester. Optionally instead, if a recipient accepts the connection, then the recipient's private profile is automatically shared or shareable with the requester.

In addition, a user interface may be displayed to the visiting user that lists communication subject threads for the current webpage and/or website. The visiting user can select a subject communication thread, and messages in the thread may be accessed from memory and displayed on the user device. In addition, the visiting user may post a message within the thread. Optionally, the visiting user may create and name a new thread if such creation privilege has been granted to the given user (or to users in general).

A user interface may be displayed to the visiting user that lists user connections created from previous interactions and that enables the visiting user to transmit direct communications to such connections.

The example user interfaces described herein may be generated displayed via code (e.g., widget application code) received from the multimedia communication system, via a browser extension, via a dedicated downloaded application installed on the user device, or via services integrated in a website, as described elsewhere herein.

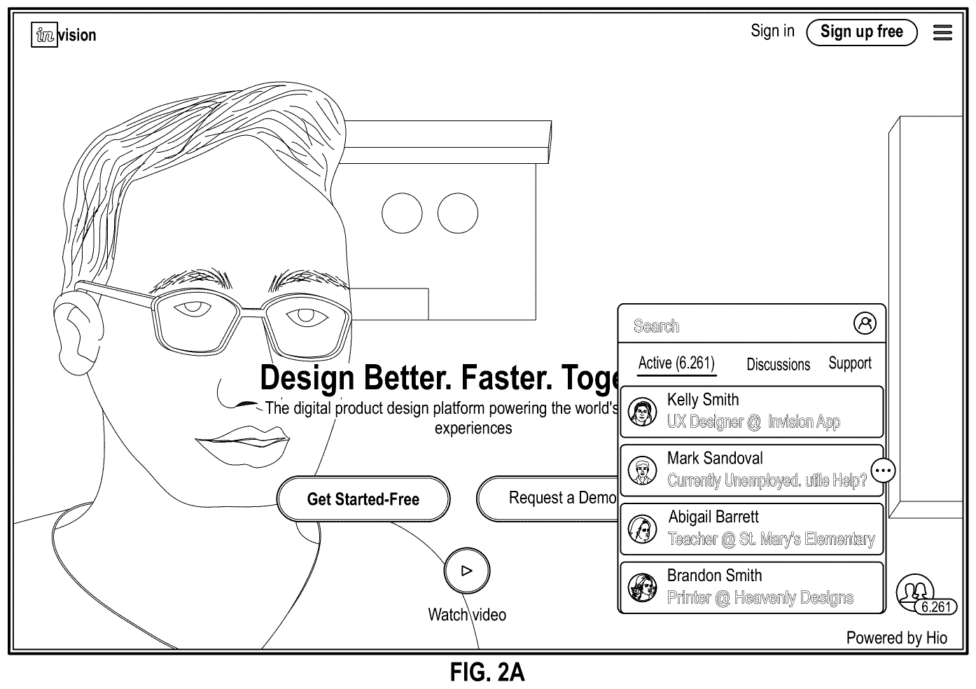

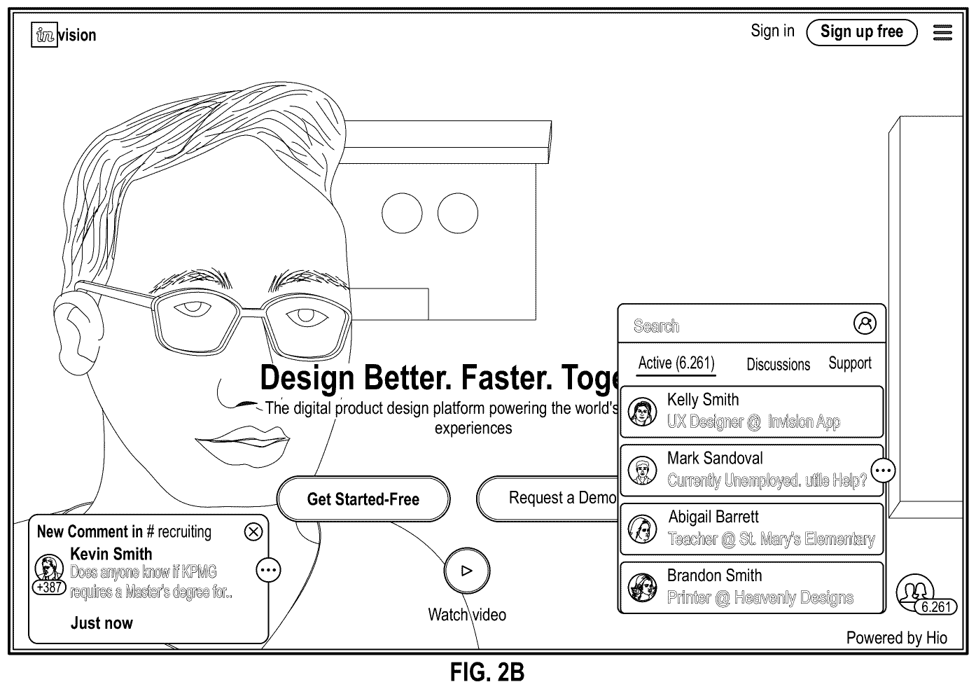

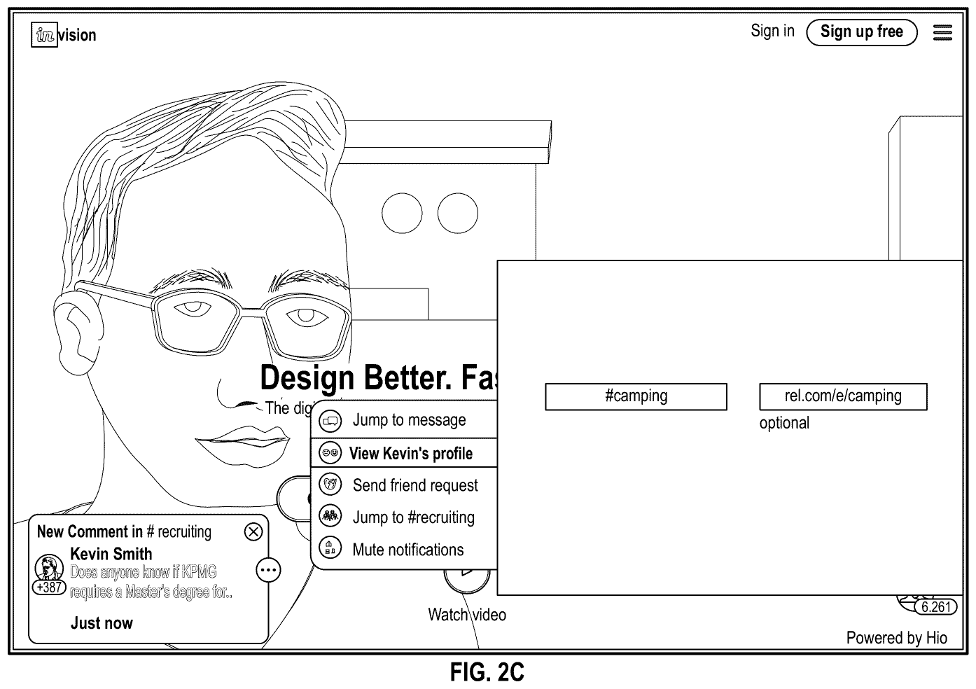

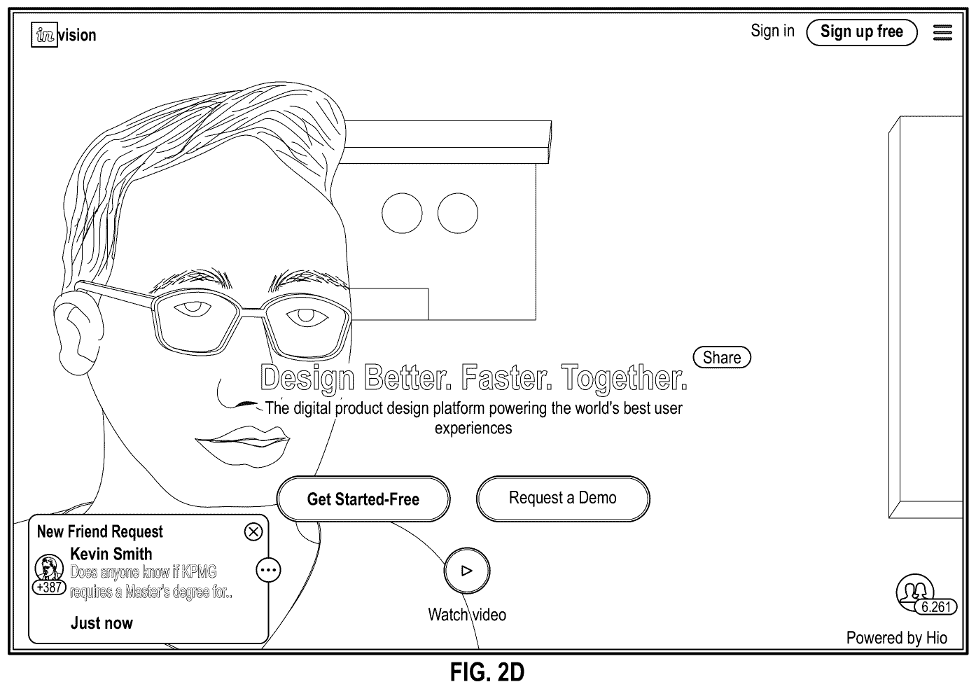

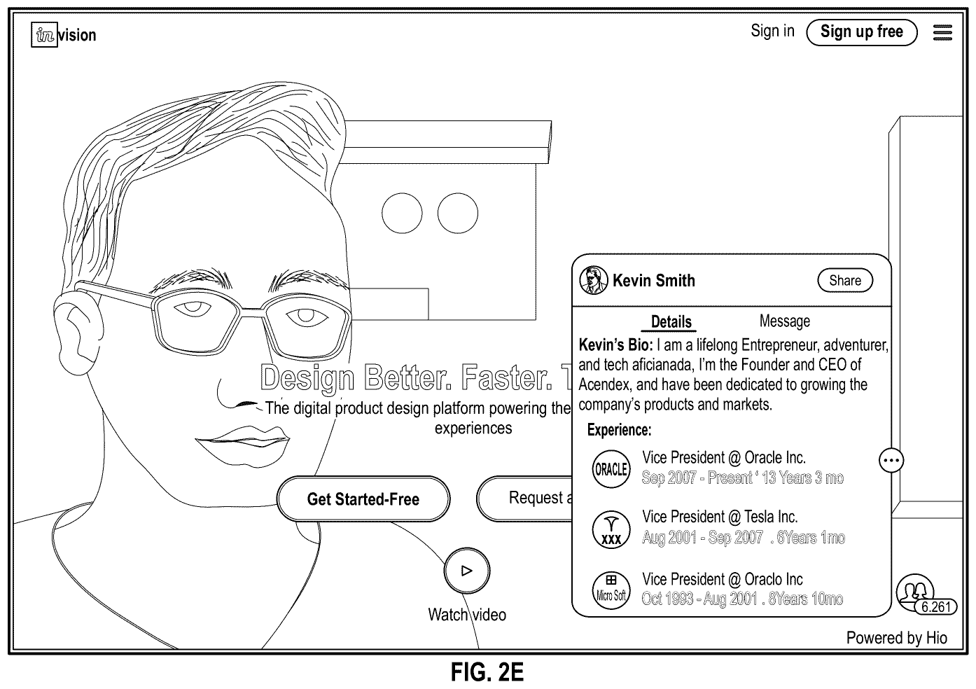

FIG. 2A illustrates an example user interface with links to active participants (optionally listing the number of active participants and/or discussions, discussions, and support). Active participants may be those who have interacted with the website and/or the multimedia communication system via the website within a threshold period of time (e.g., the last 15 seconds, 30 second, or other threshold period of time). This technique avoids identifying users that have terminated their session or been disconnected in the participant list, and so the users still on the website can avoid attempting to interact with such inactive users.

In the illustrated example, active participants are listed. FIG. 2B illustrates the user interface of FIG. 2A, with a popup of a recent posting in a given subject thread channel (e.g., recruiting). FIG. 2C illustrates the user interface of FIG. 2B, with a popup of action controls for responding to the recent posting in the given subject thread channel. For example, the action controls may include a “jump to message” control, a view selected user's profile control, a send friend (also referred to as a connection) request control, a jump to a specified thread (e.g., #clubs) control, and a mute notifications control. FIG. 2D illustrates a new friend request pop-up notification, including an image of the user making the request, the name of the user making the request, a job title, and a company name. The user can click on a link in the request, and additional information about the requester may be presented, as illustrated in FIG. 2E.

Certain additional example user interfaces will now be discussed. While the example user interfaces may illustrate or refer to text communications (e.g., text messages), the user interfaces may be similarly adapted to video and voice-only communications. The user interfaces may be presented overlaying or adjacent to a network resource (e.g., a webpage) being accessed by a user device.

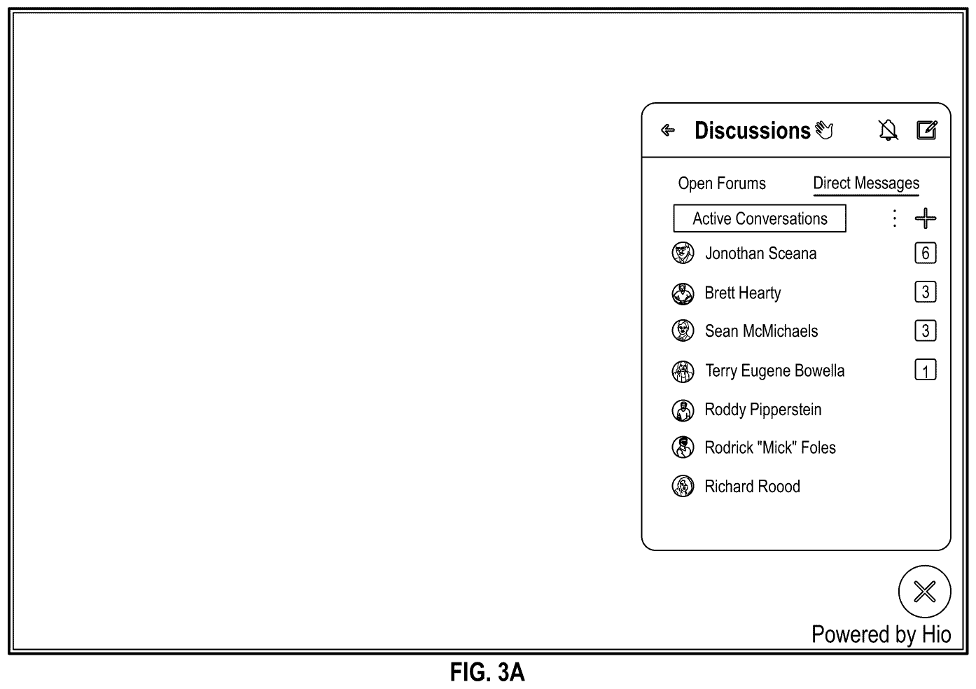

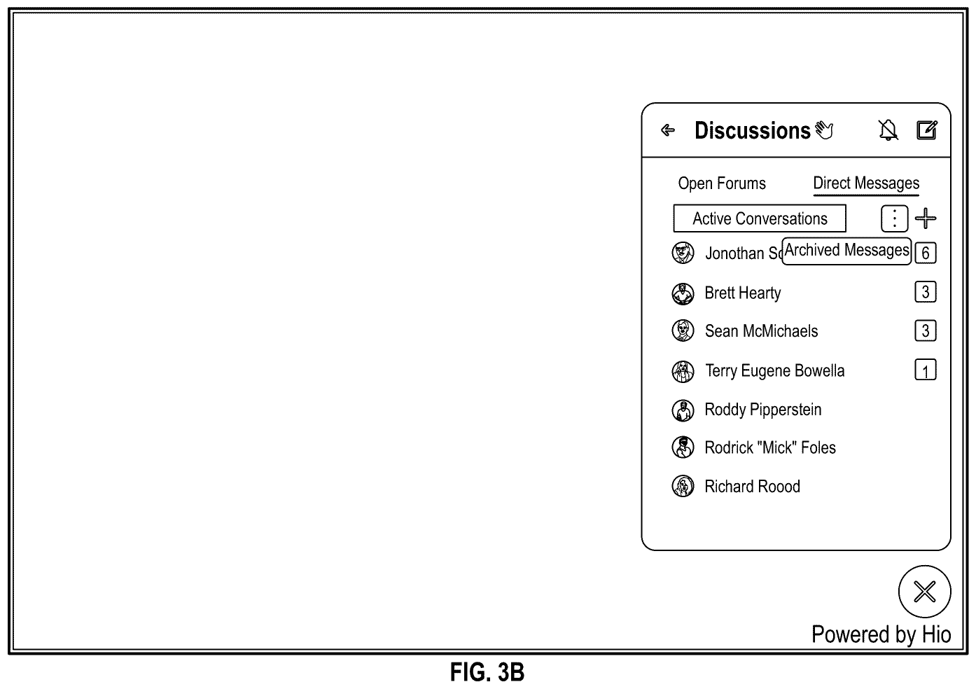

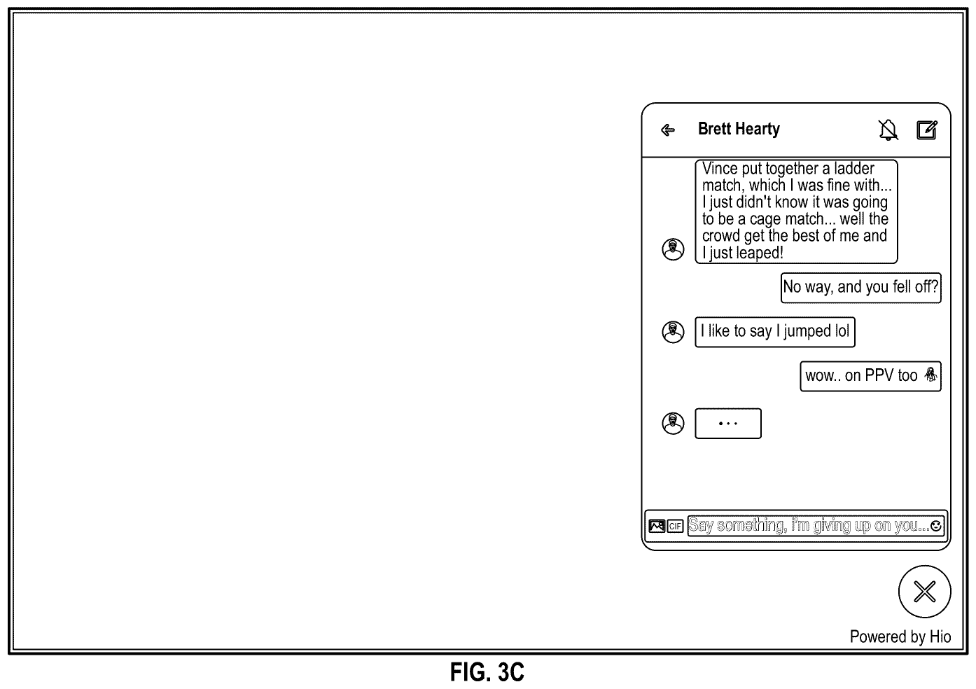

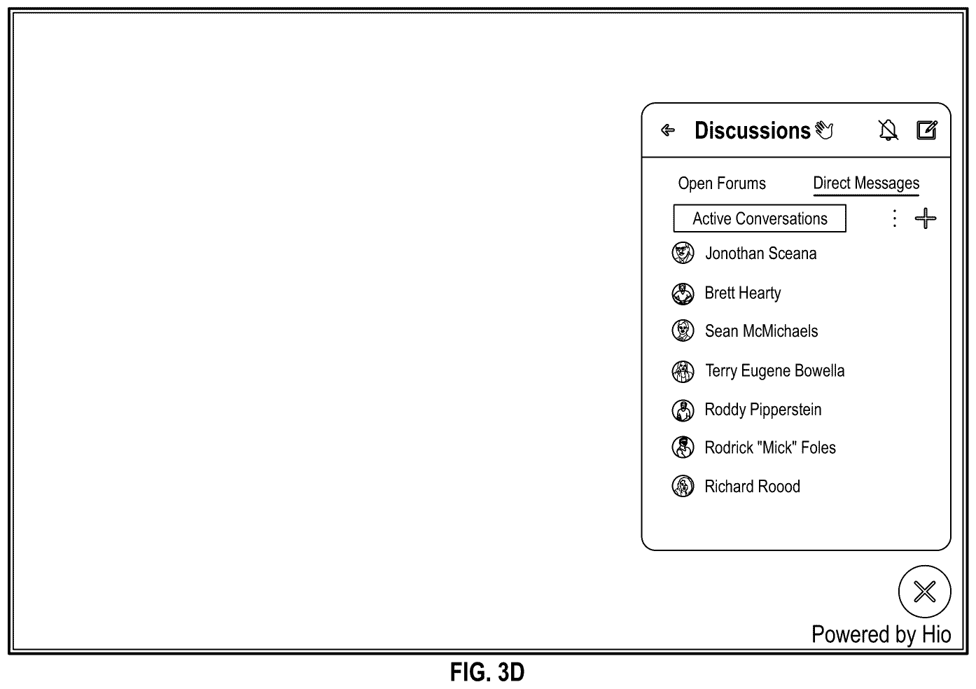

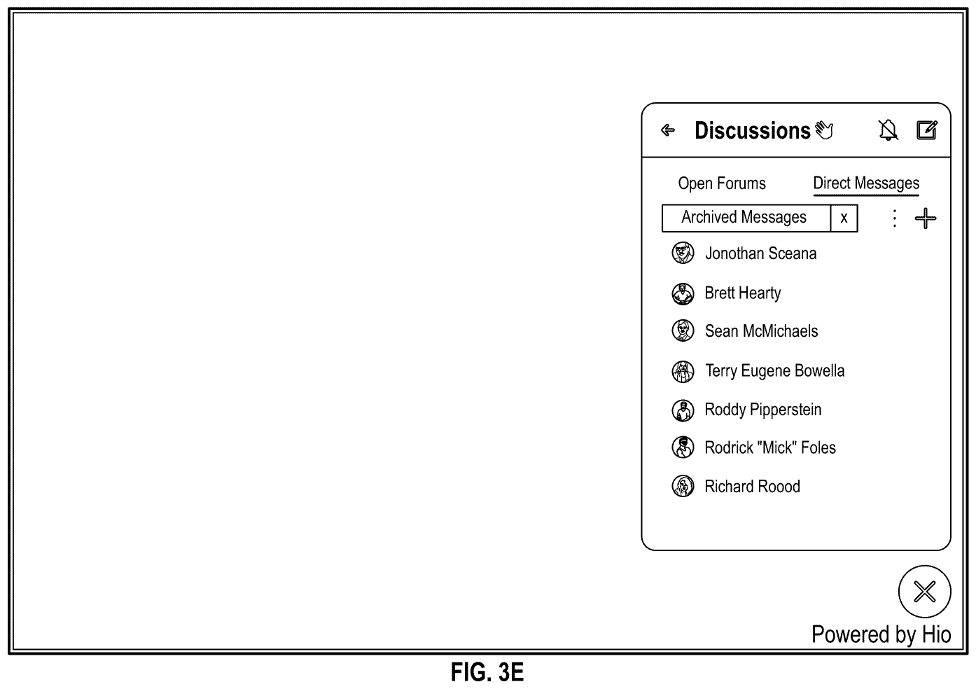

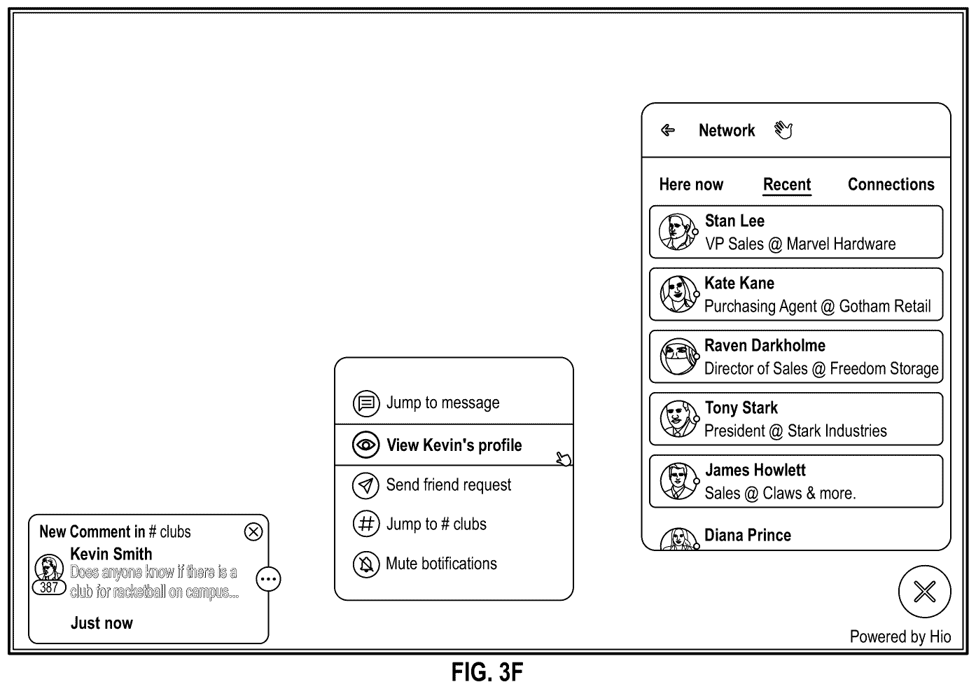

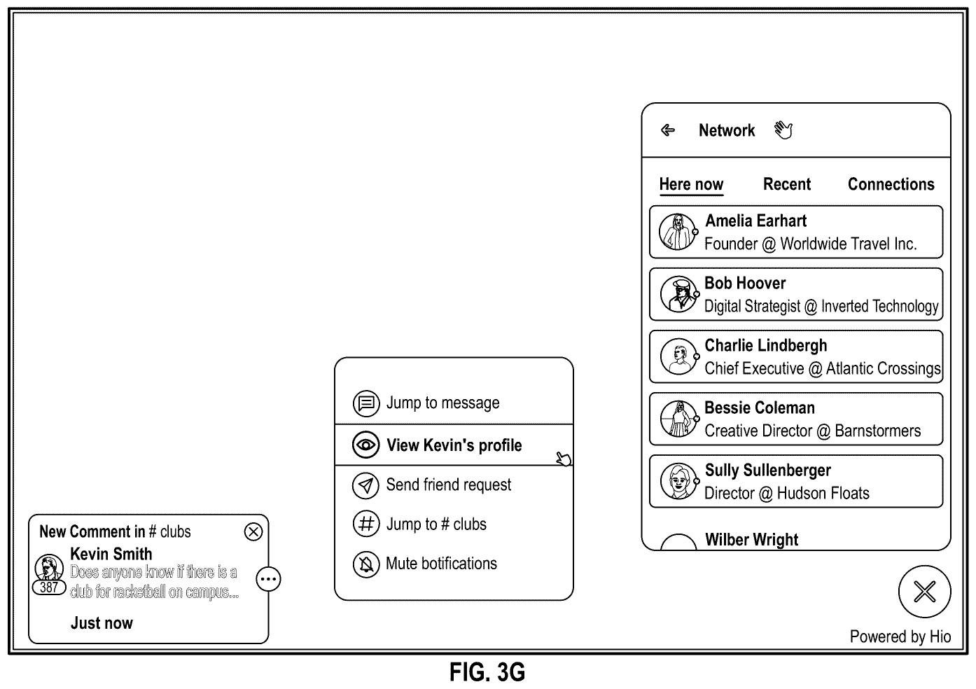

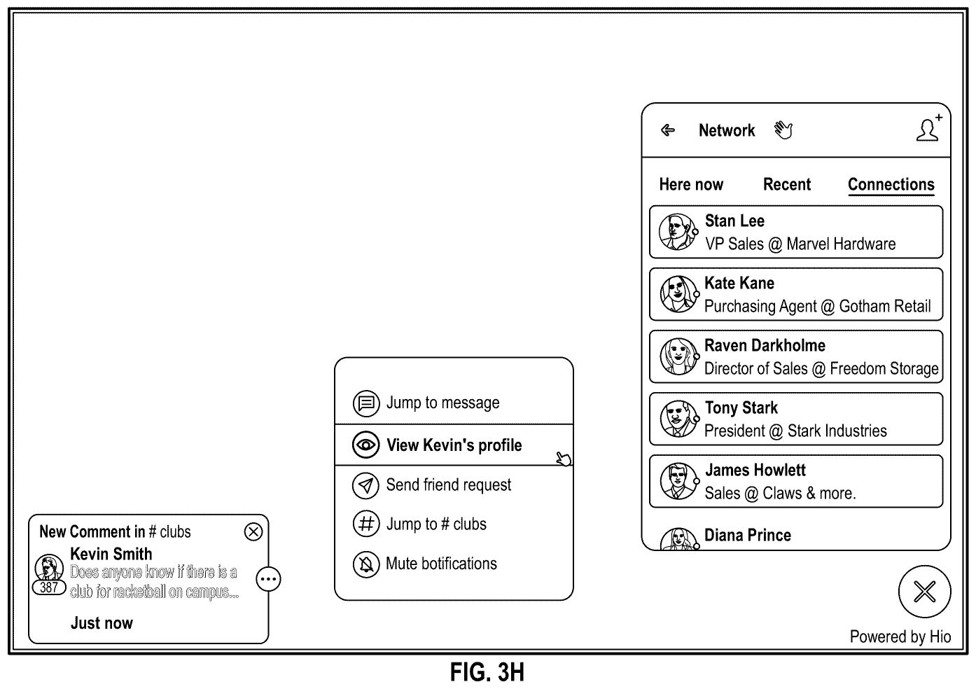

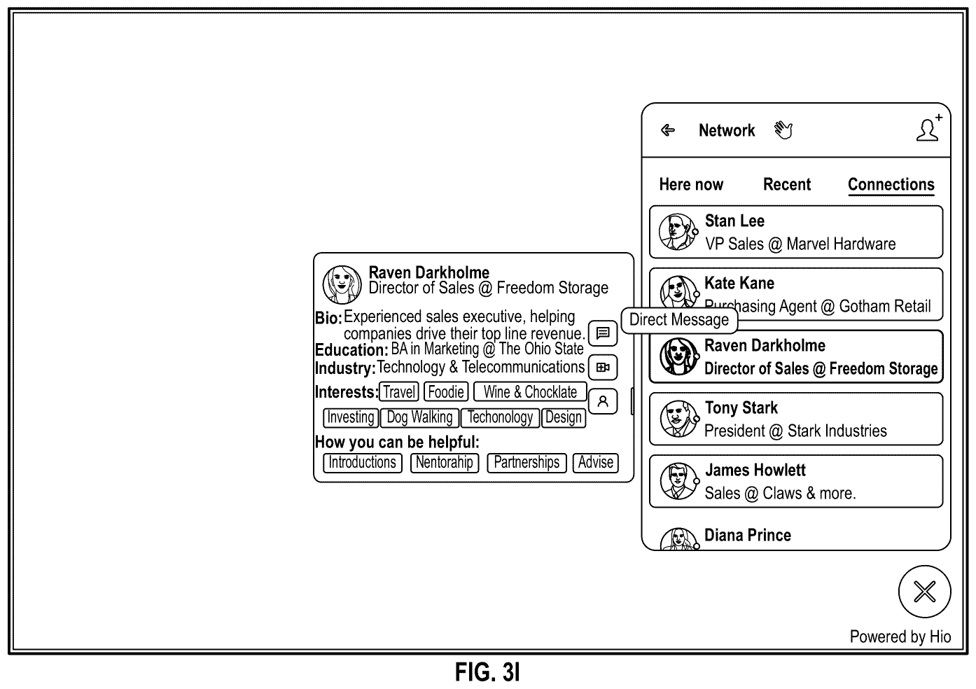

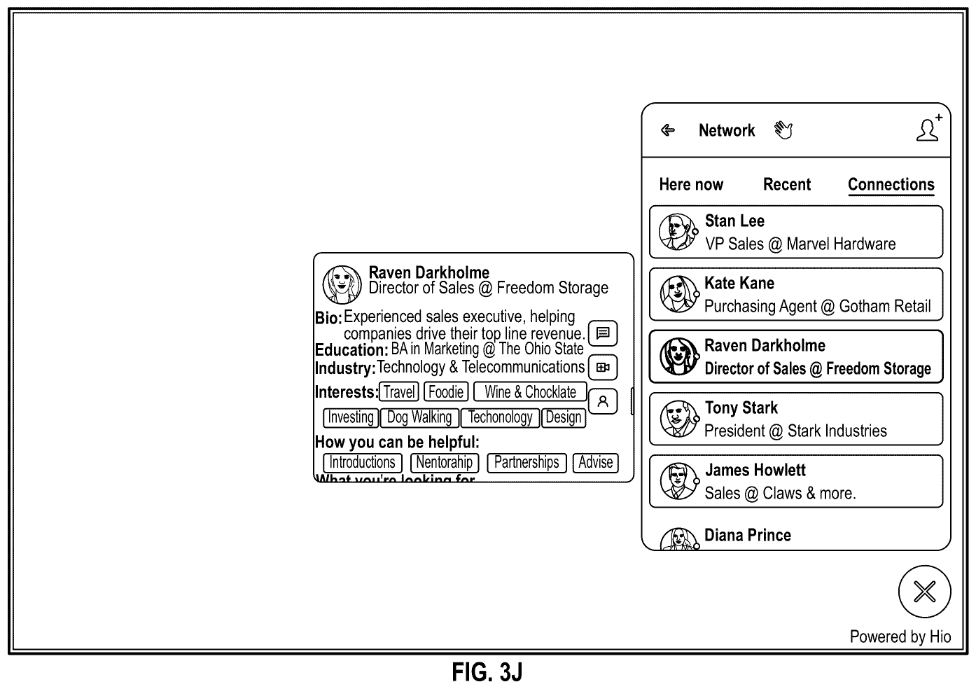

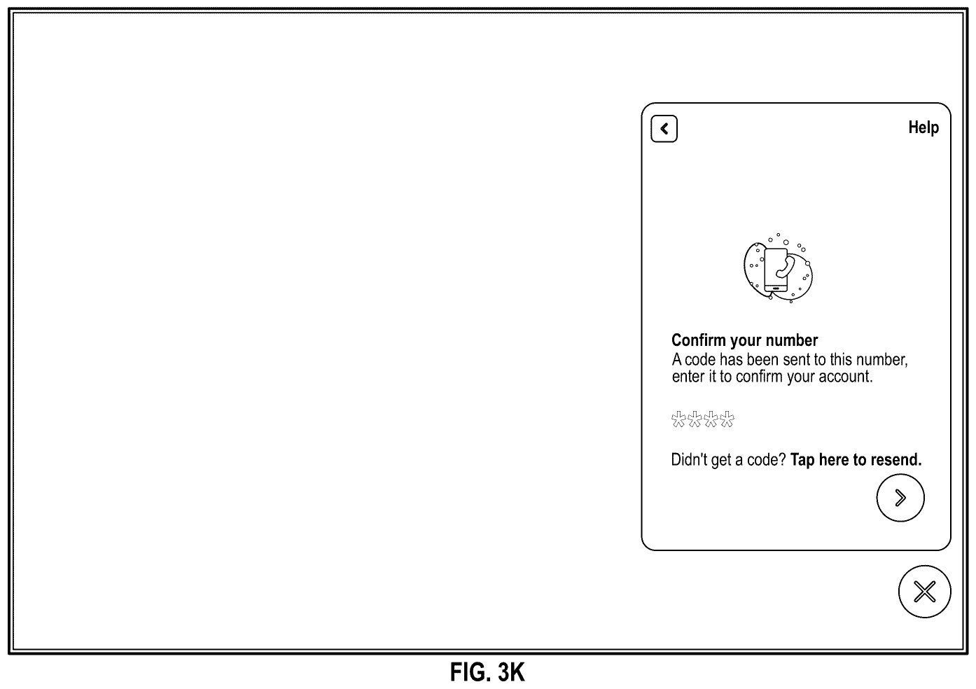

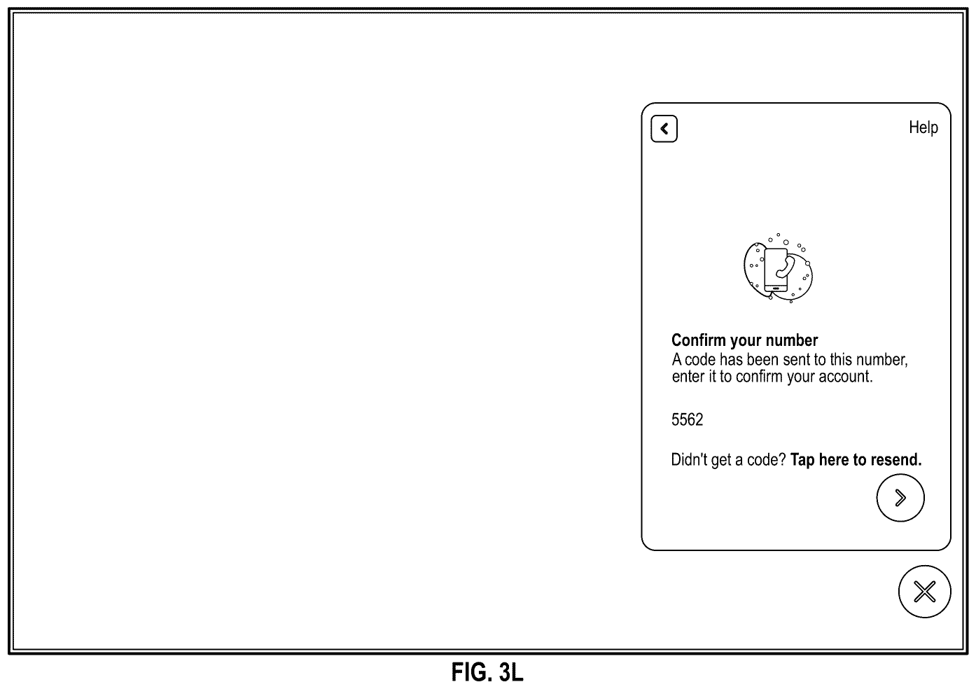

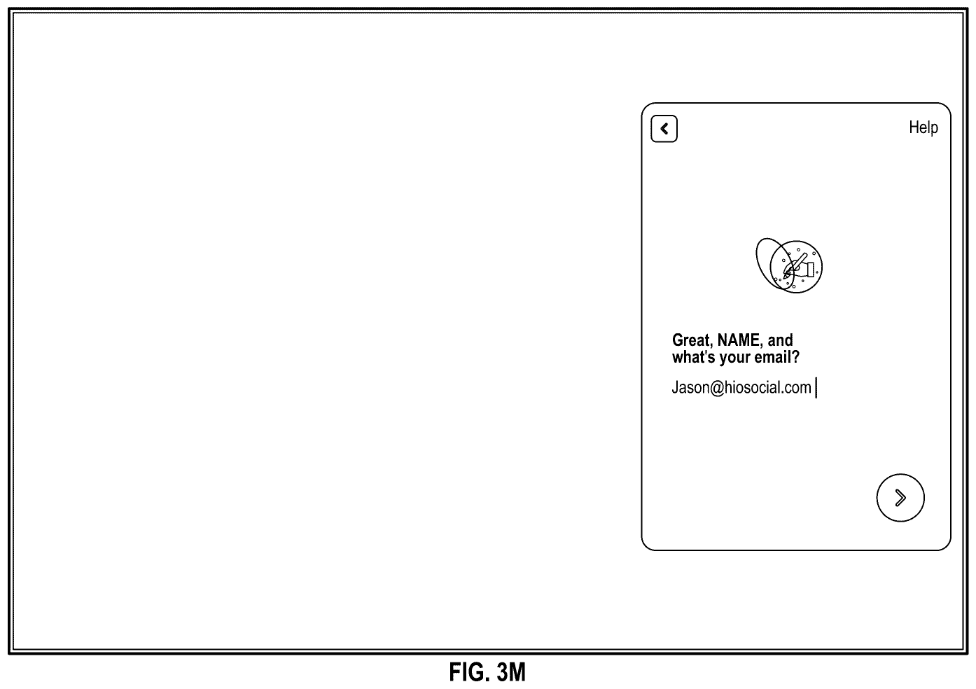

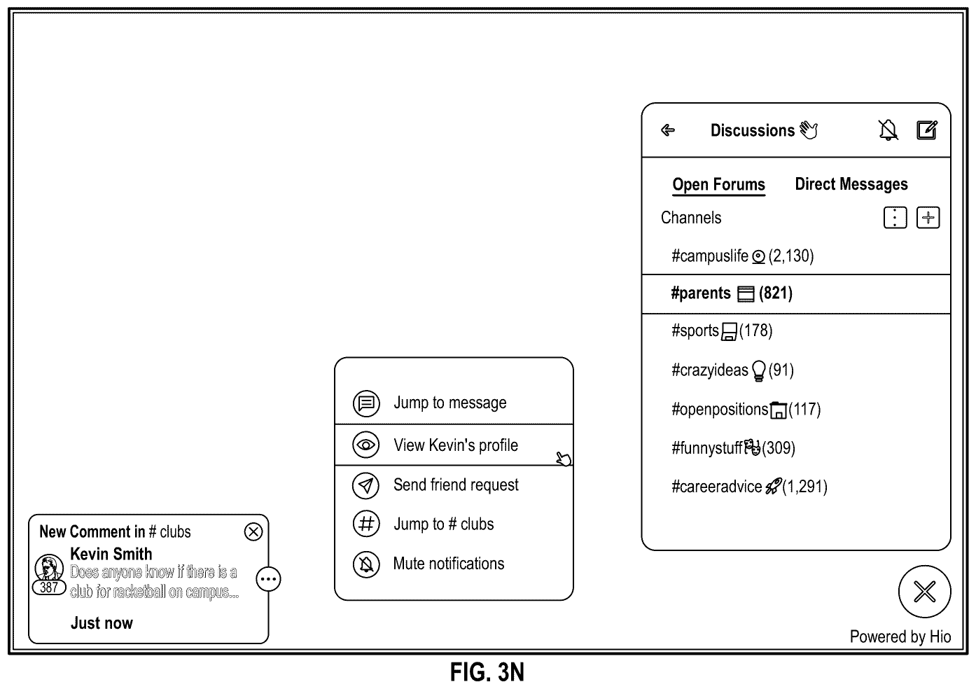

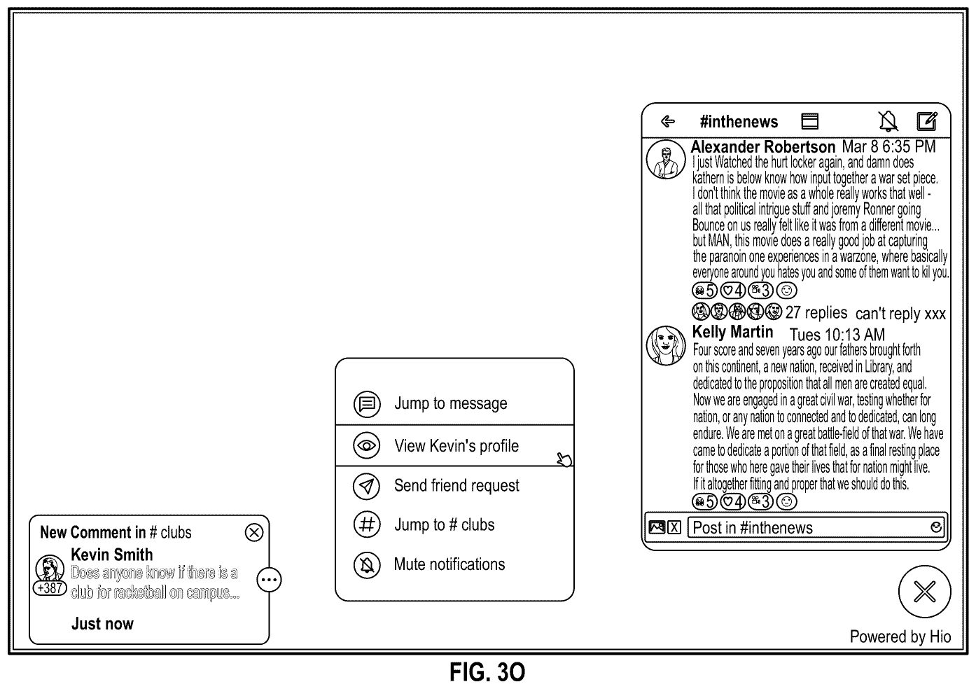

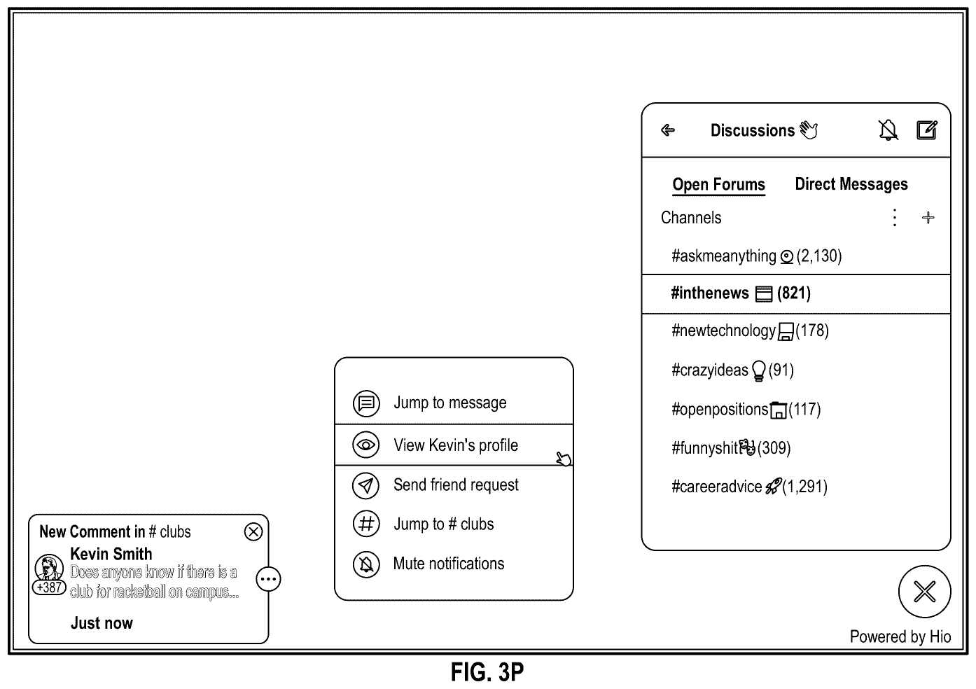

Referring now to FIG. 3A, an example one-to-one direct message chat interface is illustrated, where the multimedia communication system causes a list of those users that are engaged in active conversations to be displayed on a device of a given user accessing a network resource (e.g., users that have communicated with the given user during the current session of accessing a network resource and/or that have communicated with the given user within a threshold period of time). The list may optionally include an image (e.g., a photograph or graphic avatar) of each user and a text identifier (e.g., first and last name, first name and first initial of last name, an alias, etc.). The given user can select another user from the list (e.g., by clicking on the user entry in the list) and transmit a direct communication to the selected user, which other users are inhibited from viewing.

In addition, if the given user points at a user entry in the active conversations list (e.g., or hovering over the user entry in the list using a cursor being navigated using a mouse, trackpad, stylus, or other pointing device), a control, such as an archived messages control, may be presented as illustrated in FIG. 3B. In response to the given user selecting the archived messages control associated with the listed user, archived messages from prior conversations between the listed user and the given user may be accessed from system memory and transmitted to the given user's device for display, as illustrated in FIG. 3D. A field may be provided via which the given user can enter and transmit a new message to the listed user.

FIG. 3C illustrates a detailed chat conversation user interface depicting a chat conducted by the given user with a user selected from the conversation list. The detailed chat conversation user interface may include the name of the selected user at the top of the detailed chat conversation user interface, and an image associated with the selected user presented in association with messages composed by the selected user (where the message text may be displayed in a message frame, such as a bubble). Different colors or shadings may be used to distinguish the selected user's messages from the given user's messages. A field may be provided via which the given user can enter and transmit a new message to the selected user.

Referring to FIG. 3E, a list of users that have archived conversations with the given user may be displayed. Optionally the given user may select a listed user and delete archived conversation messages associated with the listed user or may delete the user's archived messages.

Referring to FIG. 3F, an example recent network connections user interface is illustrated. As illustrated, there are user-selectable links to a “here now” user interface and a “connections” user interface, which will be discussed elsewhere herein. The illustrated interface lists other users with whom the given user has recently made a connection. An image associated with a corresponding user, a text identifier (e.g., first and last name, first name and first initial of last name, an alias, etc.), and profile information (e.g., place of employment, job title, school currently attending, preferred pronouns, and/or other information) may be displayed. In addition, an action user interface including controls may be provided via which the user may initiate a corresponding action. For example, the action controls may include a “jump to message” control, a view selected user's profile control, a send friend request control, a jump to subject thread (e.g., #clubs) control, and a mute notifications control. The “here now” and “connections” interfaces present similar data regarding listed users and provide similar action controls.

Referring to FIG. 3G, an example “here now” user interface is illustrated. The user interface may be accessed via the “here now” control/link discussed above. The interface lists users that are currently concurrently accessing the same network resource as the given user (active users). In addition, a pop up may display new comments posted by another user that the given user is networked with and/or for subject threads the given user has subscribed to.

Referring to FIG. 3H, an example “connections” user interface is illustrated. The user interface may be accessed via the “connections” control/link. In addition, a pop up may display new comments posted by another user that the given user is networked with and/or for subject threads of which the given user has subscribed to.

Optionally, a user may subscribe to a subject thread via a subscribe control. The user may optionally specify whether the user is to be notified by the multimedia communication system of all new postings to the subject thread while the user is visiting the network resource/website, all new postings to the subject thread made by connections (and not non-connections), or is not to be provided with any posting notifications. Such notifications may then be provided by the system, and the user may access and view the postings corresponding to the notifications. Optionally, a subject thread may be configured so that the administrator needs to approve a subscription request, and if such approval is not provided the user may be selectively inhibited from accessing the thread or may be allowed to access the thread but may be prohibited from posting to the thread.

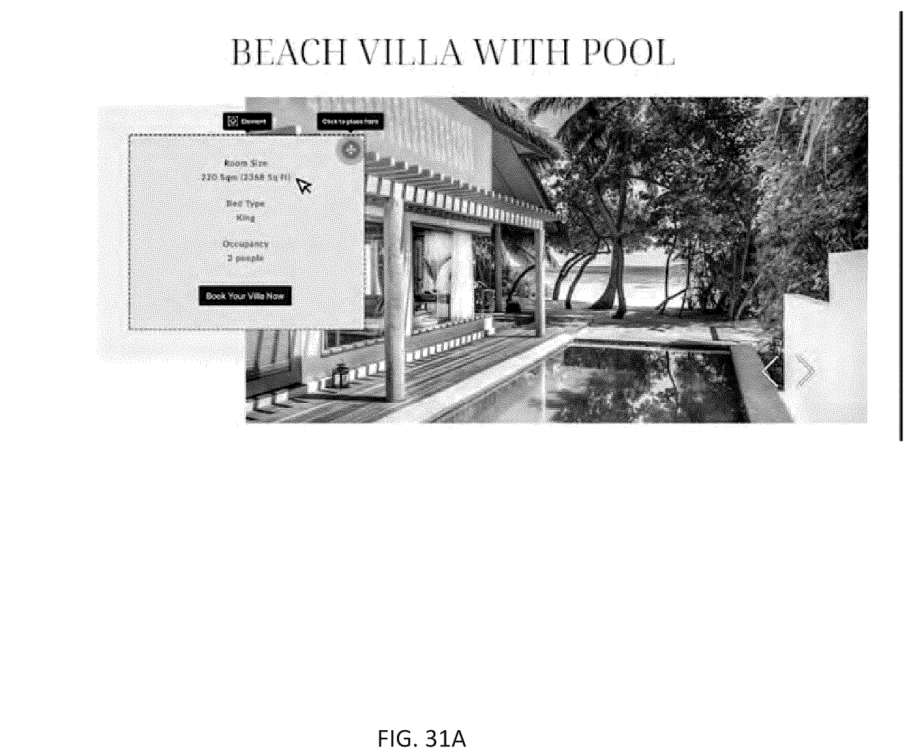

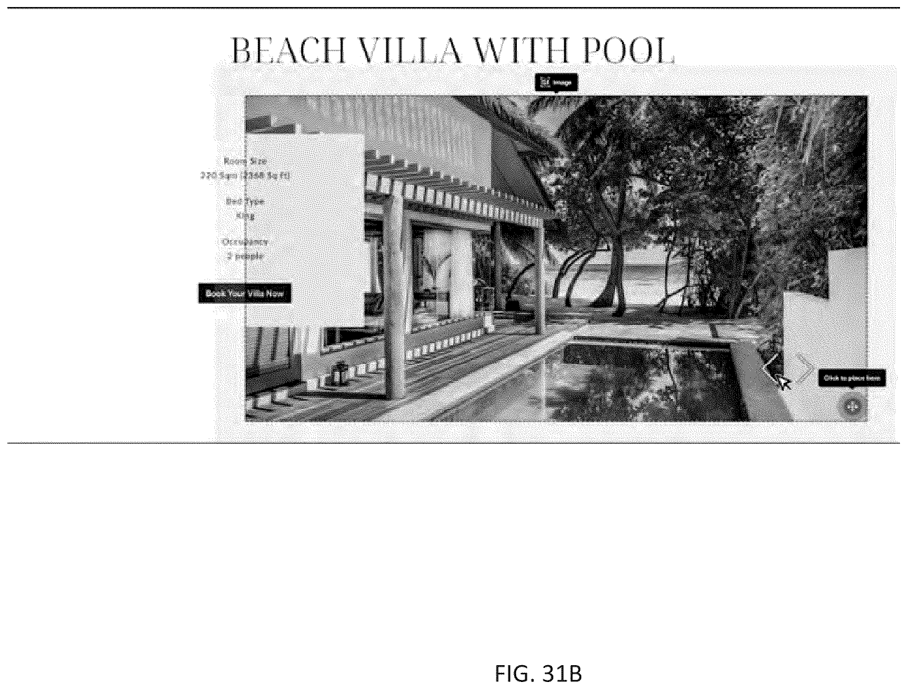

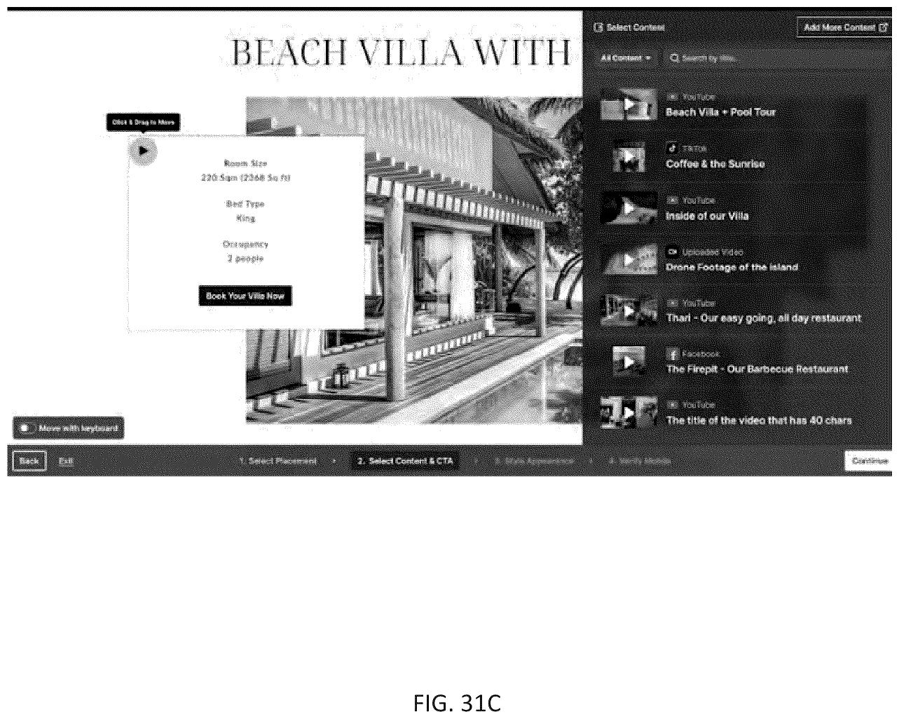

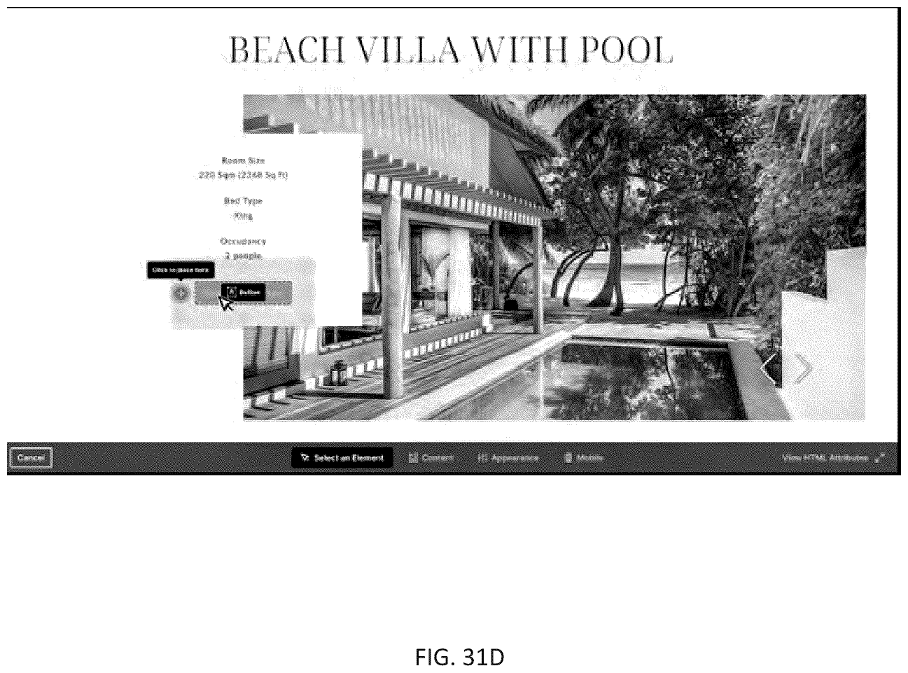

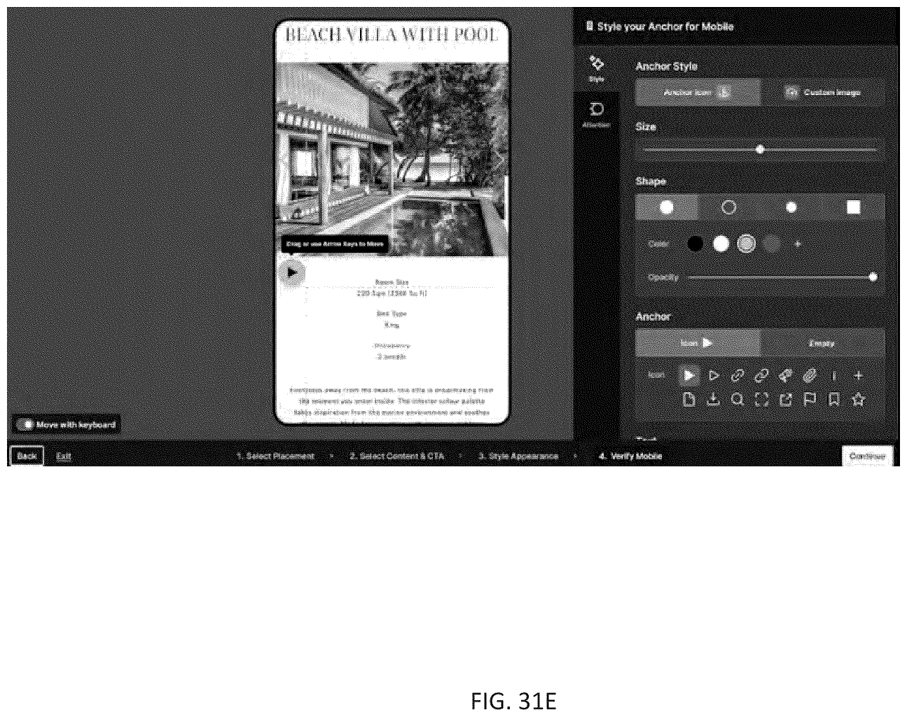

Referring to FIGS. 31 and 3J, an example “connections” user interface is illustrated, wherein in response to the given user selecting a user entry by pointing at a user entry in the connections list (e.g., or hovering over the user entry in the list using a cursor being navigated using a mouse, trackpad, stylus, or other pointing device), additional profile/content information may be presented (which may include private profile information not accessible by non-connections). For example, some or all of the following information may optionally be presented: name, image, place of employment, bio, education, interests (e.g., food, travel, wine, chocolate, sports, music, clothing, investing, design, pets, technology, cars, art, etc.), how the selected user can help others (e.g., provide business introductions, provide mentorship, provide advice, partnership, etc.), and/or other information. The given user, in viewing such context information may decide whether or not to enter into a communication with the selected user. Controls (e.g., a text chat control, a video chat control (which includes an audio channel), an audio chat control, etc.) may be provided via which the given user can initiate a conversation (e.g., via direct messaging) with the selected user via a desired communication channel. Optionally, the user may establish a communication session with multiple selected users (e.g., to establish a video conference).

Referring to FIG. 3K, an example account confirmation user interface is illustrated. As discussed elsewhere herein, rather than using a password for authentication, a user may provide the user's phone number (via a user phone number field in a corresponding registration user interface) when creating or accessing an account. As depicted in FIG. 3K, a code may be transmitted as a text message to the phone number. The user then needs to enter the code via the user interface illustrated in FIG. 3K (as depicted in FIG. 3L) to confirm that the phone number actually belongs to the user. If the user enters the correct code, the user may be authenticated, and the account may be created (or the user may be logged in to the user's existing account). Otherwise, the account may not be created or the user may be denied access to an existing account associated with the phone number.

Once the user is authenticated, the user interface illustrated in FIG. 3M may be presented. The user interface may request additional information from the user, such as name and email address and provide fields for receiving such additional information (e.g., to establish an account record and user profile).

Referring to FIG. 3N, an example discussions user interface is illustrated. Available subject thread channels may be listed (where a given channel is directed to a corresponding subject, such as campus life, parents, sports, open positions, funny stuff, career advice, clothing advice, travel, pets, technology, etc.), including the number of participants and/or the number of postings (e.g., text, image, and/or video postings).

In response to the user pointing at or selecting a channel thread, the user interface illustrated in FIG. 3O may be presented, and corresponding recent posts (e.g., posts posted during the current browsing session, posts that the user has not yet viewed, posts posted within a threshold period of time, etc.) in the channel are displayed (e.g., in association with the number of reactions (e.g., likes, emoji postings, etc.), the number of replies, and/or other information). A field may be provided via which the user may enter and submit a post, which may be transmitted to the multimedia communication system and posted to the channel thread. As similarly discussed elsewhere herein, the action controls may be provided that include a “jump to message” control, a view selected user's profile control, a send friend (also referred to as a connection) request control, a jump to a specified thread (e.g., #clubs) control, and a mute notifications control.

FIG. 3P illustrates a user interface listing open forum discussion threads (sometimes referred to as channels) and the number of posts for a given forum. The user may select, access, and view posts for a given open forum, and may enter and submit a post, which may be transmitted to the multimedia communication system and posted to the open forum thread.

In addition, the multimedia communication system may enable users to schedule a group visit to a website, where each user may view the same content (e.g., webpage) at the same time. Optionally, a member of the group or a website administrator may be designated as a group leader. The group leader may navigate to different content (e.g., webpages) on the website and the other group members may be presented with the same content via their respective browsers. Optionally, the group may be broken up into subgroups, where a group leader assigns members of the group to different subgroups or where a given group member can elect to join a subgroup. Optionally, different subgroups may be assigned or may elect their own subgroup leader. The different subgroups may separately navigate the website, so that different subgroups may be accessing different website webpages. Optionally, a user interface may be provided via the system (e.g., via the widget) to members of one group or subgroup showing what content (e.g., what website webpage) one or more other groups or subgroups are accessing. Optionally, the members of the group or subgroup may navigate to the content being accessed by one of the other group or subgroups. Optionally, the system provides a user interface showing an individual user, a subgroup, or a group showing what content (e.g., what website and/or webpage) one or more other groups or subgroups are accessing.

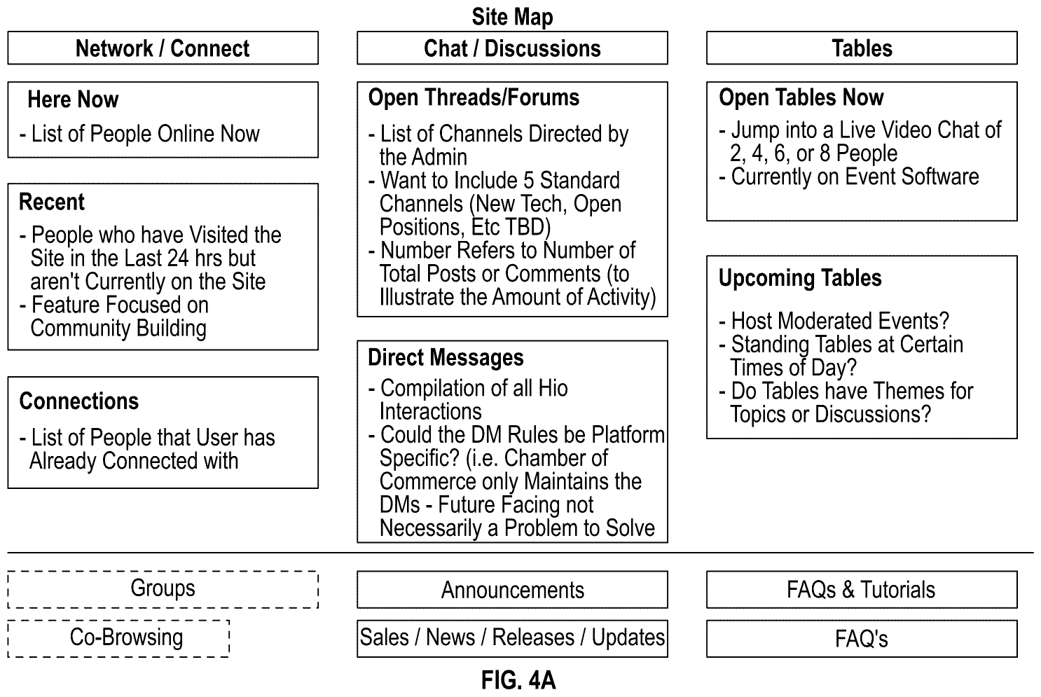

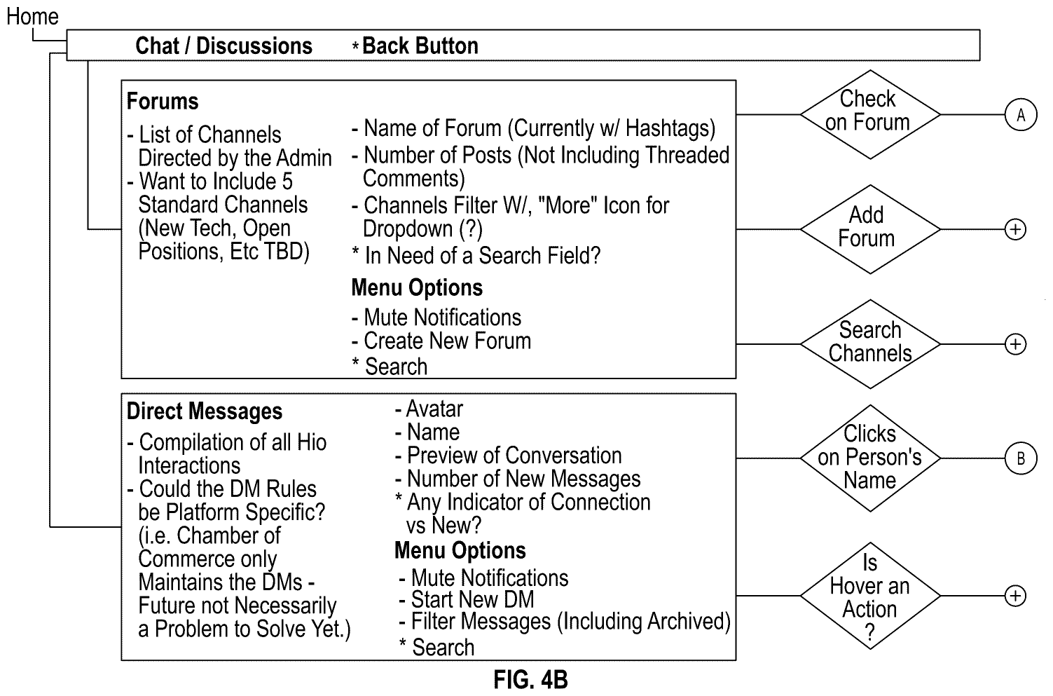

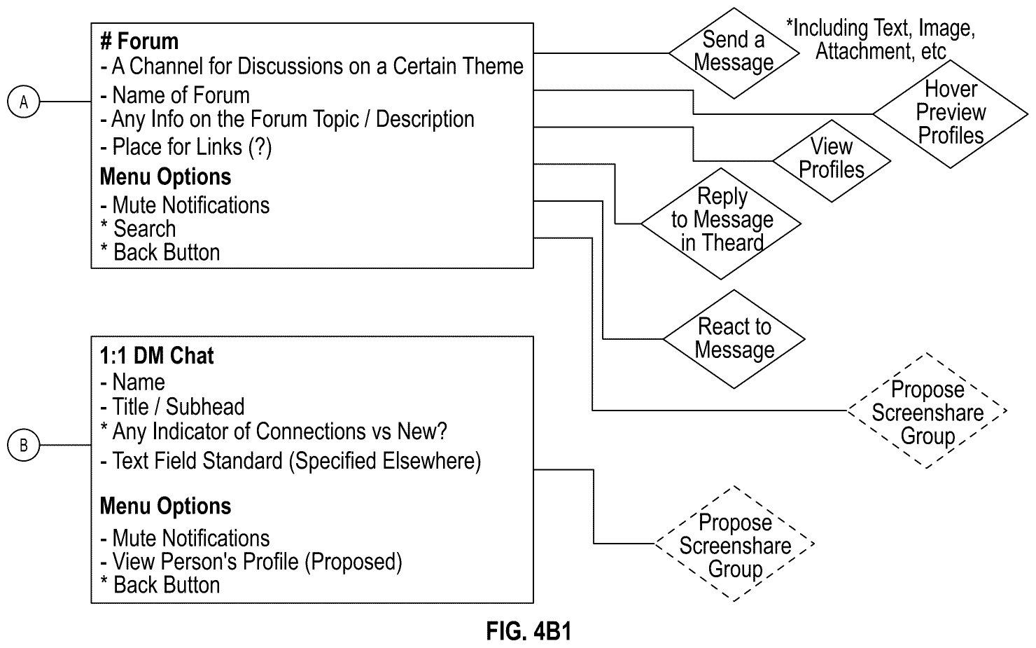

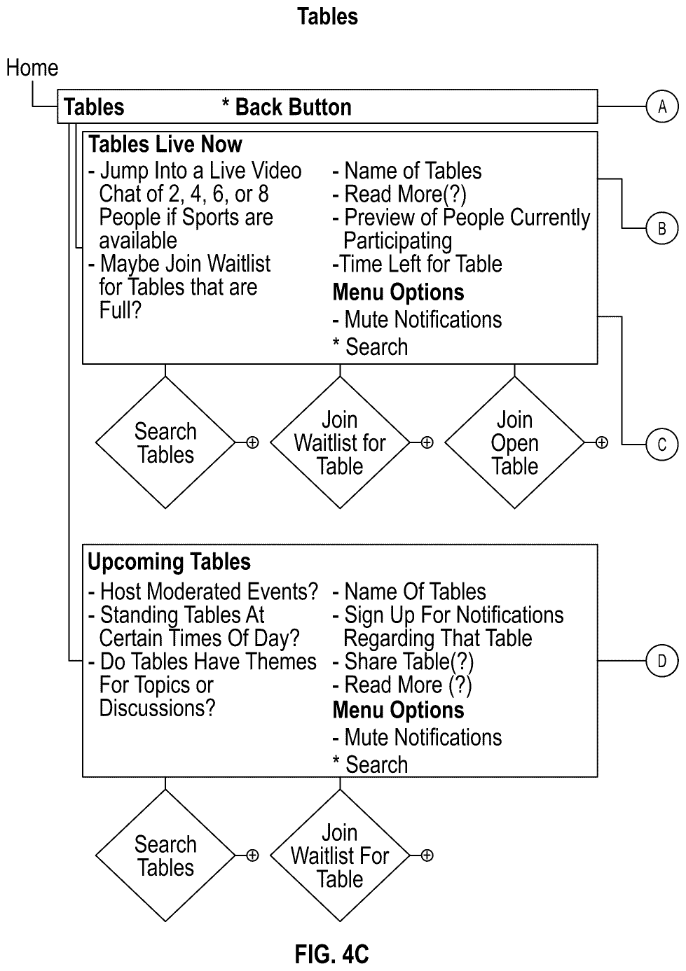

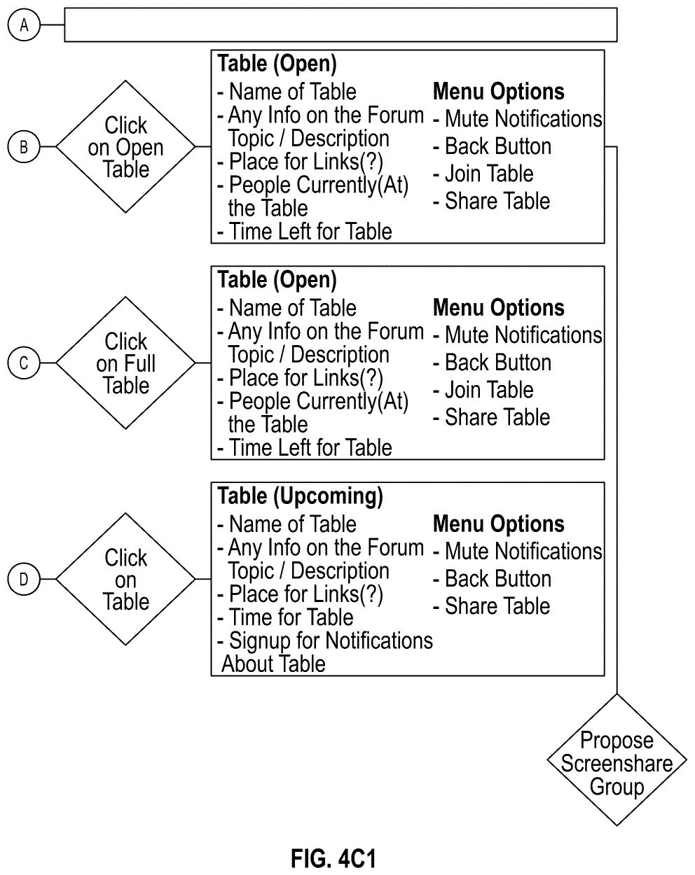

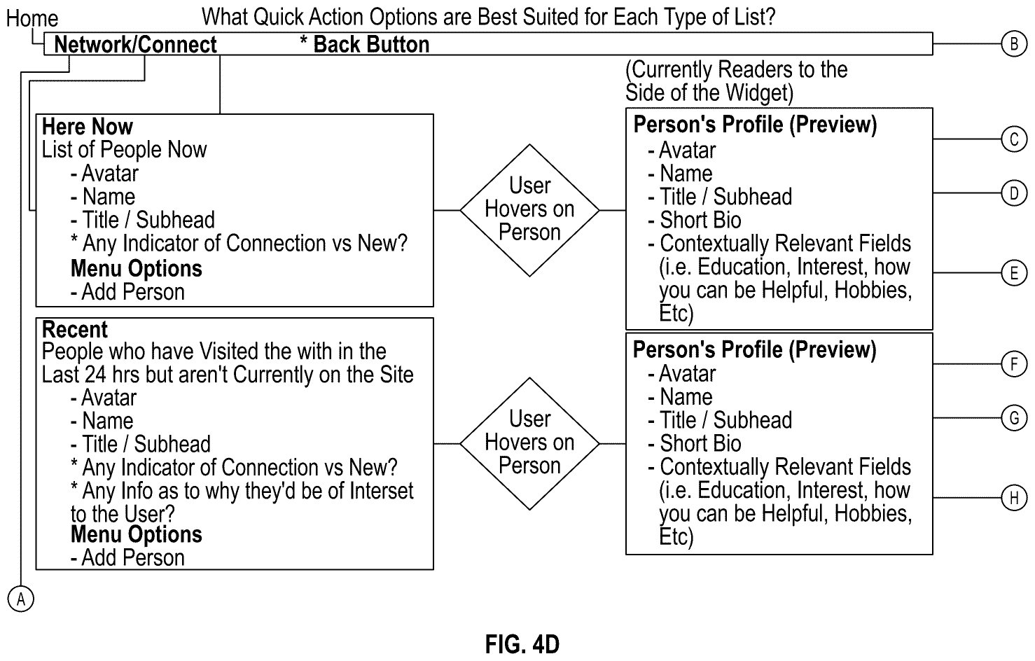

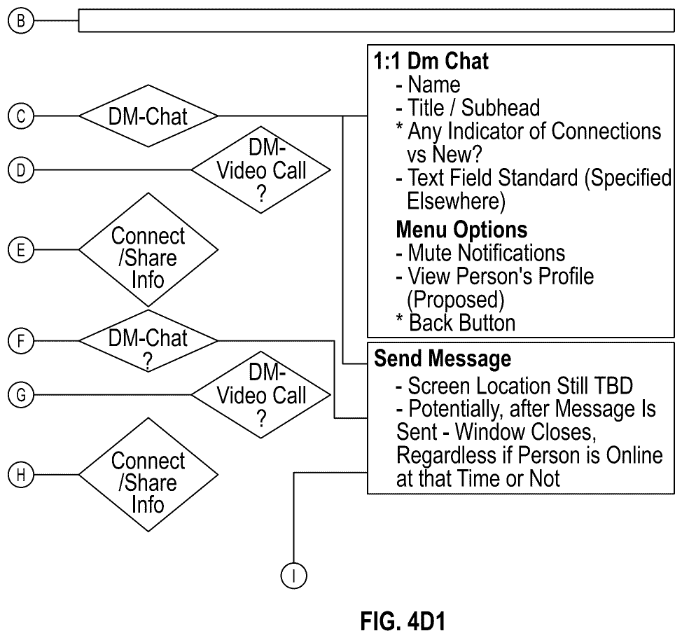

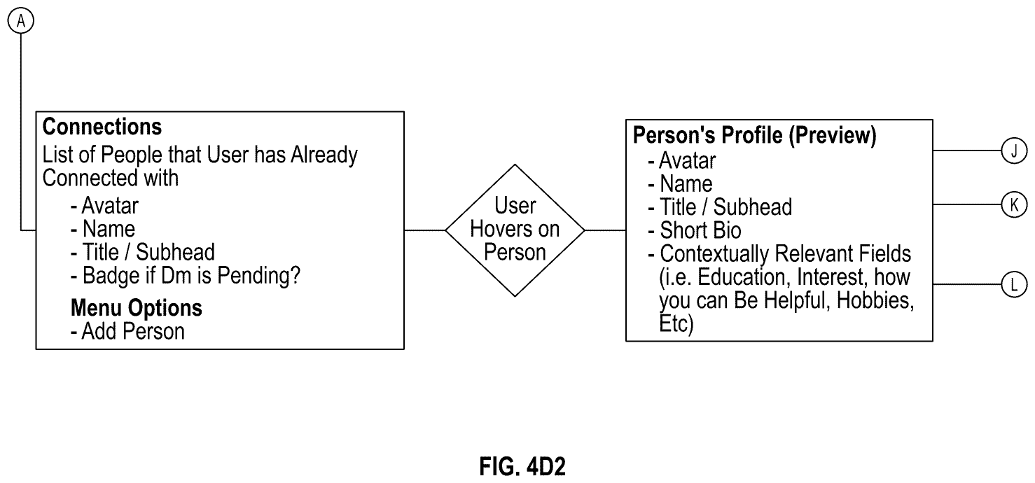

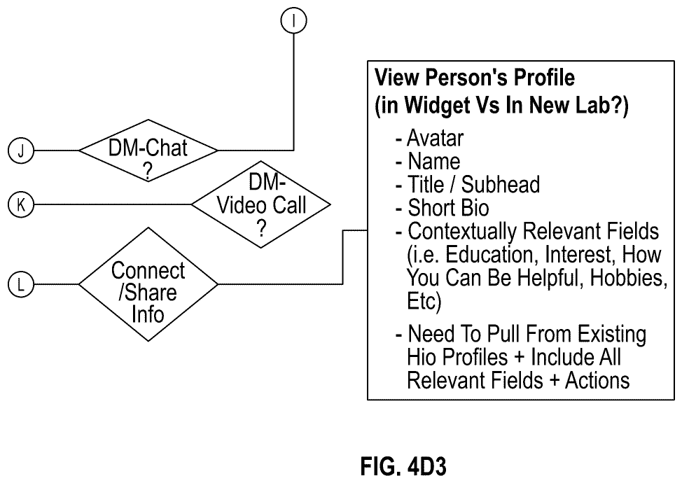

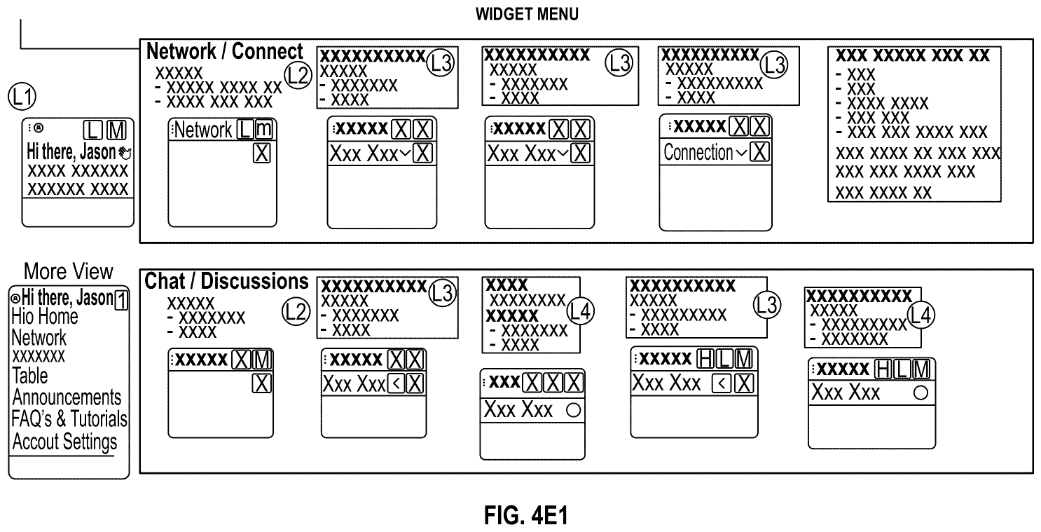

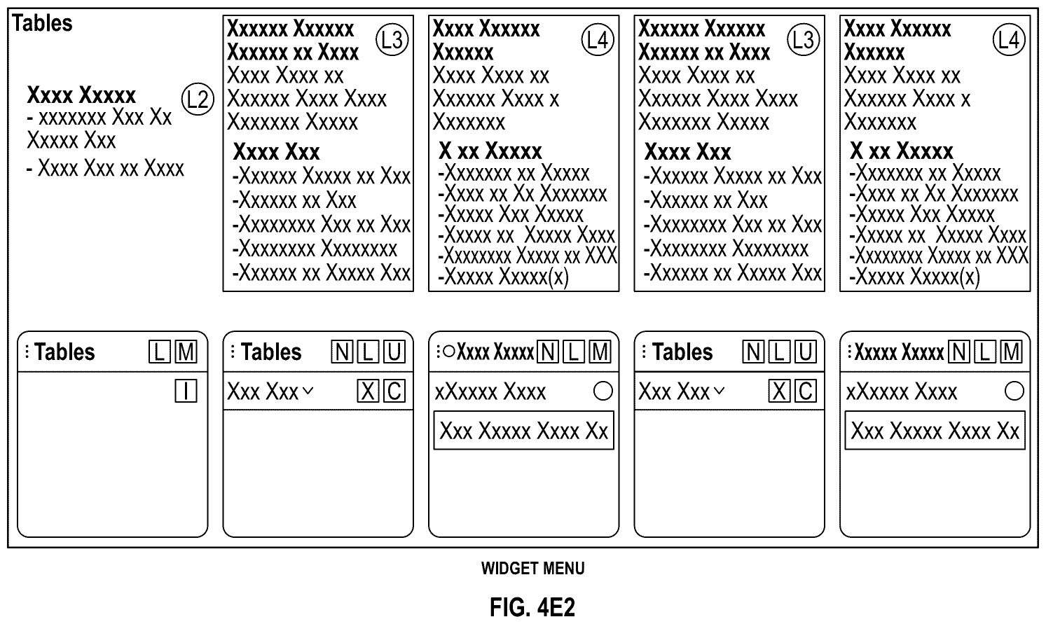

FIGS. 4A-4E2 illustrate various aspects of systems, applications, and processes. Referring to FIG. 4A, a functionality map is provided for certain services provided to users (e.g., via user interfaces presented via a widget, browser extension, or otherwise). The user network/connection function may provide: a “here now” user interface that provides a list of currently active, online users accessing a network resource (e.g., a website); a list of users that recently (e.g., within a threshold period of time, such as 12 hours, 24 hours, etc.) accessed the network resource but are not currently accessing the network resource; and/or a list of other users that the user has already established a connection with.

The user chat/discussion function may provide: a user interface listing channels (e.g., subject threads) which may be established and/or managed by an administrator associated with the network resource (where the number of posts or comments may be displayed in association with a given channel); and a direct message user interface which may list a compilation of some or all of the direct messages sent or received by the user via the system (where the direct messaging rules may be specific to a given website).

The tables function (which may also be referred to as a subgroup function, where multiple users may conduct a live chat session, such as a video chat session, and where the number of table participants may be limited to a specific maximum number) may provide: a list of currently available “tables” of a certain number of users (e.g., where a table may have 2, 4, 6, 8, or other number of users greater than 1) that the user may join (e.g., for a video, audio-only, and/or text chat session); and an upcoming tables user interface listing when the tables are scheduled for, and indication as to whether the table chat session will be moderated by a host, whether the tables have a specified discussion topic, etc.

The groups function provides a user interface that may enable users to co-browse a website (such functionality may be provided via the tables, direct messaging, and/or channels/threads functionality). The announcements function provides a user interface that enables the operator of the network resource (e.g., a website) to post information on news, releases, updates, sales, coupons, and/or the like for users to access and view. The FAQs and tutorial function may provide a user interface enabling a user to access and video answers to frequently asked user questions and to tutorials on the use of functionality described herein.

FIG. 4B illustrates the chat/discussion functionality in greater detail. FIG. 4C illustrates the tables functionality in greater detail. FIG. 4D illustrates the networking/connections functionality in greater detail. FIGS. 4E1-4E2 illustrate example widget user interface flows.

Additional user interfaces presented on a user device will now be described. Certain data in the user interfaces may be populated in real time by the multimedia communication server system and user inputs may be communicated from the user device to the multimedia communication server system which may store and process the user inputs.

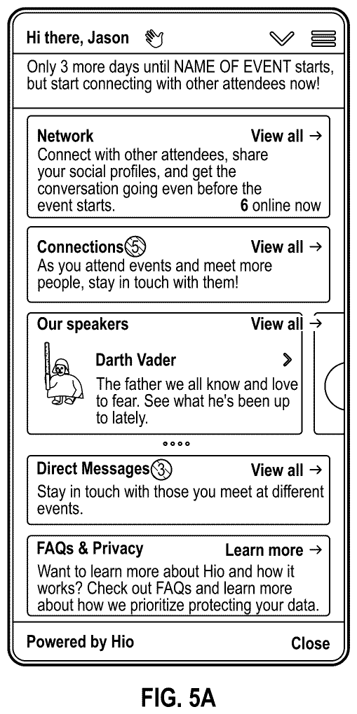

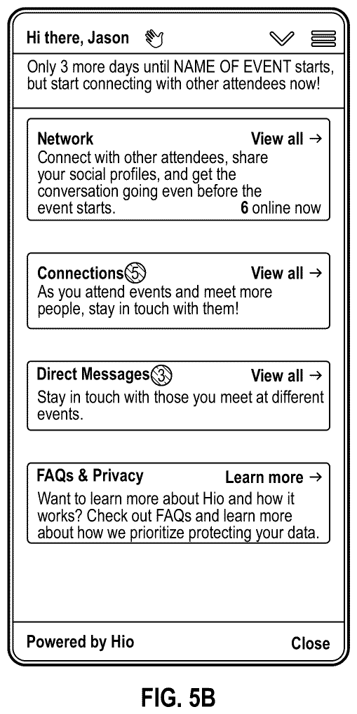

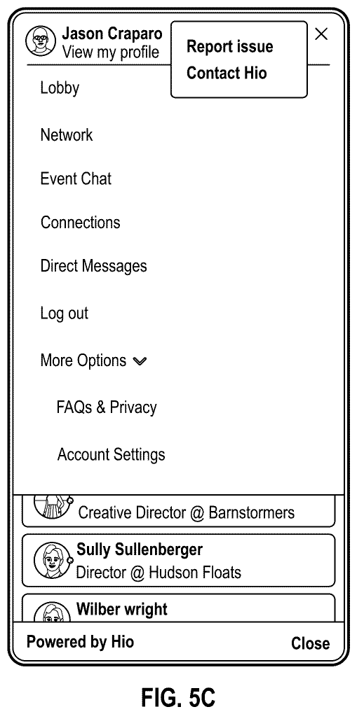

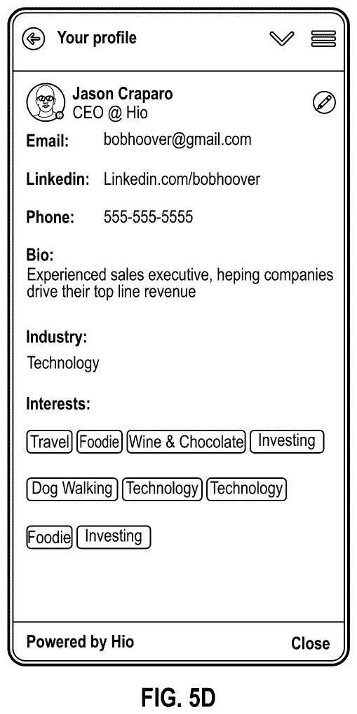

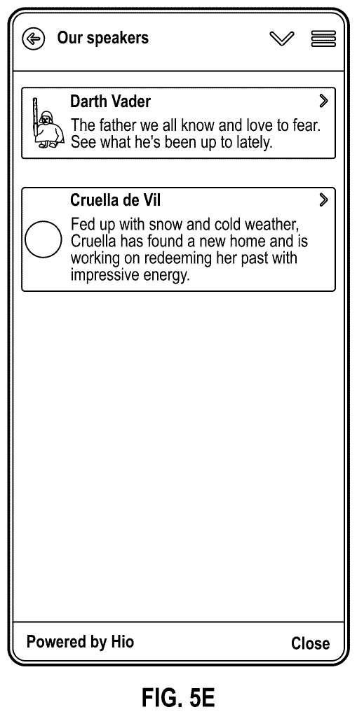

FIG. 5A illustrates an example user interface providing a reminder to a user regarding an online event that the user has signed up for. The user interface may be populated with the number of days until the event (which may be populated using a remote or local electronic calendar) and the name of the online event.

A network module of the user interface enables the user to access a network user interface that enables the user to connect with other event attendees. The network module displays the number of event attendees currently online and available to network with. Such networking may include connecting with one or more of the online fellow online event attendees, communicating with one or more of the online fellow online event attendees (e.g., via text, video/audio, or audio only chat), and/or the sharing of social profiles from one or more social networking sites. A view all control, when activated, enables the user to access the network user interface and view which attendees are online.

A connections module of the user interface enables the user to access a connection user interface that enables the user to connect with the user's connections. The connections module displays the number of connections that are currently online. A view all control, when activated, enables the user to access the connections user interface and view which connections are online.

A speakers module lists one or more speakers for the online event, and provides a brief biography or curriculum vitae of one or more speakers and optionally includes a photograph or avatar of a given speaker. A view all control, when activated, enables the user to access a list and brief biography or curriculum vitae of all the scheduled event speakers. If there are no speakers at the event, the speaker module may be excluded, as illustrated in FIG. 5B.

A direct messages module provides access to a direct messaging user interface that enables the user to direct message other users, in a one-to-one fashion, that the user met at prior online events. The direct messages module displays the number of unread directed messages to the user. A view all control, when activated, enables the user to access direct messaging user interface and view the users that the user has attended events with.

A FAQs & privacy module provides access to frequently asked questions (FAQS) and answers thereto, and a privacy policy of the website operator.

FIG. 5C illustrates an example network user interface that lists the event attendees currently online and available to network with (e.g., including name, job title, company at which the attendee is employed, and/or a photograph or avatar). A dropdown menu is provided via which the user can navigate to other user interfaces, such as those discussed herein.

A user interface may be provided enabling the user to access user interfaces corresponding to a virtual event virtual lobby, the network user interface, an event chat user interface, the connections user interface, the direct messages user interface, a log out user interface, the FAQs & privacy user interface, and the accounts setting user interface.

An interface may be provided that enables the user to report an issue or contact the operator.

FIG. 5D illustrates an example profile user interface including name, job title, company name, social media link(s), phone number, biography, industry-field, and interests.

FIG. 5E illustrates an example speakers user interface, listing the names, images, and brief biography of the online event speakers. Controls may be provided in association with respective speaker entries, which when activated, navigates the user to a user interface that provides additional speaker information (e.g., a more extensive biography, contact information, and/or other data).

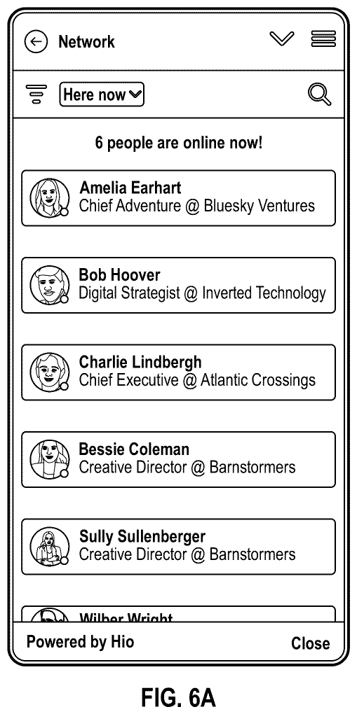

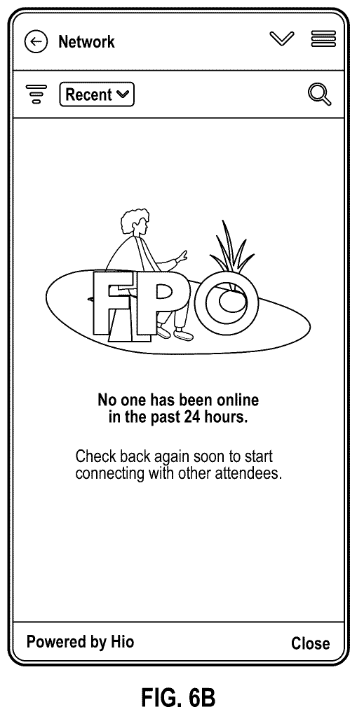

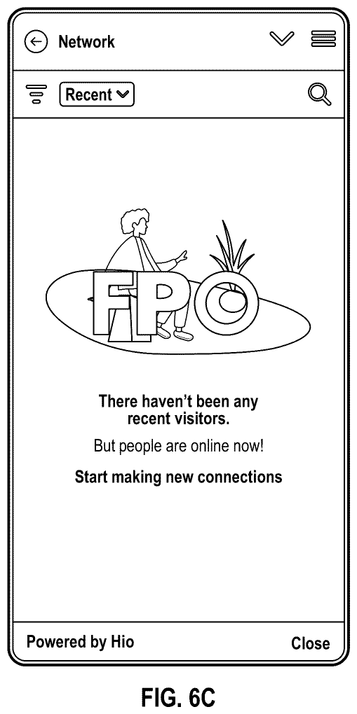

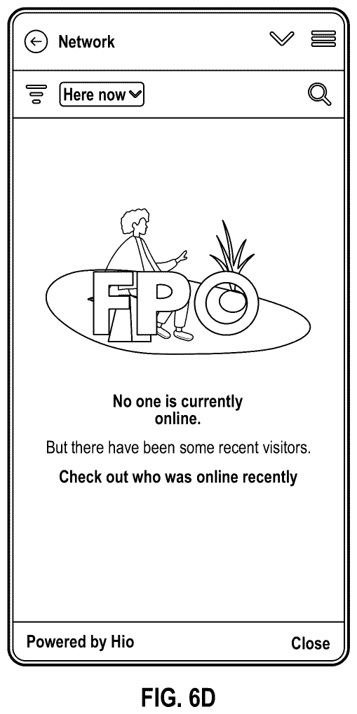

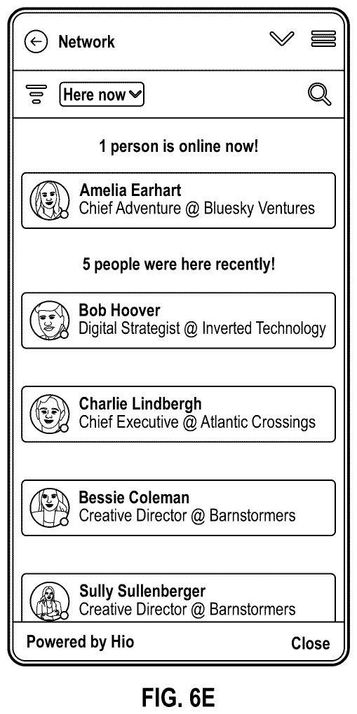

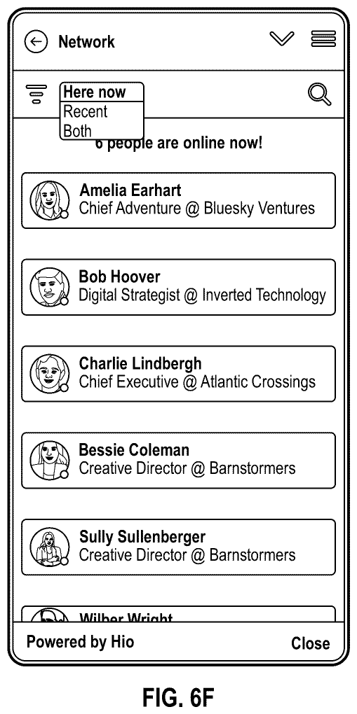

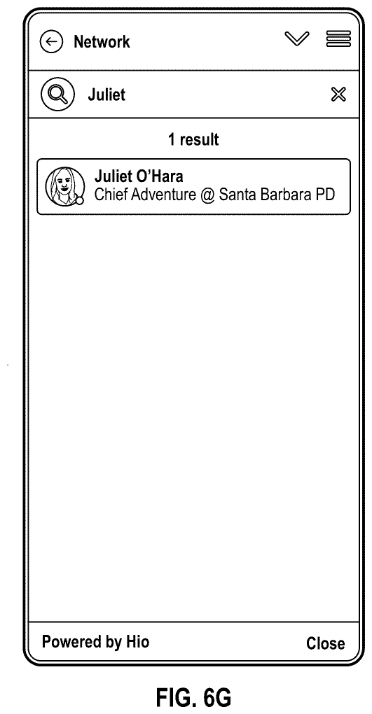

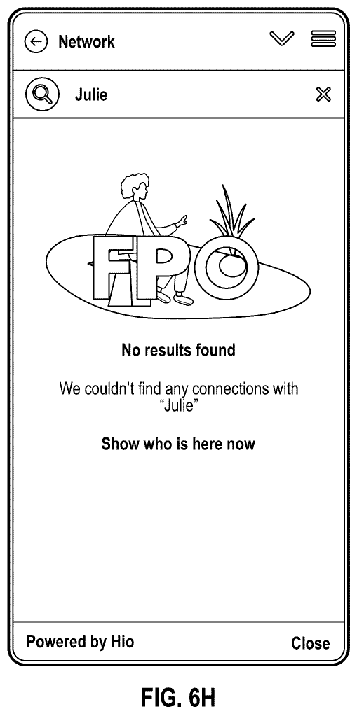

Referring to FIG. 6A, an example network user interface is illustrated. The network user interface is in a “here now” mode (where the mode may be selected via a mode user interface providing “here now”, “recent”, and “both” options) listing all event attendees that are currently online (e.g., including name, job title, company at which the attendee is employed, a photograph or avatar). The user may select a listed attendee, and additional attendee data may be presented, and controls may be provided via which the user may connect with and/or direct message the attendee.

FIG. 6B illustrates the example user interface of 6A, with the mode set to “recent”. The recent mode will list those attendees that were recently online (e.g., in the past 24 hours or other time period) but that are not currently online. In this example, the user interface reports that no attendee has been online in the past 24 hours.

FIG. 6C illustrates the example user interface of 6B, except in this example, although the user interface reports that there have been no recent visitors, it further reports that other users are currently online and available to make connections with.

FIG. 6D illustrates the example user interface of 6A, except in this example, although the user interface reports that no one is currently online, it further reports that there have been recent visitors.

FIG. 6E illustrates the example user interface of 6A, identifying the attendees that are currently online (one person in this example), and further identifies attendees that have recently been online (e.g., including name, job title, company at which the attendee is employed, a photograph or avatar). Thus, the example user interface provides both the users that are “here now” and that were “recent.”

FIG. 6F illustrates a drop down menu enabling a user to select which types of users are to be displayed: those who are currently online at the website (“here now”), those that were recently online at the website but are no longer online at the website (“recent”), or both (“both”).

FIG. 6G illustrates an example search network user interface that enables a user to submit a search query term, which is received by a search engine remote from the user device which identifies matching users in the network, and returns search results comprising the matching users, ranked in accordance with the closeness of the match. Optionally, the search engine may perform an incremental search, where, as the user is typing search term characters the search engine identifies matches in real time and present search results, where the search results may be modified with each character entered by the user. In the illustrated example, a single search result is found, and the search result includes the name, job title, company, and a photograph or avatar of the matching user.

FIG. 6H illustrates the search network user interface of FIG. 6G, except in this example, the user interface reports that no matches have been found, and provides a link which when activated causes a user interface to be displayed listing who is currently on line.

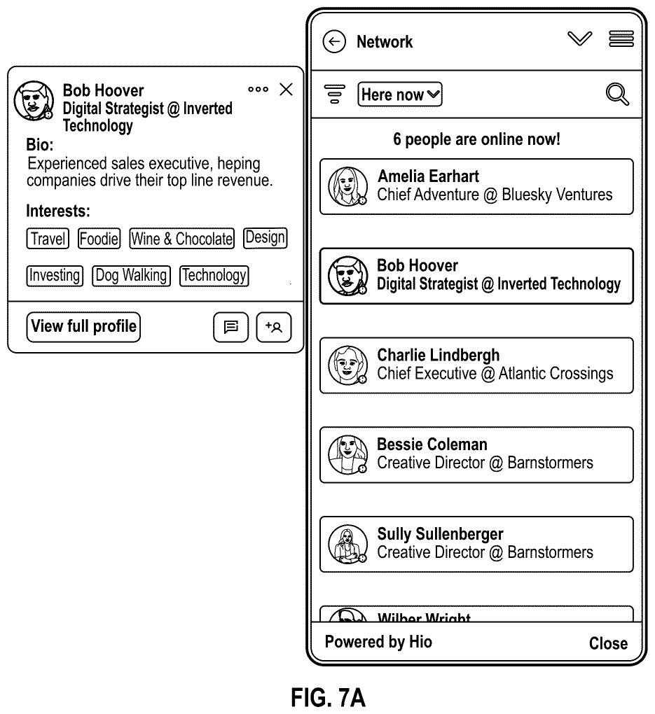

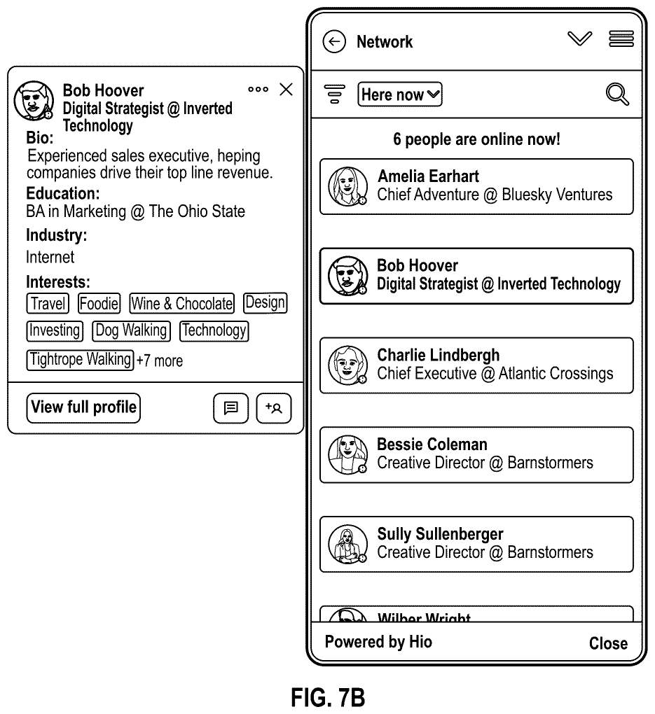

FIG. 7A illustrates an example profile user interface that may be displayed in response to the user hovering a cursor or otherwise pointing at an entry in a listing of users that are currently online (and may similarly be displayed with responding to other listings of users). The profile may pop-up over or adjacent to the listing and may include an “X” control that when activated by the user will cause the profile to be closed so that it is no longer displayed.

The example profile user interface provides user data including name, job title, company name, social media link, phone number, biography, industry-field, and interests. Controls may be provided via which the user can chat (e.g., video, audio, and/or text chat) with the user whose profile is presented or make a connection with such user. A view full profile control is provided which when activated, causes the full profile, an example of which is illustrated in FIG. 7B to be presented. In this example, in addition to the information provided via the profile in FIG. 7A, the full profile may include educational accomplishments, industry, and additional interests.

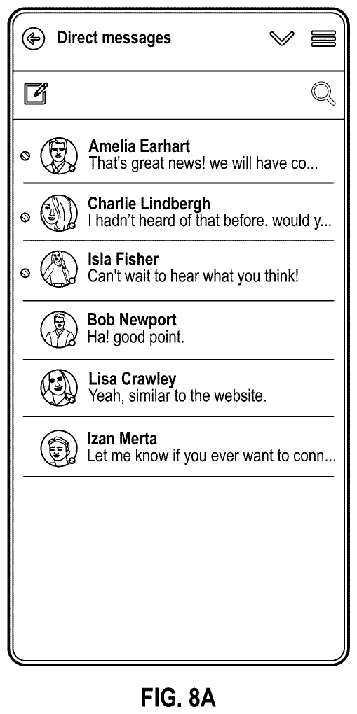

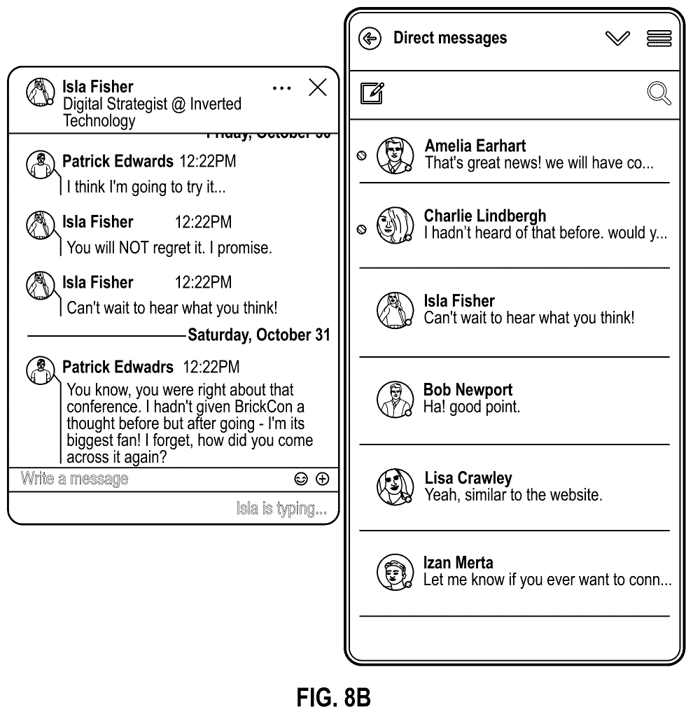

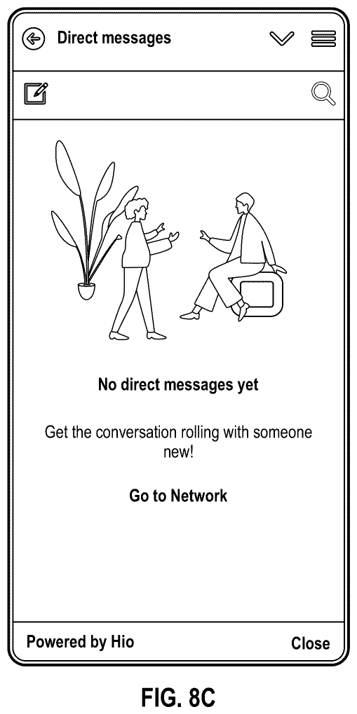

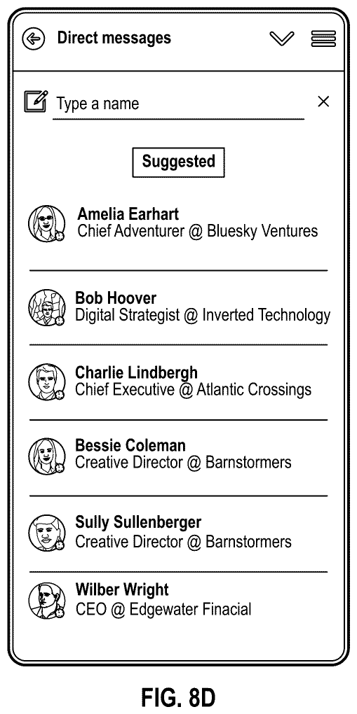

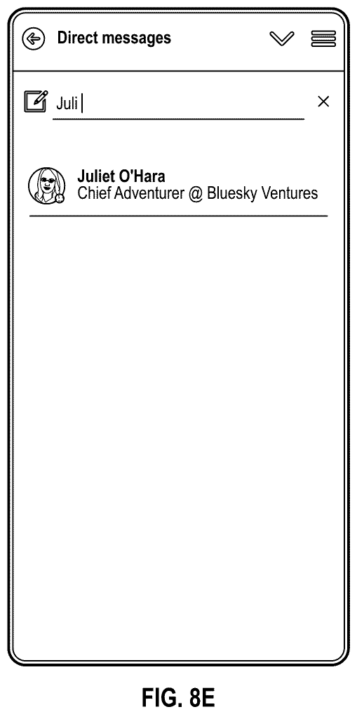

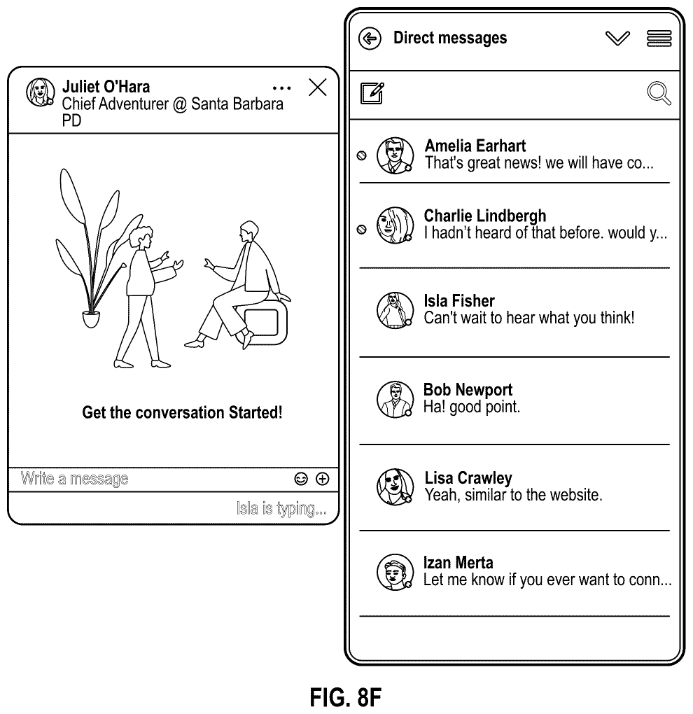

FIG. 8A illustrates an example direct messaging user interface (e.g., which may be accessed via a direct messaging module interface or menu). The direct messaging user interface may list a certain number of the most recent direct messages to the user (using a selected communication channel (e.g., text, video, audio)), optionally via a scrollable user interface via which the user can scroll down (or up) to view additional direct messages. A given direct message entry may include the name and/or image or avatar of the user that transmitted the message, an initial portion or all of the message, and an indication as to whether the message is new (e.g., via a filled in circle or other indicator) or that the user has already viewed the message. A control is provided via which the user can draft and transmit a direct message to another user.

As illustrated in FIG. 8B, in response to a user selecting a user in the direct messaging list of FIG. 8A, a corresponding message thread may be displayed (e.g., as a pop-up overlaying the messaging list in whole or in part, or displayed alongside the message list). A control may be provided (e.g., an “X” control) which when activated causes the thread user interface to close. The thread user interface may display some or all of the messages in the thread, the user name, user image/avatar, a portion or all of the message, and the date and/or time the message was transmitted or received. A field is provided configured to receive a user message which will then be transmitted to others in the thread and which will be included in the thread display.

If there are no direct messages yet, the user interface illustrated in FIG. 8C may be displayed. The user interface includes an indication that no direct messages have been received yet, and a link/control is provided via which the user can initiate a direct message conversation with other users in the user's network.

The system may suggest potential targets for direct messages from the user via a suggestions user interface, such as that illustrated in FIG. 8D. The suggested potential targets may be identified based on a commonality of identified interests, common other users with whom the user and the potential target have exchanged direct messages, common other users with whom the user and the potential target are in networks with, and/or using other information discussed herein. A given suggested target user for a direct message may include the name and/or image or avatar of the suggested target user, a job title, and a company name. A field is provided via which the user can enter the name of another user, and the system may utilize a search engine to search for, identify and return matching users.

FIG. 8E illustrates a search direct messages user interface that enables a user to submit a search query term, which is received by a search engine which identifies matching users that have sent to and/or received from the user one or more direct messages, and returns search results comprising the matching users, optionally ranked in accordance with the closeness of the match. Optionally, the search engine may perform an incremental search, where, as the user is typing search term characters the search engine identifies matches in real time and presents search results, where the search results may be modified with each character entered by the user. In the illustrated example, a single search result is found, and the search result includes the name, job title, company, and a photograph or avatar of the matching user.

FIG. 8F illustrates an example user interface prompting the user to initiate a conversation (e.g., via text, audio, video) with one or more other users, including the name, job title, company, and a photograph or avatar of the suggested user. A field is provided via which the user can enter a message (e.g., a text message, where a text message may comprise one or more emojis) to the user.

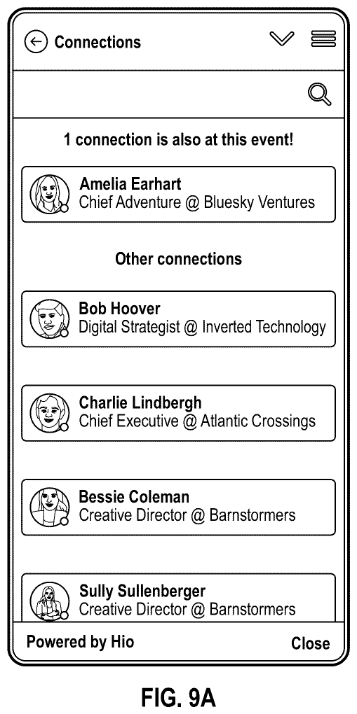

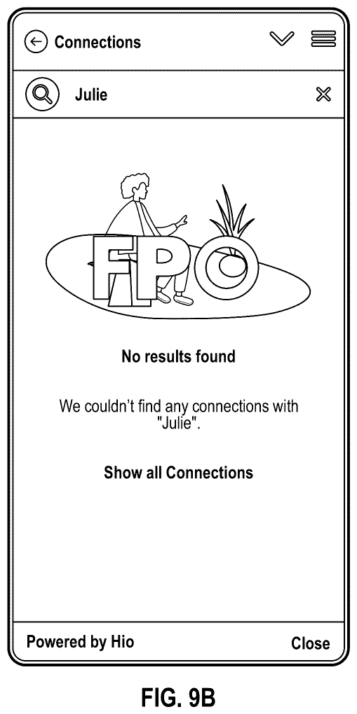

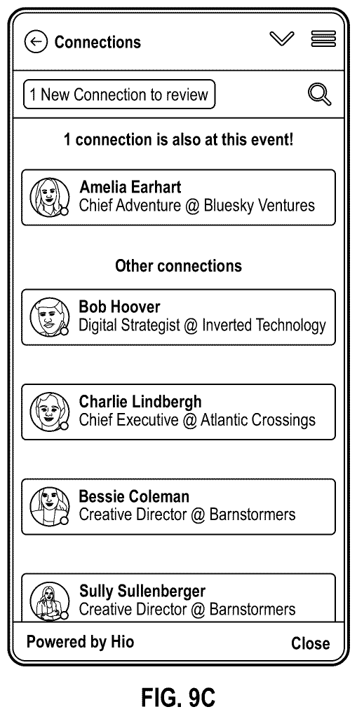

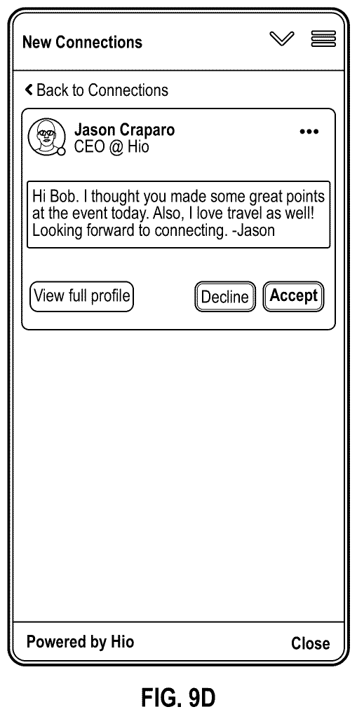

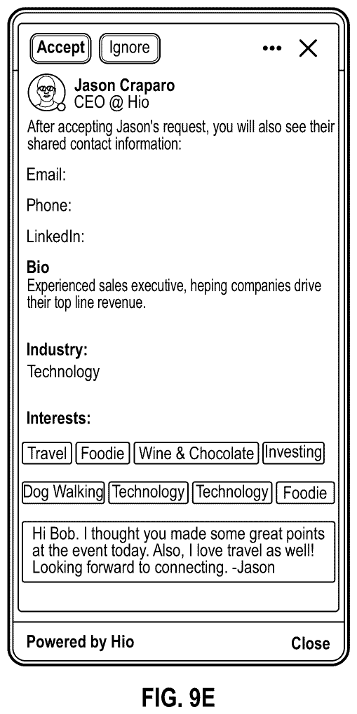

FIG. 9A illustrates an example connections user interface. The system determines which of the user's connections are currently at an online event at which the user is an attendee, identifies the user's connections that are not currently at the online event, and populates the connections user interface accordingly. In the illustrated example, the user interface presents the number of the user's connections that are attending the online event, and provides the name, job title, company, and a photograph or avatar of the attendee. In addition the user interface displays connections of the user that are not attending the online event.

FIG. 9B illustrates a search direct messages user interface that enables a user to submit a search query term, which is received by a search engine which identifies matching users that are connected with the user, and returns search results comprising the matching users, optionally ranked in accordance with the closeness of the match. Optionally, the search engine may perform an incremental search, where, as the user is typing search term characters the search engine identifies matches in real time and present search results, where the search results may be modified with each character entered by the user. In the illustrated example, no matches are found.

FIG. 9C illustrates the connection user interface, but in this example, the user interface is populated by the system to identify the number of connection requests (corresponding to requests by other users to become a connection) for the user to review. In response to the user selecting the new connection entry, a new connections user interface, such as that illustrated in FIG. 9D, may be presented. As illustrated in FIG. 9D, the name, job title, company, and a photograph or avatar of the new connection may be presented, with a message from the new connection to the user. Controls are provided via which the user can accept or decline the connection request, and the acceptance or declining of the request may be stored in memory in association with a user record. A view full profile control is provided, which when activated, causes the full profile of the user to be presented, such as that illustration in FIG. 9E.

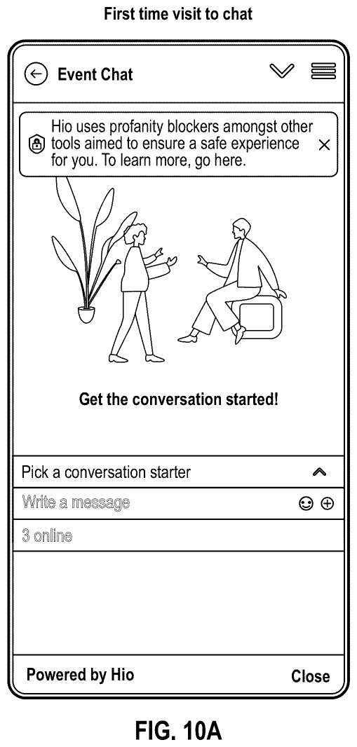

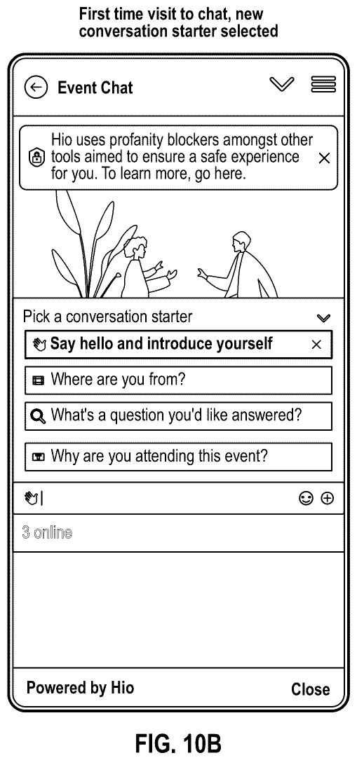

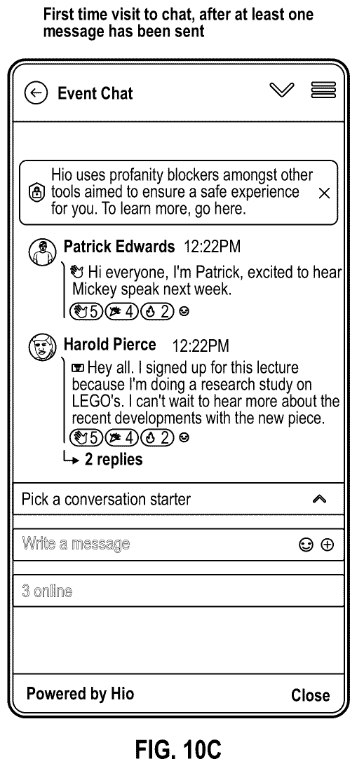

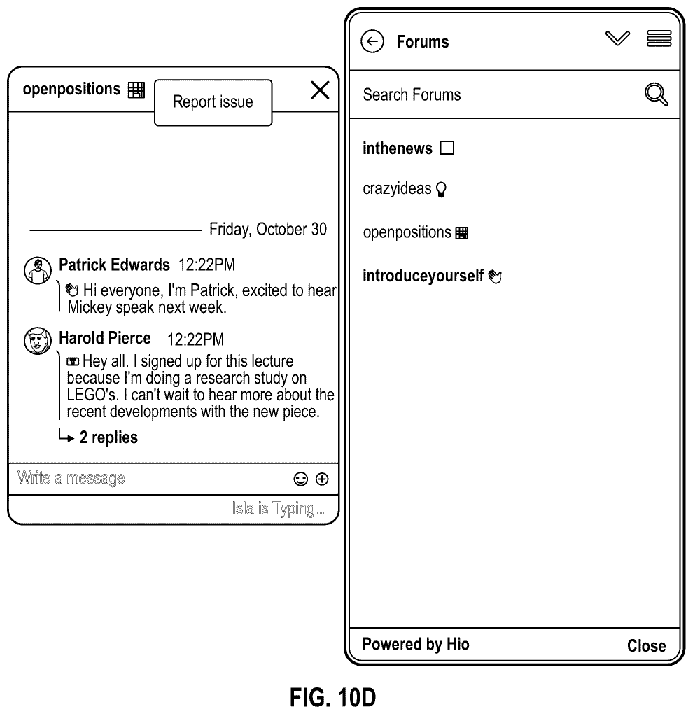

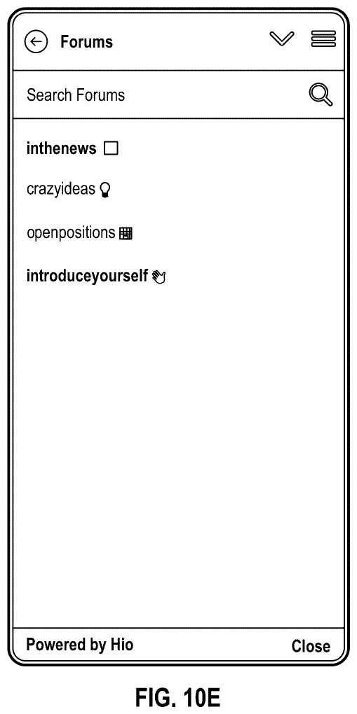

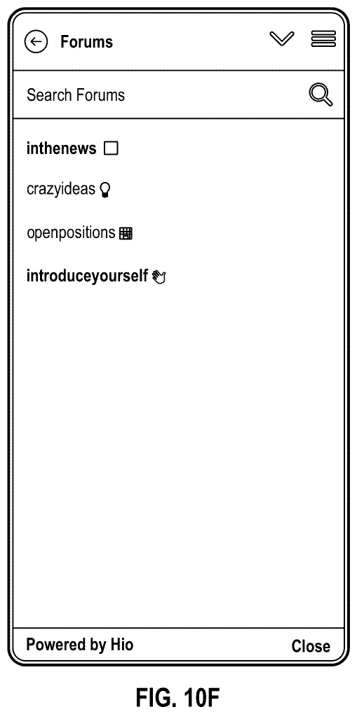

FIG. 10A illustrates an example channels user interface. The user interface may be presented if the system detects that this is the first time the user has visited to chat (e.g., in a particular forum). The disclosed system may include or utilize a profanity blocker that detects profanities and other potential offensive language. For example, the system may use a blacklist of certain words, scan text or other messages for blacklisted words, and if such words are detected, deletes such words from the message (and optionally replaces such words with comparable or other phrases from a list). The user interface illustrated in FIG. 10A includes a notice regarding the use of such profanity blockers, where a control is provided via which the user can close the notice. The user is prompted to start a conversation with other users. A control is provided via which the user can pick a conversation starter from a list of conversation starter messages (where a control is provided via which the user can cause a list of conversation starter messages to be displayed). A field is provided via which the user can enter a custom, user-drafted message. The user interface may be populated by the system with the number of users currently online.

FIG. 10B illustrates the user interface of FIG. 10A where the user has activated the control that causes the list of conversation starter messages. Optionally, if the user selects a conversation starter message, the other prospective conversation starter messages are no longer displayed.

FIG. 10C illustrates a user interface which may be presented after at least one message has been sent. The user interface may present the message in the thread and the message timing. A hand wave icon may be displayed indicating how many other users have transmitted an electronic hand wave indication to the user. The user interface may be populated with the number of replies received to the user's messages.

FIG. 10D illustrates a user interface displaying, for a selected subject forum, the chat messages in the forum, including the message dates and times. The available forums may be displayed alongside the forum messages.

FIGS. 10E and 10F illustrate an example search forum user interface that enables a user to submit a search query term, which is received by a search engine which identifies matching forums, users, topics, and/or text in the forums, and returns search results comprising the matching users, ranked in accordance with the closeness of the match. Optionally, the search engine may perform an incremental search, where, as the user is typing search term characters the search engine identifies matches in real time and present search results, where the search results may be modified with each character entered by the user. In the illustrated example, a single search result is found, and the search result includes the name, job title, company, and a photograph or avatar of the matching user.

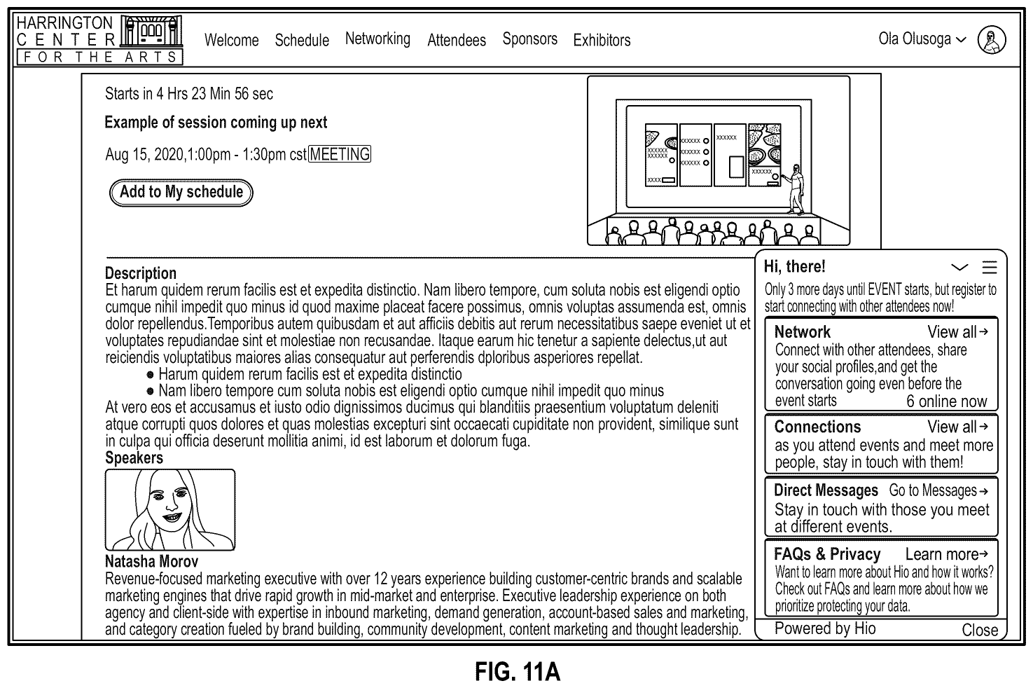

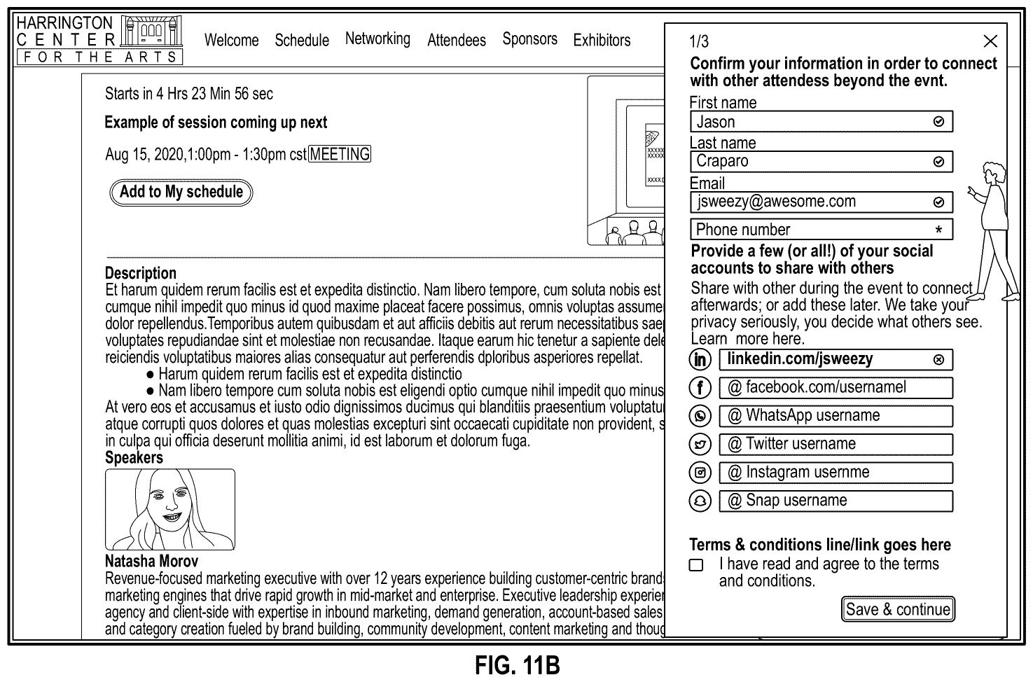

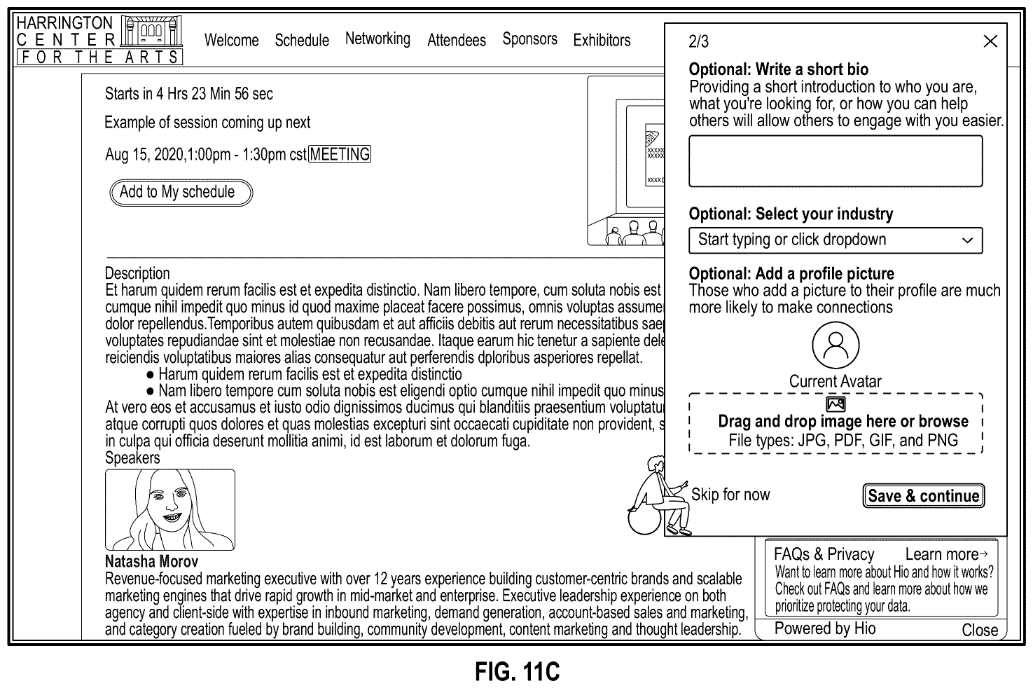

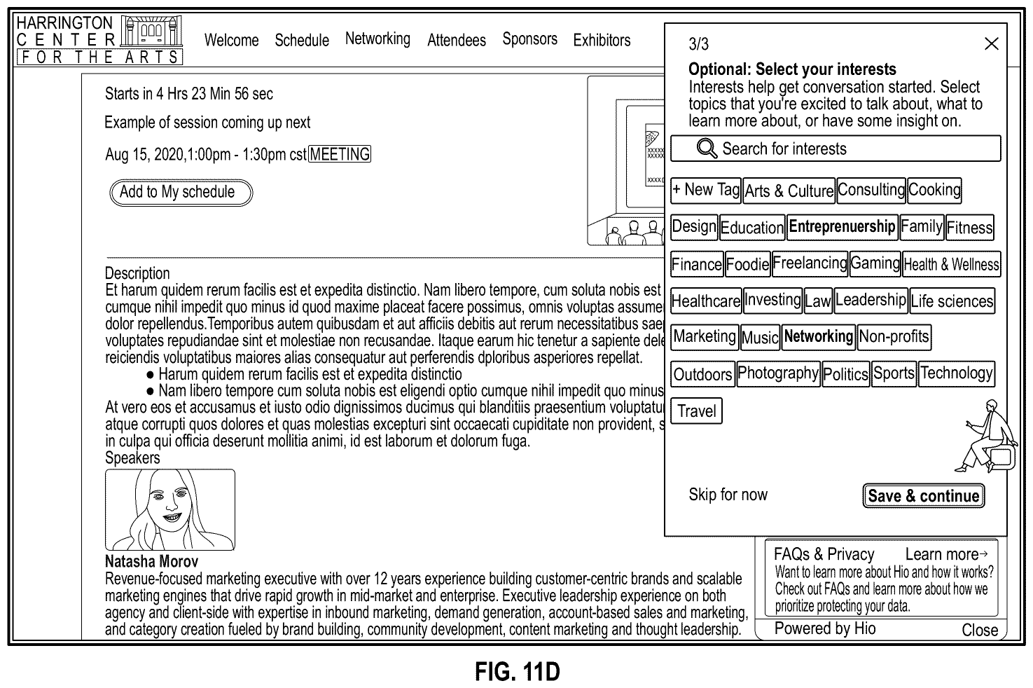

Example user interfaces that enable a user to register for an online event will now be described. Referring to FIG. 11A, a notification is presented regarding an upcoming online event. The notification may include the event name, the type of event (e.g., meeting, party, lecture, etc.), the event date, the event time, and the time (e.g., days, hours, and/or minutes) until the event begins (e.g., via a countdown timer that continuously updates with a time decrement, such as every second, minute or hour). Optionally, an add to my schedule” control is provided, which when activated, may add the event to the user's calendar at the corresponding date and time. Once the user registers for the event, the user may be enabled to chat with other users/attendees registered for the event, even before the event takes place. Network, connections, direct messages, and FAQs & privacy modules are provided, which are described elsewhere herein.

In response to the user activating the “add to my schedule” control or a “register for this event” control, the example registration user interface illustrated in FIG. 11B is presented. The user interface may include fields configured to receive the user's first and last names, email address, and phone number (e.g., mobile phone number of a phone configured to receive text messages). A list of social networking platforms may be provided. The user interface may be configured to receive a user selection of one or more of the listed social networking platforms to share during the online event (e.g., to enable other attendees to connect with the user (e.g., during or after the event). Corresponding fields are provided via which the user can enter a link to a given social network page of the user. Optionally, the user may be able to select such social networking platforms at a later time (e.g., before, during or after the online event) via a corresponding user interface.

FIG. 11C includes fields configured to receive a user biography from the user, a field configured to receive a profile photograph or avatar selection from the user, and a drop down menu of predefined industries via which the user can select an industry the user is engaged in. Optionally, a field is provided via which the user can type in an industry type, which is received by a search engine which identifies matching industries, and returns search results comprising the matching industries, ranked in accordance with the closeness of the match. Optionally, the search engine may perform an incremental search, where, as the user is typing search term characters the search engine identifies matches in real time and present search results, where the search results may be modified with each character entered by the user.

FIG. 11D illustrates an example user interface via which the user can select one or more predefined interests to be associated with the user. Optionally, the interests may be categorized (e.g., arts & culture, consulting, cooking, etc.), where in response to the user selecting category, corresponding interests that fall under the category may be displayed. In addition, a new tag control is provided via the user can add a user-defined tag. A save control is provided via which the user can save the interest selections.

Optionally, in order to authenticate the user, a code may be transmitted to the user's phone number or email address. The user then needs to enter the correct code into a code field in order to enable one or more features (e.g., registration to the event, the ability to chat with other attendees, etc.).

As discussed above, the system may enable a user to quickly and accurately specify which features discussed herein are activated or deactivated and to configure the operations of features. The system may then automatically generate code enabling/disabling and configuring the features accordingly. The generated code may then be embedded on the website/webpage and provided and execute the features accordingly via a customized widget (also referred to herein as access detection and communication code). The disclosed technology may advantageously reduce the amount of computer process, memory, and network resources that would otherwise be necessary if each website operator had to develop their own widget.

Example user interfaces that will now be described enable the user to create a widget for the user's website, including the configuration, branding, features layout, and chat channels, as well as to define collaborators.

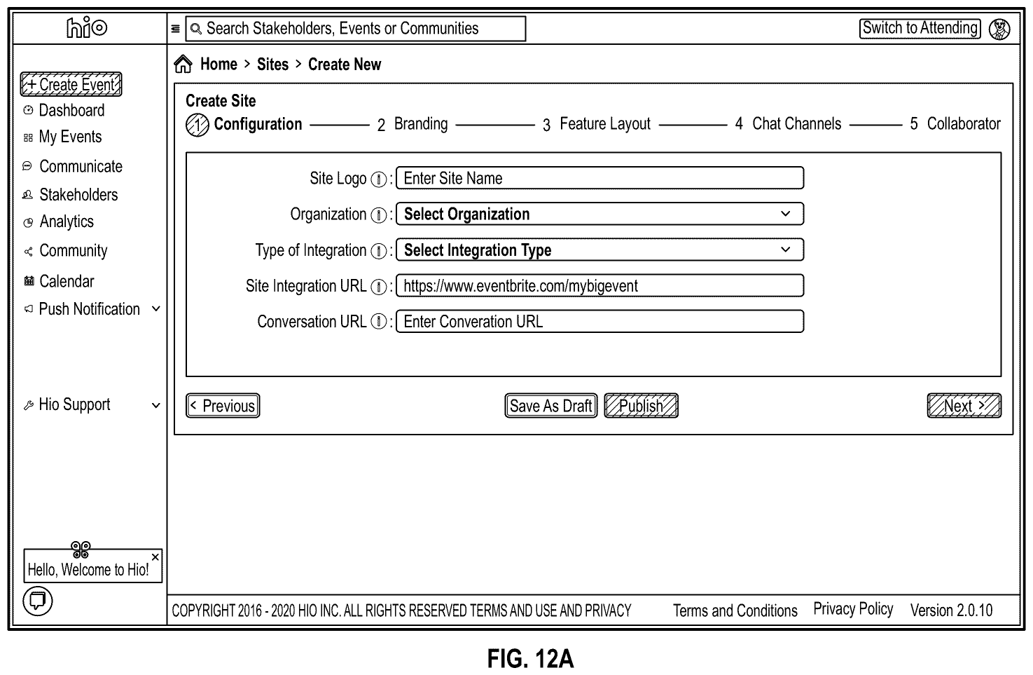

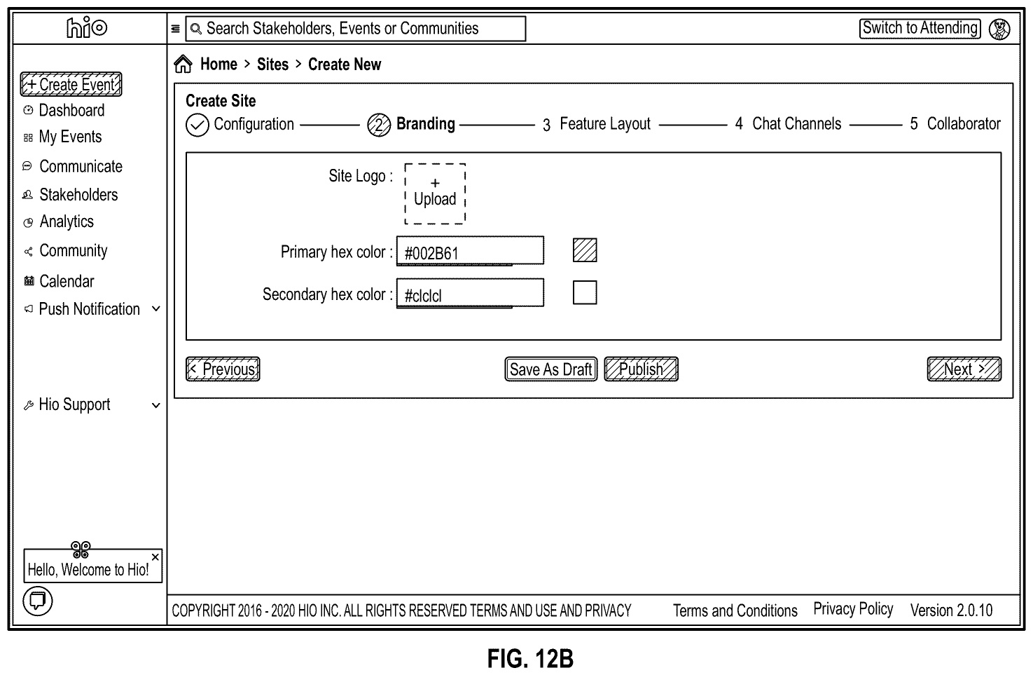

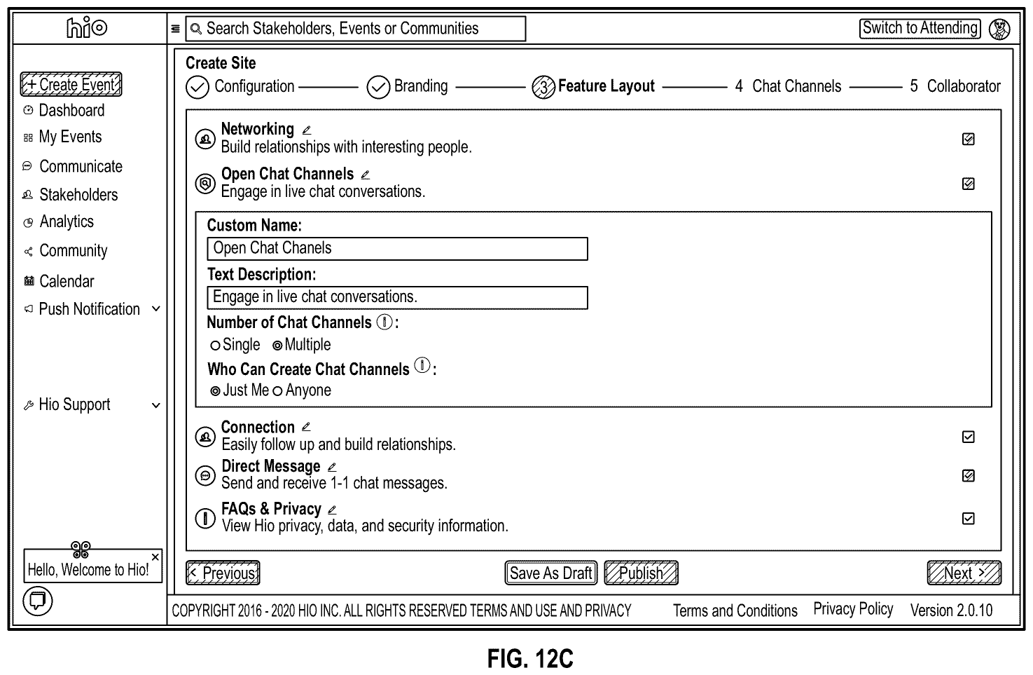

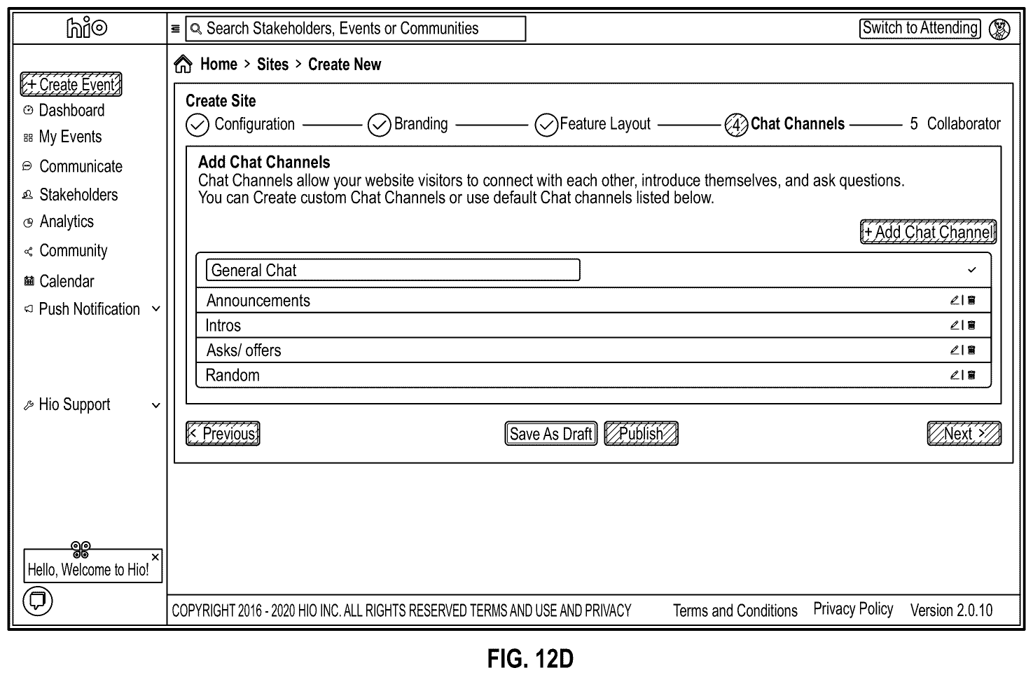

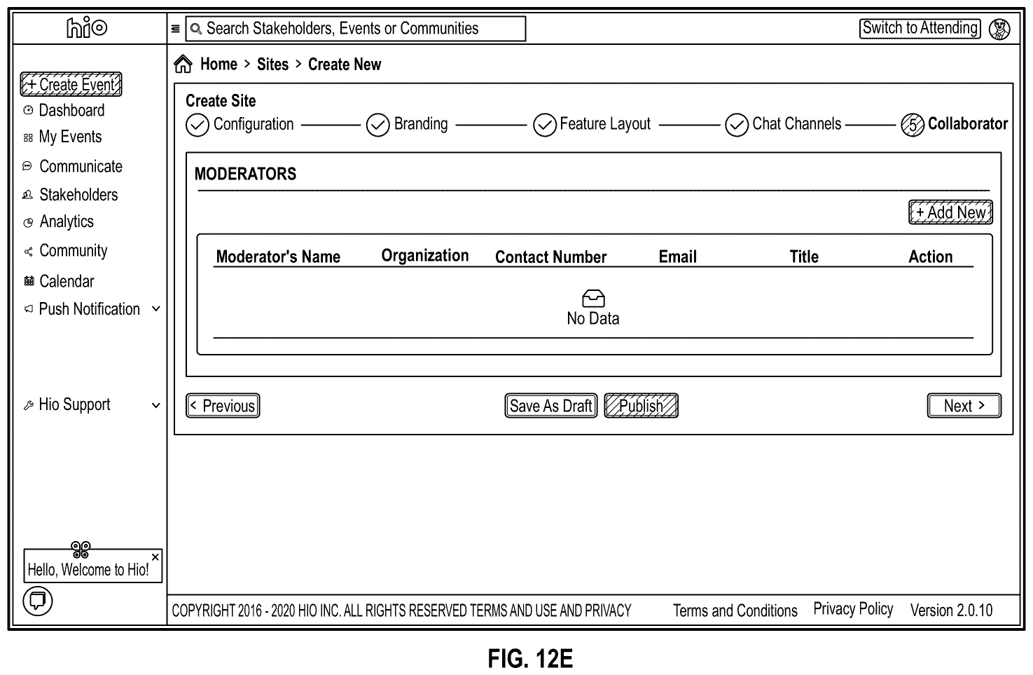

Referring to FIG. 12A, an example user interface indicates the current access detection and communication widget customization stage (e.g., configuration, branding, features layout, chat channels, collaborators). Such stage indication may be updated to reflect the current stage in the other user interfaces described below. FIG. 12A includes fields enabling the user to specify configuration parameters for the access detection and communication widget. Fields are provided configured to receive from the user a site name, an organization selection, an integration type, a site integration URL, and a conversion URL. A conversion URL may be a subsequent URL that a site visitor may end up landing on/navigating to. Such a conversion URL may be categorized as a successful “conversion” (e.g., based on a site publisher categorization criteria). For example, a successful conversion may be a successful signup to a newsletter, the entrance to or exit by a user of a shopping checkout process, the addition of an item to an online shopping cart, the viewing of an internal blog site, and/or the like. Controls are provided via which the user can save the user entries as a draft or to publish the user entries so that they may be implemented as an access detection and communication code widget. Activating a next control may cause the example branding user interface illustrated in FIG. 12B to be presented.

Referring to FIG. 12B, a control is provided via which the user can upload a site logo to be added to the access detection and communication code widget. A field is provided via which the user can specify a primary color (e.g., via a primary hex color value). A field is provided via which the user can specify a secondary color (e.g., via a secondary hex color value). Activating a next control may cause the example feature layout user interface illustrated in FIG. 12C to be presented.

Referring to FIG. 12C, a control is provided via which the user can enable or disable the networking features described herein that enable users to build relationships with other users via online communications and content sharing (where if a feature is disabled, the corresponding module interface may not be displayed via the user interfaces described herein). A control is provided via which the user can enable or disable chat channels via which users can engage in live communications with each other. A field is provided configured to receive a custom name for a chat channel (which may be presented to users when viewing a list of chat channels). A field is provided configured to receive a text description of the chat channel (which may be presented to users when viewing a list of chat channels). A field is provided via which the user can specify whether a single chat channel or multiple chat channels are to be opened. A field is provided via which the user can specify whether only the user can create chat channels for the website (accessible via the access detection and communication code widget) or whether anyone can create chat channels for the website. A control is provided via which the user can enable or disable the ability of users to make connections. A control is provided via which the user can enable or disable direct messages. A control is provided via which the user can enable or disable the presentation of the FAQs & Privacy module. Activating a next control may cause the example chat channels user interface illustrated in FIG. 12D to be presented.

Referring to FIG. 12D, the example chat channels user interface enables one or more chat channels to be added to the access detection and communication code widget (where users can communicate via the channels, introduce themselves, ask questions, or connect). The user interface enables the user to define custom chat channels and/or add predefined channels, such as general chat, announcements, introductions, asks/offers, random, etc. Delete controls are provided that enable the user to delete a corresponding channel. Activating a next control may cause the example collaborations user interface illustrated in FIG. 12E to be presented.

Referring to FIG. 12E, the example collaborator user interface enables the user to specify authorized chat channel/forum moderators. Fields are provided configured to receive a moderator name, organization, contact phone number, contact email, title, and action. For example, an action associated with a moderator/collaborator may be an invitation to the widget (e.g., via email and/or text message), where the moderator may be granted special permissions enabling the moderator to join a discussion as a moderator, to flag content, to engage on the brand's behalf, and/or to assist in configuring the widget itself.

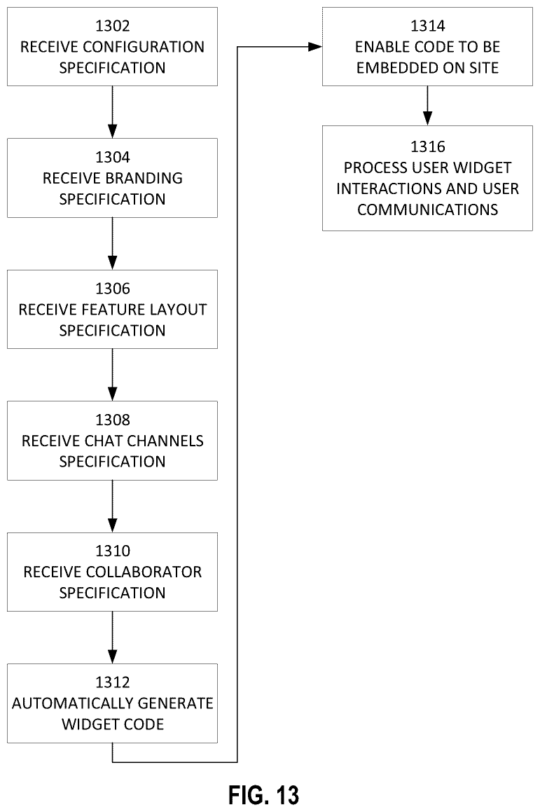

FIG. 13 illustrates an example process for defining and automatically generating a communication access detection and communication code widget (without requiring manual coding), and enabling the communication access detection and communication code widget to provide functions and features described herein. At block 1302, an access detection and communication code widget configuration specification is received from a user device (e.g., via the user interface illustrated in FIG. 12A). For example, the configuration specification may include site name, organization, integration type, site integration URL, and a conversion URL. As discussed elsewhere herein, the URL(s) (and/or other site identifiers) may be transmitted to the multimedia communication system to identify the website being visited by a user accessing the widget.

At block 1304, a branding specification is received from a user device (e.g., via the user interface illustrated in FIG. 12B). For example, the branding specification may include site logo(s), primary color, and/or secondary colors.

At block 1306, a feature layout specification is received from a user device (e.g., via the user interface illustrated in FIG. 12C). For example, the feature layout specification may include the configuration (e.g., enabling or disabling) of chat channels via which users can engage in live communications with each other, chat channel name (which may be presented to users when viewing a list of chat channels), chat channel description (which may be presented to users when viewing a list of chat channels), whether one or more than one chat channels are to be opened, who is permitted to create chat channels, the configuration of connections, the configuration of direct messages, and/or the configuration of a FAQs & Privacy module.

At block 1308, a chat channels specification is received from a user device (e.g., via the user interface illustrated in FIG. 12D). For example, the chat channels specification may include an identification of one or more custom or predefined channels to be added to the access detection and communication code widget (where users can communicate via the channels, introduce themselves, ask questions, connect, and/or the like).

At block 1310, a collaborator specification is received from a user device (e.g., via the user interface illustrated in FIG. 12E). For example, the collaborator specification may include an identification of one or more moderator names, organizations, contact phone numbers, contact emails, titles, and/or actions.

At block 1312, in response to a user activation of a corresponding control, the system may automatically generate corresponding access detection and communication widget code, without requiring a user to manually write the code. The code may optionally be in the form of JavaScript.

At block 1314, the access detection and communication widget code is provided to a website operator which may embed the code in a website's webpage. For example, optionally similar operational access detection and communication code may be embedded in different webpages of different websites operated by different, unrelated entities (although the code may be modified for each website in accordance with the configuration process described above and to include a unique identifier associated with the website) and may optionally provide a functionally common or similar interface with respect to the different websites (although each website may optionally have its own branding and may disable or enable certain functions via the process described herein).

At block 1316, the process detects users accessing the website via the embedded widget code, may identify such users, may enable such users to direct message each other, may enable users to post to or read selected chat forums, may enable users to connect to each other, and may provide other functions and services described herein.

As described elsewhere herein, systems and methods are disclosed that are configured to enhance network resource (e.g., website) real time engagement, content streaming, navigation, communication, and online communities. Such enhancement may be provided via one or more digital breadcrumbs (sometimes referred to herein as an anchor), associated with a webpage that may be accessed via a browser on a user device. The use of such anchors enables content to be provided to a user in the context of other content (e.g., webpage content) displayed to the user.

Optionally, a given anchor may be associated with an application programming interface (API) which pulls data from a content source, such as a social media site, microblogging site, video content sharing site, audio content sharing site, or other source specified by the authorized entity via a corresponding user interface.

As described elsewhere herein, optionally, an anchor may have a specified start time and/or end time, wherein the associated content will only be pushed and/or be accessible within the specified start time and end time, or if an end time is not specified, any time after the specified start time (or after the anchor was set even if a start time is not specified) unless such anchor is removed. Such anchor may ensure that the pushed content is provided in a useful context, such as ensuring the pushed content is directly related to webpage content currently being displayed to the user. Such context will enhance the user experience and make it more likely the user will further engage with the webpage and website. By way of example, if a user is scrolling through a recipe and reaches a cutting instruction, a video of a cutting lesson may be pushed. Optionally, the content may be pushed to the user via a user notification (e.g., a pop-up, scrolling text, highlighting of content, and/or otherwise) and/or via an automatic presentation/playing of the content to the user.

As disclosed herein, the user interfaces and functionality may be provided via code (e.g., automatically generated widget code) embedded in a webpage. The user interface may be accessed by an end user device (e.g., a desktop computer, laptop computer, smart phone, networked television, networked game console, networked wearable device, and/or the like) via a webpage of the website, where the webpage may be accessed and presented by a browser hosted on the user device. Such user interface enables the third party to stream live and/or prerecorded video, audio, and/or text via the user interface to a user accessing a preexisting webpage. The content may be pushed to the user via a user notification (e.g., a pop-up, scrolling text, highlighting of content, and/or otherwise) and/or via an automatic presentation of the content to the user.

As disclosed elsewhere herein, optionally, an anchor may be associated with one or more rules which may control which content is displayed to which viewer. Hence, a given user may be provided with a customized engagement experience when accessing a webpage.

Optionally, an anchor may be displayed (e.g., as a graphic, text, photograph, a highlighting of webpage text or graphic/image content, or otherwise) on a webpage, optionally independent of a user's interaction with the webpage. Optionally, an anchor may be displayed in response to a user hovering a cursor over or clicking on/selecting a specified area (e.g., where the anchor is positioned) or webpage HTML element.

Optionally, a user interface may be provided which enables an entity setting the anchor to specify a location on a webpage at which the anchor is to be located. Optionally, the user interface enables a user to drag and drop an anchor from an anchor menu to any desired location on the webpage. Optionally, the user interface may enable the user to drop the anchor on a webpage HTML element (e.g., an element defined by a start tag, some content, and an end tag). Optionally, the user interface may enable the user to drop the anchor on a webpage HTML element with a specified left, right, top, or bottom offset, wherein the anchor may be placed in accordance with the specified offset(s) from the HTML element.

Referring now to FIG. 1D, an example process of associating an anchor with a portion of a webpage and of dynamically presenting content in context is illustrated. At block 102D, a webpage area specification is received over a network from a device of an entity (e.g., an authorized administrator or any end user is so permitted) via a corresponding user interface. For example, the user may drag and drop an anchor to a desired webpage location or may otherwise specify an anchor location. By way of illustration, the user may associate an anchor with a specified webpage HTML element (e.g., content associated with a start tag and an end tag). By way of further illustration, the user may associate an anchor with a specified webpage HTML element, wherein a positional offset is specified (e.g., an x, y offset).

At block 104D, an anchor customization is received via a user interface. For example, the customization may specify content (e.g., text, audio, still image, video, and/or graphic content) or a content source (e.g., a social media site account, an image sharing site account, a video sharing site account, an audio sharing site account) that is to be pushed to an end user. By way of further example, a user may specify one or more rules as to under what circumstances content is to be pushed. For example, a rule may specify that a given item of content is to be pushed to a user having certain subject and/or brand preferences and optionally not to other users. In addition or instead, a rule may specify that a given item of content is to be pushed to a user having certain demographics (e.g., a certain age range, certain locations, certain estimated income, certain family situation, etc.) and optionally not to other users.

At block 106D, anchor location data and anchor customization data are stored. For example, anchor location data and anchor customization data may be stored on a networked cloud-based storage system. At block 110D, code is embedded in a selected webpage (e.g., a webpage associated with a content provider, such as an online news site, a blog, an education site, a game site, etc.). For example, the code may be automatically generated and may be used to generate user interfaces that may be accessed via the webpage and provide functionality described herein.

At block 112D, in response to a user device browser requesting the webpage, the anchor location data and anchor customization data are retrieved from the storage system. At block 114, the anchor is optionally rendered in accordance with the location data.

At block 116D, a determination is made as to whether the aforementioned rule(s) that control under what circumstances content is to be pushed are satisfied. Once the rule(s) are satisfied, the process proceeds to state 118D, and the content (e.g., text, graphic, audio, video, etc.), associated with the anchor is accessed. At block 120D, the content is rendered on the user device (e.g., in line with webpage content or overlaying the webpage).

FIG. 1E illustrates an example computer environment that may be utilized to stream an uploaded audio and/or video broadcast. A stream processing and distribution system 104E may be configured to ingest a video/audio file from a system 102E (e.g., the system of a host of the broadcast), create a video asset from the ingested file, and prepare the video/audio asset for streaming. The stream processing and distribution system 104E may optionally, in real or near real time (e.g., less than a 3 second delay), generate the appropriate renditions of the video asset for a given listener/viewer device 108E1, 108E2, . . . 108EN and for the available network bandwidth, thereby providing a visually enhanced rendition of the video asset and avoiding streaming stutters. The stream processing and distribution system 104E may be configured to generate a URL at which the video/audio asset may be accessed.

The file may also be stored in a storage system 106E, which is optionally a cloud-based storage system, for later access by the listener/viewer devices 108E1, 108E2, . . . 108EN. The video/audio asset may be added to a content library associated with an entity (e.g., a brand), a website, and/or a webpage, such as content libraries discussed elsewhere herein.

FIG. 1F illustrates an example computer environment that may be utilized to stream a live audio and/or video broadcast from a host system 102F. A host may control whose live audio/video stream is to be shared with the broadcast viewers/listeners. For example, the host may be enabled to mute or enable a microphone or camera of a given listener/viewer. The host system 102F streams the conference to a broadcast system 104F, optionally in RTC (real time communication) format. The broadcast system 104F may enable the host to control various aspects of the broadcasts (e.g., selectively muting or enabling the microphones and/or video cameras of listener/viewer devices 108F1, 108F2, . . . 108FN). Data associated with the live broadcast may be stored in a storage system 106F (which may be a cloud-based storage system).

The broadcast may be streamed from system 104F to stream processing and distribution system 106F. The stream processing and distribution system 104F may optionally, in real or near real time (e.g., less than a 3 second delay, less than a 2 second delay, or less than a 1 second delay), generate the appropriate renditions of the video asset for a given listener/viewer device 108F1, 108F2, . . . 108FN and for the available network bandwidth, thereby providing a visually enhanced rendition of the video asset. The stream processing and distribution system 106F may optionally convert the stream from RTC to RTMP (Real-Time Messaging Protocol). Advantageously, although RTMP may result in more latency (e.g., 0.3-2 seconds) than RTC (which may be less than 0.3 seconds), RTMP may be more scalable than RTC. For example, using RTMP, a live stream may be scaled to stream live audio/video content to millions of devices simultaneously. By contrast, RTC may be more suitable for streaming to a few thousand devices.

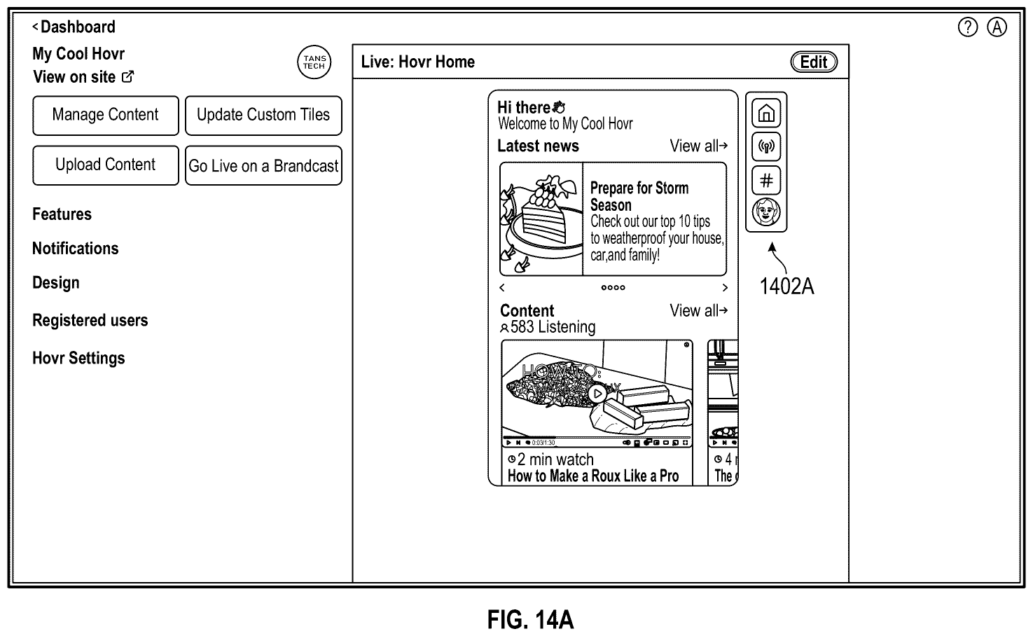

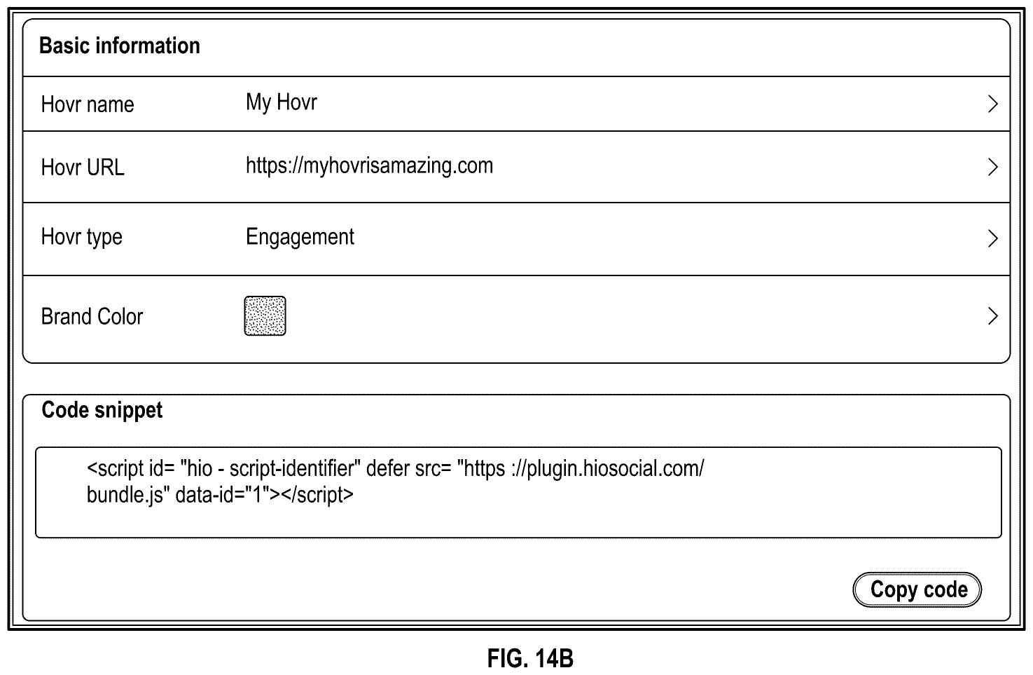

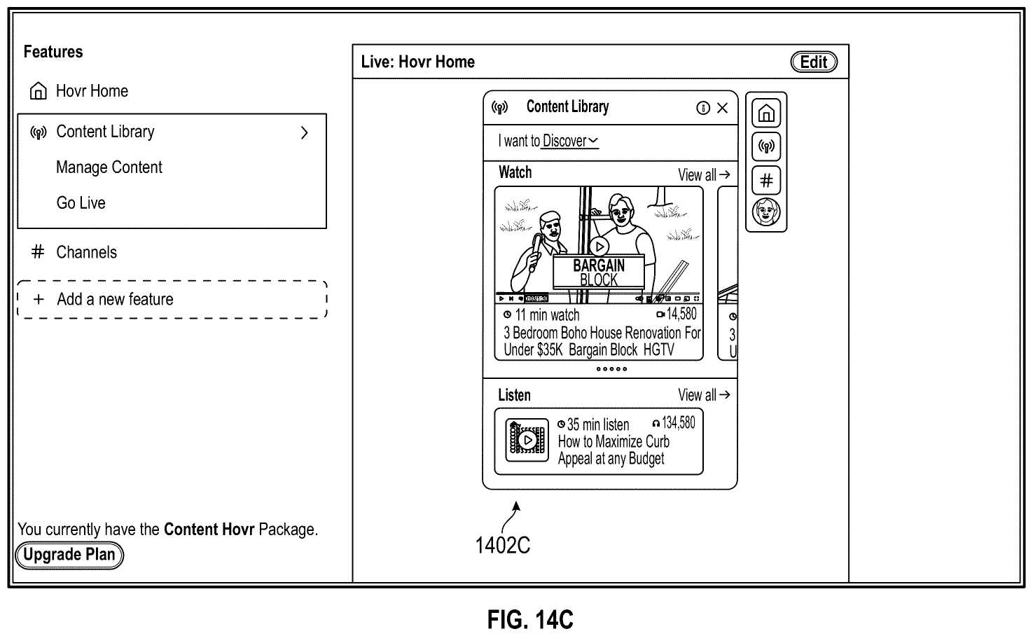

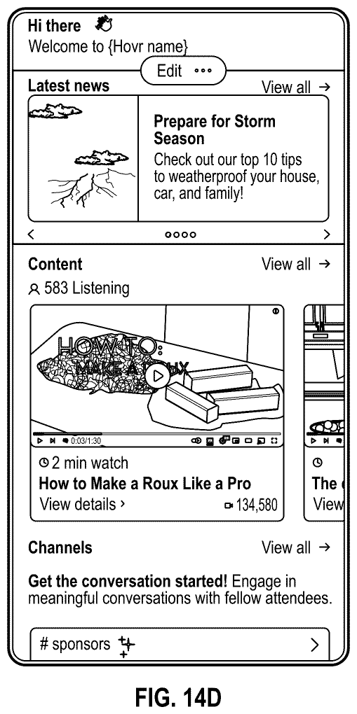

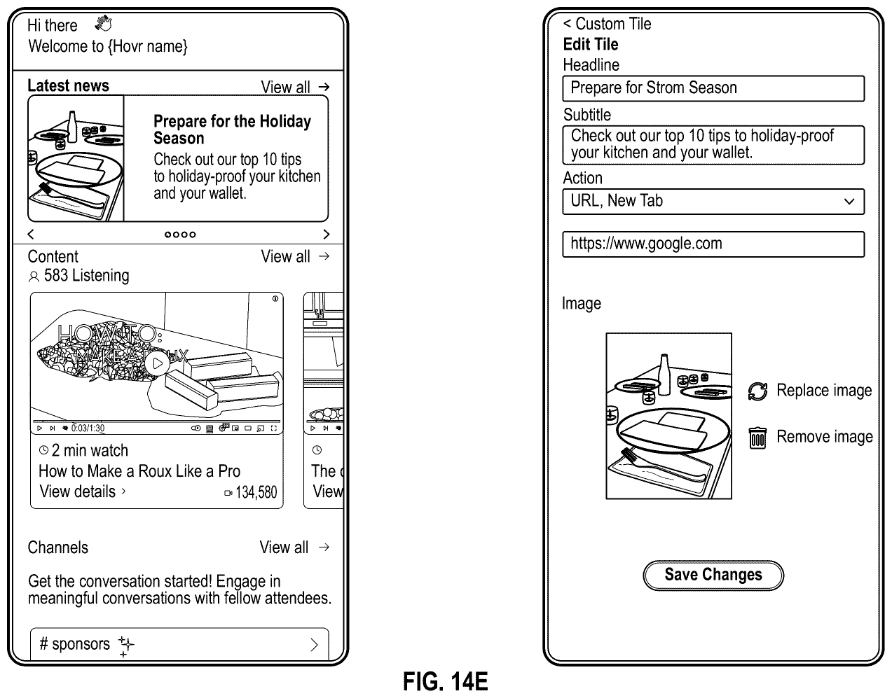

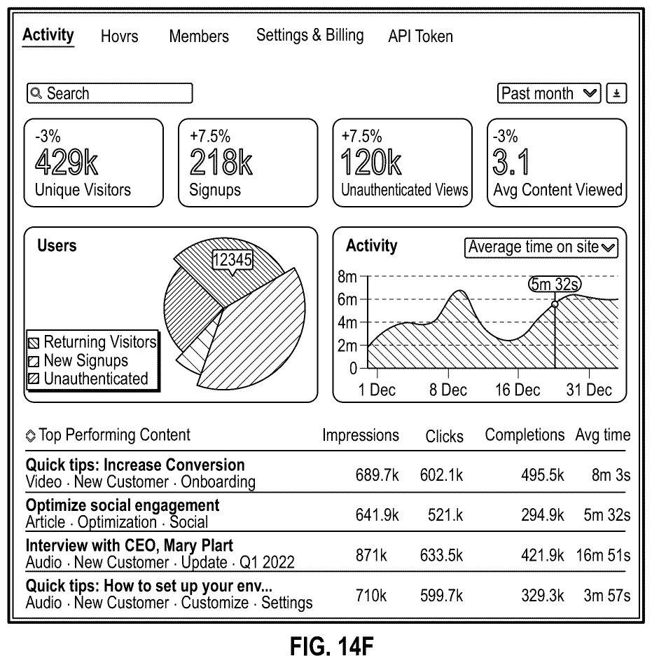

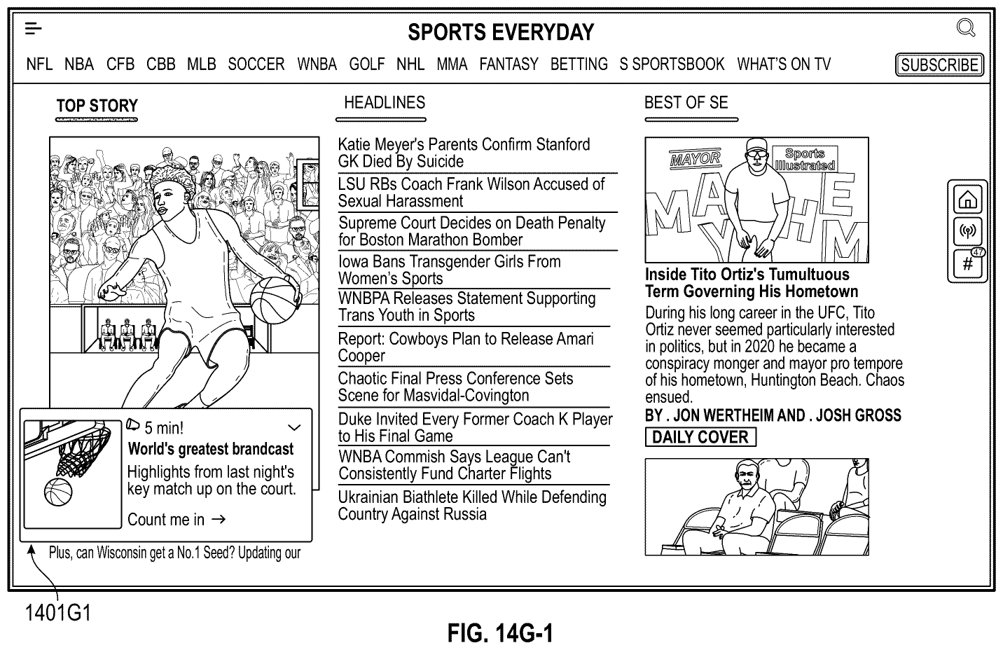

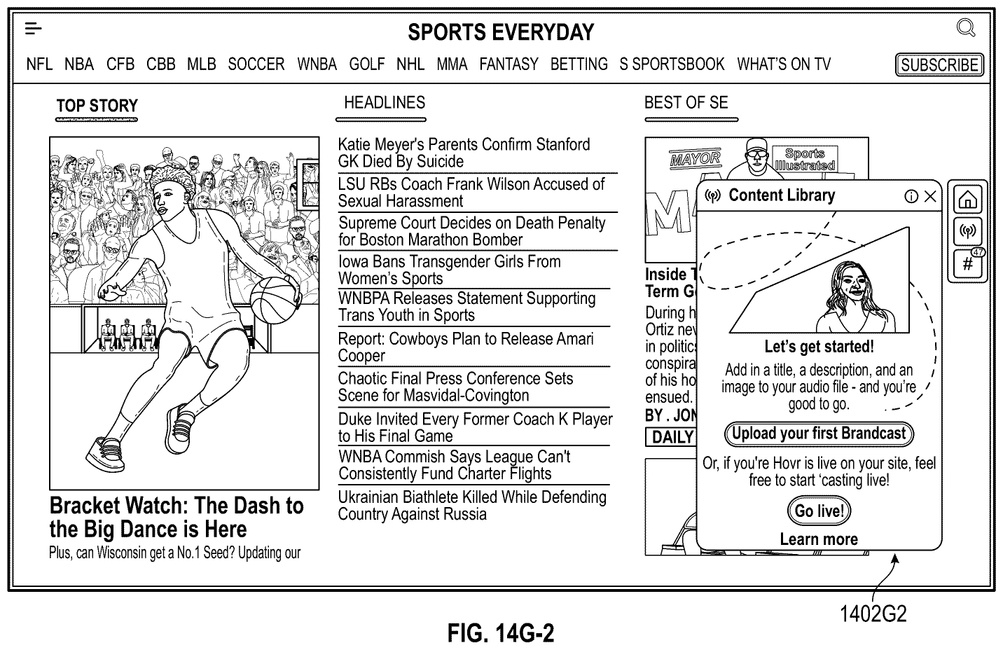

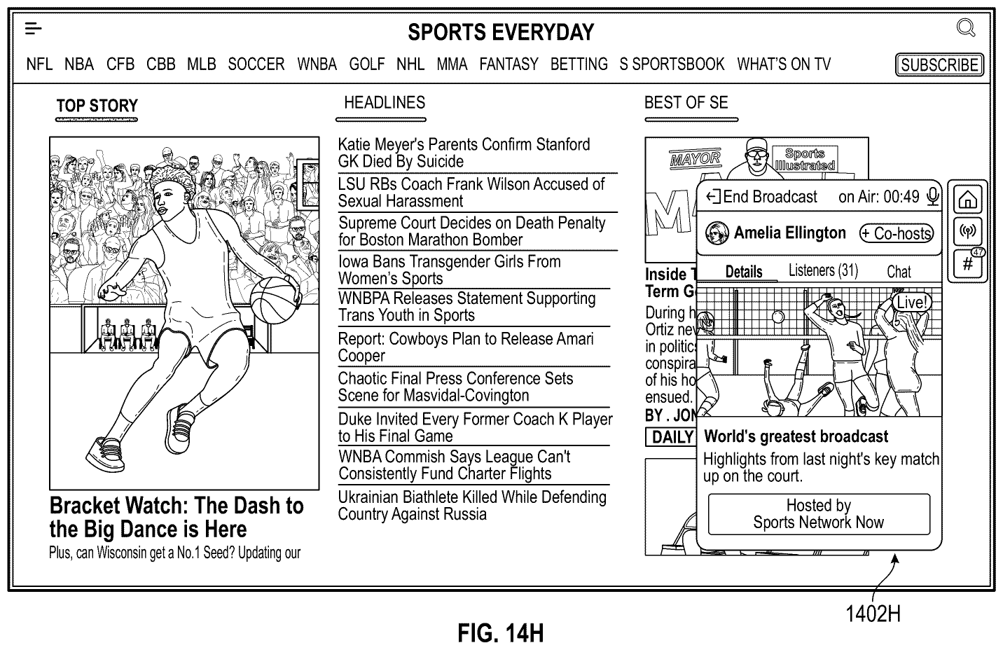

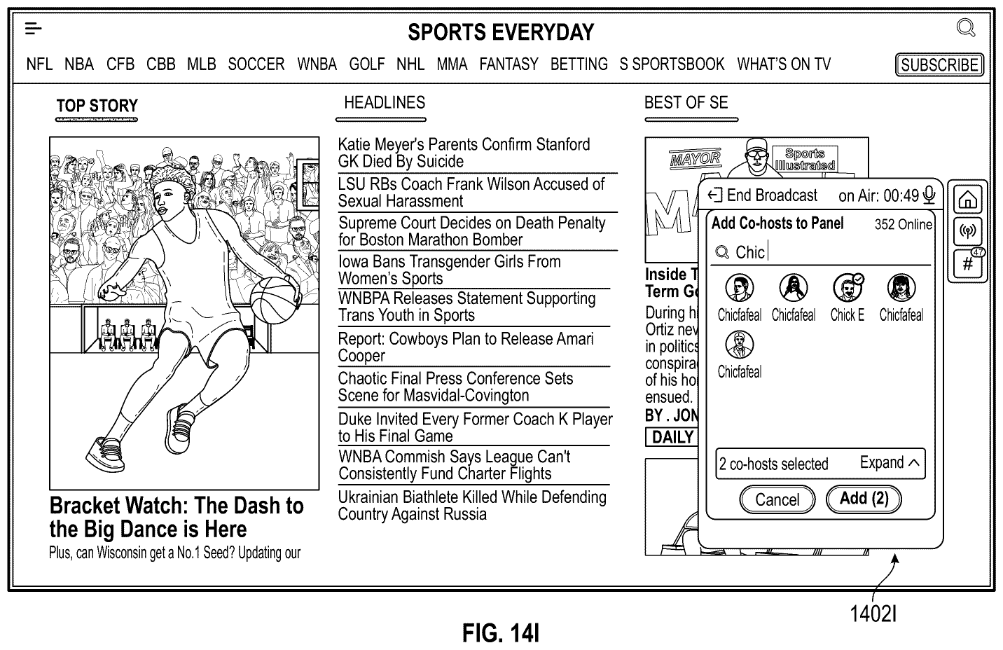

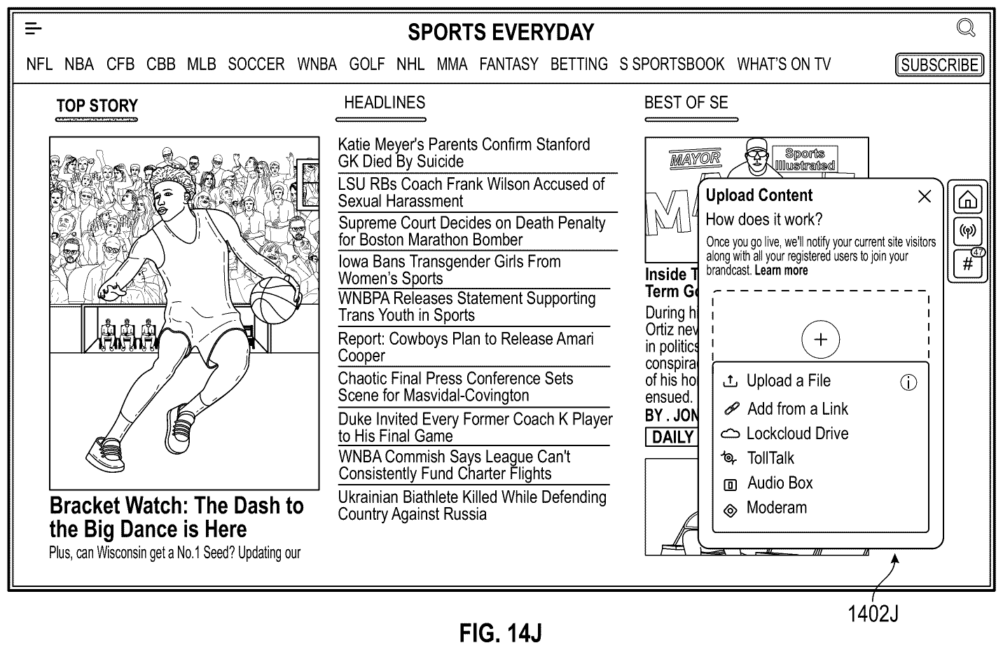

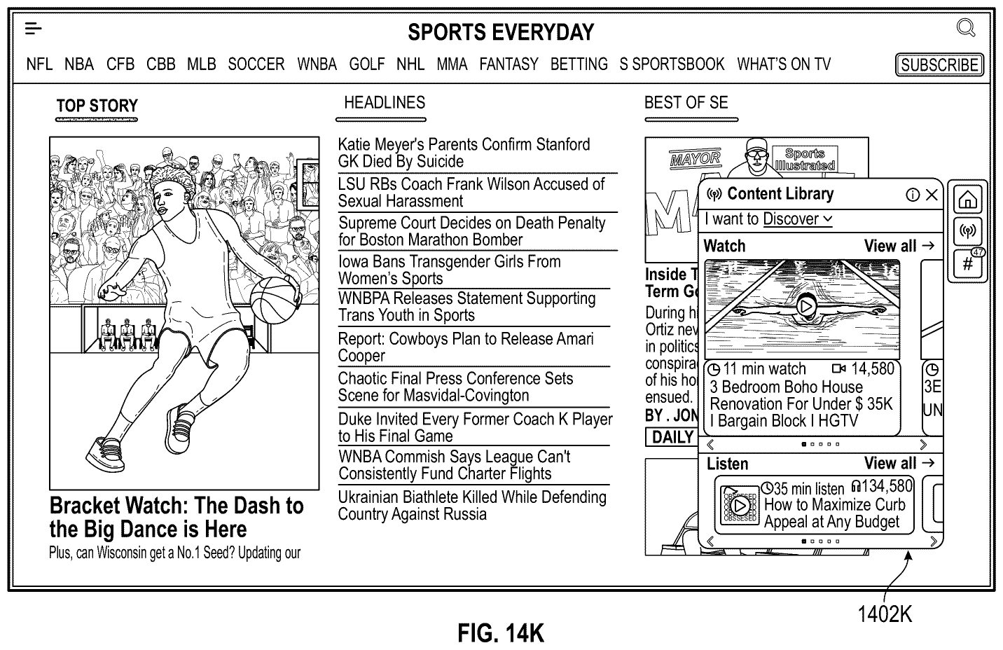

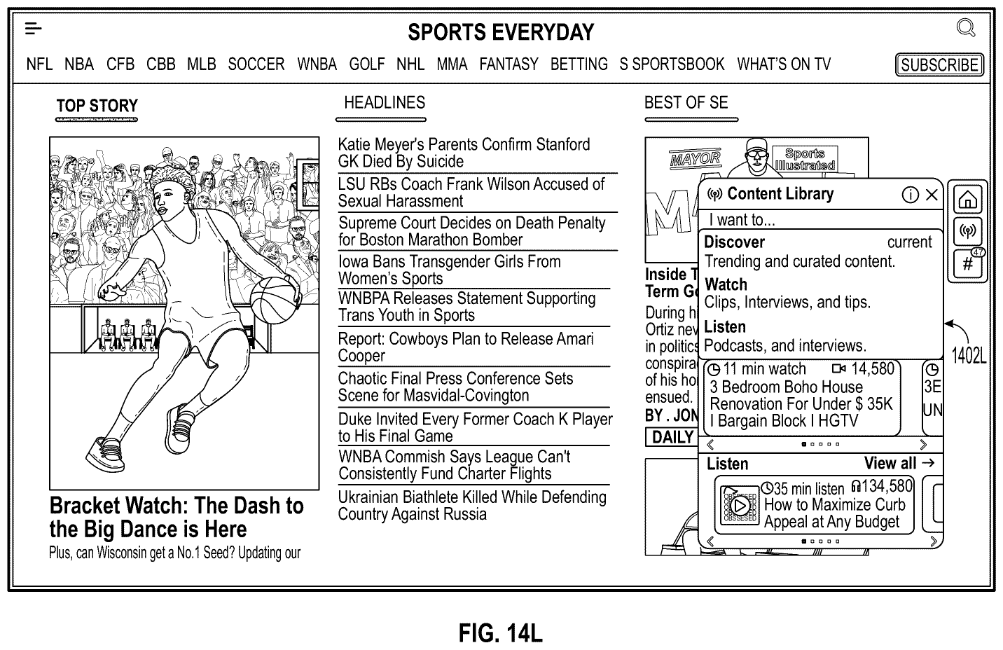

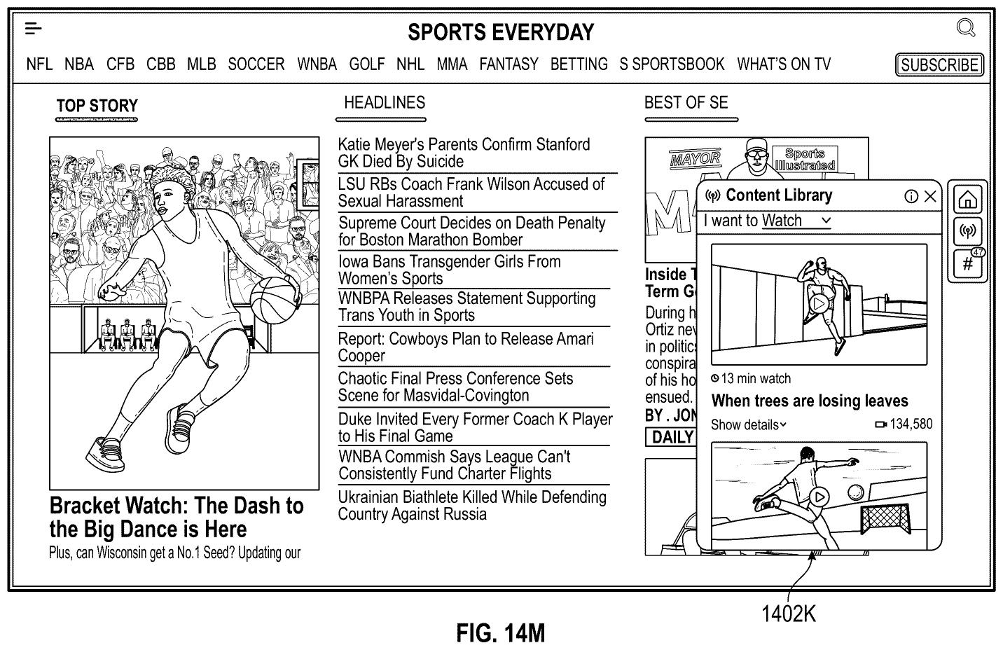

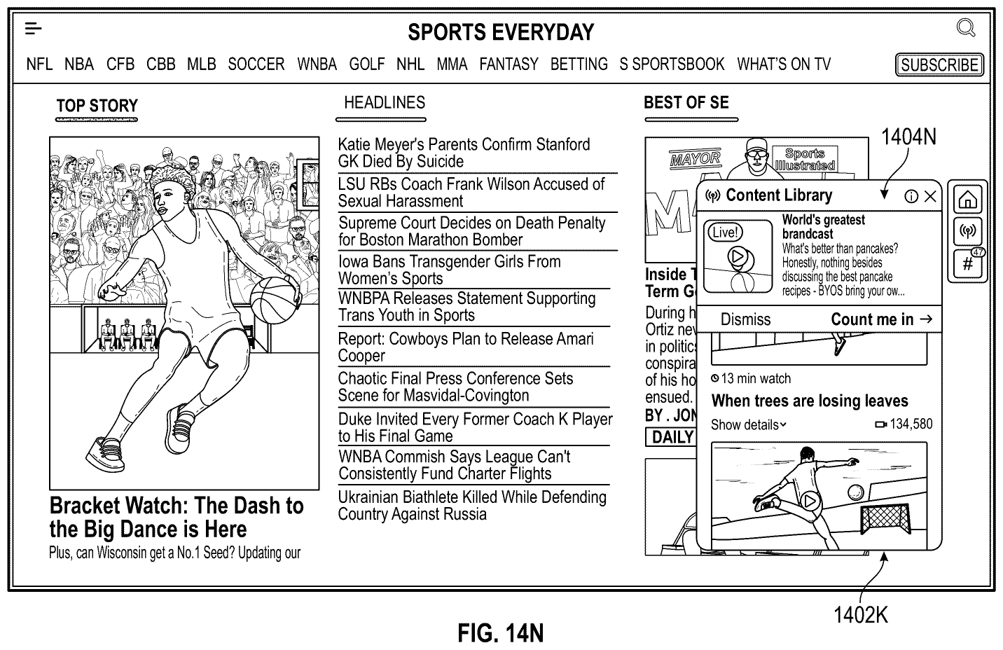

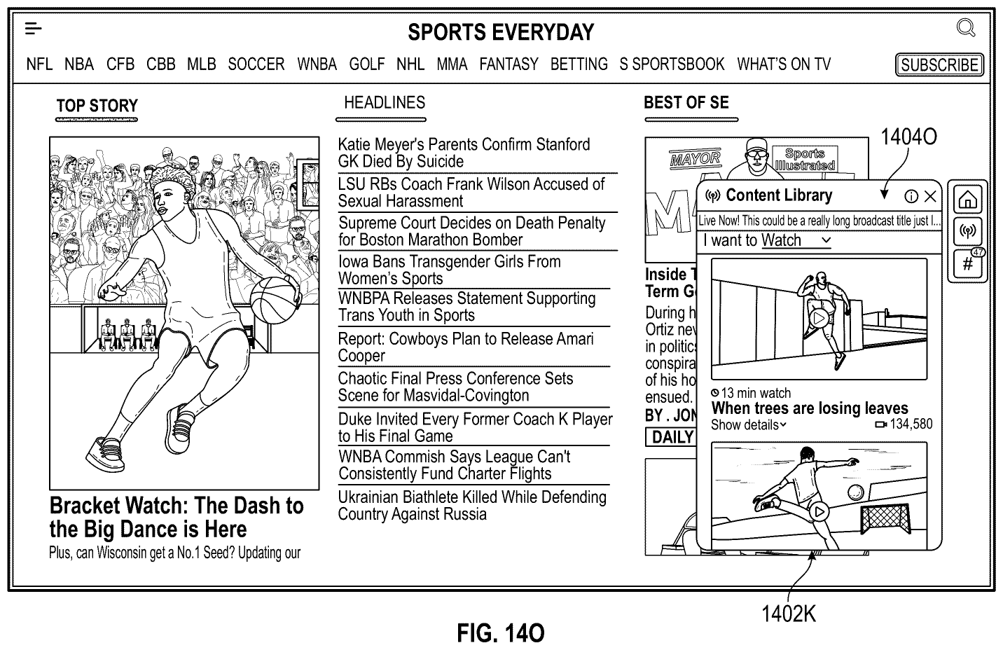

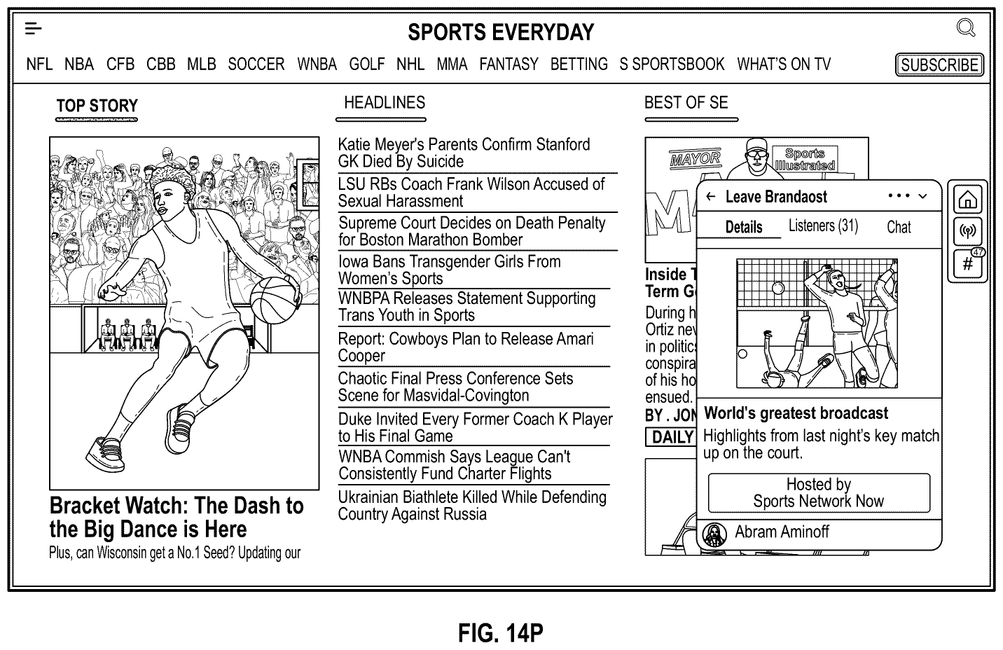

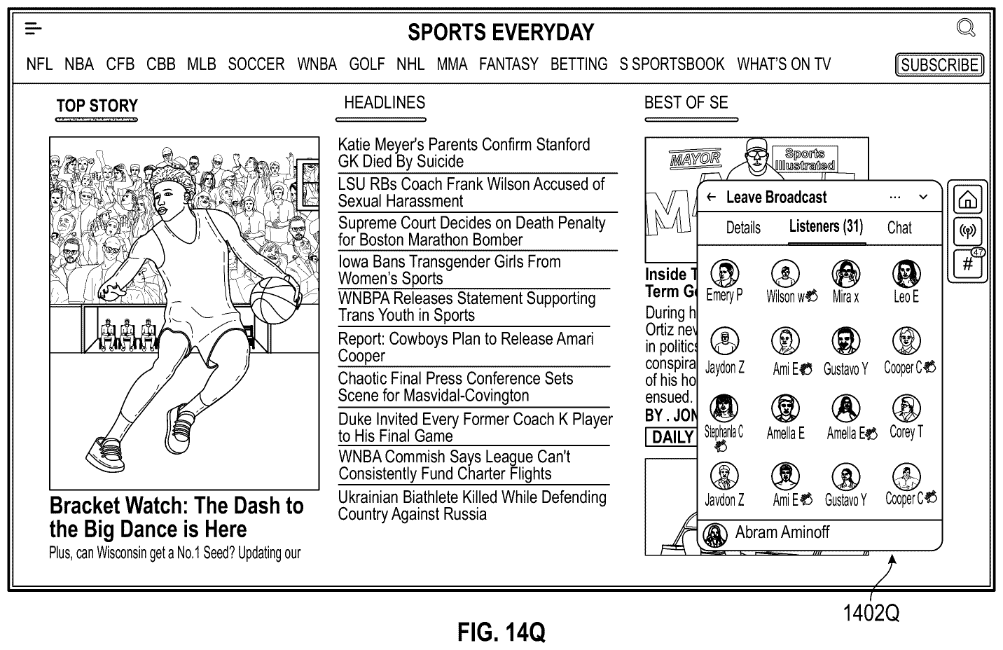

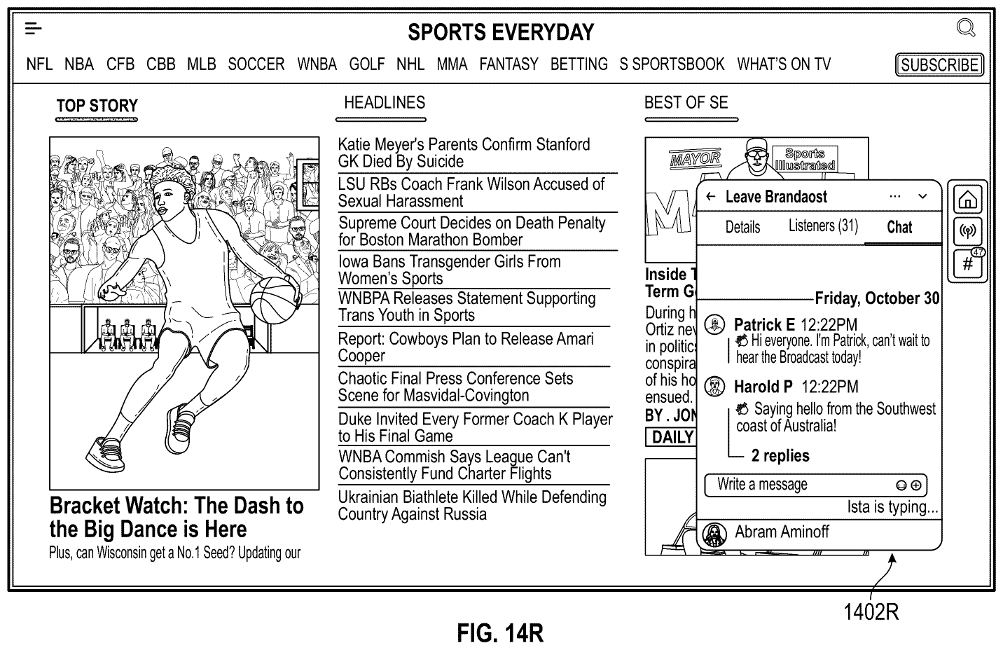

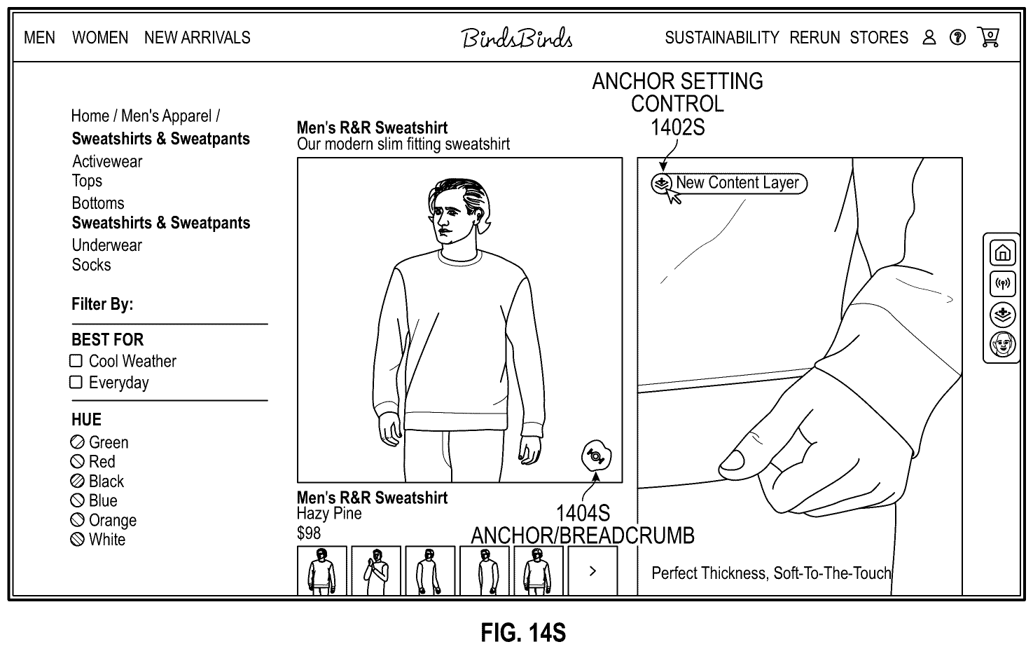

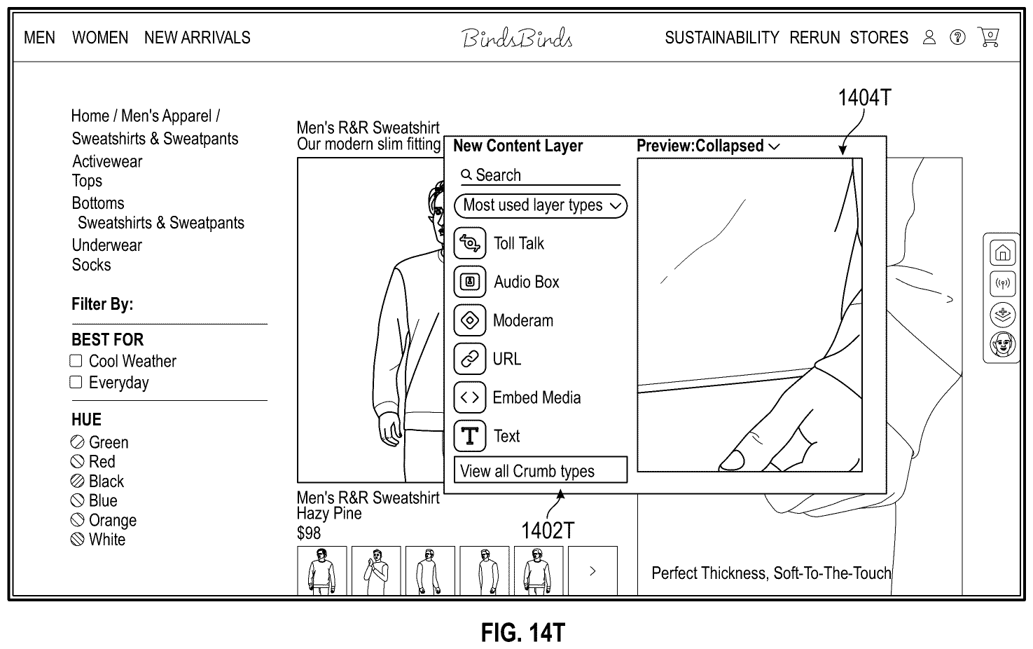

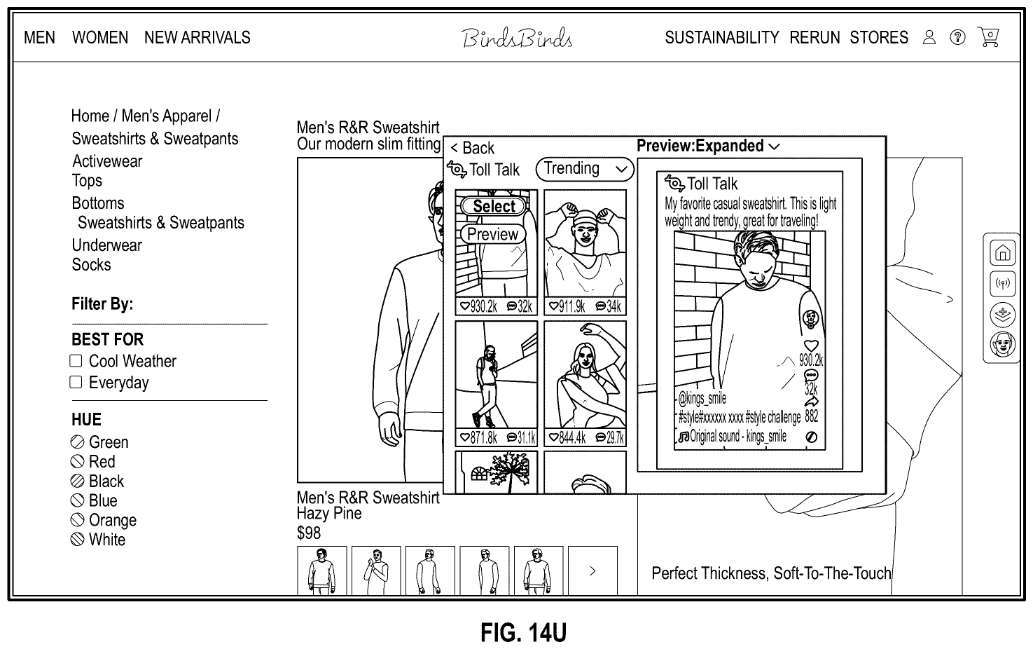

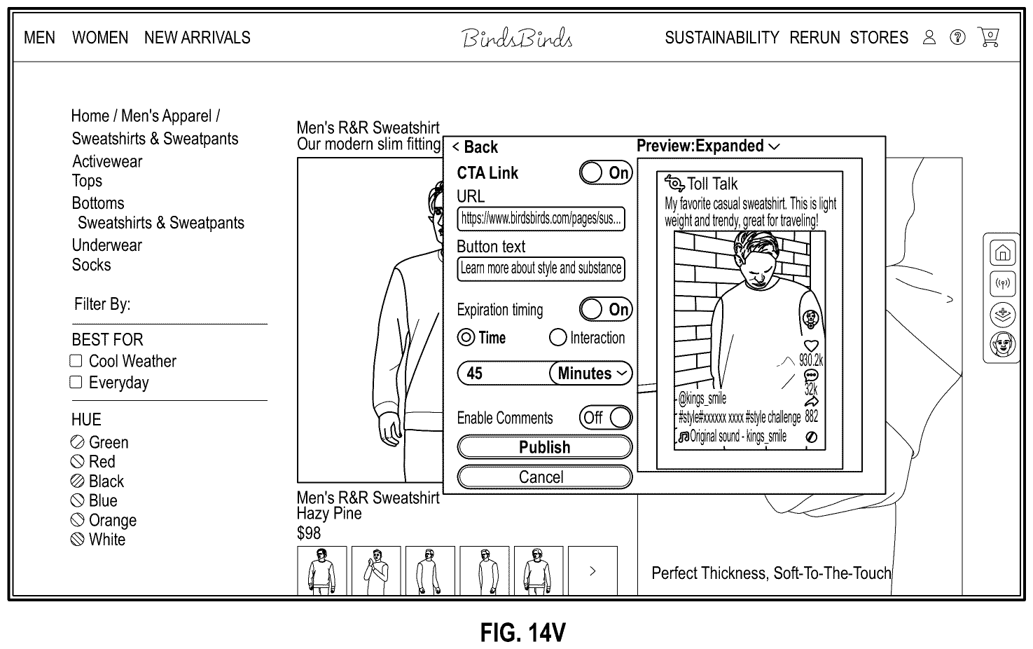

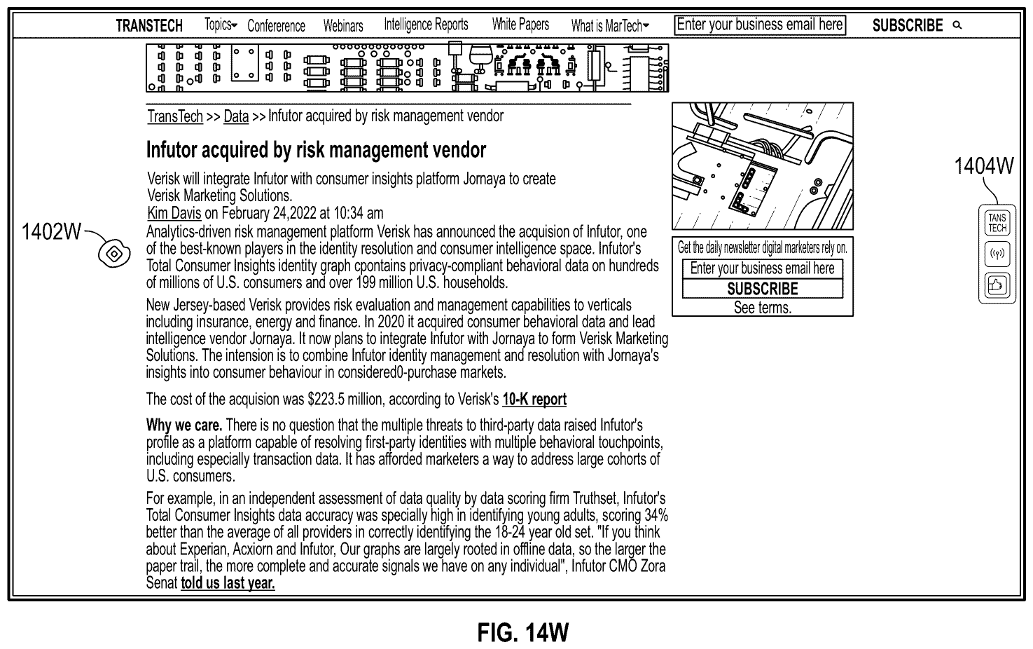

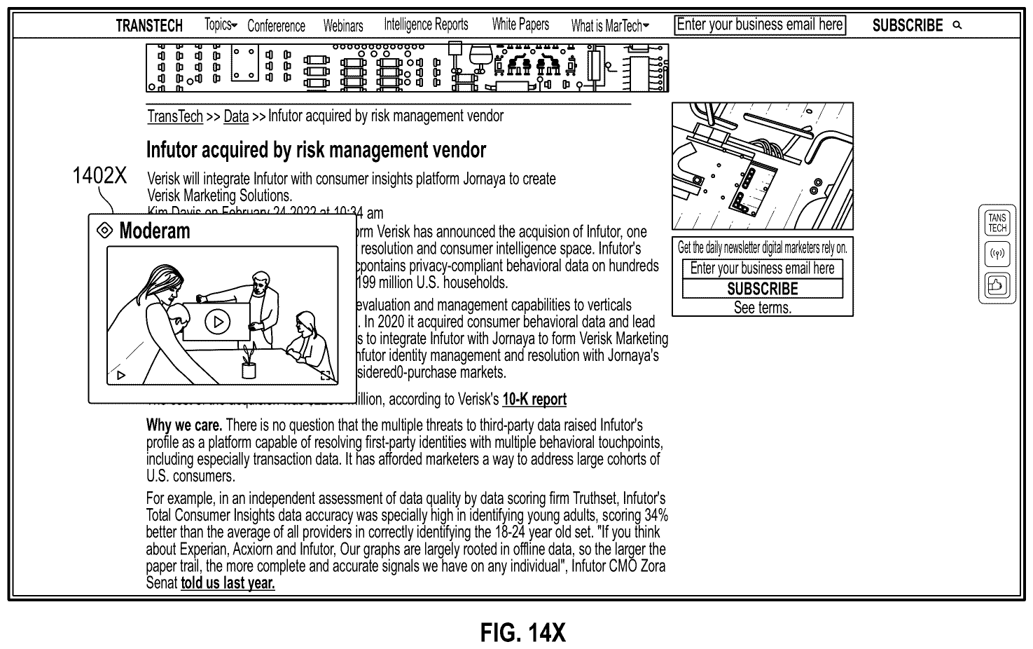

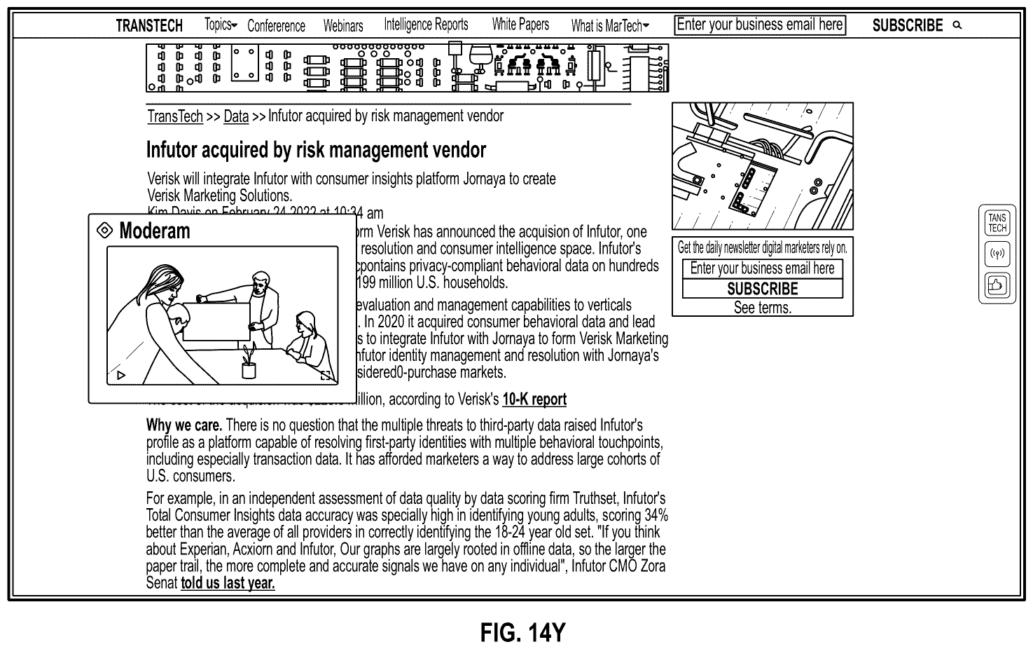

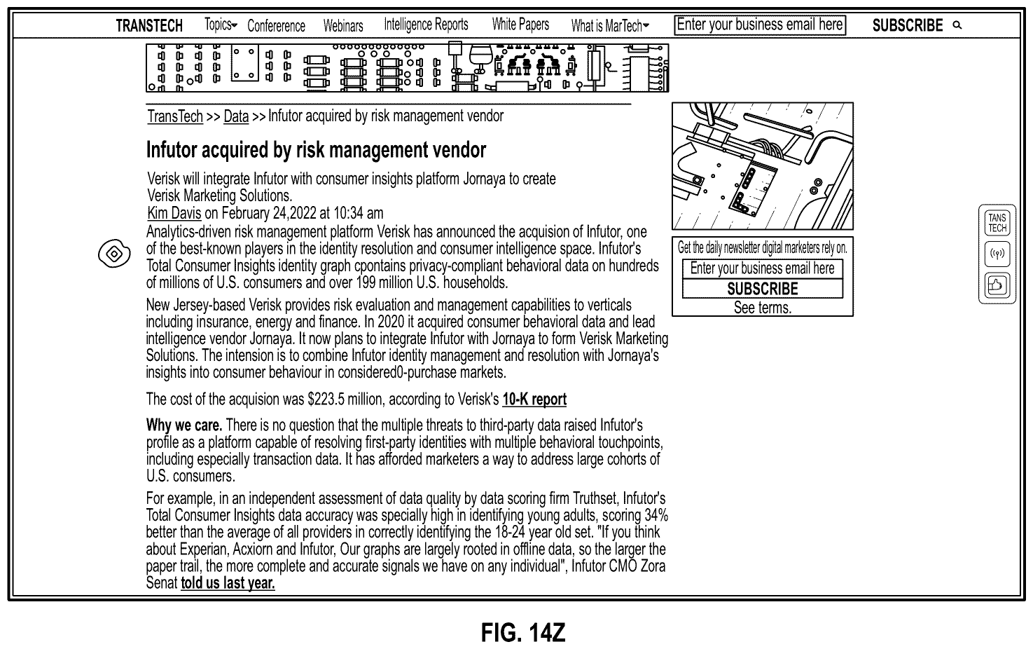

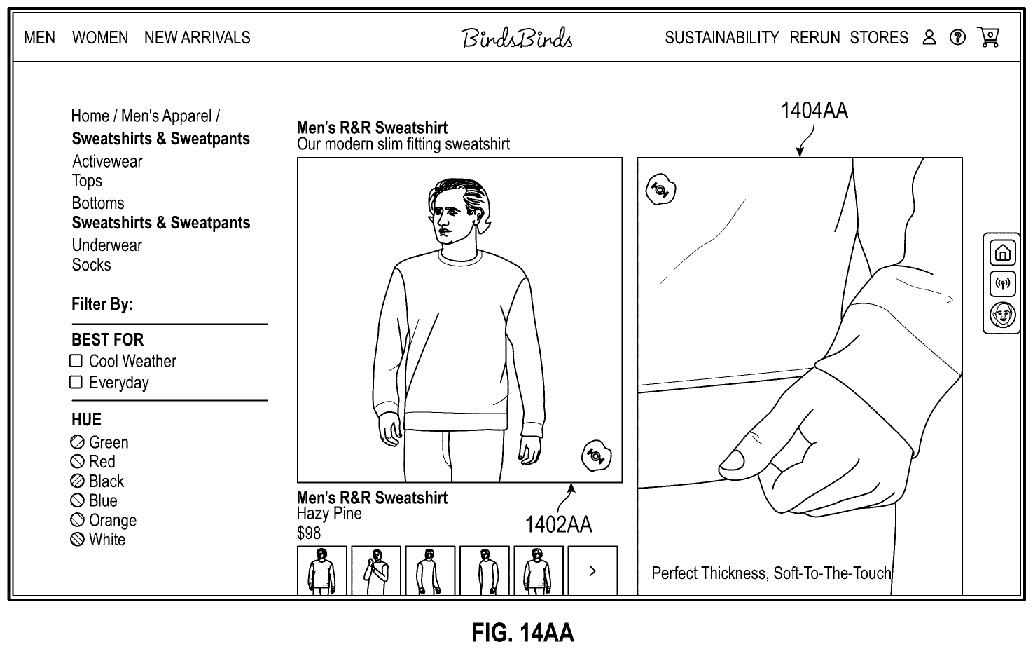

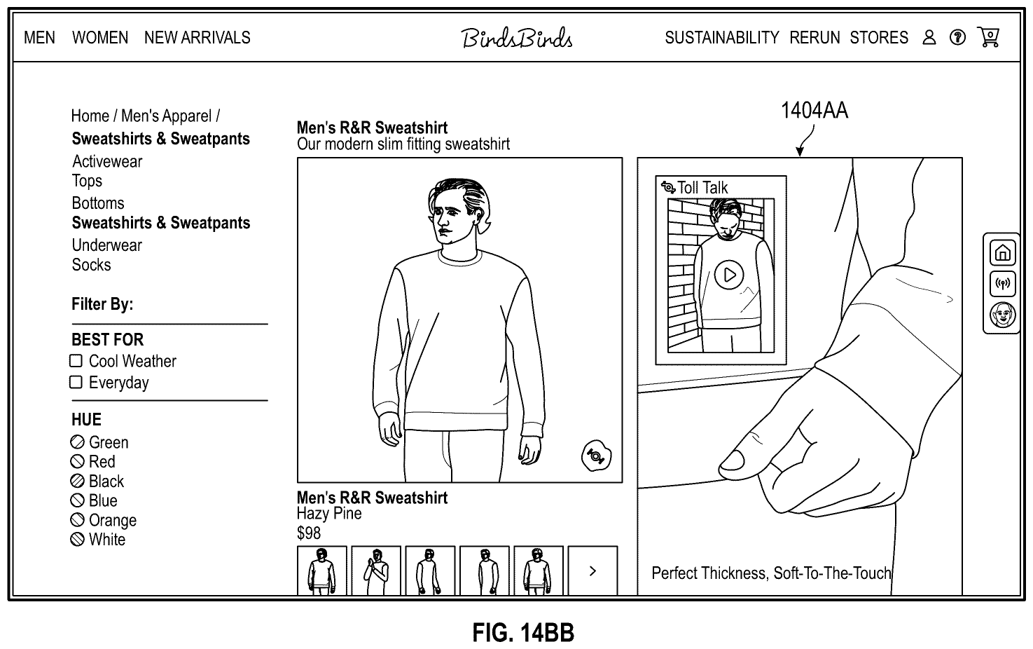

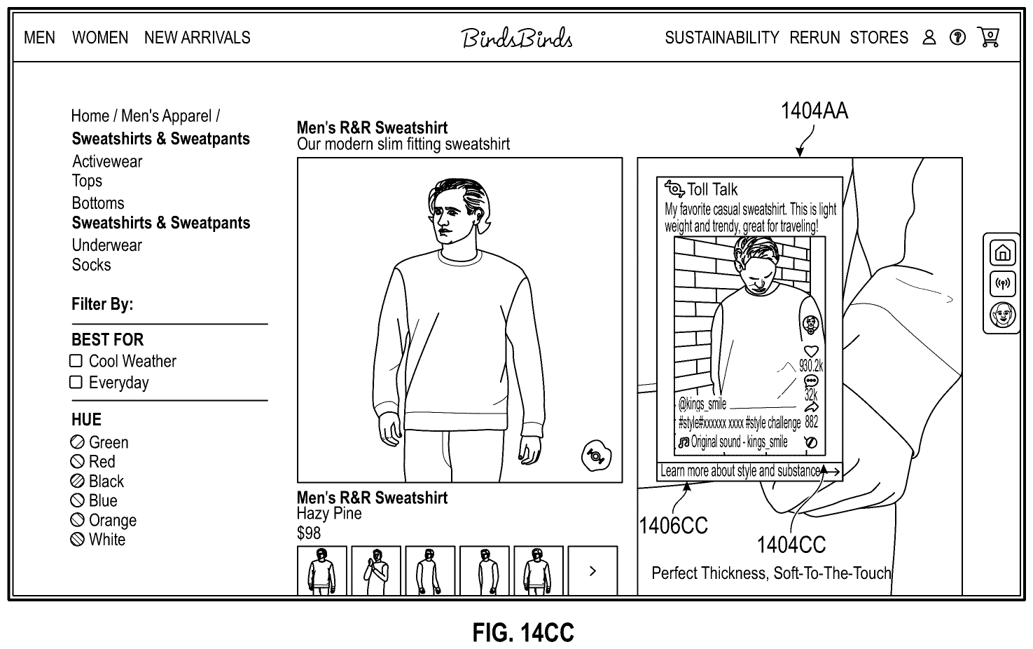

Certain example user interfaces will now be described with reference to FIGS. 14A-14CC. The user interfaces may be accessed from and/or populated by one or more of the systems and devices disclosed herein. One more of the disclosed systems and devices may execute instructions and configuration specified using the disclosed user interfaces or the like.

FIG. 14A illustrates an example administrative user interface configured to enable an administrator to control various features and content access, such as that of an activity feed. It is understood that while certain references may be made herein to an administrator or administrative user, optionally other authorized users may be enabled to perform the same functions. Optionally, the set of authorized users may include specifically specified users or may include all users.

The user interface illustrated in FIG. 14A displays the activity feed (sometimes referred to as a Hovr feed) that may include one or more tiles. The tiles may include, by way of example, news content, library content, advertisements, coupons, and/or other content as specified by an administrative user. One or more of the tiles may be customized by an administrative user (e.g., representing a brand) with respect to appearance and/or content.

Various controls may be provided which enables the administrative user to specify the appearance of the activity feed, the content included in the activity feed (e.g., publishing content, re-ordering content, unpublishing content and/or the like), and/or features provided via or in association with the activity feed. A given change made to the activity feed may optionally be reflected in the displayed activity feed in real time.

Optionally, the activity feed may be displayed in the context of the webpage with which it is associated (e.g., overlaying the webpage or in line with the webpage) to provide enhanced visualization of the end user experience. Such visualization may optionally be more “real” or authentic than a preview function, and may mirror what is actually on the webpage (what an end user would see live). However, optionally, changes to the activity feed will not be published for access by end users until the administrative user authorizes such access (e.g., by activating a publish control). Optionally, unpublished content may be deleted from the activity feed but may be maintained in a content storage system for later access/inclusion in an activity feed.

Controls are provided via which an authorized user can access a content management user interface, an upload content user interface, an update custom tiles user interface, or go live on an online presentation/conference.

Other controls enable the user to access user interfaces via which the user can specify and/or view settings for features, notifications, design, registered users, and/or “specify Hovr” settings. The features user interface may enable the user to select and/or create/upload icons, enable the user to specify direct messaging settings (e.g., enable/disable direct messaging for a given website or webpage), enable the user to specify connection settings (e.g., for users that are connected as described elsewhere herein), enable the user to specify which users can view who is online and/or accessing the website, and/or enable the user to select and/or upload content to be included in a content library to be accessible via a library interface display on a designated website webpage.

The notifications user interface enables the user to specify in-browser end user notifications correlated with particular actions. For example, if direct messaging is enabled, a notification regarding an incoming direct message may be provided to the end user. By way of further example, if “connections” are enabled, an end user may receive a notification of a content request from another, connected end user. By way of yet further example, a notification may be provided in connection with an anchor on the webpage. By way of illustration, if the user scrolls the webpage and reaches a certain anchor (or a certain threshold distance before or after an anchor), a specified notification may be provided to the user.

Optionally, content (e.g., text, graphic, video, and/or audio content) for a given specified notification may be specified for all end users, a specified subset of end users, or may be customized for an individual end user. For example, the disclosed system may determine which end users are currently accessing the webpage, historical user interactions (or lack of actions) with the webpage and/or website, user demographics, and use some or all of the foregoing information to select and/or generate a notification for the user.

The design user interface may enable, by way of example, the user to specify a navigation bar color, headers, typefaces, font sizes, font colors, line spacing, and/or the like.

The registered users interface enables the user to specify for registered users (e.g., end users that have provided their name or alias, email address, mobile phone address, user interest preferences, user content preferences, user brand preferences, and/or other user data) gated content and/or features (e.g., for a given item of content or page as a whole), wherein access to such gated content and/or features is restricted to registered users (where non-registered end users are inhibited from accessing such content and features). Optionally, the registered users interface lists some or all registered users, and the administrative user is enabled to delete users, transport user data, export user data to a customer relationship management system, and/or the like. The registered users interface optionally enables the administrative user to specify when access to such content and/or features or to be provided to a given end user (e.g., based on website or webpage access frequency, on the number of clicks on a given webpage or item of webpage content, and/or the like).

The Hovr settings user interface enables the user to specify where and/or how the activity feed window opens/renders (e.g., left, right, float, drawer, partial screen, expanded, minimized, and/or the like). Optionally, the Hovr settings user interface enables settings to be separately set by device/display type (e.g., mobile phone, tablet, laptop, desktop display, etc.) so that the activity feed user interface is optimized based on the display size or category.

A menu bar 1402A on the right side of the user interface provides additional controls. Such a menu bar may be displayed on various user interfaces discussed herein.

Activation of a home control in the menu bar 1402A causes the activity feed to be displayed. The user interface illustrated in FIG. 14A displays the activity feed in response to an activation of the home control.

Activation of an antenna control in the menu bar 1402A causes the content (e.g., video, audio, text, and/or graphic content) of the activity feed to be displayed.

Activation of a hashtag control in the menu bar 1402A causes a channels and content library user interface to be displayed via which the user may select channels and content to be displayed by a given activity feed tile.

A face user interface in the menu bar 1402A displays a face or avatar of the person currently logged-in to the administrative account. Optionally, the person is authenticated or not authenticated.

FIG. 14B illustrates an example user interface configured to enable a user to specify data and code for an activity feed. A basic information section includes a name field configured to receive a name for the activity feed. A URL field is configured to receive a URL where the activity feed is to appear/be rendered. A type field is configured to receive a type specification for the activity feed (e.g., billing plan, engagement (community+content), community (networking), content, and/or the like). The type may be selected from a menu generated or presented based on a user/subscription package selection. A brand color field is configured to enable the user to select a brand color to be used in conjunction with the activity feed user interface (e.g., sharing brand content). A code snippet field figure is configured to receive and/or display code text to be used to embed the activity feed at the corresponding URL. The code may include a script ID, an src (a URL for an external script file), and a data-id that specifies a unique id for an HTML element.

FIG. 14C illustrates an example features user interface via which an administrative user can edit, delete or add features and modify a content carousel. The user interface illustrates a library content interface 1402C displayed in response to the user activating the antenna control menu entry. The content library may be highlighted and related features are displayed if the user enters edit mode. The user interface enables the user to add or delete content from the displayed content carousel, to reorder the content displayed on the content carousel, to control the content carousel rotation rate, to specify how long in time a given item of carousel will be displayed, and/or the like. In addition, the user interface enables one or more navigation tabs to be added (e.g., corresponding to one or more content libraries added by the user, where the content and/or content libraries may be grouped as desired by the user).

FIG. 14D illustrates an example user interface via which an administrative user can specify where on the webpage the activity feed will load and the state the activity feed load in (e.g., render in a minimized state if the webpage is rendered by a mobile device with a relatively small display, render in a maximized state if webpage is rendered by a desktop or laptop display). An edit control is provided via which the user can edit what tiles are displayed and the tile content.

FIG. 14E illustrates an example user interface, which may be accessed in response to activation of the edit control illustrated in the user interface depicted in FIG. 14D. The user interface enables an administrative user to edit a tile, such as the title headline/header, a descriptive subtitle, an action (e.g., a URL via which tile content is to be accessed, tab), and a tile image. Controls are provided via which the user can replace the tile image or remove the tile image. Tiles that are not being edited may be blurred in the user interface so as to better emphasize the tile that is being edited. A save changes control may be provided which when activated causes the edits to be saved in memory. Optionally when published, the system may track, aggregate, and store the number of end user clicks, selections and previews of tiles, which may then be displayed in an analytics user interface, such as that illustrated in FIG. 14F.

FIG. 14F illustrates an example analytics user interface that provides, in textual and graphic form, various aspects of tracked, aggregated, and analyzed data generated and provided by the system. For example, the user interface may display the number of unique visitors, the number of new signups/user registrations, the number of returning visitors, the number of unauthenticated visitors, the average number items of content viewed, a percentage of changes in one or more of the displayed metrics from a prior period (e.g., the prior week, month, year), activity time on site (rendered via a graph over a period of calendar time), number of impressions, number of clicks, number of completions (e.g., conversions of website visitor to a customer or the achievement of other specified goal), average time on website, and/or the like.

FIG. 14G-1 illustrates an example user interface with a push notification in the form of a popup window 1402G1. The notification in this example, indicates how long until a live broadcast is to take place (optionally in the form of a continuously updated countdown timer), provides a title for the live broadcast, provides a brief description of the live broadcast, provides an image relevant to the live broadcast, and includes a control via which the end user can indicate that the user intends to view/participate in the live (optionally interactive) broadcast.

FIG. 14G-2 illustrates an example user interface 1402G2 prompting to the user to set up a live broadcast, and via which an administrative user can define a broadcast notification (such as the one illustrated in Figure G-2), upload content to a content library of an entity (e.g., a brand) or stream content (e.g., a live broadcast). For example, the user can add a title, description, and image to be displayed in a push notification regarding the broadcast and/or otherwise in association with the broadcast. A control is provided via which the administrative user can initiate the actual live broadcast.

FIG. 14H illustrates an example user interface 1402H of an actual live broadcast. The user interface displays a broadcast host name. A control is provided via which the existing host and/or other administrative user may add one or more co-hosts (where a host can control the microphone-who is speaking in the broadcast). A header may display an indication that the broadcast is live, and how long the broadcast has been live (via a count up timer). A panel may display the broadcast name, the broadcast description, and an identification of the hosting entity. A details control is provided which when activated will cause additional details regarding the broadcast to be presented. A listeners control is provided in association with an indication as to the number of people currently viewing the live broadcast. Activation of the listeners control may cause a list or gallery of some or all of the listeners to be presented. A chat control is provided via which a listener can initiate a chat with the host and/or one or more other listeners.

FIG. 14I illustrates an example user interface 1402I displayed in response to activation of the add host control discussed above with respect to the user interface depicted in FIG. 14H. The user interface lists listeners who may be added as a host. A search field is provided via which the host can search for a specific listener to add as a host. A search engine may receive the text entered into the search field and incrementally provide the corresponding search results (e.g., as each character is entered the search results are further filtered to display only those listener names that match the entered characters). The number of potential co-hosts selected may be displayed. A control may be provided via which the host can confirm that the selected potential co-hosts are to be added as co-hosts.

FIG. 14J illustrates an example user interface 1402J displayed in response to the user activating an upload content control. Controls are provided via which the user may upload a file (e.g., by dragging and dropping prerecorded content to a corresponding field or by navigating to and selecting the file). A control is provided via which the user can add a link to the content. Controls are provided via which the user can specify various social networking and content sharing sites via which the content is to be accessed.

FIG. 14K illustrates an example content library user interface 1402K via which an end user can discover content of interest. Optionally, a menu of content categories may be provided, wherein in response to a user selecting a category, corresponding content items are accessed from memory and displayed (e.g., if the content items comprise video content, a representative image or frame may be displayed). The user may select an item of content and if the content is playable (e.g., video or audio content) the content may be played back. Optionally, a search field may be provided via which the user may enter a textual search term, and a search engine will identify matching content (e.g., by comparing the search terms with tags associated with content items in the library), and display the matching content in ranked order (e.g., where the ranking is based on the closeness of the match, on the popularity of the items of content as measured by views or like indications, and/or other criteria).

FIG. 14L illustrates the example content library user interface with the category menu 1402L expanded. In this example, the category menu includes “Discover” (curated and trending content), “Watch” (clips, interviews, and tips), and “Listen” (podcasts and interviews).

FIG. 14M illustrates the example content library user interface 1402K with content items displayed. In this example, the content items are streaming from different sources (e.g., different content sharing websites) but are normalized so that they have the same appearance (e.g., are of the same size and/or have the same framing).

FIG. 14N illustrates the example content library user interface 1402K with a notification 1404N that a live streaming broadcast is going to take place, with a control via which the user can join (view and optionally participate via chat or as a co-host) the broadcast.

FIG. 14O illustrates the example content library user interface 1402K with a notification 1404O that a live streaming broadcast is taking place, optionally with an indication as to the broadcast length.

FIG. 14P illustrates a details user interface with a live streaming broadcast being presented. The title and description of the live broadcast are displayed. An image and name of the current host is displayed. If another host (a co-host) takes over the microphone/is speaking, the image and name will change to the new host. The user interface includes tabs for the details user interface, a listeners user interface, and a chat user interface.

FIG. 14Q illustrates an example listeners user interface 1402Q depicting images (e.g., photographs or avatars) and/or names of some or all listeners to the live broadcast. Optionally, the listener image or name is only displayed for registered users, while for non-registered users a randomized name and/or avatar may be displayed. In addition, an image and name of the current host is displayed.

FIG. 14R illustrates an example broadcast chat user interface 1402R. The name and/or image of a chat participant are displayed in association with the corresponding user's chat entry. Optionally, the time of the chat entry is displayed. A chat entry field is provided via which the user can enter text, emojis, audio content, and/or video content to be communicated with all or a subset of the broadcast listeners specified by the user. Optionally, a control is provided via which the user can leave the broadcast and the chat session. Optionally, the name and/or image of the host are displayed. Optionally, the chat session for the broadcast may be recorded for later access by authorized users or by any user depending on the access configuration setting.

FIG. 14S illustrates an example user interface including an anchor setting control 1402S (which enables an anchor to be added to a desired location on an anchor layer) and an example anchor 1404S.

FIG. 14T illustrates an example user interface including the anchor setting control in expanded form 1402T. A menu of available types of anchors/breadcrumbs are displayed. The menu entries may include sources for content to be associated with the anchor, such as social media sites, content sharing sites, content management systems, URLs (a URL menu entry via which the user can enter a URL where the content is located), uploaded media (where the user can embed a specific item of uploaded content by activating an embed control), text (where the user can enter text into a text field accessed by activating a text control), and/or other content source entries. For example, a given source may be a social media account/presence of a brand associated with the webpage.

Optionally, the content may be dynamically changed (e.g., to display the latest posting on the source site, such as on a brand social media account; to display a highest rated/most liked item of content from the source; to display the most viewed item of content from the source in a specified period of time, etc.). Optionally, the sources are ranked based on their frequency of use over a period of time (such as the past 24 hours, the past week, the past month, etc.). The user interface may enable the user to drag and drop an anchor to a desired location (e.g., on or offset from an HTML element). Optionally, a preview of the webpage is provided which will show the location of a dropped anchor 1404T.

Optionally, performance data associated with a given content source may be displayed (e.g., how many followers or links, how many likes, how many reshares, etc.). The user interface enables the user to view and approve the anchor and associated content prior to publishing the crumb to the actual webpage.

FIG. 14U illustrates the example user interface illustrated in FIG. 14T, with 1404T depicted in expanded form in the preview pane. The user interface indicates the source of the content as well as the content itself. Optionally, user interface controls 1404CC from the content source are provided as well (e.g., a following control (that enables the user to follow the creator of the content), a like control (that enables the user to indicate that they like the content), a commenting control (that enables the user to leave comments regarding the content), a sharing control (that lets the user forward a link to one or more destinations via email, text messages, or other messaging service), and a scroll to next post control). A call-to-action text 1406CC may be displayed, which when clicked on or otherwise selected causes the user browser to be navigated to another destination (e.g., another URL).

FIG. 14V illustrates the example user interface illustrated in FIG. 14U, with various anchor-related setting controls illustrated. For example, a call to action (CTA) URL field is depicted populated by the corresponding URL that links to another site or webpage. A button text field is configured to receive user-provided text to be displayed in association with the anchor (e.g., in response to a cursor being hovered over the anchor). An expiration control and field enable the user to specify an expiration time associated with the anchor, after which the anchor will no longer appear on the webpage. An interaction control enables the user to enable/specify user interactions. A comments control enables comments to be enabled or disabled. If comments are enabled, viewers may be permitted to leave comments with respect to content associated with the anchor. A publish control, when activated, causes the anchor to be published on the webpage so users accessing the webpage can view and interact with the anchor and anchor-related content.

FIG. 14W illustrates an example webpage with a published anchor 1402W and an activity feed menu 1404W (with a home button, an antenna control (that causes the activity feed and content to be displayed), and/or a hashtag control (that causes a channels and content library user interface to be displayed).

FIG. 14X illustrates the example webpage illustrated in FIG. 14W, wherein in response to a user focusing on the anchor (e.g., touching or hovering a cursor over the anchor or scrolling the webpage until the anchor is reached), the corresponding associated content 1402X is displayed, with the associated title and a play control overlaying the content.

FIG. 14Y illustrates the example webpage illustrated in FIG. 14X, wherein in response to a user activating the play control, the content (video content in this example) begins playing and associated controls (e.g., a like control, a chat control, a replay control, and/or a download control) are displayed.

FIG. 14Z illustrates the example webpage illustrated in FIG. 14Y, wherein in response to the user activating an exit control and/or in response to the video content completed playing, the anchor content may be minimized, and the anchor is displayed again.

FIG. 14AA illustrates the example webpage illustrated in FIG. 14S, with two anchors 1402AA, 1404AA at respective locations (e.g., overlaying two images of two different products).

FIG. 14BB illustrates the example webpage illustrated in FIG. 14AA with the anchor 1404AA expanded to show an image of the associated content (e.g., in response to the user hovering over or pointing at the anchor).

FIG. 14CC illustrates the example webpage illustrated in FIG. 14BB with anchor 1404AA still further expanded in response to the user clicking on or otherwise selecting the image illustrated in FIG. 14BB. The expanded display include a content description, an enlarged image, text and controls from the source (e.g., a following control (that enables the user to follow the creator of the content), a like control (that enables the user to indicate that they like the content), a commenting control (that enables the user to leave comments regarding the content), a sharing control (that lets the user forward a link to one or more destinations via email, text messages, or other messaging service), and a scroll to next post control). A call-to-action text may be displayed, which when clicked on or otherwise selected causes the user browser to be navigated to another destination (e.g., another URL).

As discussed above, various edit user interfaces and editing functions may be provided (e.g., for use by an administrative user to add a moment, such as a general-purpose anchor, underline anchor, product anchor, slide, and/or the like). The edits (e.g., the addition and positioning of moments and the association of content with moments) may be stored locally and/or on a remote server for later access and use. Optionally, some or all of the edit user interfaces and functions may be provided via code embedded in the webpage being edited, where the webpage may be accessed and presented via a browser. Thus, optionally, advantageously, the editing functions may be provided to a user without the user having to add a web browser extension and/or without having to download an editing application.

For example, the embedded code can be used in a webpage to enable editing by providing dynamic and interactive functionality. As similarly discussed elsewhere herein, optionally, this may be accomplished via a scripting language (e.g., JavaScript), which may be embedded within the webpage's HTML. For example, the code written using the scripting language may be stored in a separate file with the appropriate file extension (e.g., .js for JavaScript). A corresponding script tag (a script src specifying a URL for an external script file) may be added to the webpage HTML, and the source attribute may be specified that points to the file containing the embedded code. For example, the following example tag may be used:
<head>
   <script src=“path/the/editing/script.js”></script>
</head>

For example, where the code is written in JavaScript, a browser JavaScript engine that provides a JavaScript runtime environment may be utilized to execute the JavaScript to provide the described functionality. The browser's built-in interpreter searches for <script> tag or .js file linked with an HTML file while loading the web page, and then interpretation and execution of the code is performed.

Once the code is embedded into the webpage, it may be utilized to add interactive elements (e.g., moments, such as anchors) to the webpage and/or to format such elements. Optionally, the embedded code may be utilized to dynamically manipulate webpage content, such as by changing the text or images displayed based on user input. Optionally, the user may be enabled to drag (e.g., from an anchor menu or other tool interface) and drop a moment to a desired webpage location. Optionally, a user may be enabled to designate existing text in the webpage as an anchor (e.g., by underlining text, by highlighting text, by bolding text, by italicizing text, by changing the text font, and/or otherwise). Optionally, the text underlining, highlighting, bolding, italicizing, color change, and/or font change may be visible to an end user when rendered via an end user browser. Optionally, the moment is in the form of a hotspot is not visible on the webpage when rendered via an end user browser. Optionally, the editor may enable the user to specify that the anchor is not to be visible to an end user (e.g., where the anchor will act as a hotspot), and can specify the size (e.g., the dimensions, such as the length and/or height in pixels or units of measurement) of the anchor/hotspot.

Optionally, the editor may enable the user to specify what user action will cause content associated with the anchor/hotspot to be rendered. Example user actions that may trigger the rendering of anchor-associated content may include scrolling to or past an anchor, hovering a cursor over an anchor, clicking or tapping on an anchor, otherwise focusing on an anchor, and/or the like.

Optionally, the editor may enable the user to specify a location offset relative to a webpage element (e.g., webpage text, graphic, image, or video) at which an anchor/hotspot is to be placed. The offset may be specified in pixels or as a unit of measurement (e.g., inches, millimeters, centimeters, etc.). For example, the editor may enable the user to select a webpage element, and specify that an anchor is to be placed a specified number of millimeters or pixels above, below, to the left, or to the right of the selected webpage element. Optionally, a horizontal offset slider and/or vertical offset slider is provided which can be manipulated by a user to set a horizontal and/or vertical offset.

Optionally, the embedded code may be utilized to generate a form that enables users to enter new content or edit existing content. The form can then submit the data back to a server, which can process the data and update the webpage using or based on the processed data.

As discussed above, the editor can be configured to enable a user to selectively place anchors (e.g., general purpose anchors, underline anchors, product anchors, non-visible hotspots) and associated content (e.g., video content, audio content, slides, graphics, text, PDF documents, and/or other content, which may include a call to action, a link/URL, and/or the like) with a given anchor.

Optionally, the editor may enable to reformat a webpage, including anchors and associated content for different device types, screen sizes, and/or screen configurations, and have the reformatted webpage displayed as a preview of what an end user will view via a corresponding device type. For example, controls may be provided that enable a user to specify that the webpage is to be formatted for a mobile device (e.g., a smartphone), a laptop, or a desktop display, or displays of specified ratios (e.g., 4:3, 16:9).

A publish control may be provided that enables an edited webpage to be published and available to end users. Optionally, until the publish control is activated, the webpage will be stored and maintained as a draft webpage and will not be made available to end users.

Optionally, the content associated with or available to be associated with respective anchors may be displayed to one side of, or overlaying the webpage. Optionally, a user interface may be provided that enables a user to specify whether or not a given anchor and/or item of content (e.g., associated with a moment, such as an anchor or hotspot) is to be rendered or not on a given specified type of end user device (e.g., mobile device/smartphone, laptop, desktop, etc.). For example, the user interface may include a listing of device types (e.g., mobile device, desktop device, television, smart wearable), where the user can select for which device types a given anchor and/or associated content is to be provided via a webpage or disabled for a given webpage. Optionally, a plurality of content items (e.g., all of the content items) associated with respective anchors of a given webpage may be displayed in pane or other area of the user interface, and controls are provided via which the user can selectively or as a group enable or disable the display of the content items for a given device type.

Optionally, analytics may be displayed via a user interface in association with a given moment and/or webpage (e.g., where the webpage has previously been published with the given moment). The analytics may be rendered in textual and/or graphic form and may provide various aspects of tracked, aggregated, and analyzed data (e.g., generated and provided by the system). For example, a user interface displayed in association with a given item of content associated with an anchor may display the number of unique views of the content item, the number of returning viewers viewing the content item, a percentage of changes in one or more of the displayed metrics from a prior period (e.g., the prior week, month, year), activity time on the corresponding webpage and/or website (rendered via a graph over a period of calendar time), number of impressions, number of clicks, number and/or completions (e.g., conversions of website visitor to a customer or the achievement of other specified goal, such as responses to call to action), average time on website, and/or the like.

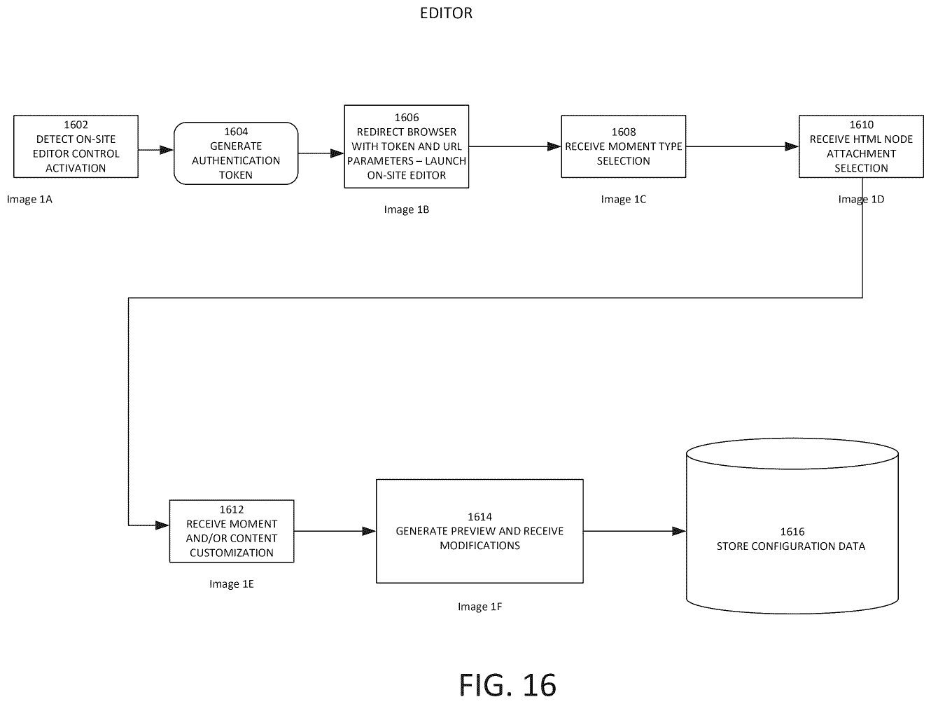

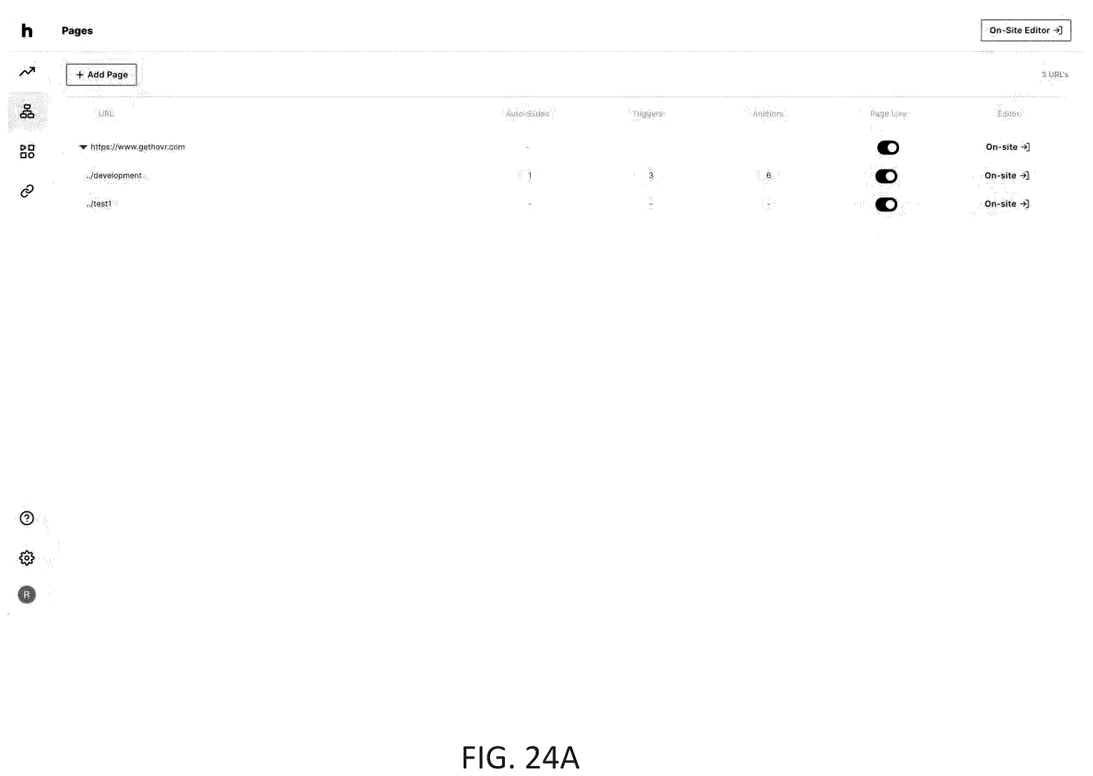

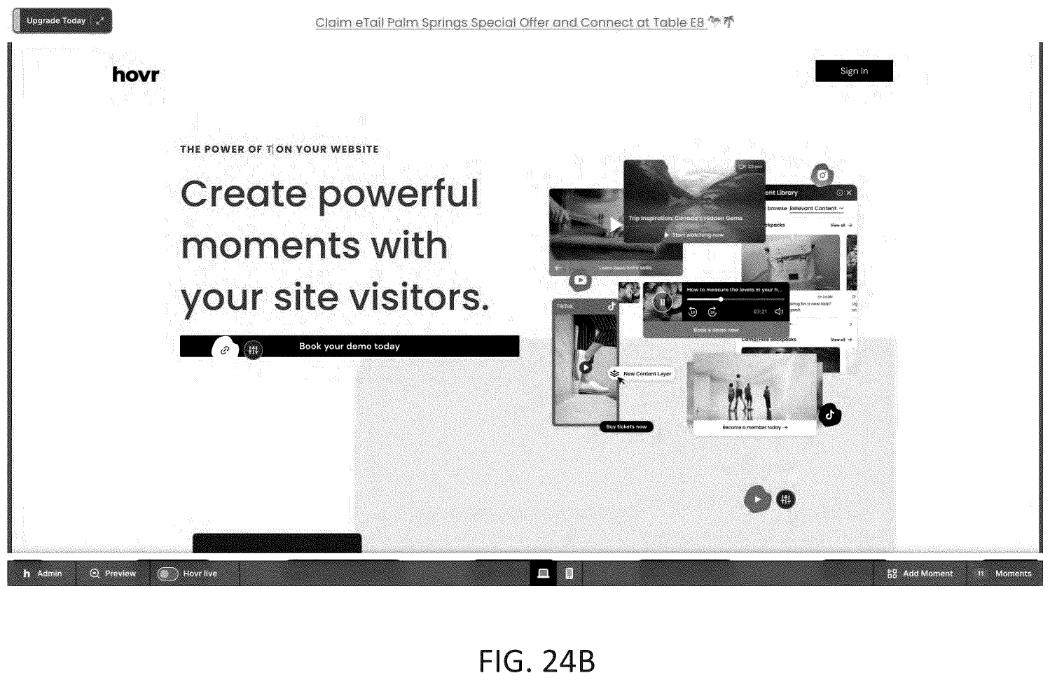

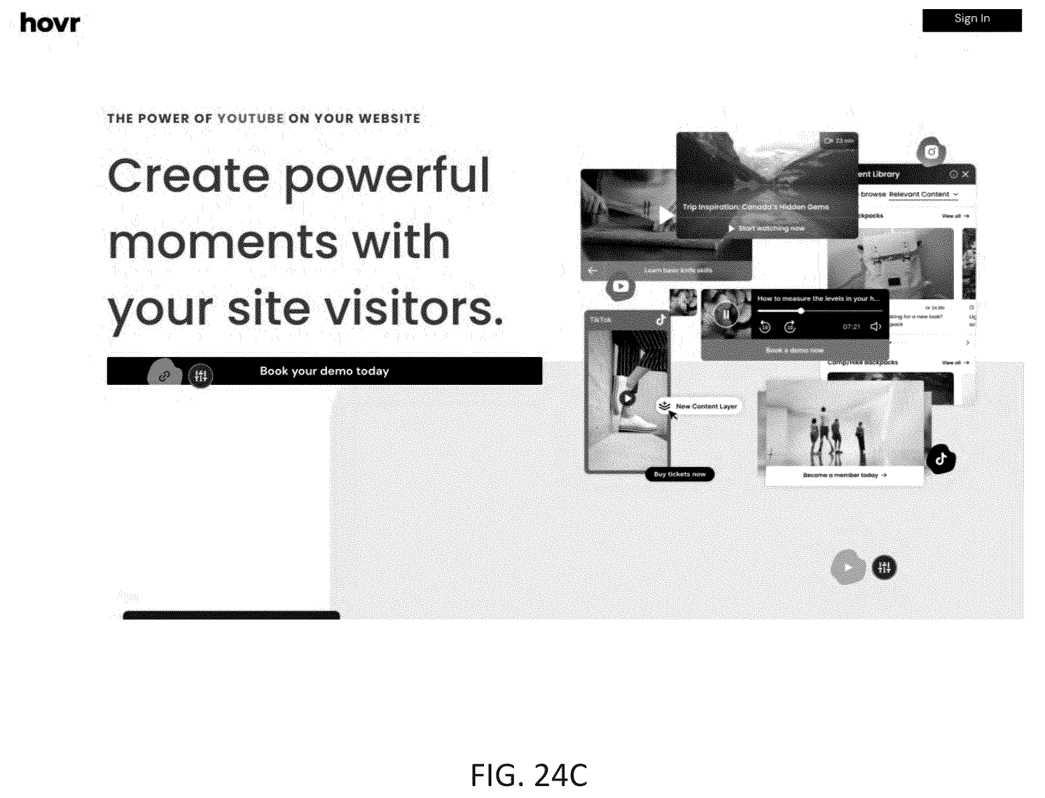

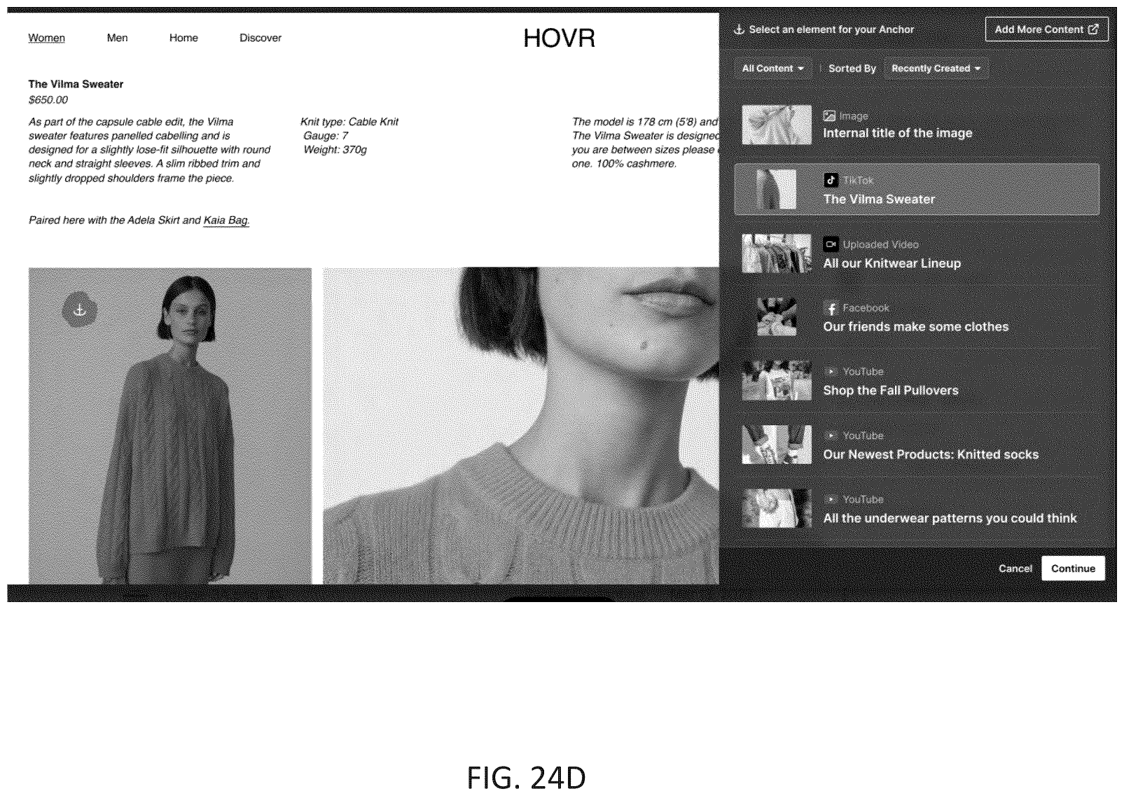

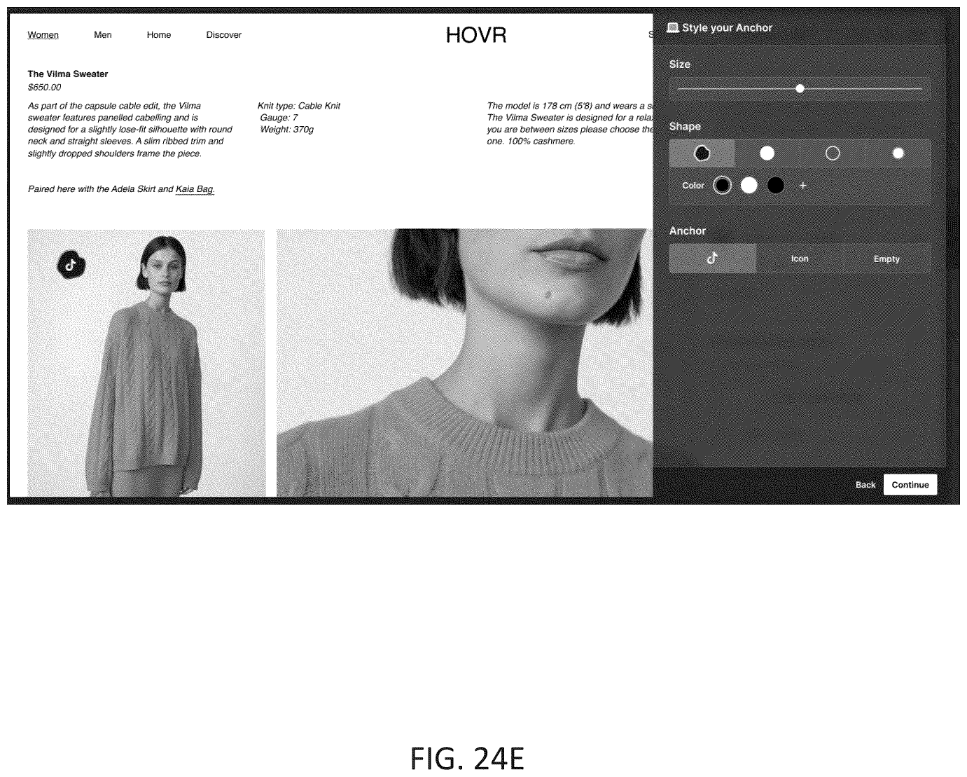

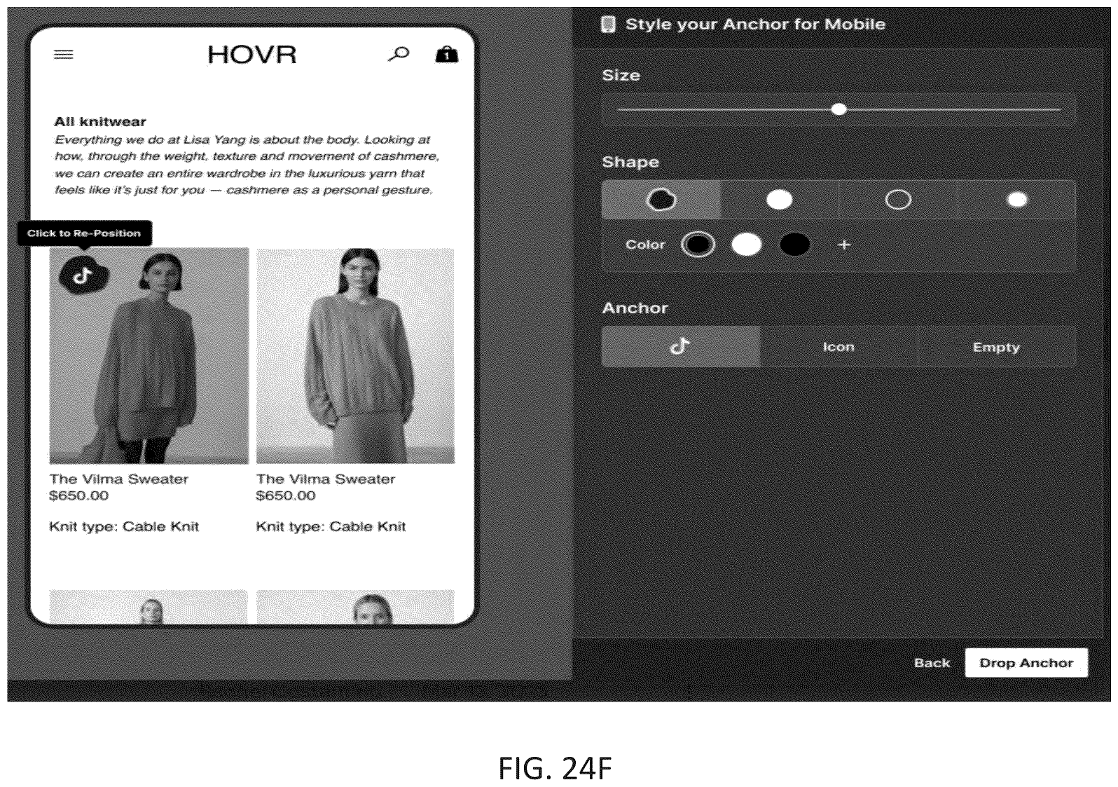

Certain example figures will now be discussed with respect to certain example processes and example user interfaces. Referring to FIG. 16, at block 1602, a user (e.g., an administrator) activates an on-site editor control. For example, with reference to FIG. 24A, a user may access a user interface that lists webpages available for editing and the associated URLs. The user interface may also access and display the number of auto-slide elements, triggers, and anchors currently associated with the webpage. A control may be provided in association with a given webpage that enables a user to set the webpage as live (available to end users) or unpublished (not available to end users). In addition, an on-site editor control is provided which when activated causes the corresponding user interface to be displayed in a web browser in edit mode.

At block 1604, an authentication token is generated. At block 1606, the user browser is redirected to a corresponding website with the authentication token and URL parameters to launch the on-site editor. The selected webpage is displayed in the browser (see, e.g., FIG. 24B). Previously added anchors may be rendered on the webpage. Controls may be provided that enable the webpage to be previewed, set to live or unpublished, or displayed in mobile format or desktop format. A moment (e.g., an anchor) may be added to the webpage (see, e.g., FIG. 24C).

At block 1608, the user may select a desired moment type. For example, with reference to FIG. 24D, a menu is presented of moment types, such as anchor, highlight, and slide. The user may select a desired moment type, and a set of available moments are displayed in a moments pane, and a user selection of a given content item is received by the editor. For example, a content item may include video content, audio content, slides, graphics, text, PDF documents, and/or other content, which may include a call to action (examples of which are discussed elsewhere herein), a link/URL, and/or the like.

At block 1610, a user selection of an HTML node (e.g., an HTML element, such as a text element, an image, or other element, which may be associated with a corresponding position in the webpage) is received with which the moment is to be attached.

At block 1612, customizations of the moment (e.g., anchor) are received. For example, the customization may involve setting the color, the color saturation, color hue, the color lightness, the size, the font of included text, animations (e.g., pulsing), shadowing, and/or other customizations. The editor may enable the user to offset the moment or anchor from a given HTML node. FIG. 24E illustrates an example anchor customization user interface configured for a desktop display via which the user can set the anchor size, shape, color, and icon user to represent the anchor. FIG. 24F illustrates an example anchor customization user interface configured to enable anchor to be customized mobile devices (e.g., mobile phone) via which the user may set the size, shape, and icon used to represent the anchor, and via which the user may drop and/or move the anchor. Thus, advantageously, a given anchor may be customized differently for different device types (e.g., mobile devices, desktop/laptop devices, networked televisions, etc.).

At block 1614, the user may select a target device type (e.g., a mobile device with a relatively small display, a desktop with a relatively large display, etc.), and the webpage may render a view formatted for the selected target device. The user may confirm the previous user edits or may modify the edits. The editor may optionally enable the user to make different edits for different specified target device types.

At block 1616, the user customizations (e.g., HTML node attributes, position, offsets, expressions, etc.) may be saved in a datastore for later access. Optionally, the datastore may comprise a NoSQL document database configured for automatic scaling and high performance. The database may enable data to be stored, synced, and queried for mobile and web applications.

For example, upon a future loading of the webpage, the correct element and anchor/moment positioning can be recalled and utilized to correspondingly position the moment/anchor.

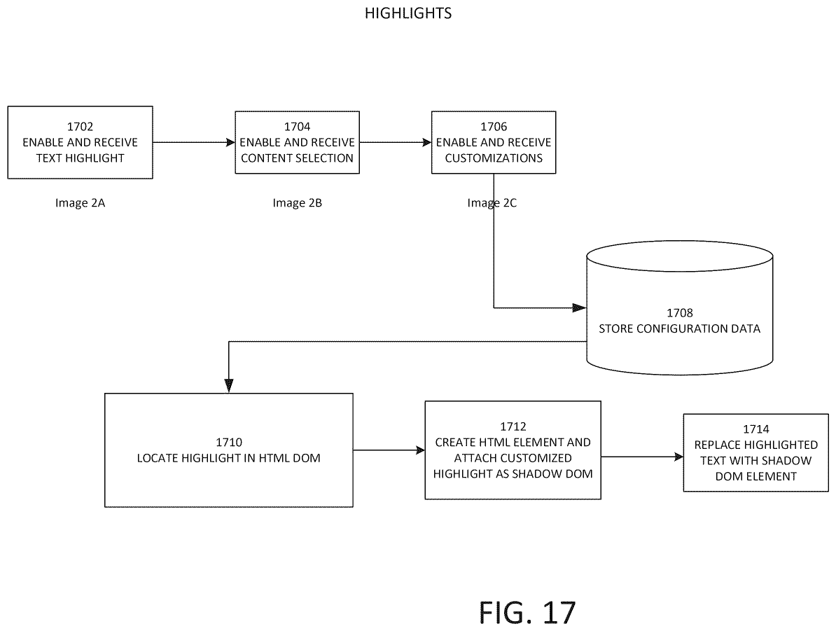

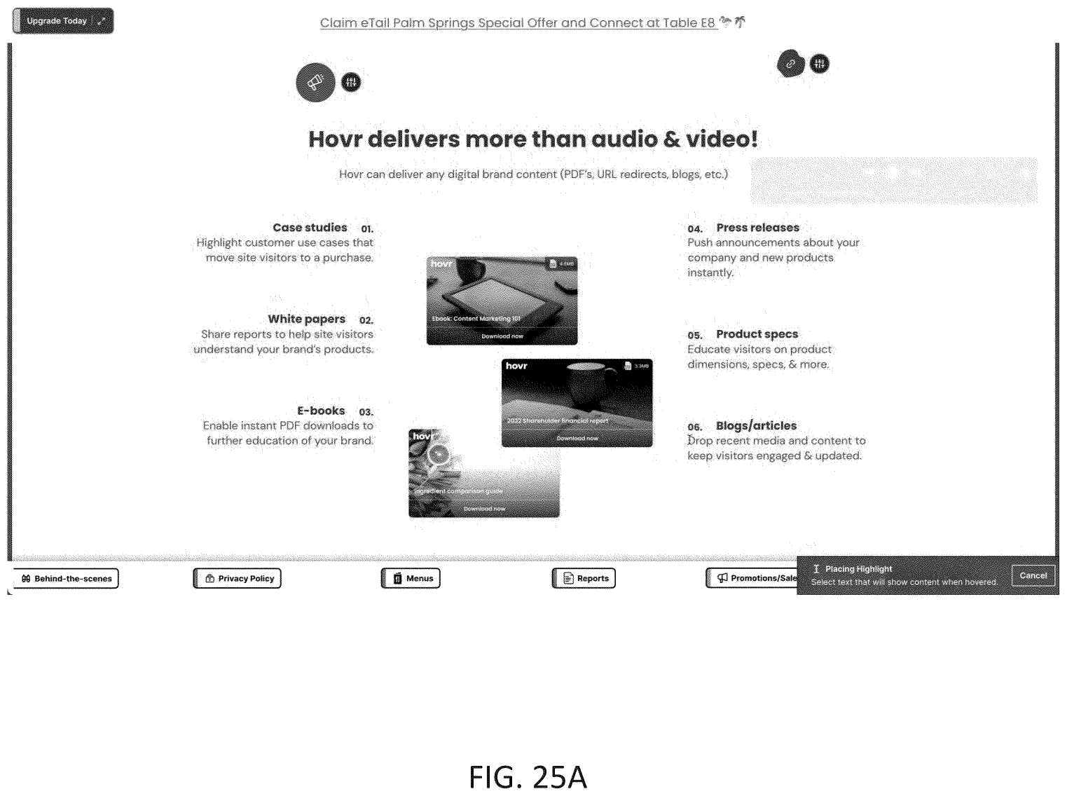

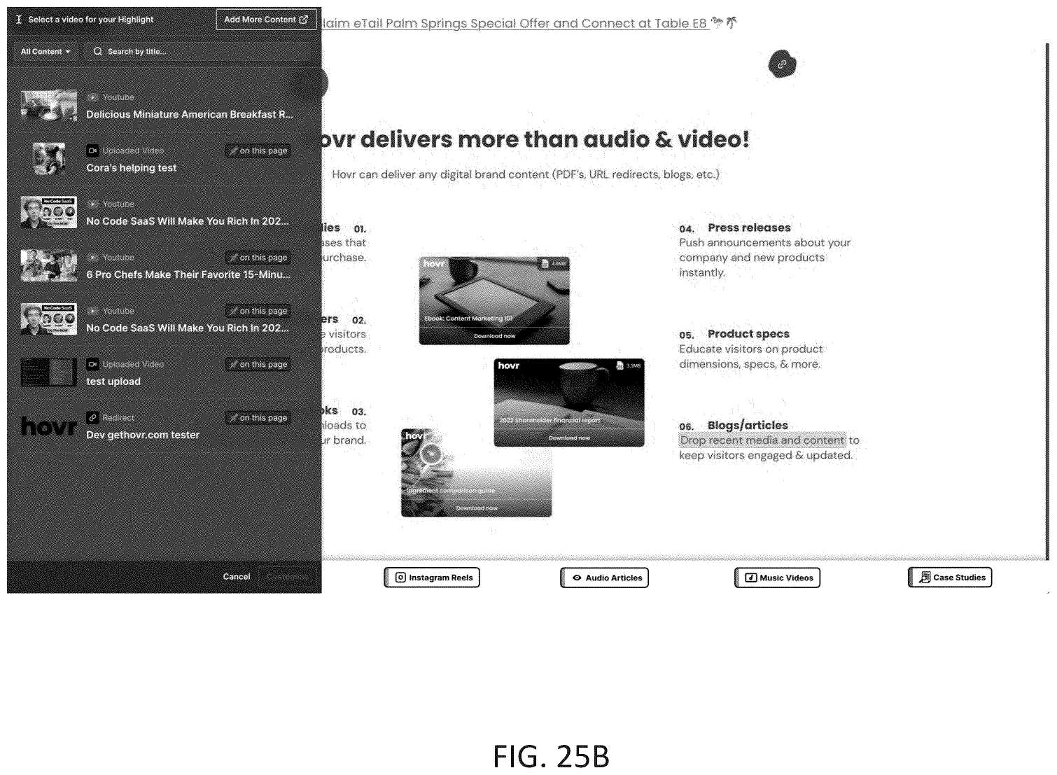

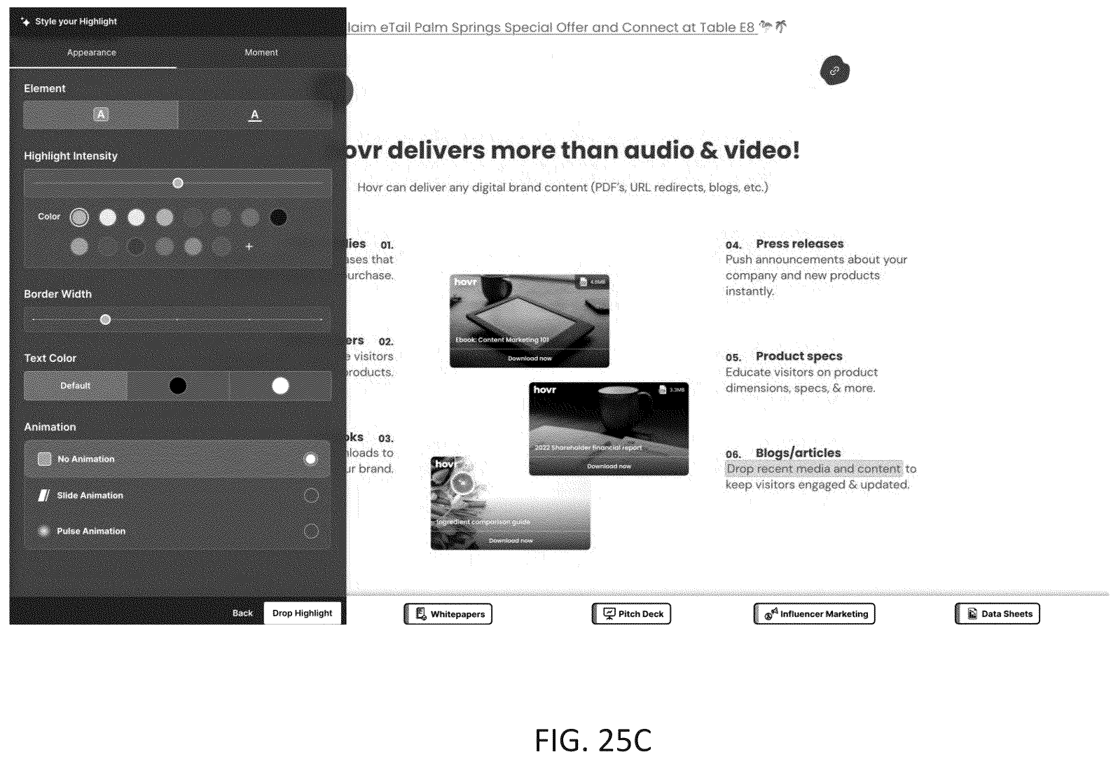

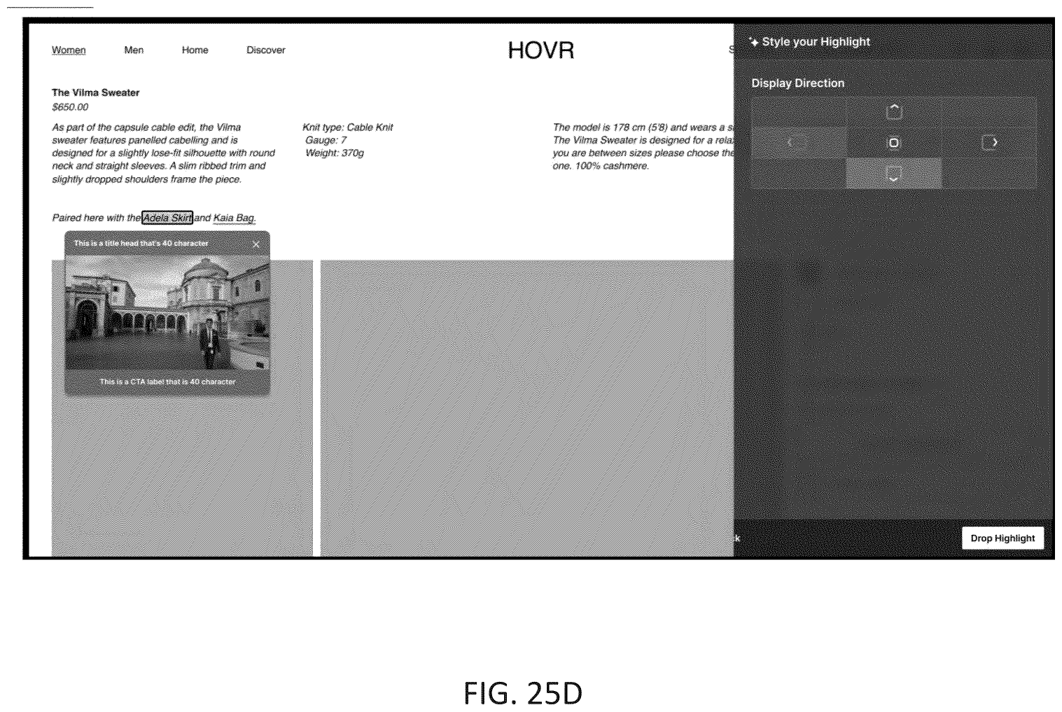

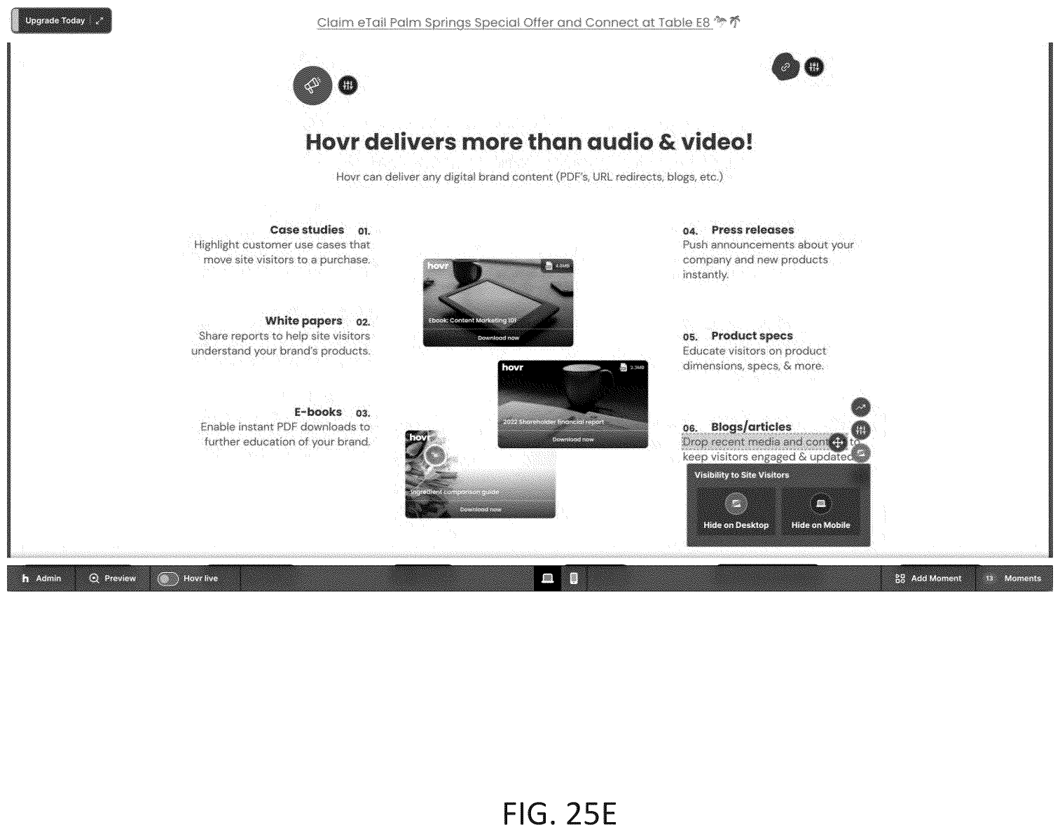

Referring now to FIG. 17, an example process for setting and configuring an anchor using highlighting is illustrated. At block 1702, a user (e.g., an administrator) selects and highlights webpage text to be converted to an anchor (e.g., wherein when an end user interacts with the anchor (highlighted text in this example), such as by hovering a cursor over the highlighted text or tapping on the highlighted text via a touch screen, associated content will be displayed). For example, as illustrated in FIG. 25A, a user may be prompted to place a highlight selecting corresponding text, which will be used as an anchor.

At block 1704, a user interface may be displayed on a pane or pop-up window that depicts content (e.g., video content, animations, graphics, audio, and/or other content, such as that described elsewhere herein) that may be selected and associated with the highlighted text/anchor. For example, FIG. 25B illustrates such a user interface. A search field may be provided via which the user may enter a content search query, which will be executed by a search engine which will return corresponding search results, optionally ranked in order of the closeness of the match of tags associated with the content with the search query.

At block 1706, a user interface may be presented via which the user can customize the highlight. For example, with reference to the example customization user interface illustrated in FIG. 25C, controls may be provided via which the user can specify a highlight intensity/translucence, a highlight color, a highlight border width, a color of the highlighted text, animation (e.g., no animation, slide animation, pulse animation, etc.), and/or other customizations. With reference to the example customization user interface illustrated in FIG. 25D, controls may be provided via which the user can specify a positioning of the content to be used when displayed in response to a user interaction with the highlighted text/anchor (e.g., display above, below, to the left, to the right or over the highlighted text). Referring to FIG. 25E, a user interface may be displayed that enables the user to suppress the display of the highlight and associated anchor functionality on a specified user device type (e.g., a mobile device, a desktop device, etc.).

At block 1708, the foregoing user-specified highlight configurations are stored in a datastore for later access and use. As similarly discussed above, the datastore may comprise a NoSQL document database configured for automatic scaling and high performance. The database may enable data to be stored, synced, and queried for mobile and web applications.

At block 1710, based on the user-specified highlight configuration, corresponding highlight code may be generated and inserted into the corresponding webpage DOM (Document Object Model that represents a document with a logical tree). At block 1712, a new HTML element is created, and the customized highlight is attached to the new element as a shadow DOM.

Disadvantageously, using a conventional DOM, when a new HTML id/class is used in a page, it may conflict with an existing name used by the page. Other complications may similarly result. Advantageously, the use of a shadow DOM may overcome such technical challenges by enabling compartmentalized DOM and CSS for web components to be created.

Thus, for example, self-contained components may be generated using JavaScript. Further, advantageously, CSS defined within the shadow DOM is limited to the shadow DOM, preventing style rules from leaking out and preventing page styles from bleeding in.

At block 1714, the original highlighted text is replaced in the HTML with the new shadow DOM element.

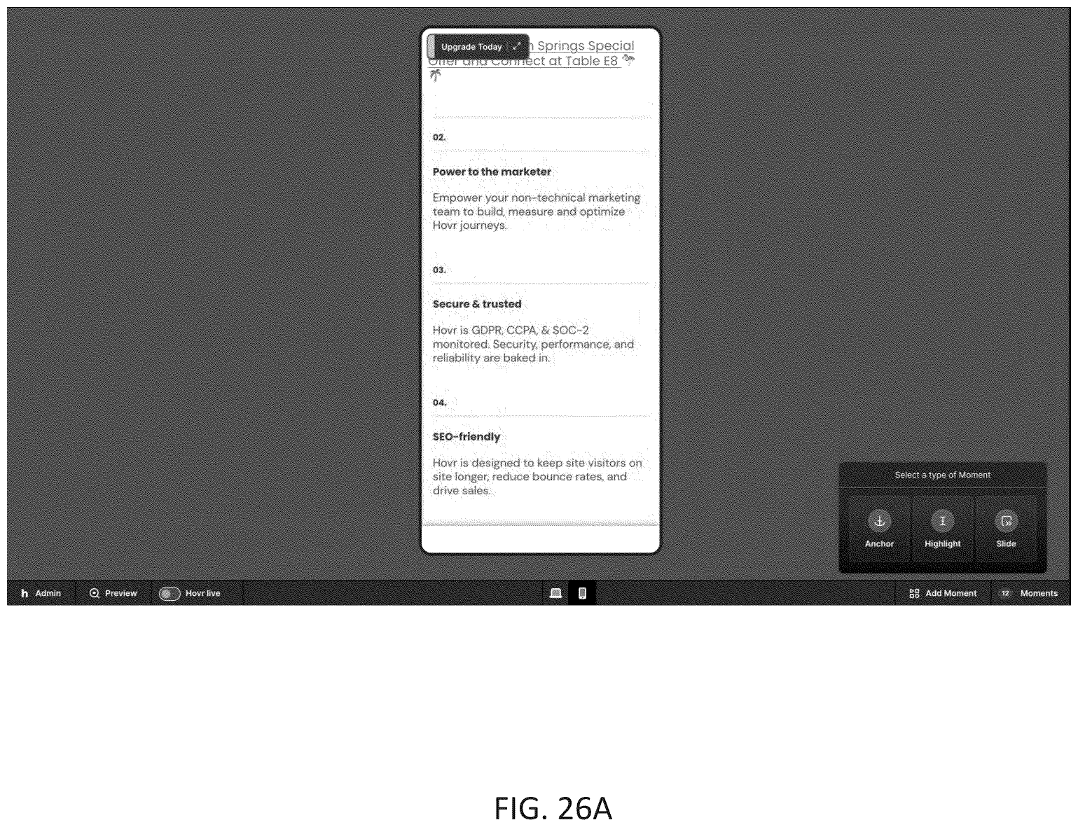

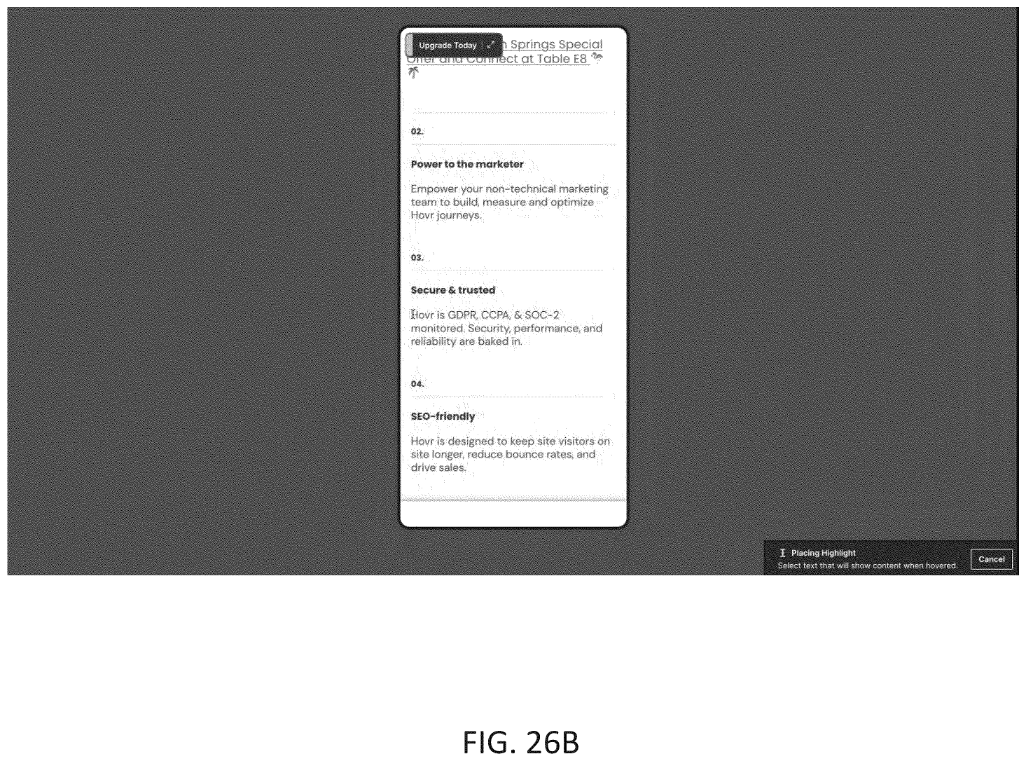

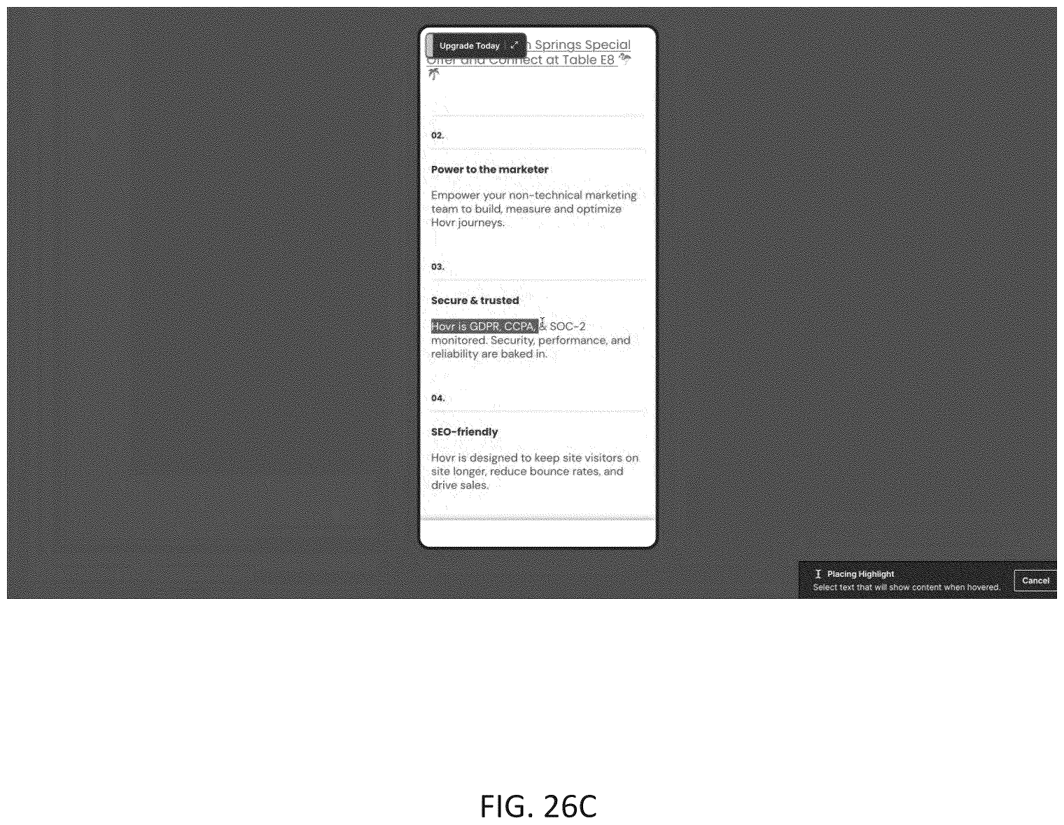

FIG. 26A illustrates an example user interface configured for a mobile device that enables a user to select a moment type (e.g., an anchor, highlight, slide). FIG. 26B illustrates an example user interface configured for a mobile device that enables a user to place a highlight by selecting text. FIG. 26C illustrates the example user interface of FIG. 26B with selected text highlighted in response to a user selection. FIG. 26D illustrates an example user interface that presents content that the user can select to associate with the highlighted text.

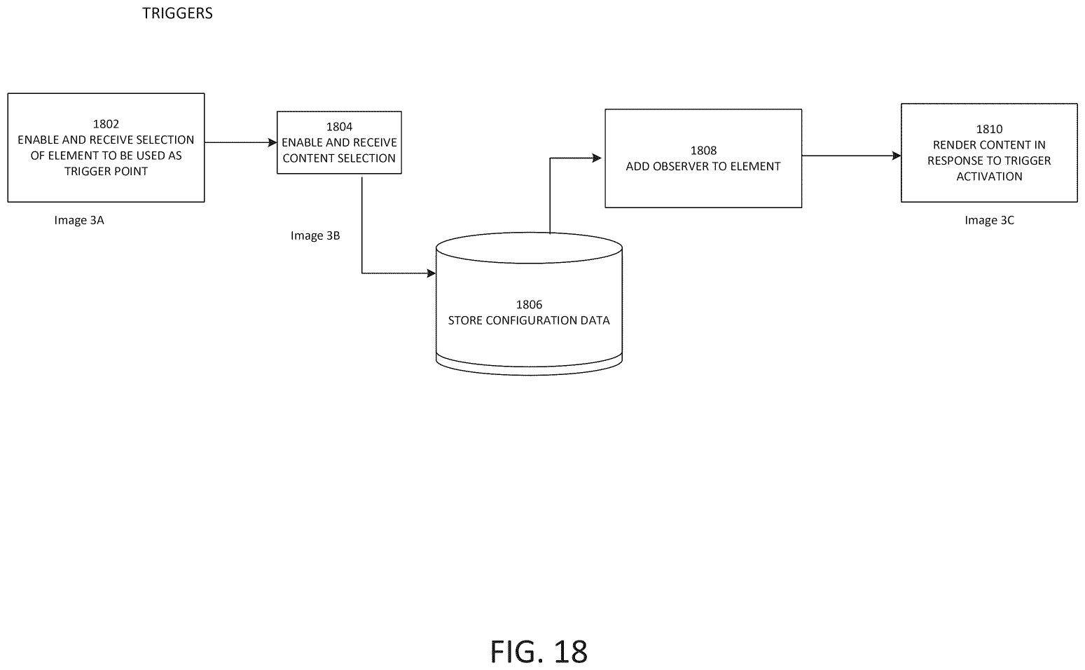

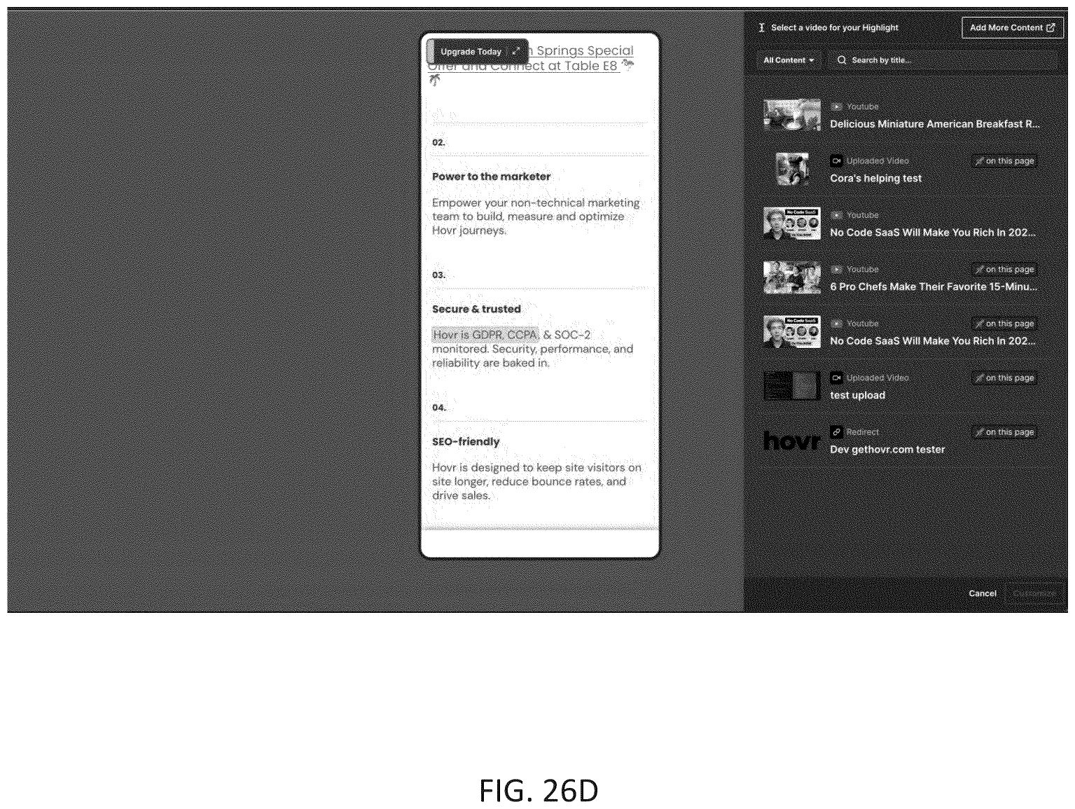

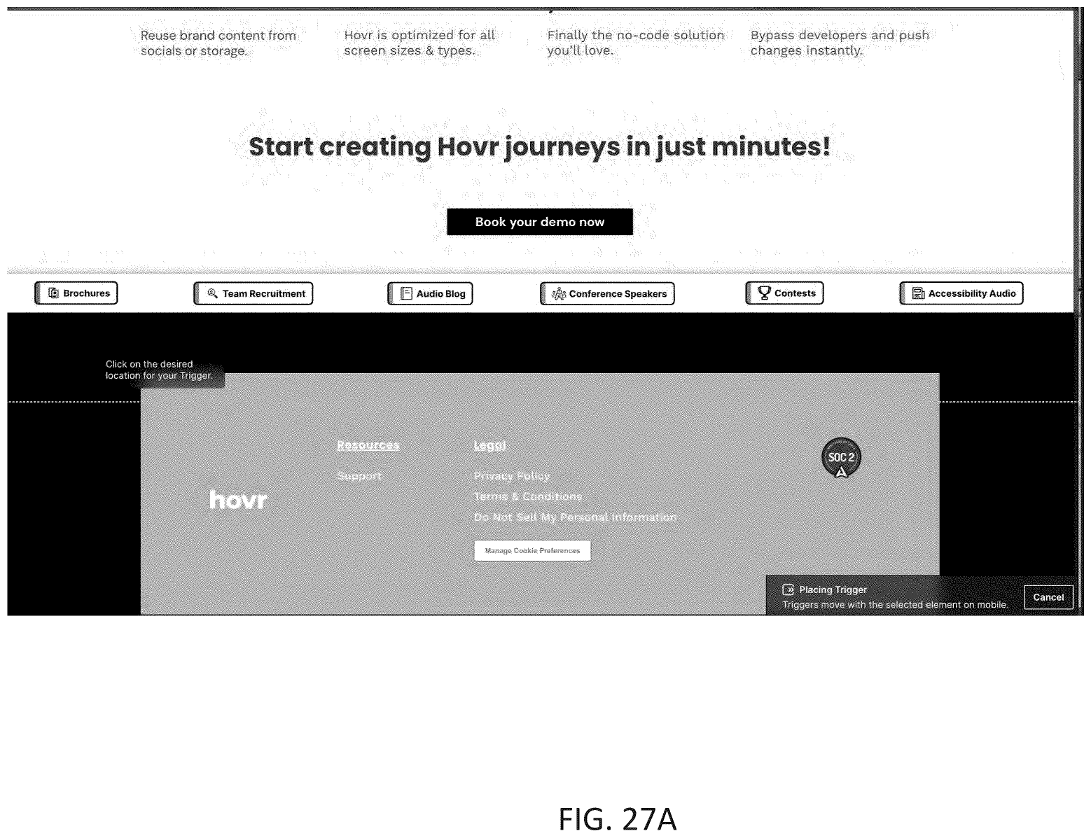

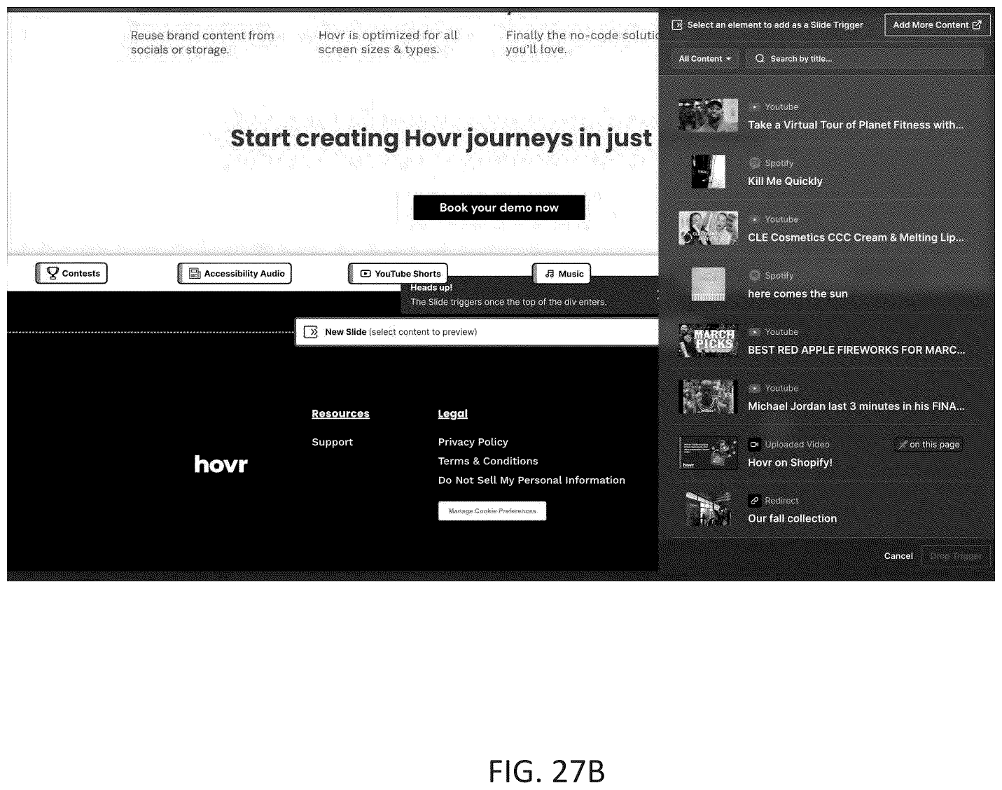

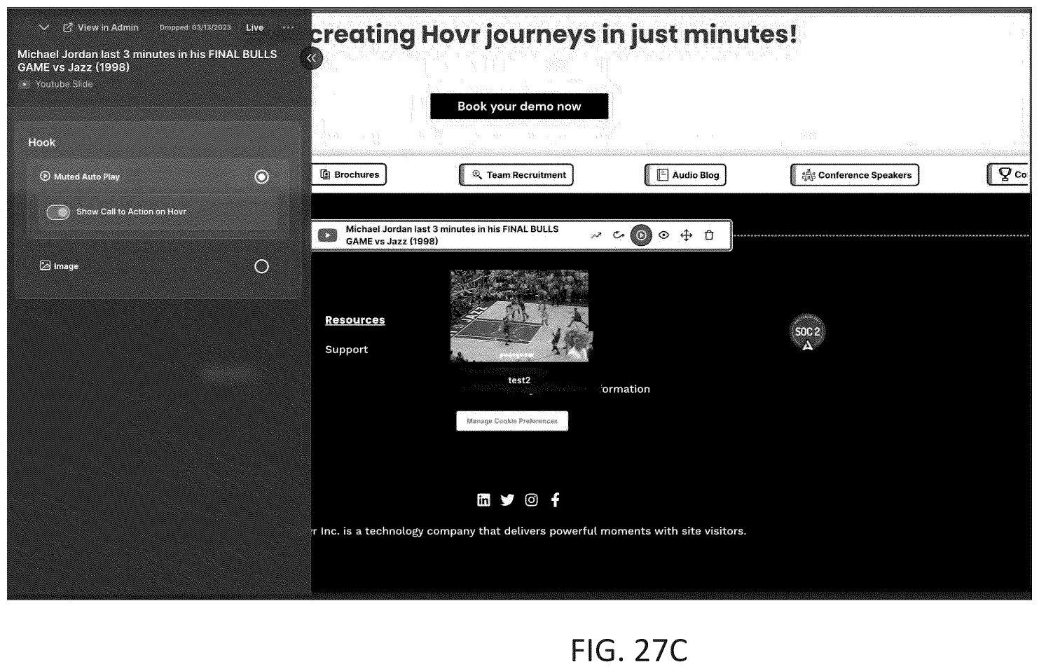

FIG. 18 illustrates an example process of setting and configuring triggers in a webpage. For example, when a webpage is scrolled to a trigger point, associated content may be automatically accessed and displayed. At block 1802, a user selects a HTML node (e.g., an HTML element) of a webpage that is to be used as a trigger point. In response to the element selection, when an end user accessed the webpage and when the selected element is rendered, a corresponding associated notification comprising content will be rendered (e.g., to one side of the element or the webpage). For example, with reference to FIG. 27A, an element may be selected.

At block 1804, a user interface is presented displaying a set of content. The user may select an item of content (e.g., a slide) via the user interface to be associated with the trigger. For example, FIG. 27B illustrates such a user interface. A search field may be provided via which the user may enter a content search query, which will be executed by a search engine which will return corresponding search results, optionally ranked in order of the closeness of the match of tags, associated with the content, with the search query.

At block 1806, the trigger configuration is stored in a datastore. For example, as similarly described elsewhere herein, optionally, the datastore may comprise a NoSQL document database configured for automatic scaling and high performance. The database may enable data to be stored, synced, and queried for mobile and web applications.

At block 1808, based on the selected node, a mutation observer is added to the desired element to monitor and detect when that node (e.g., element) is being displayed on the user's device display. For example, the mutation observer object observes a DOM element and fires a callback when it detects a change. At block 1810, the notification comprising the selected content may be displayed via the user browser when the trigger is activated. For example, the slide notification may comprise video content that is automatically played in response to the selected element being on-screen or may comprise a static image ‘(which may be a frame of video content, where the video content is played in response to the user activating a play control). FIG. 27C illustrates an example webpage with a slide notification rendered. A control is provided via which the user can specify that autoplay of the content is to be inhibited or enabled. A control is provided via which the user can specify whether a call to action is to be presented in response to an end user interaction (e.g., hovering a cursor over the content or clicking on a play button).

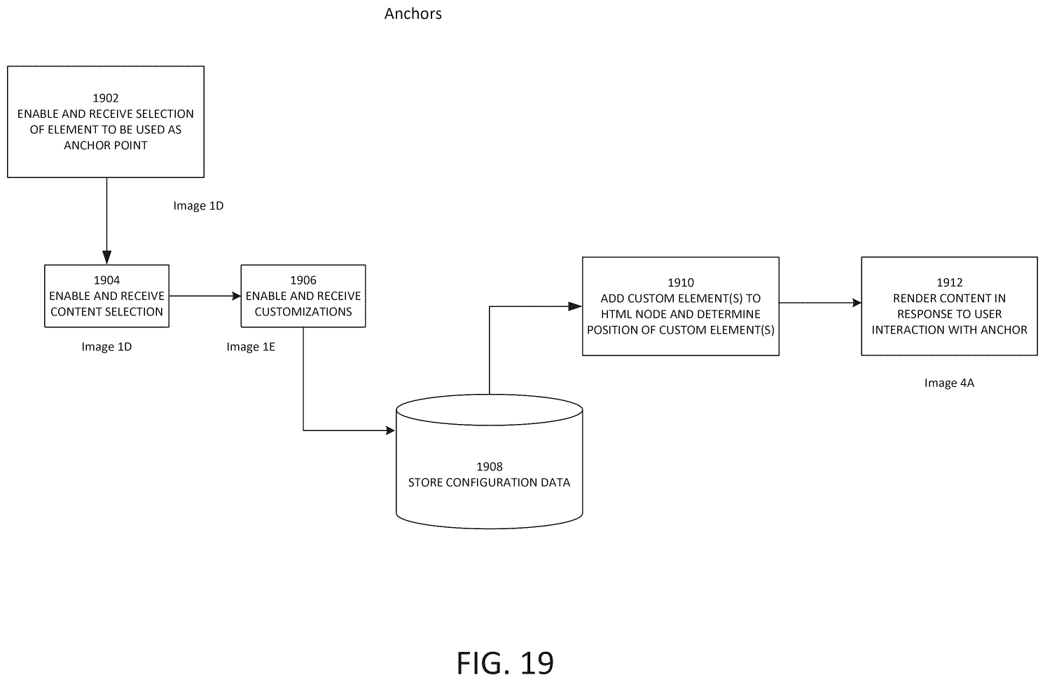

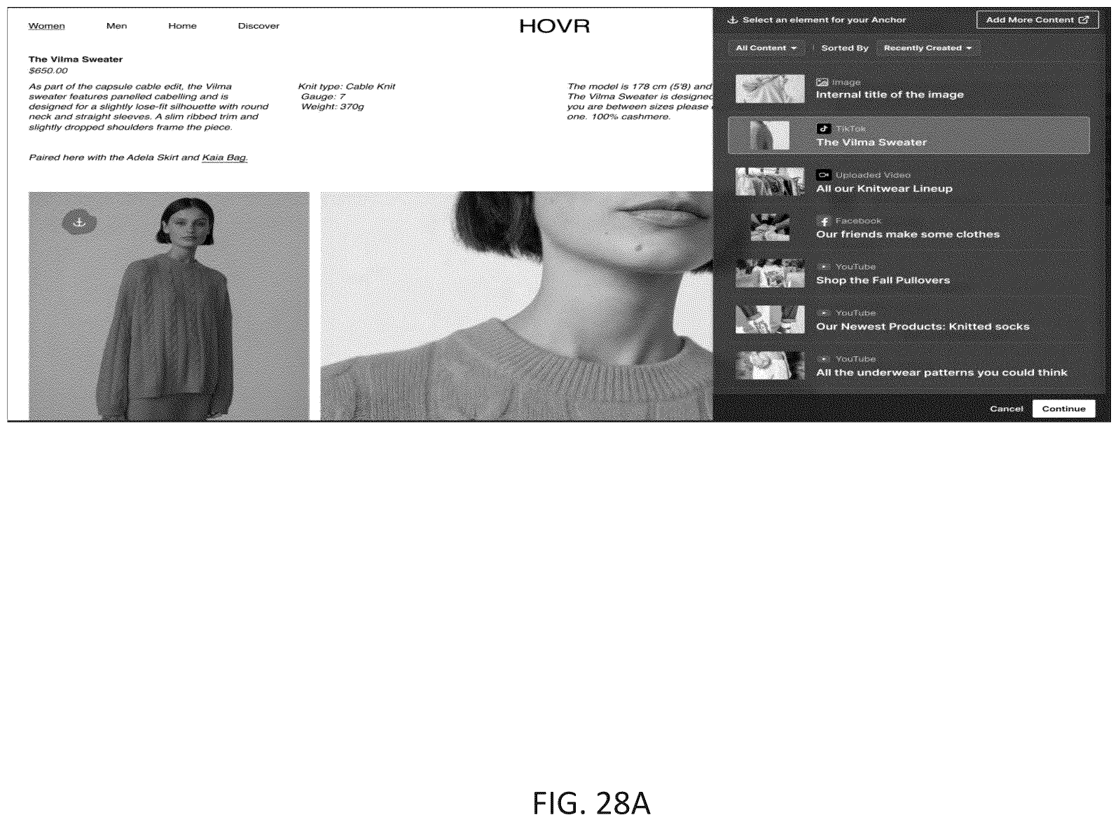

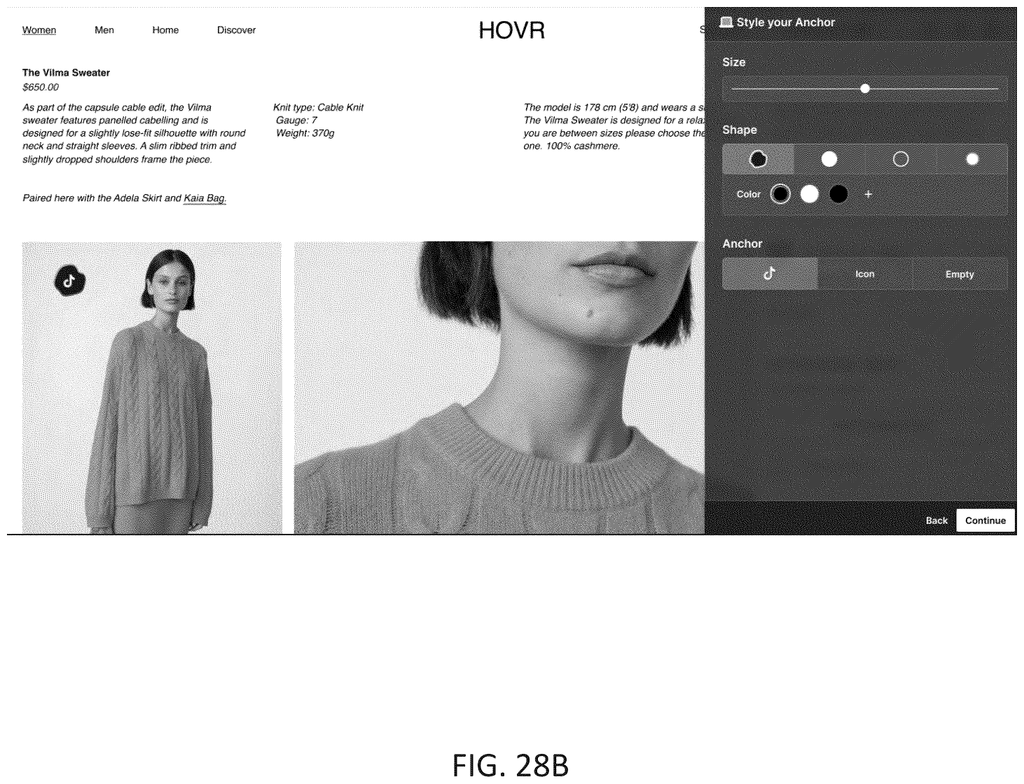

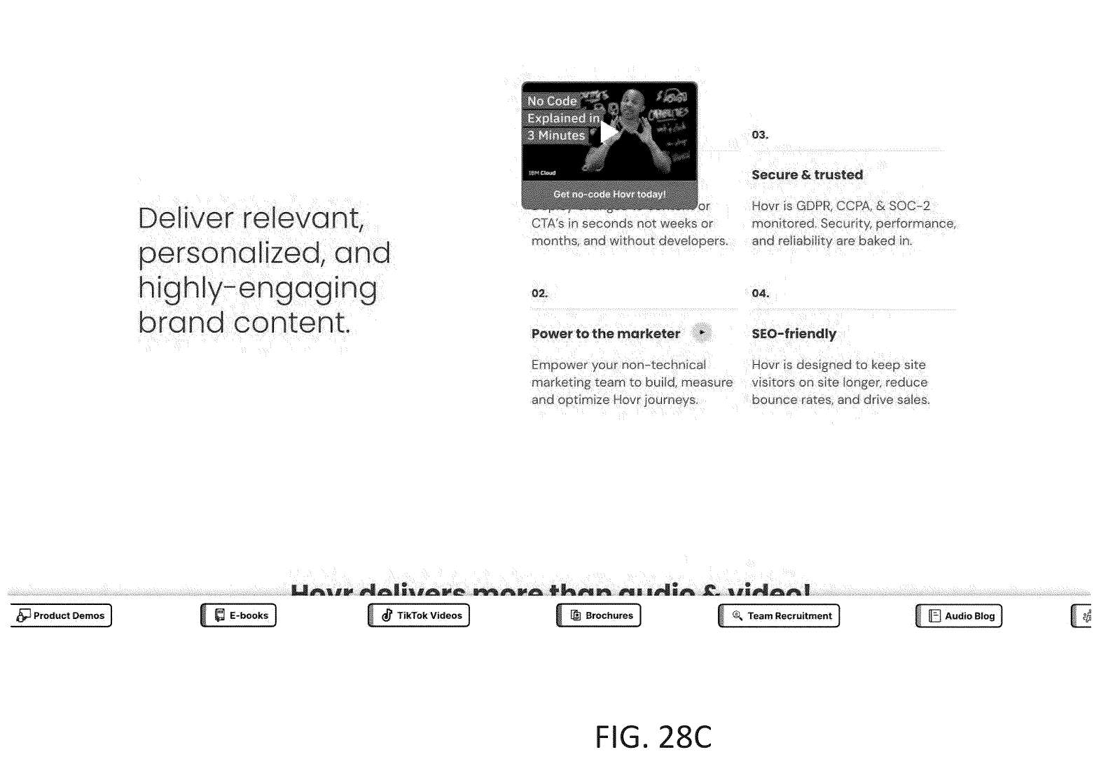

FIG. 19 illustrates an example process of setting and configuring anchors, such as a general purpose anchor. At block 1902, a webpage is presented (e.g., via a browser with the editor instantiated, which may be referred to as an in-site editor). The editor enables the user to select an element to be used as an anchor point for an anchor. Referring to FIG. 28A, an example webpage and user interface are illustrated that enables a user (e.g., an administrator) to select an element to be associated with an anchor. At block 1904, a user interface is presented displaying a set of content. The user may select an item of content via the user interface to be associated with the anchor. For example, FIG. 28A illustrates such a user interface. A search field may be provided via which the user may enter a content search query, which will be executed by a search engine which will return corresponding search results, optionally ranked in order of the closeness of the match of tags associated with the content with the search query.

At block 1906, a user interface may be presented via which the user can customize the anchor. For example, with reference to the example customization user interface illustrated in FIG. 28B, controls may be provided via which the user can specify an anchor size, shape, color, and anchor representation (e.g., an icon). Optionally, controls may be provided via which the user can specify a positioning of the content to be used when displayed in response to a user interaction with the/anchor (e.g., display above, below, to the left, to the right or over the anchor). A user interface may be displayed that enables the user to suppress the display of the anchor and associated anchor functionality on a specified user device type (e.g., a mobile device, a desktop device, etc.).

At block 1908, the anchor configuration is stored in a datastore. For example, as similarly described elsewhere herein, optionally, the datastore may comprise a NoSQL document database configured for automatic scaling and high performance. The database may enable data to be stored, synced, and queried for mobile and web applications.

At block 1910, based on the selected node, the custom element/anchor is added to the corresponding HTML node (e.g. using a positioning engine). The positioning engine is utilized to calculate one or more offsets used to precisely position the new element (corresponding to the anchor) relative to the element selected at block 1902.

At block 1912, when a user browser (e.g., an end user browser) accesses the webpage and interacts with the custom element (e.g., the anchor), the user may optionally be presented the opportunity to interact with the associated content (e.g., play the content, click on the content and have the user's browser navigated to another website via a URL associated with the content). By way of example, the user may interact with the anchor by hovering a cursor over the anchor or clicking on the anchor. FIG. 28C illustrates an example of video content being displayed in response to a user hovering a cursor over an anchor.

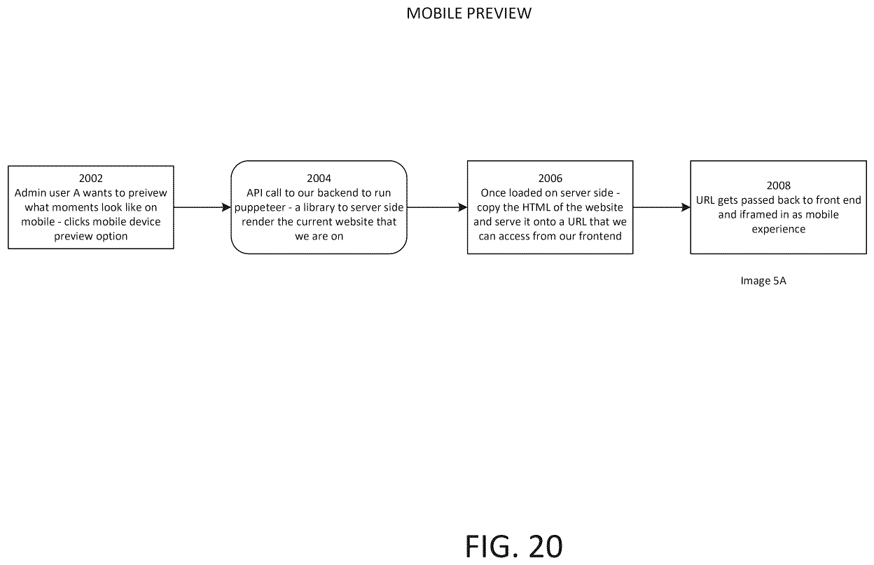

FIG. 20 illustrates an example process of viewing a webpage modified using one or more of the techniques described herein (e.g., via an addition of one or more anchors, highlight anchors, triggers, hotspots, and/or the like) at it would appear on a mobile device (e.g., a device with a relatively small display, such as less than 10 inches in diagonal, or having certain types of screen ratios (e.g., 9:16, 4:5, 2:3)), such as a mobile device of an end user.

At block 2002, a user (e.g., an administrator) activates a mobile device preview control. At block 2004, an API call is made to a server backend to execute a puppeteer (e.g., a library) to server-side render a webpage being accessed by a user device browser. For example, the puppeteer may utilize a headless Chrome (a Chrome web browser without a graphical user interface, which can be controlled via a command-line interface or with an automated script.), as a companion, executing on a web server. The puppeteer can be configured to emulate a mobile device by specifying a user agent and a viewport size.

At block 2006, the mobile device HTML code for the webpage generated by the puppeteer may be copied and served to a URL that is accessible by the frontend user device browser.

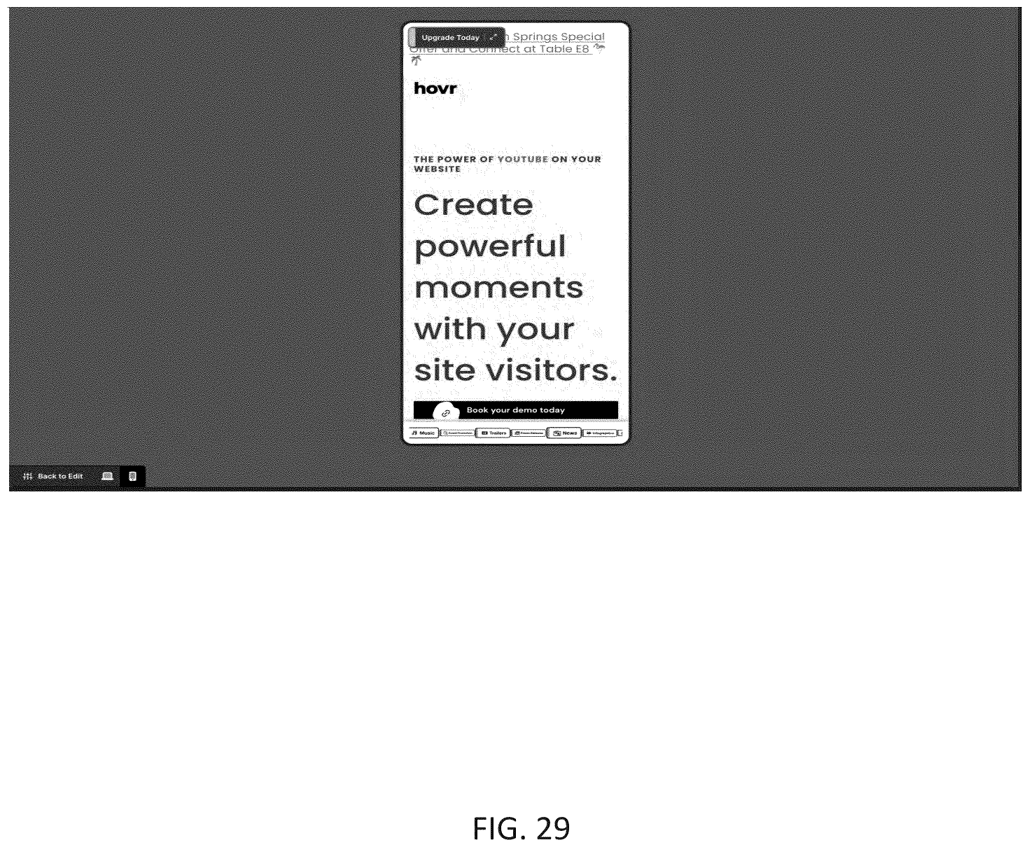

At block 2008, the URL is passed to the frontend browser executing on the user (e.g., administrator) device. The frontend browser accesses the HTML code at the URL for the mobile device. The frontend browser may then render the webpage formatted for a mobile device via an iFrame whose source is set to the URL, as illustrated in FIG. 29. The foregoing process enables user agents to emulate the display of certain device types and provides a workaround with respect to websites that prevent iFrames.

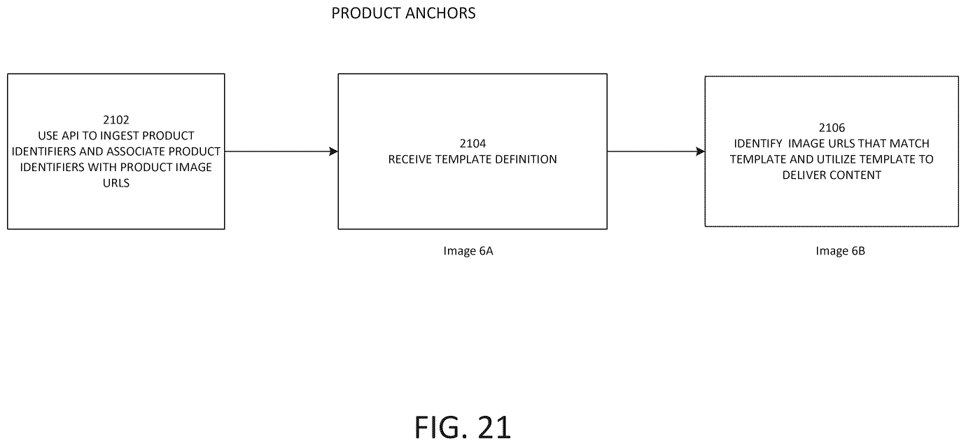

An example process of setting and configuring product anchors will now be described with reference to FIG. 21. A product anchor is a special type of anchor that is associated with a product identifier, such as a SKU (shop keeping unit) or Product ID, and that enables the anchor to follow a corresponding HTML element (e.g., an image of a product) even when the HTML element is moved to a different location on the webpage, overcoming the technical challenges presented by dynamically changing webpages. For example, a webpage of an online store may be updated daily to position an image and link of the bestselling product for the previous 24 hours at the top of the page, which may thereby change the position of one or more other product images (which may be associated with respective anchors) in the webpage. By way of further example, a given product entry (e.g., a product image) may appear on multiple locations on the website, where each entry is to be associated with the same anchor and anchor content.

At block 2102, product identifiers, such as SKUs or Product IDs specified by manufacturers or retailers are accessed from one or more databases. In addition, other data associated with the product identifiers may be accessed as well (e.g., the src/URLs of images associated with the products and product identifiers, metadata describing aspects of the product, and/or other data).

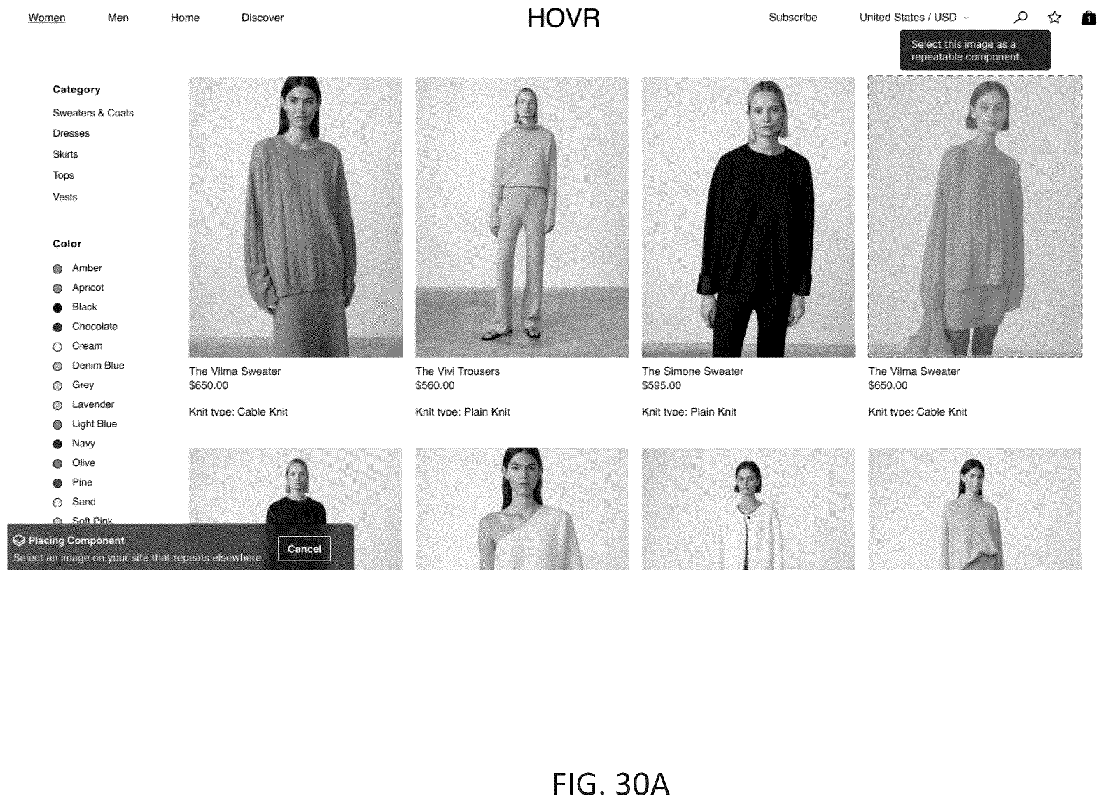

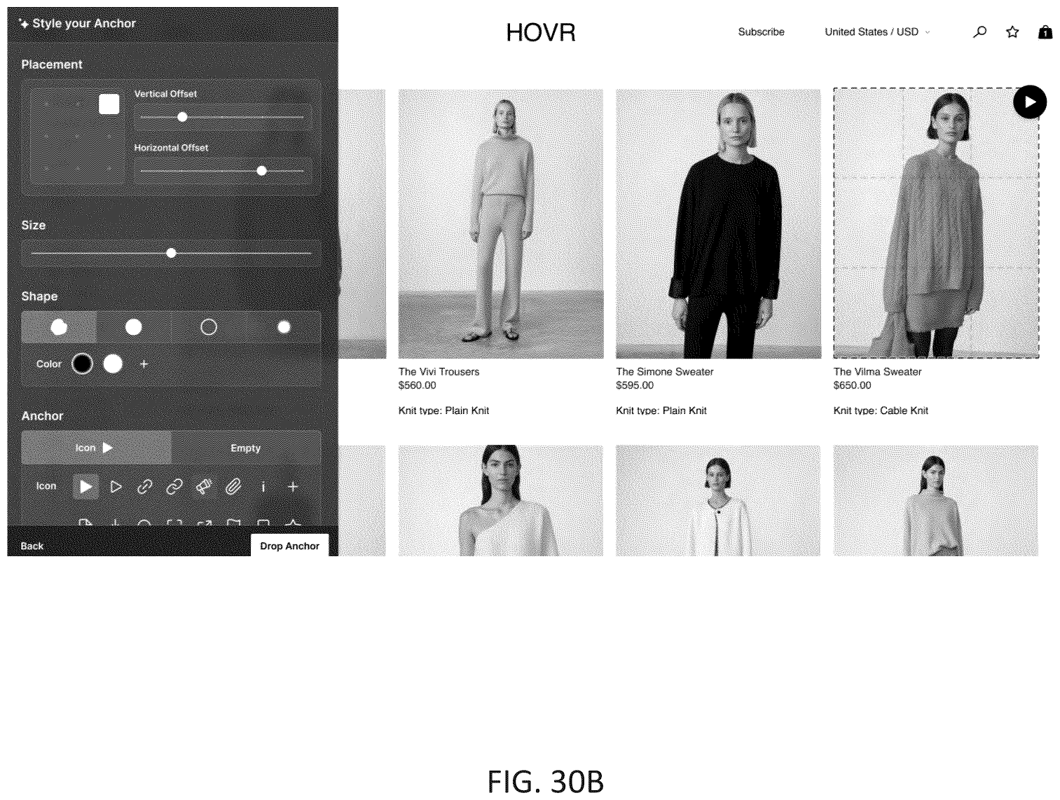

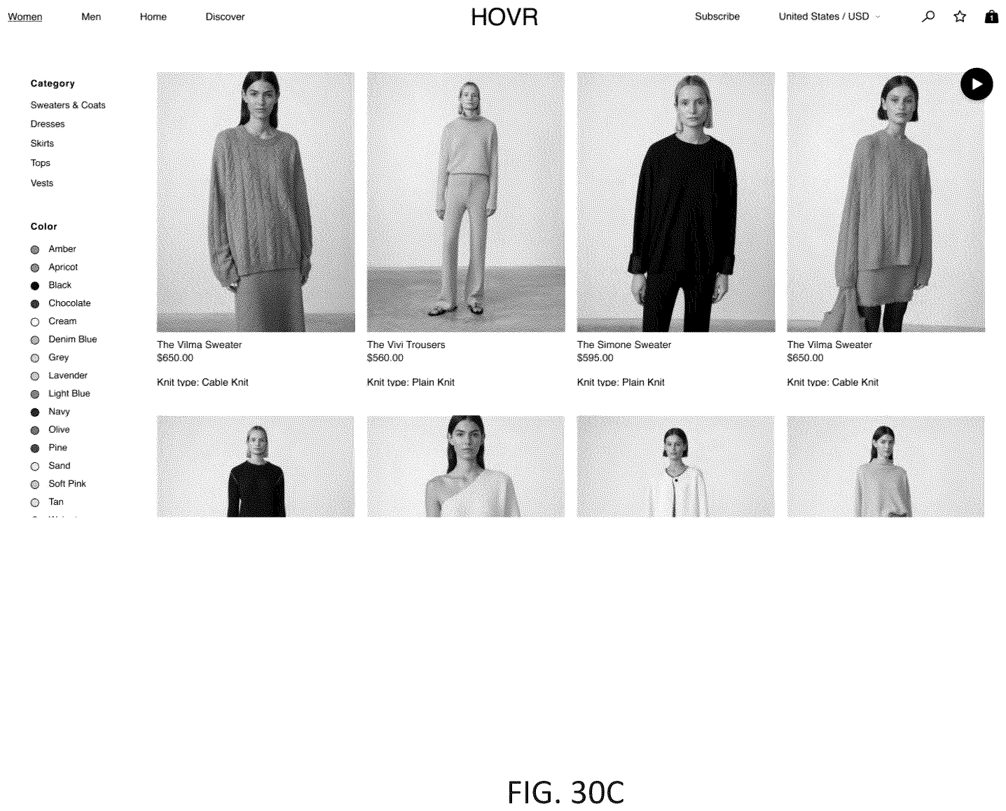

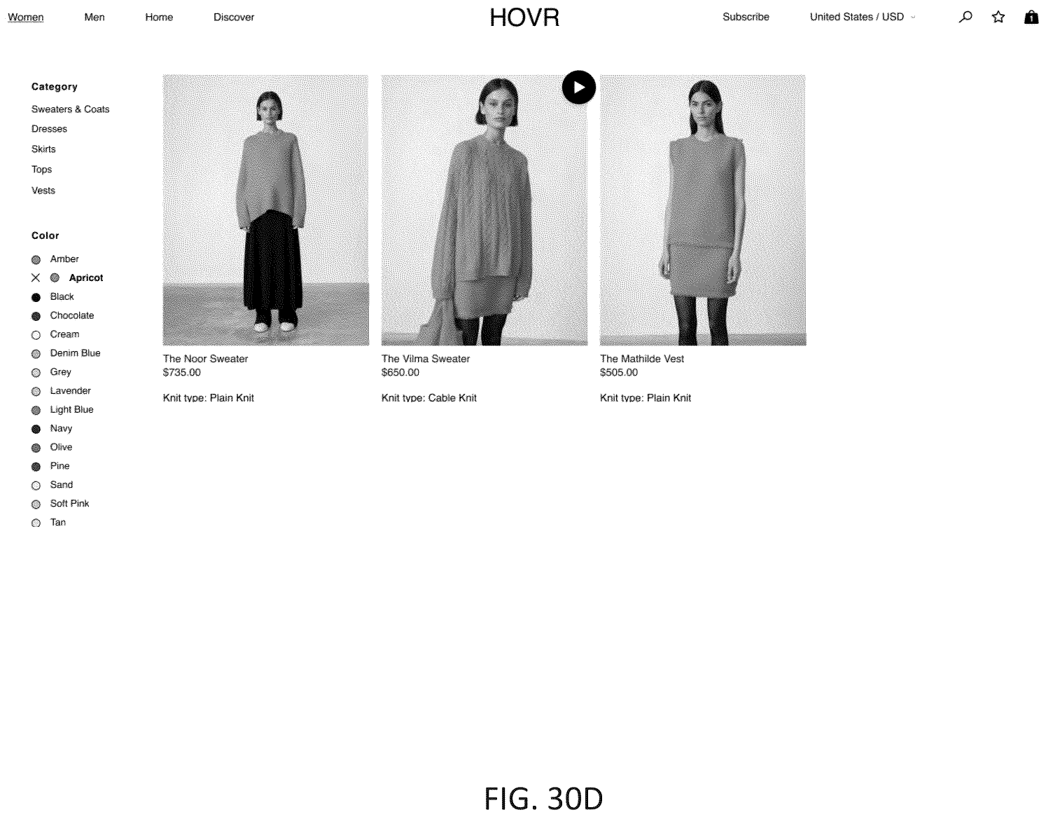

At block 2104, the on-site editor enables a user (e.g., an administrator) to create a component template for a given product associated with a product identifier. The component template may be utilized in response to detecting that the corresponding product has an entry on a website webpage, such as by detecting the URL of the product image (e.g., the URL associated with an IMG tag used to embed a product image). The component template may associate the product identifier with content that is to be associated with the product. The component template may specify how custom elements (e.g., anchors) are to be rendered (e.g., size, shape, representation, offset, etc.). For example, with reference to FIG. 30A, a user interface may be provided via which a user is enabled to select a product image to be used as a repeatable component and to place the repeatable component at other website webpages. With reference to FIG. 30B, a customization user interface is provided via which the user can set the placement of the anchor (e.g., a vertical and/or horizontal offset with respect to a center of the element/image), the size of the anchor, the shape of the anchor, and the icon to be used to represent the anchor (e.g., a play control, a link, a paperclip, etc.). The placement may be enabled via horizontal and vertical offset sliders. The offset may be previewed in an offset preview element.

At block 2106, when a webpage is rendered in a browser, a search is performed through the HTML code for IMG HTML tags to identify SRCs (URLs) that match that of a product associated with an anchor. The component template may thus be utilized to deliver the anchor and associated content in the same manner, regardless of the location of the product image in the webpage. FIG. 30C illustrates an anchor (represented by a play control) on an image of a product located in the top right hand corner of the webpage. In FIG. 30D, the same product image is presented in the middle of the top row of product images in the webpage. Regardless of the placement of the product image, the anchor icon is located at the same position relative to the product image, and will act in the same way when interacted with by a user.

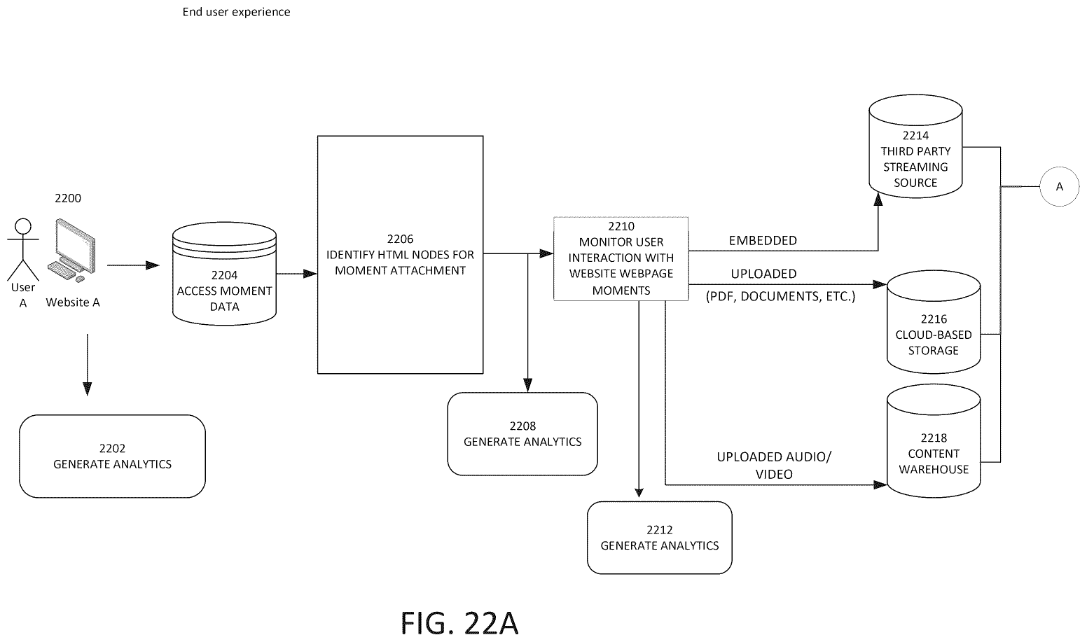

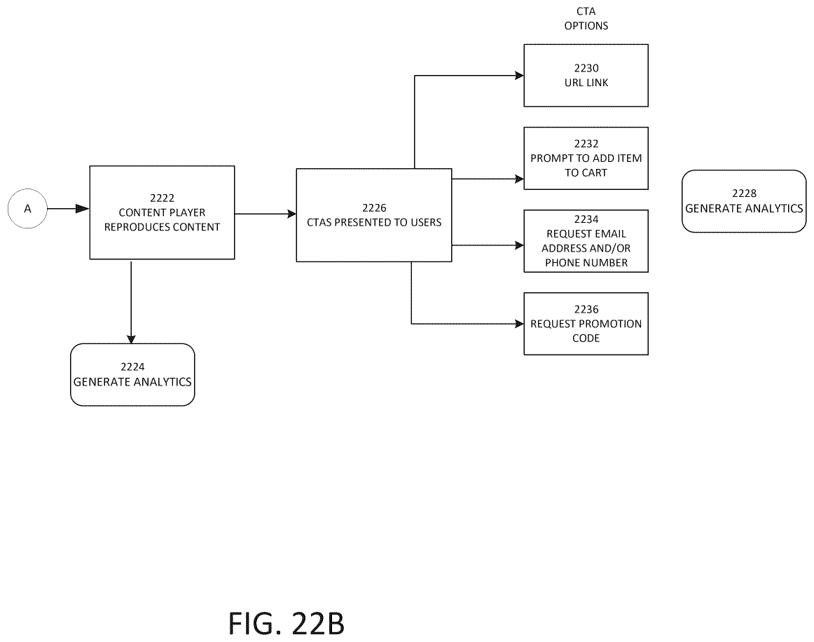

Referring now to FIG. 22A and FIG. 22B, an example process is illustrated with respect to an end user accessing and interacting with a webpage on which one or more anchors and associated content have been added. A user device 2200 accesses a webpage. At block 2202, analytics related to the page load are generated (e.g., with respect to page load time, the number of anchors, other moments, etc.) and reported (e.g., via an electronic document, such as a spreadsheet and/or a text document). Optionally, the page load analytics are filtered before reporting to exclude pages that do not have moments added to them to thereby ensure that only analytics that are relevant to the moments are reported, reducing display space utilization and memory utilization.

At block 2204, anchor configurations and HTML attributes are accessed from a data store, such as a NoSQL database, as described elsewhere herein. The foregoing data may be utilized to place anchors at the appropriate HTML nodes. At block 2206, the HTML nodes are identified. For example, the HTML attributes accessed from the data store may be used to search for matching nodes, and to identify parent and sibling elements, to locate the HTML nodes on the webpage that the moments are to be attached to.

For example, query selectors, querySelectorAll, and/or getElementById may be utilized in JavaScript to find and access specific nodes in the HTML DOM. By way of example, getElementById may be used to retrieve an element from the DOM based on its unique ID. It takes a single argument, which is the ID of the element to be retrieved, and returns the element node. The querySelector method may be utilized to retrieve the first element that matches a specified CSS selector (used to select the content based on name, or, class). The querySelector method takes a single argument, which is a CSS selector, and returns the first matching element node. The querySelectorAll method returns a list of all elements that match the specified CSS selector. The querySelectorAll method takes a single argument (a CSS selector), and returns a NodeList object containing the matching element nodes.

Anchors may be placed at the appropriate HTML nodes in accordance with the configuration data accessed from the datastore.

At block 2208, analytics are generated and reported related to the placement of anchors. For example, the analytics may indicate if no anchor was placed (e.g., because an HTML element node was not located that has an anchor associated with it). If no anchors are placed, optionally the process may terminate.

At block 2210, user interactions with website webpage moments (e.g., anchors) are monitored. For example, the process may detect and track when a user has hovered over or clicked on an anchor. At block 2212, analytics are generated and reported related to the user interactions with the moment. For example, the analytics may report on the number of times the user hovered over a moment, the length of time the user hovered over a moment, the number of times a user clicked on a moment, and/or the like.

Content (e.g., video content, audio content, still images, PDF documents, graphics documents, etc.) associated with an anchor interacted with by the user may be accessed from a third party content site 2214 (e.g., that streams video content (which may optionally include an audio track) and/or audio content (e.g., music or a podcast)) that is to be embedded in the accessed webpage, may be accessed from a cloud-based datastore 2216, may be accessed from a warehouse 2218 of audio/video content via an API, and/or may be accessed from other datastores. The content may have been embedded or uploaded to a given datastore.

At block 2222, the content associated with the moment (e.g., accessed from a datastore) is presented to the user. For example, a video player may be used to present video content. The content playback may be tracked and analyzed, and corresponding analytics may be generated and reported at block 2224. For example, the analytics may track and report the beginning of the media playback (e.g., which may have automatically begun playing or may have begun playing in response to a user activation of a play control associated with the content). By way of further, the analytics may report on the number and type of calls to actions (CTA) to be presented to the user (e.g., prompting the user to take a certain action, such as the activation of a button, link, subscribing to promotional content, copying a promotion code, entering a promotion code, providing an email address, adding an item to an electronic shopping cart, etc.).

At block 2226, the calls to action are present to the user. For example, at block 2230, a link to a URL/website to drive traffic to the corresponding destination may be presented, at block 2232 the user may be prompted to add a specific product to an electronic shopping cart, at block 2234 the user may be prompted to enter the user's email address (and/or phone number/messaging address) into a corresponding field, and/or at block 2236 the user may be prompted to enter a promotion code into a corresponding field. At block 2228, the user responses to the calls to action are monitored, and an analytics report is generated.

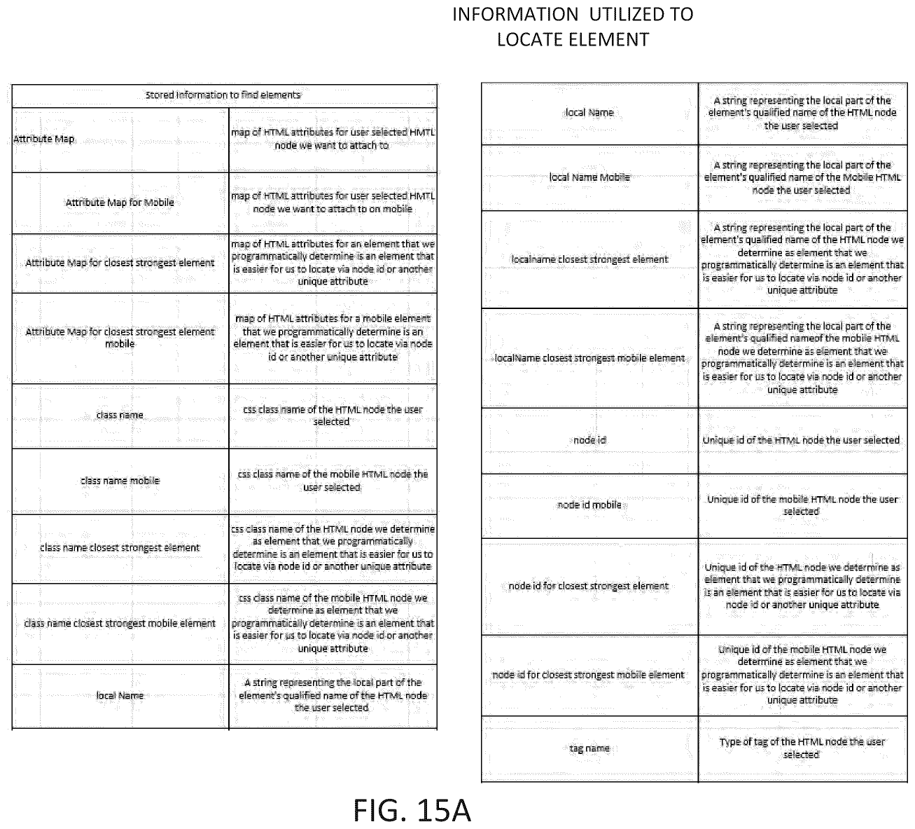

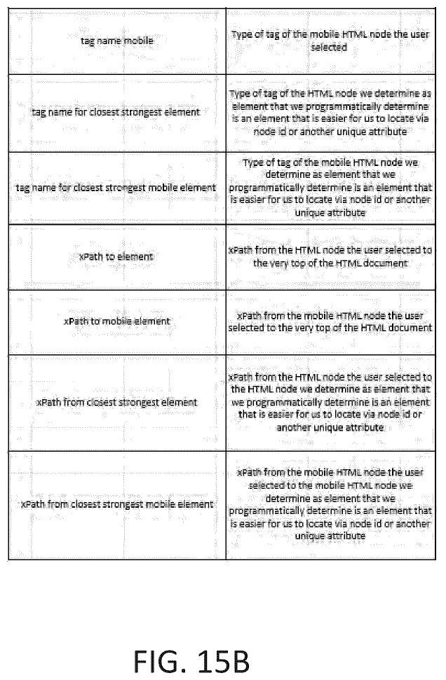

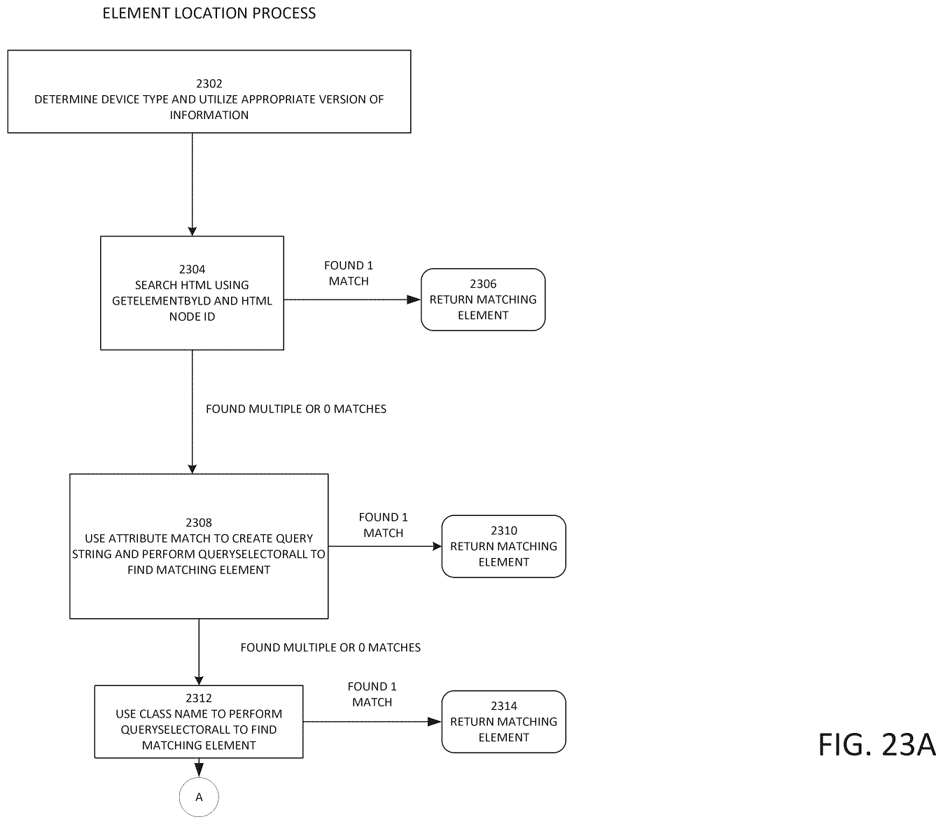

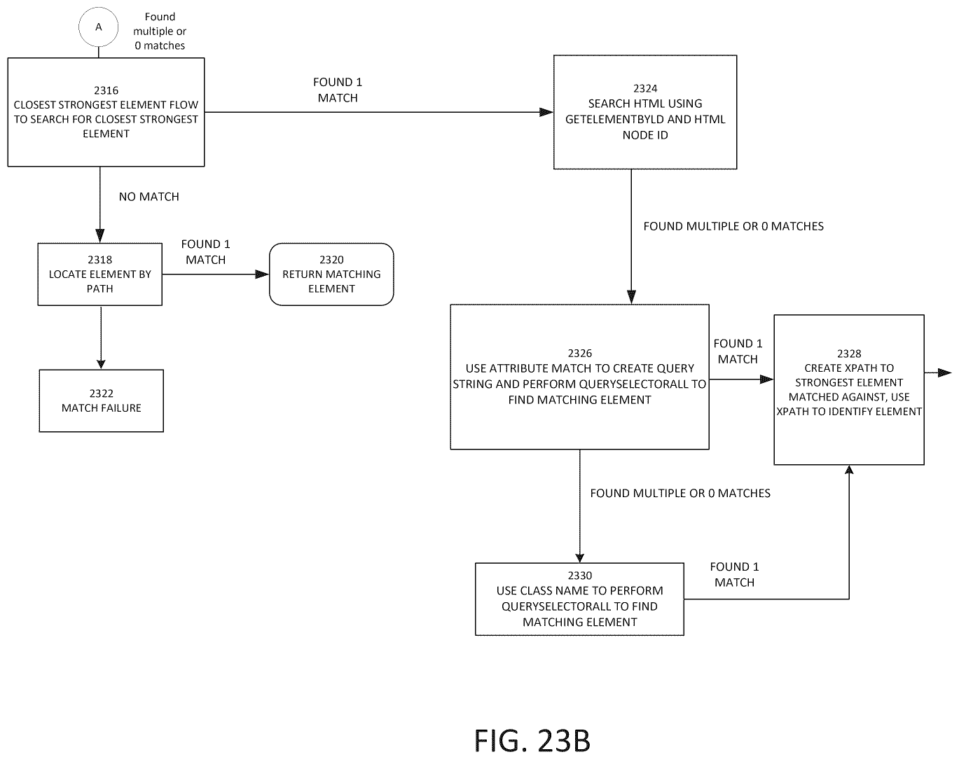

As discussed above, it may be desirable to locate a webpage element associated with an HTML node. FIG. 23A and FIG. 23B illustrate an example process for locating an element. FIG. 15A and FIG. 15B provide examples of information captured to locate an element on a webpage load.

At block 2302, a determination is made as to whether the user device loading a given webpage is a mobile device (with a relatively small screen and/or a screen of certain ratio set) or a desktop/laptop device. Depending on the device-type, the corresponding version of information will be utilized (e.g., the appropriate attribute map). Once the appropriate information to be used is determined, the remainder of the process may be the same or similar for both a mobile device and a desktop/laptop device, although different attribute maps may be utilized. At block 2304, the HTML node ID is utilized, if one is available, in locating the desired element. For example, the getElementById may be used to retrieve an element from the webpage DOM based on the node's unique ID. The getElementById method takes a single argument, which is the ID of the desired element, and if a single match is found, the getElementById method returns the element node at block 2306 to attach the element to.

If a match is not found, or if multiple matches are found, at block 2308, a query string is generated using the corresponding stored attribute map (which comprises a map of HTML attributes for a user selected HTML node that a moment is to be attached to) of the combined attributes, and the querySelectorAll method may be utilized that returns a list of all elements that match the specified CSS selector. If a single match is found, the getElementById method returns the element node at block 2310 to attach the element to.

If a match is not found at block 2308, or if multiple matches are found, at block 2312, the querySelectorAll method is utilized with the class name (where the HTML class attribute specifies one or more class names for an element). The elements returned by the querySelectorAll method are compared against the desired tagName to determine if there is a match. If a single match is found, the getElementById method returns the element node at block 2314 to attach the element to.

If a match is not found, or if multiple matches are found, at block 2316, the closest strongest element values are used to find a match. The closest method searches up the DOM tree for elements which match a specified CSS selector. Blocks 2304-2312 may be repeated as needed, except a match for the strongest element values is sought, which may be easier to locate than the original searched-for element.

If a matching element is not found, at block 2318, an attempt may be made to find a matching element using xPath. If a match is found, the matching element is returned to attach to. If a match is not found, at block 2322, a match failure may be logged.

If a single match is found at block 2316 and if the desired HTML node ID is available, at block 2324, the webpage HTML is searched using the getElementById method to retrieve an element from the DOM based on its unique ID.

If a match is not found, or if multiple matches are found, at block 2326, a query string is generated using the corresponding stored attribute map of the combined attributes, and the querySelectorAll method may be utilized that returns a list of all elements that match the specified CSS selector (the query string). If a single match is found, at block 2328, an xPath is generated to the strongest matching element. Then using the xPath from the closest strongest element (see the table illustrated in FIGS. 15A, 15D) the two strings are combined to provide the element.

If a match is not found at block 2326, or if multiple matches are found, at block 2330, the querySelectorAll method is utilized with the class name (where the HTML class attribute specifies one or more class names for an element). The elements returned by the querySelectorAll method are compared against the desired tagName to determine if there is a match. If a single match is found, the process proceeds to block 2328.

Referring now to FIG. 31A, optionally, rather than dragging and dropping an anchor or other moment to a desired location or element on a webpage, a user interface may enable a user to select an element first and then add a moment (e.g., an anchor) to the element. The moment may be added with a default positioning, size, alignment, and/or the like. Optionally, before or after a moment is added to an element, a process (e.g., executed by the user computer using code embedded in the webpage, a browser extension, and/or by the remote system) may identify (e.g., via corresponding HTML tags) the element type, such as what is text, a video, an image, a control (e.g., a button), contact information, a self-contained composition (e.g., an article, a post, a blog entry, a product card, an interactive widget or gadget, or other independent item of content), an aside (e.g., a portion of a document whose content is indirectly related to the document's main content, which may be presented as sidebars or call-out boxes), a footer, a header, a heading, main content (the dominant content of the body of a document), navigation links, a section, search controls, and/or the like.

When a user selects a given element to add an anchor corresponding to a moment, optionally a mapping of element types to element characteristics, stored in memory (e.g., as a lookup table) may be accessed and used to determine certain presentation characteristics of the moment, such as anchor drop placement (e.g., to the left, right, above, below, at a specified offset from the element), size (e.g., font size, pixel height and width, etc.), shape (e.g., circular, square, rectangular, triangular, etc.), and/or alignment (e.g., where the anchor may be automatically aligned vertically or horizontally with the element, such as a button element). The moment anchor may then be automatically presented in accordance with such mapped presentation characteristics.

Thus, advantageously, the exact element the moment is associated with may be determined regardless of the webpage layout. Further, the user-selected element may be automatically categorized/labeled and support for such categorized element may be adjusted accordingly. The selected element type may be identified to the user via a text description (e.g., “text”, “image”, “button” etc.) displayed to the user in association with the element.

A given webpage may contain one or more divs (where a <div> tag defines a division or a section in an HTML document, and may be used as a container for HTML elements that may be styled with CSS (Cascading Style Sheets) or manipulated with JavaScript.). Optionally, if the user selects a div at large (rather than a specific element within the div), the process may cause the moment anchor to snap to a specified position of the default of the div (e.g., left, right, or center). For example, the div may be divided into a grid of squares or rectangles (e.g., a 9 square grid) and the anchor may be snapped to a specified square.

Optionally, a determination may be made as to whether a div (or a portion thereof) is empty. For example, JavaScript may be utilized to determine if a <div> is empty (e.g., has no text or child elements). The moment anchor may optionally be automatically placed at the identified empty div.

Optionally, once added to the element, the anchor positioning may be adjusted (e.g., via a drag operation or otherwise) by the user via a user interface, such as a via a touch screen, touch pad, keyboard navigation controls (e.g., up, down, left, right arrow keys), voice control, and/or otherwise.

Similarly, if emphasis of text is utilized to indicate the presence of a moment, a default emphasis may be utilized, wherein a user interface may enable the user to adjust the type of emphasis used (e.g., underlining, bolding, color change). In addition, where underlining is used to provide text emphasis, a user interface may be provided enabling the user to specify the color of the underlining and the width of the underlining.

Certain user interfaces will now be described. User inputs may be received via the user interfaces, stored in memory, and retrieved for later use. For example, moment anchor placements, text emphasis, moment content, and moment styles may be stored in memory (e.g., in association with a webpage and/or website), and then accessed to appropriately annotate a given webpage with the corresponding moments when rendered via a browser. The user interfaces and the functionality provided thereby may be provided by local execution on a user system or via a remote server.

FIG. 31A illustrates the automated placement of a moment anchor in the upper right corner of a selected element, wherein in response to the user selecting the element, the selected element is emphasized (e.g., highlighted via a change in color, shade, brightness, via the placement of an outline, and/or otherwise) and the anchor is automatically placed at a default location for the element type. A prompt may be generated asking the user to confirm the automated placement of the anchor (e.g., “click to place here”). If the user does not confirm the automated placement, the user may be prompted to select an alternative placement location and the moment anchor may be placed in accordance with a user selection of a placement location.

FIG. 31B illustrates the automated placement of a moment anchor in the lower right corner of a selected element (in this case an image, wherein the determined element type is presented to the user via a text description of “image”), wherein in response to the user selecting the element, the selected element is emphasized (e.g., highlighted via a change in color, shade, brightness, via the placement of an outline, and/or otherwise)) and the anchor is automatically placed at a default location for the element type. A prompt may be generated asking the user to confirm the automated placement of the anchor (e.g., “click to place here”). If the user does not confirm the automated placement, the user may be prompted to select a placement location and the moment anchor may be placed in accordance with a user selection of a placement location.

FIG. 31C illustrates a user interface via which the user can select, from a set of video items, a video item and/or a call to action (a prompt that tells the user to take some specified action.) to be associated with an anchor (where in this example, the anchor is rendered as a “play” control). In addition, the user interface enables the user to drag and drop the anchor from a current location to a desired location.

FIG. 31D illustrates the automated placement of a moment (e.g., an anchor) in automatic horizontal alignment with a selected element, a button in this example (wherein the determined element type is presented to the user via a text description of “button” in association with the button), wherein in response to the user selecting the element, the selected element is emphasized (e.g., highlighted via a change in color, shade, brightness, via the placement of an outline, and/or otherwise). A prompt may be generated asking the user to confirm the automated placement of the anchor (e.g., “click to place here”). If the user does not confirm the automated placement, the user may be prompted to select a placement location and the moment may be placed in accordance with a user selection of a placement location.

FIG. 31E illustrates a user interface that enables a user to style an anchor, at the same time the corresponding webpage, webpage element(s), and anchor is displayed. Recently used anchor styles are presented from which the user may select an anchor style to be used with the selected element. The user interface also enables the user to select an anchor style from a larger anchor library, upload an image to be used to represent the anchor, specify an anchor size (e.g., via a slider control), specify an anchor shape, select an anchor color, specify an anchor opacity (e.g., via a slider control), and/or perform other anchor customization options described herein. The anchor may be rendered in accordance with the user style specification (e.g., using JavaScript, using CSS to specify a font size, using CSS to specify the size in a CSS class, using the CSS width/height properties, if the anchor is inside a flexible container (e.g., a button or a div) using CSS to control the size of the container, which in turn controls the size of the icon, and/or the like).

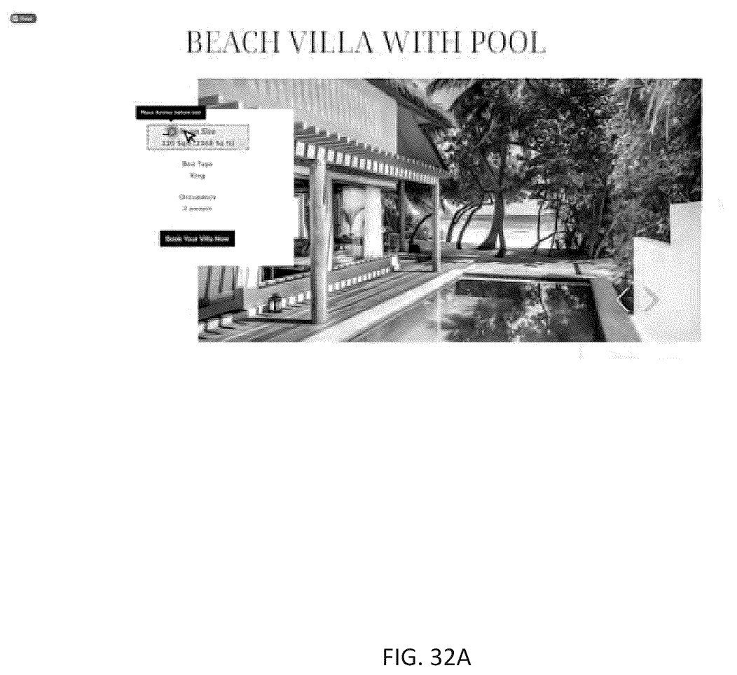

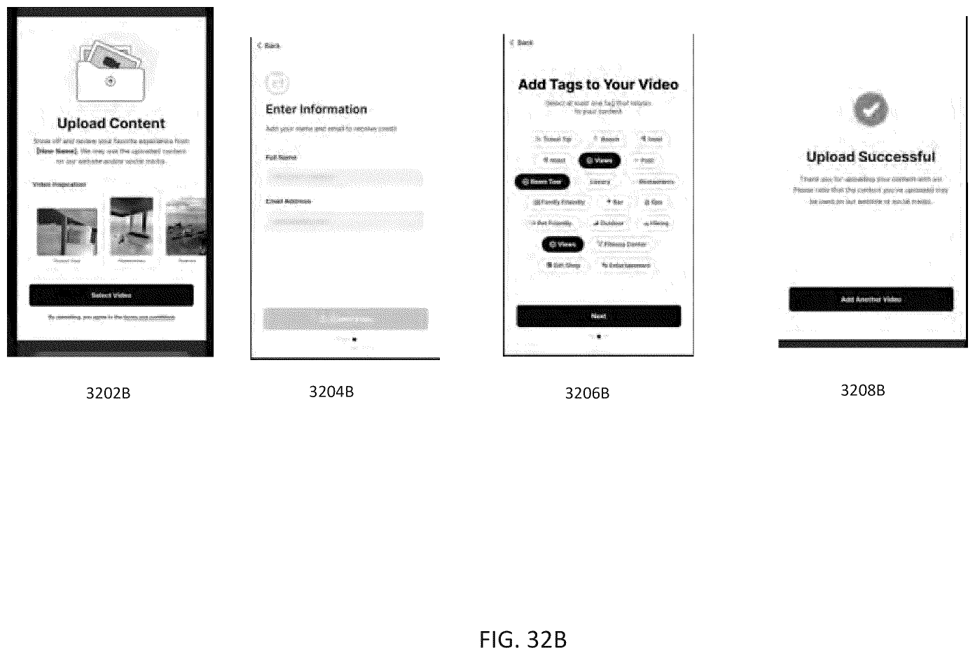

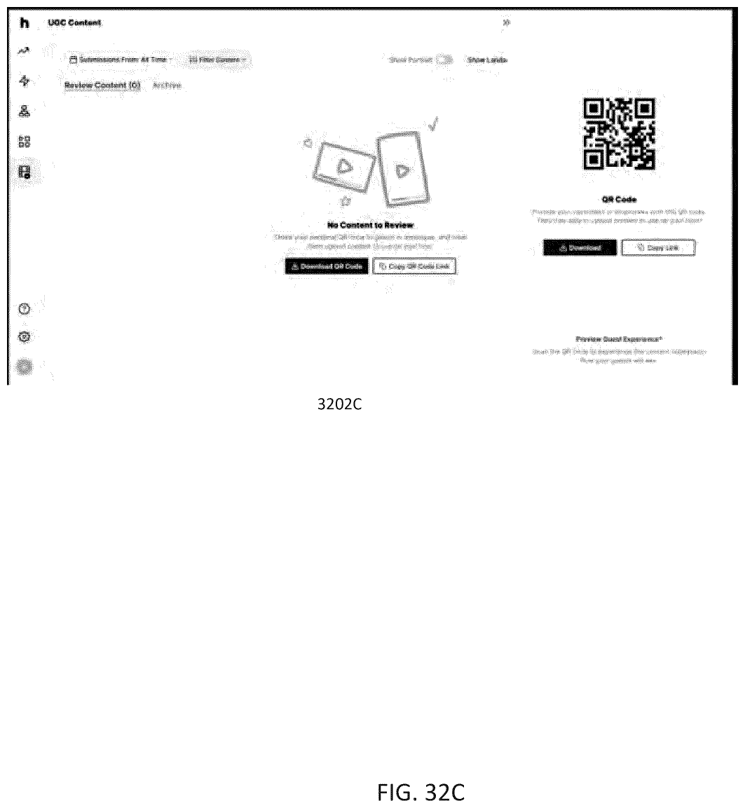

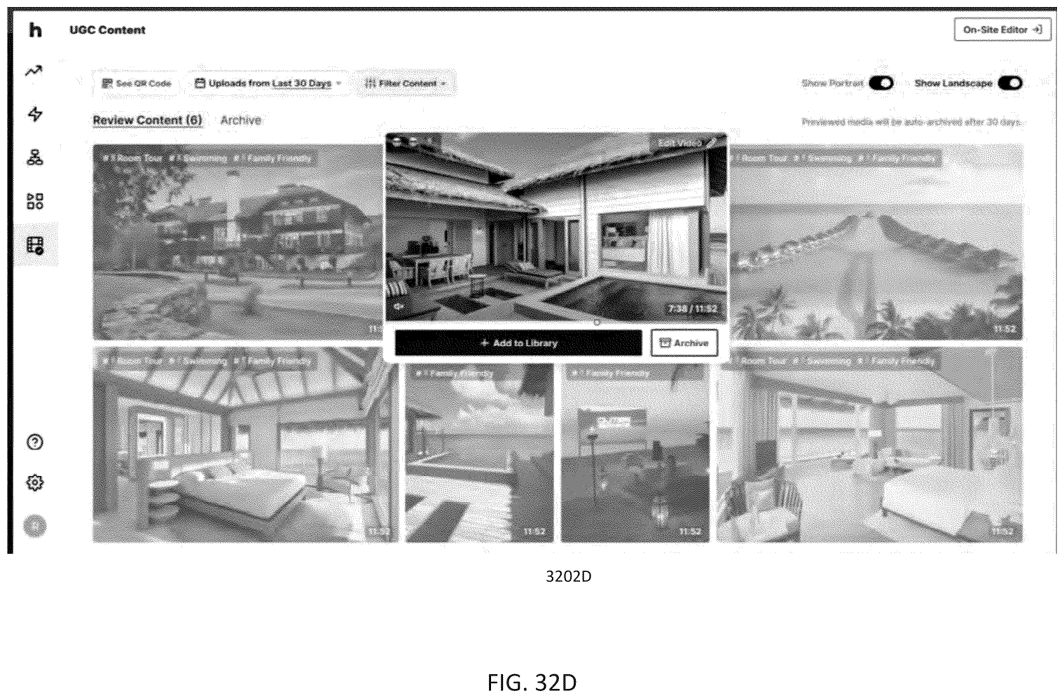

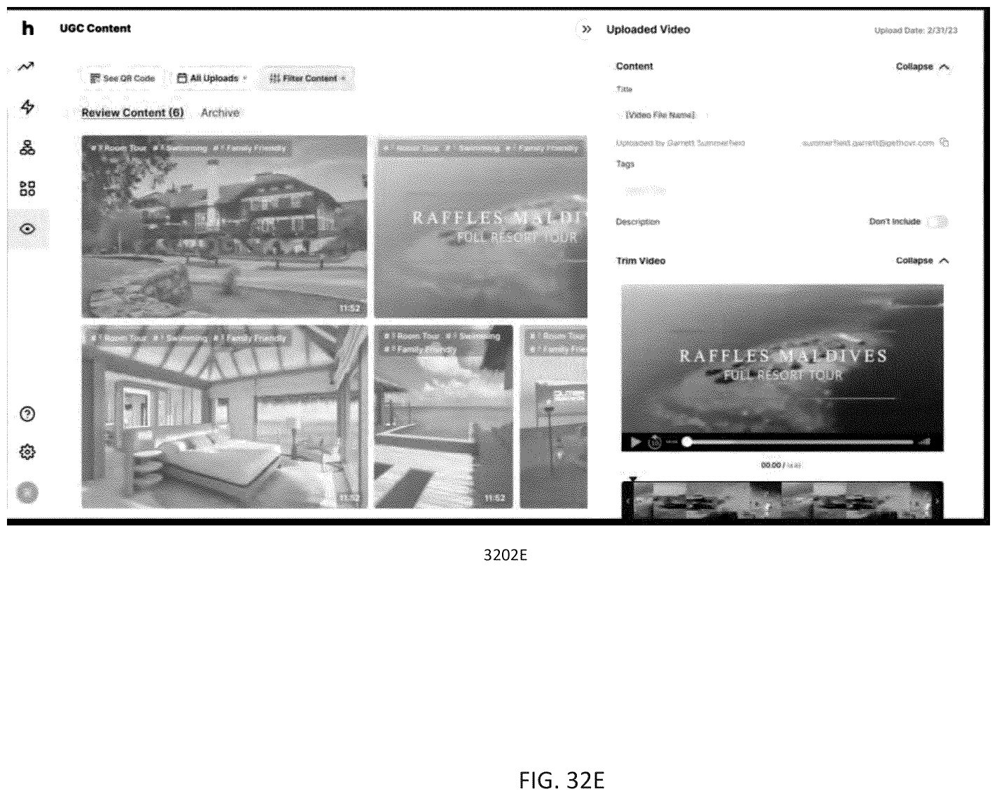

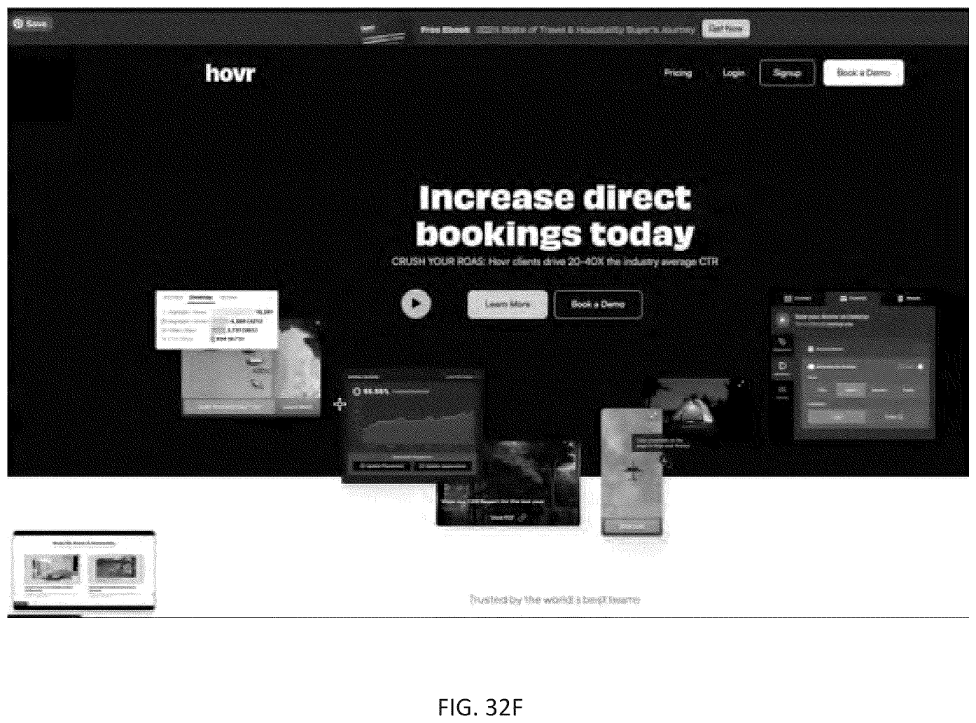

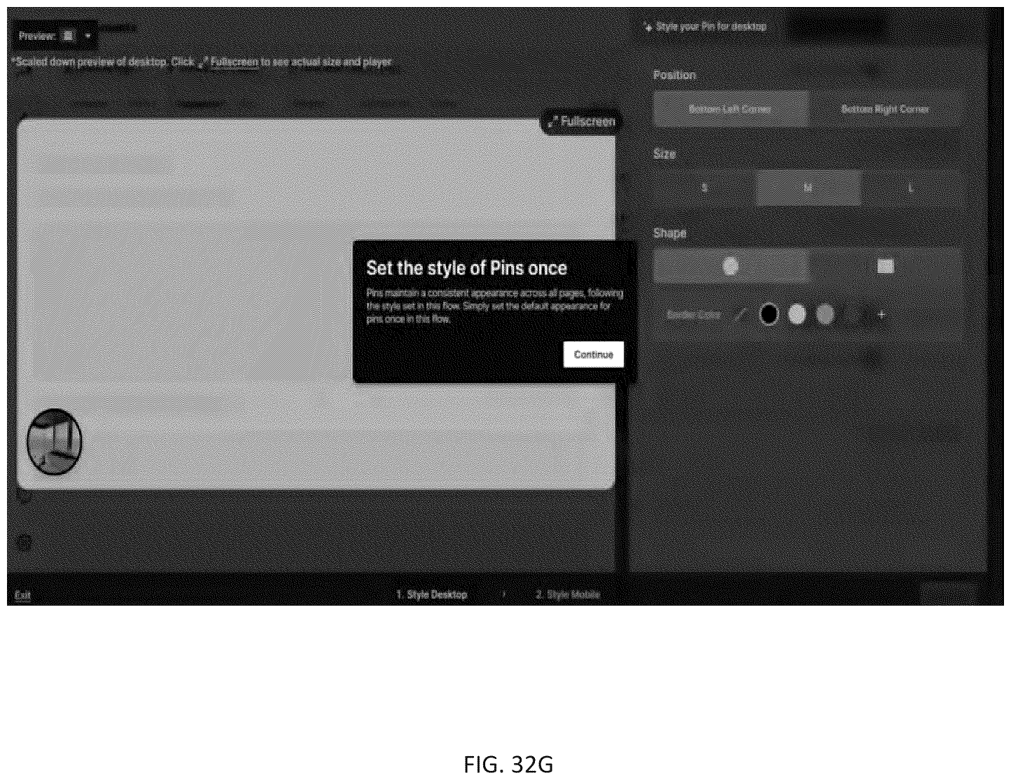

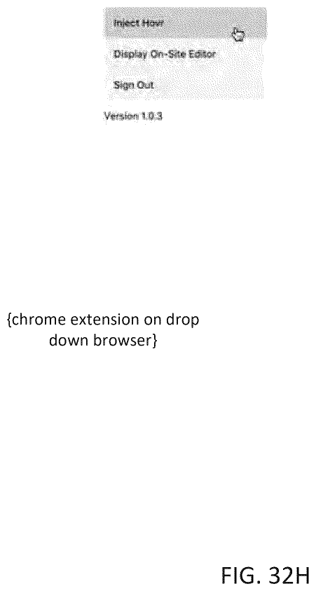

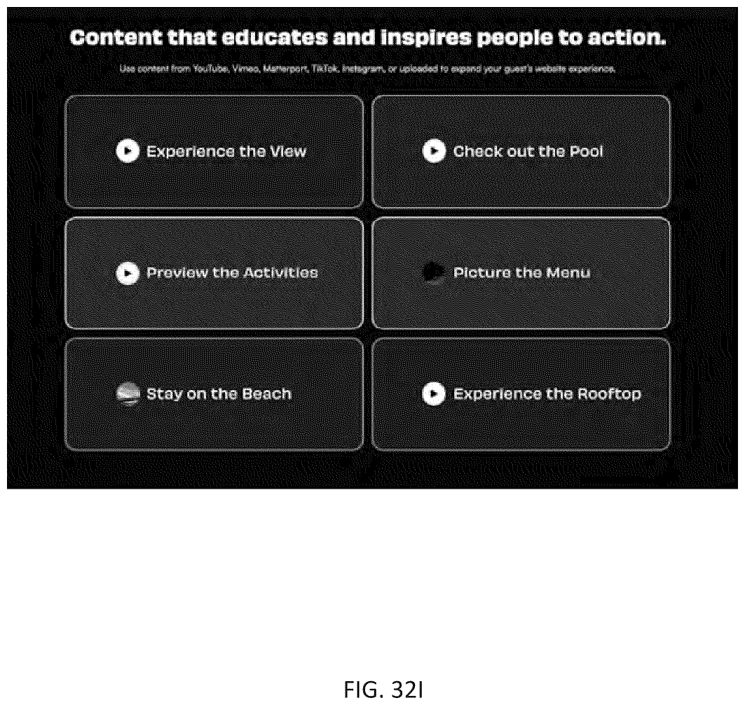

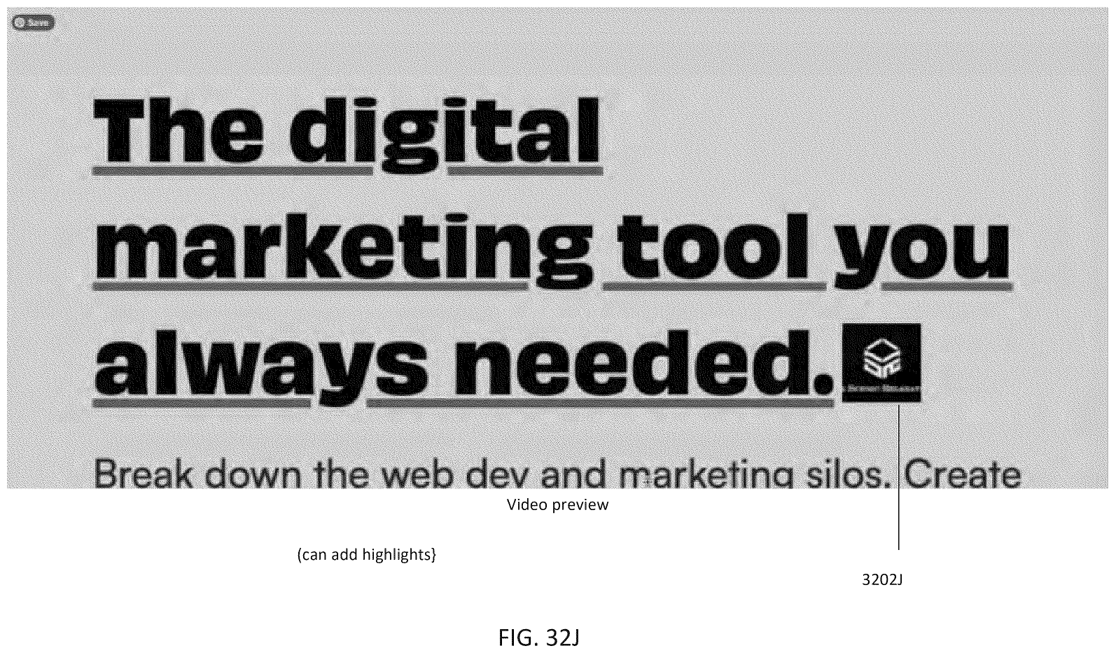

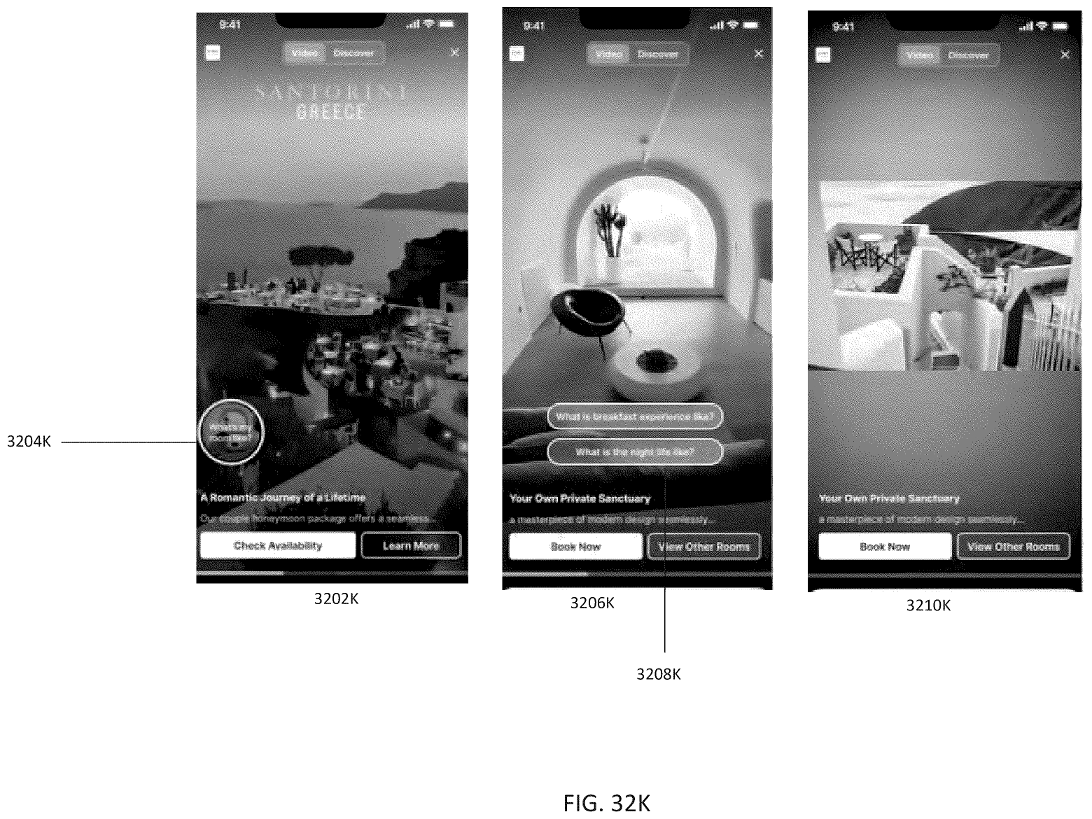

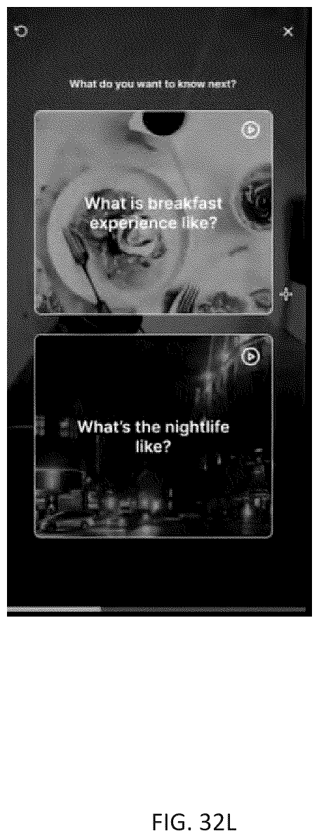

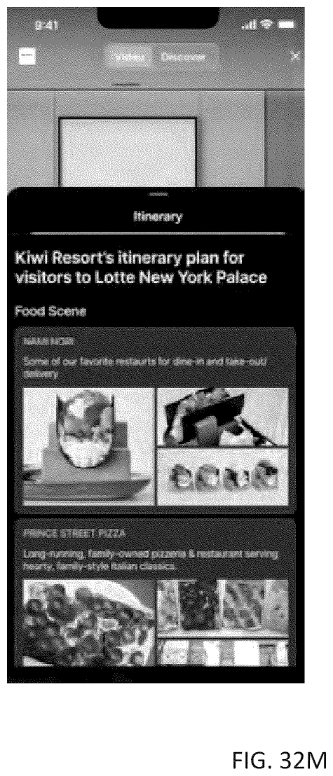

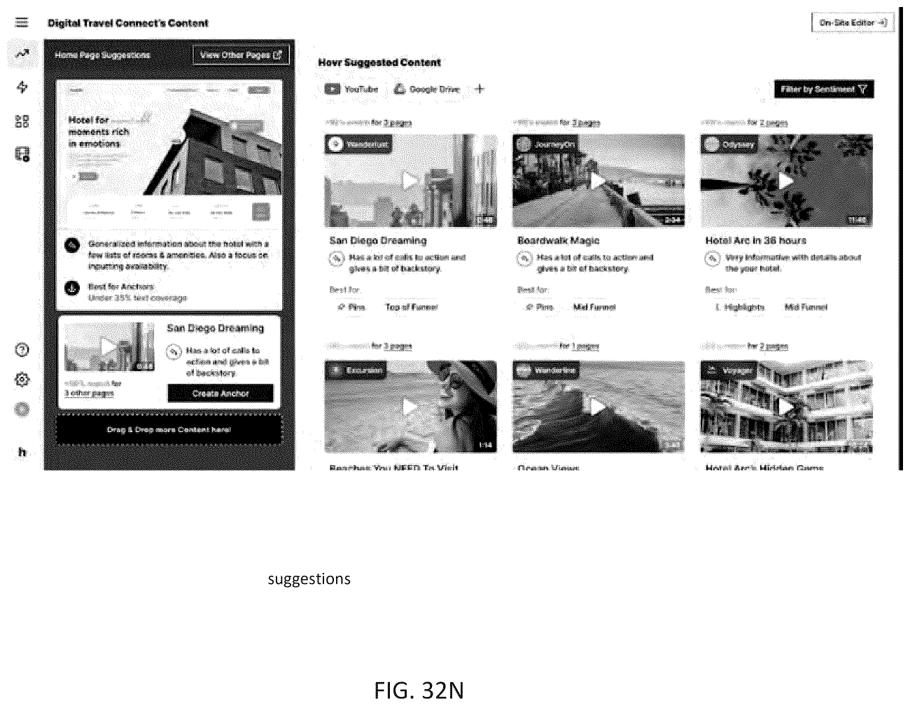

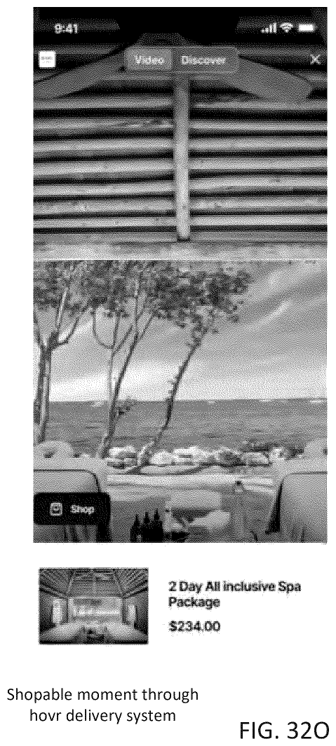

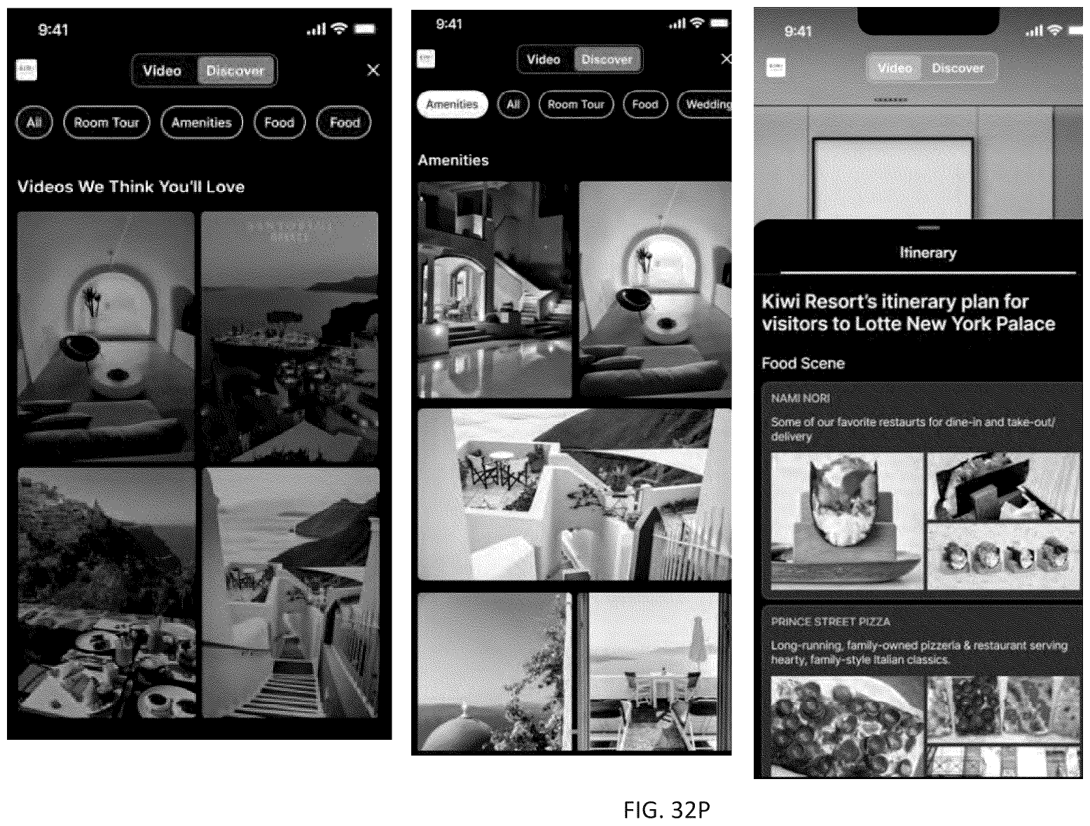

Optionally, text injection may be utilized with respect to a moment (e.g., an anchor) as illustrated in FIG. 32A. The process may recognize when the user is currently hovering over text (e.g., via a cursor, finger, or otherwise), and the anchor position may be adjusted to be placed either at the beginning or the end of the text string. The process may also automatically size the anchor (optionally as similarly discussed elsewhere herein) and snap to a specific placement (e.g., to the beginning or the end of the text string). The text may need to wrap because the div becomes smaller and the anchor will move with the text. In this example, the anchor is automatically placed to the left of, and just before the text “room size”. As similarly discussed elsewhere herein, a prompt may be presented asking the user to confirm the automated placement of the anchor (e.g., “click to place here”). If the user does not confirm the automated placement, the user may be prompted to select a placement location and the moment may be placed in accordance with a user selection of a placement location.

Referring to FIG. 32B, example user interfaces are illustrated that enable a user to upload content which may be associated with one or more moments. User interface 3202B enables the user to navigate amongst images stored on a user device or remote library and to select one or more images (still and/or video images) to be uploaded. If the user has not logged into a user account, the user interface 3204B may be presented to the user via which the user may enter contact information, such as a name, email address, and/or phone number. User interface 3206B enables the user to select one or more tags from a library of tags to be associated with the user provided content. User interface 3208B provides a confirmation that a user upload of content was successful.

Referring to FIG. 32C User interface 3202C provides an administrative user interface that enables an administrator or other authorized user to review uploaded content from users. In addition, an optical code (e.g., a QR code) is provided which the administrator can share (e.g., via email, text message, webpage, and/or otherwise) the code with other employees, customers, guests, and/or clients, enabling recipients of the optical code to quickly upload and share content. When the optical code is imaged by a camera on a user device, the user device display displays a locator (e.g., a URL). Optionally, the locator may be associated with a specific campaign. For example, a campaign may comprise a coordinated series of marketing activities designed to promote a product, service, brand, or company with the goal of achieving specific objectives (e.g., raising awareness, generating leads, driving sales, or building customer loyalty over a defined period). Activation of the locator by the user (e.g., by tapping on the locator on the user device display) may cause a content upload user interface (such as user interface 3202B) to be automatically presented on the user device. The images uploaded may be stored in a folder or other record associated with a corresponding campaign and/or associated with a campaign tag.

Referring to FIG. 32D, the user interface 3202D provides an overview of the uploaded content. The user interface displays images uploaded by users in association with the tags added by the users. Optionally, the user-provided content may be filtered to ensure there is no inappropriate content (e.g., violent or sexually explicit content) as specified by a rule. Such filtering may be performed using a model trained to detect such inappropriate content. Optionally, a summary and keywords related to the content may be automatically generated and presented (e.g., using a neural network-based classification engine that analyzes content, such as images, to identify whether certain types of content are presented) to a user (e.g., an administrator). A control is provided enabling an administrator to select one or more of the displayed images, and activate a control to add the selected images to a library of content items (which may then be used to associate a selected content item with a moment). An archive control is provided which the user can activate to add images that were not saved to the library to an archive of images. Optionally, images in the archive may later be added to the library.

The user interface 3202E displays images uploaded by users and enables an administrator to add tags to the images via a tag field, add titles to the images, add a description to the images via a description field, edit and/or trim video images via a video editing user interface.

Optionally, certain types of moments, which may be referred to as “pins” are configured to stay at the same location in a browser screen (which may be referred to as a viewport) even while the user scrolls through a webpages (e.g., vertically scrolls or horizontally scrolls). For example, using CSS, the “position: fixed;” property may be utilized to fix the moment relative to the viewport. Thus, for example, rather than selecting an element to associate with a pin, the user may place the pin at a desired location in the viewport (e.g., by dragging and dropping a pin to a desired location via the editor, by selecting a pin icon and then pointing at a desired location by assigning a URL (rather than utilizing an onsite editor), or otherwise). A pin may be in the form of a still image, a video image, an icon, text, a button or other control, or other media.

FIG. 32F illustrates an example webpage with various pins added thereto, comprising graphs, still images, video images, and the like. FIG. 32G illustrates an example pin edit user interface that enables a user to set a style for pins. The style may be set to apply all pins on a given webpage, or all pins on a website. Optionally, each pin may be individually styled. Optionally, a given user-specified pin style may be used as a default, wherein various characteristics of the style may be edited and modified for a specific pin or for pins in general. The user-specified style may be stored with an indicator as to which pins the style is to be applied to. The user interface enables a user to specify a pin position (e.g., bottom left corner, bottom right corner, upper left corner, upper right corner, etc.), size, shape, and/or color. A viewport, corresponding to a browser screen is displayed. The styled pin may be displayed at the specified position in the viewport (in the bottom left corner in the illustrated example) in real time.

Optionally, a browser extension may be provided which enables moments to be styled and a preview of a styled moment to be displayed in real time at the specified location on any website. Such a preview may not be visible to other users accessing the website. However, it may be used to preview the webpage to other authorized users with the added moments.

A browser extension (sometimes referred to as a plugin) may comprise a small software program that adds specific capabilities to a web browser. These capabilities enhance the browsing experience by providing additional functionality, such as the functionality described herein with respect to moments, anchors, automatically generated sites and postcards, and/or other features described herein.

A browser extension may have an associated manifest .json file, containing metadata about the extension (e.g., name, version, permissions, the files it uses, and/or the like). The manifest file is configured to instruct the browser how to load and run the extension. The extension files may include HTML/CSS/JavaScript which may be used to create user interfaces and the extension logic. For example, JavaScript may be utilized to handle interactivity and perform actions. A persistent script may run in the background and may be configured to listen for events (e.g., browser actions, network requests, and/or the like) and respond accordingly. Content scripts, such as JavaScript files, may run directly in the context of web pages. Such scripts may interact with the DOM (Document Object Model, a programming interface for web documents) of the pages the user visits, enabling the extension to modify content or extract information. The extension may provide a user interface that pops up when the user clicks the extension's icon in the browser toolbar. Optionally, the user interface is defined in an HTML file and controlled by JavaScript.

Optionally, the browser extension may be downloaded from a web store, which may be browser-specific. The extension may be configured to request, during installation, permissions to access certain browser features (e.g., reading and changing data on websites, accessing bookmarks). These permissions may be defined in the manifest .json file. When such permissions are permitted by the user, the extension may perform the corresponding acts.

When the browser starts, it loads the background script, initializes the extension, and sets up any needed event listeners. For example, the event listeners may detect when a page is loaded and perform an action (e.g., injecting a content script) . . . . Content scripts may interact with the webpages that the user visits (e.g., modifying the page's HTML or CSS, or extract information from the page). The extension may be configured to store data locally using the browser's storage APIs. Such data may include settings, user data, and/or other information that may be used for the extension's operation.

Once a user (e.g., an administrator) specifies moments (e.g., anchors, underlining, and associated image and/or text content) for a webpage via an extension, the specified moments may be ported over to the actual website, and it may go live so that general viewers of the webpage will be able to see the added moments.

FIG. 32H illustrates an example dropdown menu presented when the user selects an icon corresponding to the extension in the browser header. The menu may include an “inject moment” (“inject Hovr”) entry (enabling a user to add a moment to an element or viewport), a display on-site editor entry, and a sign-out entry, which may provide access to some or all of the user interfaces described herein.

An aspect of the present disclosure relates to reducing network bandwidth utilization and reducing content load times on a client, such as a user device. Where a moment comprises video content, a content preview may be generated as an animated GIF (Graphics Interchange Format), which is a compact digital picture format that can show a sequence of pictures put together to make a short, optionally repeating animation. For example, an item of video content may be input to a GIF generation program which outputs a GIF corresponding to a selected portion of the input video content (e.g., the first 10 seconds, a randomly selected 10 second portion, the last 10 seconds, or other portion of the input video content). The preview may be used as an anchor.

In response to detecting a user hovering over an image representing a given GIF (e.g., by placing a cursor over the GIF or pointing at the GIF), playback of the GIF may be automatically initiated. In response to the user clicking on or otherwise selecting the GIF, playback of the actual, complete item of video content may be initiated.

FIG. 32I illustrates a user interface comprising a plurality of moments, wherein if a user hovers over a given moment, a corresponding GIF preview will be played back.

FIG. 32J illustrates a user interface comprising a moment indicated by highlighting (e.g., underlining) and an associated icon 3202J, wherein if a user hovers over the moment, a corresponding GIF preview will be played back.

Optionally, moment content may be suggested that may be associated with an anchor.

An aspect of the present disclosure relates to a feature referred to as pathways, wherein a content path is predefined, but a user is provided options to diverge from the content path down one or more branches or forks and then to return to the path.

For example, a path designer may design a path (a primary sequence) through a series of user interfaces (e.g., screens comprising text content, image content, previews, moments, and/or the like). The path designer may specify divergence paths (e.g., forks, branches) that may be selected by a user via a branch control that will result in different user interfaces/content being presented to the user (e.g., another part of a page, an email/phone number capture user interface, videos, previews, other content described herein, and/or the like).

To manage the path, including the branch/fork, content, unique IDs or tags may be assigned to each branch (e.g., branch user interface/item of content). Branch controls, such as buttons, links, video previews/buttons, call to action cards (e.g., comprising an image, text, and/or instructions to the user to take a certain action), and/or other controls may be provided that correspond to an optional branch, wherein activation of such control will navigate the user browser to the corresponding branch. Optionally, if it is detected that the user has navigated to a divergent path, if the divergent path comprises video content, once it is detected that the video content has played, the user may be automatically navigated back to the original path. Optionally, if it is detected that the user has navigated to a divergent path, if the path comprises static content (e.g., still images, text, and/or the like), after a specified period of time has elapsed, the user may be automatically navigated back to the original path. Optionally, if it is detected that the user has navigated to a divergent path, if the path comprises a form for the user to fill out (e.g., a contact information form, a payment form, and/or the like), the user may be automatically navigated back to the original path once it has been detected the user has filled out and submitted the form or activated a return control. Optionally, each user interface on a divergent path may include a navigation control, which when activated, will cause the user to be automatically navigated back to the portion of the original path the user had diverged from. Optionally, a progress indicator may be rendered that enables a user to see their progress on the path and to enable the user to backtrack if desired.

Optionally, a continuous soundtrack of music, sound effects, and/or spoken word/narration may be played as the user navigates through different paths. Thus, for example, a user interface may be provided that enables a path designer to select audio sound content (e.g., music, spoken word, sound effects, and/or the like) from a library of sound content, and designate the selected sound content as the soundtrack for a path experience, including an original path and some or all divergent paths. Such designation may be stored in memory in association with the path, and the soundtrack may be streamed to viewer devices in conjunction with the video for the paths (optionally with different header and subheader text). Optionally, the user interface may enable the path designer to designate different items of audio content for different paths (e.g., for the original path and the divergent paths) or sets of paths, so that each path or sets of several paths may be associated with a different soundtrack. Such designations may be stored in memory in association with the corresponding paths, and as the viewer is navigating amongst the available paths, the designated soundtrack may be selected and played via the viewer device in conjunction with the video for the current path.

Optionally, a single call to action (e.g., a stimulus for the viewer, such as a call to action card comprising text, a link, an image, or the like, which will be presented to the user) may be presented to the user as navigates through different paths. Thus, for example, a user interface may be provided that enables a path designer to specify call to action content (e.g., video, text, and/or spoken word encouraging the viewer to make a hotel reservation, book a spa treatment, make a restaurant reservation, make an item purchase, and/or the like) via a text entry field or via a selection from a library of call to action types/content, and designate the specified call to action as the call to action for a path experience, including an original path and divergent paths (optionally with different header and subheader text). A call to action may be associated with existing webpage content.

Such call to action designation may be stored in memory, and the call to action may be transmitted to and presented by viewer devices in conjunction with the video for the paths. Optionally, the user interface may enable the path designer to designate different calls to action for different paths (e.g., for the original path and the divergent paths) or sets of paths, so that each path or sets of several paths may be associated with a different call to action. For example, when a viewer is viewing a path for a room view on a hotel website, the corresponding call to action may be “make a room reservation.” By way of further example, when a viewer is viewing a path for a restaurant at the hotel, the corresponding call to action may be “make a dinner reservation.” Such designations may be stored in memory in association with the corresponding paths, and as the viewer is navigating amongst the available paths, the designated call to action may be selected and presented via the viewer device in conjunction with the video for the current path.

When one or more branch controls are presented via a viewer device, if the user does not select a given branch control within a threshold period of time, the user may continue to be navigated through the primary sequence, and the branch control may no longer be displayed until another branch opportunity is reached, at which point a different branch control may be presented.

Optionally, there may be multiple branches available at a given point in the primary sequence, and in which case, there may be multiple, different branch controls presented at the same time. Optionally, the user may have to select one of the multiple branch controls in order to proceed further.

Optionally, a path may be generated in whole or in part using artificial intelligence, such as a learning engine. By way of example, the path may be a suggested itinerary at a resort. The AI may input the location, the time of year, the availability of events, weather conditions, special events happening during the guest's stay, the costs of various activities (e.g., spa treatment, tennis, golf, a restaurant, etc.), as well as optionally information regarding the user (e.g., age, number of people in the user's party, the age of people in the user's party, income, previous activities the user has participated in (and any user feedback provided), personal preferences, and/or the like). The user information may include information expressly provided by the user (e.g., to populate a user profile and/or in making a reservation), historical information accessed from the database of the entity (e.g., hotel) associated with the website, and/or accessed from a third party site. For example, the user profile may include interests (e.g., adventure, relaxation, culinary experiences, golf, tennis, skiing, boating, etc.), preferred activities (e.g., hiking, spa treatments, dining, concerts, movies, and/or the like), and/or special requests (e.g., dietary restrictions, mobility needs, and/or the like).

Optionally, collaborative filtering, content filtering, classification algorithms, regression models, K-means clustering, hierarchical clustering, and/or neural networks may be utilized to generate the itinerary.

Optionally, the user interaction with and navigation of a given path and path branches may be utilized to modify what moments and contents are displayed throughout the website. For example, the path and branching functions may, based on inputs from a user, offer a room for reservation, access and display videos to generate an offer of a product or service, and/or the like. Optionally, data from a reservation system and/or revenue management system may be injected into a room offer in a hotel.

FIG. 32K illustrates an example path and navigation to a branch. User interface 3202K illustrates an example via screen of a path (e.g., for a resort website). A preview 3204K of a room view (which may be a GIF as described elsewhere herein) acts as a branch control. Prior to playing, the branch control has the text “What's my room like” thereon to indicate that the corresponding branch will provide images of a room. If the user hovers over/points at the preview 3204K, the preview will begin playing. If the user clicks on the preview 3204K, the interface will be navigated to the branch illustrated as user interface 3206K. Optionally, if the user does not take any action for a predetermined amount of time (e.g., 5 seconds, 10 seconds, etc.), the preview 3204K will be removed from the user interface 3202K so that the user interface is visually unobstructed. Optionally, instead, the user may select one of the buttons (“check of availability”, “learn more”) and corresponding user interfaces will be presented.

The user interface 3206K provides an image of a room and displays two other branch controls 3208K (“what is the breakfast experience like,” “what is the nightlife like”), as well as a “view other room” control. One or more of the branch controls 3208K may comprise static buttons or may be video previews. If the user activates the “view other rooms” control, the user interface 3210K may be presented, rendering an image of another room. FIG. 32L illustrates another user interface with two branch controls, comprising two images with overlaying text (“What is the breakfast experience like,” “what is the nightlife like”). The images may comprise a GIF preview such as described elsewhere herein. In this example, the user needs to select one of the branches in order to move forward in the path sequence.

FIG. 32M illustrates an example of an automatically generated itinerary for a user. As similarly discussed elsewhere herein, the itinerary may be launched as a path branch, from a moment, or otherwise. The itinerary may be generated from related user activity or information that may or may not have been manually input by the user. The itinerary may optionally be automatically generated using relevant images scrapped from website webpages or relevant content from third party sources. The itinerary may optionally be generated using techniques described with respect to the automatic generation of suggestions.

An aspect of the present disclosure relates to the automatic generation of suggestions of content to be included on a website and optionally used as an anchor/moment. The suggestion process may comprise scrapping the webpages of a designated website and analyzing the webpages (e.g., images and text) using a learning engine, such as a large language model (LLM). The LLM may analyze the webpages and generate text summaries and keywords for a given webpage.

For example, webpage raw text may be provided to the LLM. This can include headings, paragraphs, and lists, while HTML tags, scripts, or stylesheets may be filtered out prior to providing the text to the LLM. The LLM may recognize different types of content such as headers (e.g., H1, H2, H3), paragraphs, and metadata. The structured content may be used by the LLM in understanding the importance and relevance of different parts of the page (e.g., H1 is usually the main topic and so more weight should be provided to H1 in generating a summary and/or keywords than certain other portions of the webpage).

The LLM may then utilize natural language processing (NLP) to analyze the content structure, key themes, and semantics of the webpage. The LLM may perform tokenization, breaking down the webpage text into smaller units such as words or sentences, enabling the LLM to process and analyze the content more efficiently. The LLM may then perform part-of-speech tagging and dependency parsing. For example, the LLM may identify the grammatical structure of the text, determining the relationships between different words or phrases. Deep learning models may be utilized to understand the meaning of sentences, optionally including identifying the main topics, tone, and overall context of the content.

The LLM may then generate a summarization (e.g., an extractive summarization and/or abstractive summarization) corresponding to the webpage and/or website. With respect to generating an extractive summarization, the LLM may select what it has determined to be the most important sentences or sections from the webpage and/or website (e.g., based on word frequency, sentence importance, semantic significance, and/or the like). With respect to abstractive summarization, the LLM may generate a summary by understanding the content and producing sentences that convey the core ideas in its own words.

Keyword generation for a webpage and/or website may utilize one or more techniques. For example, statistical techniques, such as Term Frequency-Inverse Document Frequency (TF-IDF), may be utilized, wherein important words are identified by comparing how often they appear in the text versus how common they are across other documents. By way of further example, Named Entity Recognition (NER) may be utilized, wherein the LLM identifies important entities (e.g., people, places, organizations, dates) within the text that can serve as key terms. By way of additional example, topic modeling techniques, such as Latent Dirichlet Allocation (LDA), may be utilized to enable the LLM to determine overarching topics in the content and suggest keywords related to those themes. By way of further example, synonym detection may be utilized, wherein the LLM uses its knowledge of language to generate synonyms or related keywords based on the main topics, providing a broader range of relevant terms.

The LLM may be configured to evaluate the content and relevance of words in generating a summary and/or in determining keywords. For example, the LLM may evaluate the relevance of the text based on user intent or target audience, ensuring the summary and keywords align with the most meaningful aspects of the content of webpages and websites content.

Keyword weighting may be utilized wherein by analyzing word co-occurrence, importance, and specificity, the LLM may prioritize certain keywords as more relevant to the site's overall topic. Such weighting may be utilized to rank the keywords.

Optionally, in addition to or instead of text, images may be analyzed in generating a webpage and/or website summary and in identifying key words. For example, the image may be processed prior to being analyzed by a learning model. Such preprocessing may include resizing the image and normalizing to ensure consistent lighting and color levels, thereby making the image easier to analyze by the model. The image is transformed into a numerical representation (a tensor) that the model can work with. The model may use a convolutional neural network (e.g., a CNN comprising an input layer, an output layer, one or more pooling layers, and an error function) to detect patterns and objects within the image.

The CNN may process images in layers, starting from basic features (e.g., edges, colors, and/or the like) and gradually moving to more complex patterns (e.g., shapes, objects, textures and/or the like).

The pooling layers may reduce the spatial dimensions of the image, enabling the model to focus on key features while ignoring irrelevant details.

As the CNN progresses through layers, it may generate activation maps that highlight significant areas of the image that likely represent the subject (e.g., an animal, a person, a landscape, or an object). Detected objects are labeled based on pre-trained classes (e.g., animals, vehicles, food).

Object detection models, such as YOLO (You Only Look Once) or Faster R-CNN, may be trained to detect specific objects in images and locate them within bounding boxes. Once the image's key features are extracted, the model may classify the objects using a pre-trained dataset. The model may assign labels like “plate,” “bed,” “tree,” etc., based on the objects it detects.

Models such as Vision Transformers (ViTs) or CNNs may be utilized to grasp the broader context of an image. For example, such models may differentiate between a picture of a person in a park and a person in an office by recognizing background objects and textures.

Models trained to recognize entire scenes (e.g., “beach,” “cityscape”) by detecting common patterns in landscapes and other background elements may be utilized to analyze images and in labeling content. Based on the classification, the learning model may generate keywords by mapping the objects and features detected in the image to relevant labels. As described elsewhere herein, the model may assign a confidence score to a given keyword, wherein if the confidence score is less than a certain threshold, optionally the corresponding keyword is not utilized as a keyword.

Optionally, both vision and language models may be utilized to generate more descriptive keywords, captions, and/or complete sentences based on the determined objects and their relationships, leading to keywords extracted from these descriptions.

Optionally, a given model may utilize attention layers configured to enable the model to focus on the more important parts of the image, helping to refine keywords by highlighting what's most central to the subject.

The keywords and summaries may be stored in memory in association with the corresponding webpage and/or with a corresponding website and/or webpage identifier.

Optionally, the automatic selection of content and placement of a corresponding anchor may first be presented via a user interface to an authorized user for approval or disapproval. If approved, the placement of the anchor and selected content may be published and made available for general access by the relevant public. Optionally, rather than just selecting one item of content to be associated with an anchor or moment, a library of suggested relevant content may be generated and presented to the authorized user. The authorized user may then select content from the library of suggested content to be associated with the webpage anchor or moment.

Optionally, in addition to or instead of using the webpage keywords and/or summary to determine the placement of an anchor, a heatmap of the webpage may be generated based on historical focus by users on portions of the webpage (e.g., using a user interaction heatmap for the webpage). For example, if users tend to interact with content placed at the upper center of the webpage (e.g., as indicated by heatmap), the anchor may be placed at the upper center of the webpage.

A webpage may be classified based on one or more criteria (e.g., is the webpage text or image heavy, the page sentiment, the intention of page, amount of visitor traffic, which area of the conversion funnel it lands in, the amount of white space, and/or the like). For example, the page may be classified or scored based on the percentage of the page taken up by images or the percentage of the page taken up by text. Such webpage classification may be utilized to determine the type of anchor that is to be automatically placed or recommended to be placed on the webpage. For example, if the webpage is classified as a primarily text page, text highlighting/underlining may be utilized to indicate the presence of an available moment. If, on the other hand, the webpage is classified as a primarily image page, a graphical anchor (e.g., an image and/or icon) may be utilized to indicate the presence of an available moment.

For example, to determine what percentage of a webpage is text and what percentage is images, the webpage's HTML and CSS content may be analyzed. The text elements on the page (e.g., paragraphs, headings, lists, and/or the like) may be determined by extracting the text content from relevant HTML tags (e.g., <p>, <h1> to <h6>, <li>, etc.). The total number of characters and/or words in these text elements may be counted. The image elements may be determined by locating corresponding HTML tags, such as <img> tags and/or by locating background images defined in CSS. The space occupied by the located images may be determined by calculating their pixel dimensions (width×height) or their rendered size on the page. The total area of images may be compared to the total content area of the webpage. The ratio of text content (e.g., in terms of characters or rendered size) and image content (based on pixel dimensions or rendered space) to the total content may be determined and optionally multiplied by 100 to determine the percentage.

FIG. 32N illustrates an example webpage with an automatically placed anchor with suggested content that a user can select to associate with the moment anchor, where the content may have been identified as being relevant to the webpage using one or more techniques disclosed herein.

Optionally, if the user accesses a moment (e.g., views a moment video associated with an anchor), and then takes a certain action (e.g., make an associated purchase of a product or service, or other conversion), a record may be made of such a sequence, and a record of the association of the moment and the conversion so that the moment receives credit for such conversion. FIG. 32O illustrates an example shoppable moment for a hotel reservation. If the user activates the shop indicator (which may be in the form of an anchor) and makes the acquisition (e.g., makes a reservation for a room) a record may be made that the acquisition was made after passing through the moment, and hence the acquisition may be attributed to the moment.

As discussed above, technological techniques are provided for the automated identification of moment content relevant to a corresponding website, webpage, and/or webpage element. Optionally, in addition to or instead of the previous factors (wherein keywords and/or summaries of a webpage are used to find relevant content) certain goals may be utilized in selecting content and determining the placement of anchors.

For example, the goals may relate to increasing the chances that users will take a desired action. An example goal may relate enhancing engagement with a certain webpage, webpage element, and/or moment, and increasing a certain rate of conversions (e.g., where a goal may relate to “increase engagement and conversion in wedding bookings”).

Depending on the goal, a learning engine may access website content to identify relevant webpages and relevant webpage elements with respect to the input goal. By way of illustrative example, if the goal is “increase engagement and conversion in wedding bookings”, webpages with images of weddings or text that includes the phrase “wedding” may be identified, and the element may be identified which includes the image of the wedding or the text that includes the phrase “wedding”.

Content relevant to the identified webpage(s)/webpage element(s) and/or goal may be identified using techniques described herein (e.g., by comparing meta associated with the content or based on the subject matter of the content with generated summaries and keywords for the identified webpages). The corresponding webpage may be classified (e.g., as being primarily images or primarily text), and based on the classification, a determination may be made as to whether to use text emphasis or a separate anchor to indicate the availability of a moment. In addition, an approximate placement of the anchor/highlighting relative to the identified text or image element may be made.

User interactions with anchors/highlights of different anchor/highlight stylings may be accessed from memory, and the better performing styles (e.g., the best 3, 5, 7 or other number, and/or top performing) may be identified (e.g., based the average percentage of visitors to the webpage that interacted with the corresponding anchor). The best performing style may then be selected for the corresponding anchor/highlighting styling.

Using the selected styling, the anchor/highlighting and the corresponding moment may then be placed.

Optionally, the selected webpage, selected element, the selection of anchor vs. highlighting (e.g., underlining), selected style, and/or placement may be presented to an authorized user for approval via a corresponding user interface. The authorized user may approve or disapprove any of the foregoing. Optionally, the user may be presented with user-selectable options regarding which moment content, webpage, element, styling, and/or placement. The authorized user's option selections may be received, stored, and used.

The performance of the anchor/highlighting and the corresponding generated moments may then be compared against the goal, and a comparison/deviation of the actual performance and the goal may be generated and transmitted to one or more designated destinations (e.g., the entity that set the goal.

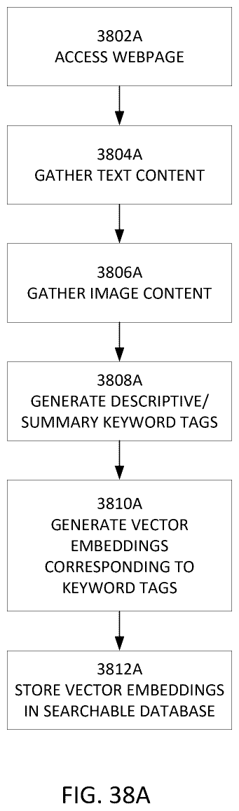

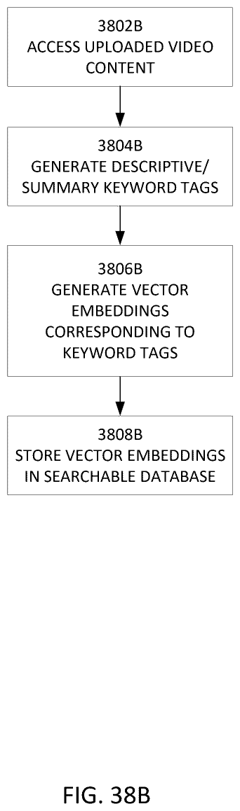

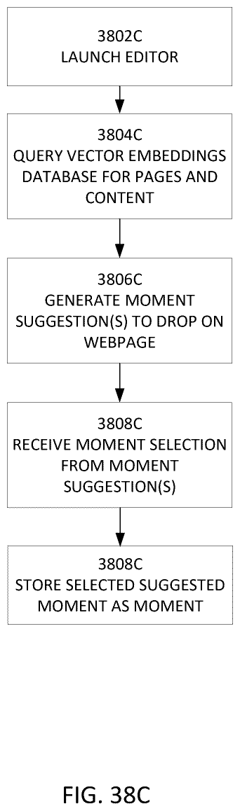

An aspect of the present disclosure relates to a digital directory. A mobile-optimized website may be generated and hosted by the system disclosed herein (the multimedia communication server system). The system may scrape still images and video images from a target website (e.g., using techniques described with respect to FIG. 38A), restructure/reskin the images, and autogenerate pages to provide a directory of images and/or text corresponding to aspects of the website. For example, if the website is for a resort, the images may comprise views of different aspects of a resort property, such as pools, spa, restaurants, golf courses, and/or the like.

Optionally, a given directory may be customized for a particular user (e.g., a guest or prospective guest at the resort) using user information, such as that discussed elsewhere herein with respect to paths (e.g., age, number of people in the user's party, the age of people in the user's party, income, previous activities the user has participated in (and any user feedback provided), personal preferences, and/or the like). The user information may include information expressly provided by the user (e.g., to populate a user profile and/or in making a reservation), historical information accessed from memory (e.g., from the booking system) associated with the website, and/or accessed from a third party site. For example, the user profile may include interests (e.g., adventure, relaxation, culinary experiences, golf, tennis, skiing, boating, etc.), preferred activities (e.g., hiking, spa treatments, dining, concerts, movies, and/or the like), and/or special requests (e.g., dietary restrictions, mobility needs, and/or the like). The selected content may also be based on the characteristics of the resort (e.g., is it romantic, is it child friendly, it is at a beach location, it is at a mount location, etc.). The images may be selected based at least in part on the season and/or anticipated weather anticipated during the user's stay at the resort (e.g., if the reservation is being made in the summer for a stay in December, images of the resort in the winter with snow may be selected).

Optionally, edit controls may be provided enabling the generated directory site to be edited (e.g., delete images, rearrange images, add images, and/or the like). By way of further example, edit controls may be provided to enable an authorized user to edit/alter existing elements on website (e.g., upload and overlay audio content on an existing image div, create a multi-image experience using still and/or video images on a single image div, and/or the like).

Optionally, a given div (e.g., comprising one or images and/or text) may be dynamically modified based on detected user inputs. For example, a user may indicate that a resort stay is for business. In response, a given directory div may be modified to exclude resort sporting activities, but to include images of the resort business center. By way of further example, in response to the user indicating that the stay will be scheduled for the summertime, images of snow and winter sports may be removed from the directory, and images of summer sports and lounging at a pool may be added.

FIG. 32P illustrates an example of directories (including an itinerary). A given directory may include filter controls via which the user can instruct that only images corresponding to the filter be displayed (e.g., room tour, amenities, food, wedding, pool, etc.). The images may accordingly be filtered and presented to the user.

An aspect of the present disclosure relates to the generation of electronic postcards on behalf of guests at a hotel or restaurant which they can share (e.g., via a messaging service, email, and/or otherwise). A link may be automatically included in the postcard that, when activated by a user, will cause the user's browser to be automatically navigated to a corresponding website/webpage (e.g., associated with the hotel or restaurant). For example, the postcard may include images or other content corresponding to activities the user engaged in (images of the pool, images of the restaurant, images of a menu, images of food, images of spa treatments, and/or the like). Optionally, the images can be images provided by the hotel or restaurant (e.g., professionally captured images). Optionally, personalized, customized, suggestions of content to be included in the postcard may be automatically generated and provided to the guest (e.g., based on the segment the guest belongs to, the guest's profile, activities the guest participated in, and/or the like). Optionally, artificial intelligence may be utilized to generate images for the guest based on the activities the guest participated in.

An aspect of the present disclosure relates to A/B testing of various content, content placement, anchor placement, video performance within a moment, moment styles (e.g., length of a moment video), types of moment, word highlighting, and/or the like.

A/B testing is a method used to compare two or more versions of a design to determine which one performs better for a specific goal, such as increasing user engagement, click-through rates (CTR), or conversions. An adjective may be defined with respect to the test goals (e.g., improving conversion rates, reducing bounce rates, increasing clicks on a specific button, increasing views of a particular item of content, and/or the like). Performance metrics may be selected based on the goals (e.g., the number of successful form submissions, the number of reservations, the number of views, the number of button activations, and/or the like).

Two or more variants of a webpage or website may be created. For example, one variant may be a baseline version, and another variant may be modified with one or more design changes (e.g., different content, different anchor placement, different video lengths, different moment types, different text highlighting, and/or the like).

Different visitors are shown different versions and their interactions with the respective versions may be monitored and the results reported. Visitors may be randomly assigned to one of the versions to avoid bias and to ensure the test results are more reliable and not skewed by external factors.

Once a threshold amount of data has been collected, statistical analysis may be utilized to determine if the difference in the monitored visitor interactions between different versions is significant or just due to random chance. For example, did more users complete the desired action (e.g., signing up, purchasing); did users click more frequently on specific buttons or links, did the design keep users engaged for longer, did fewer users leave the site after visiting just one page and/or the like.

Based on the analysis, a determination may be made as to which version performed better, and the best performing one may be selected and made available to all users.

Certain example processes of foregoing technological features will now be described. Such processes may be executed in whole or in part by the disclosed systems and/or devices and combinations thereof.

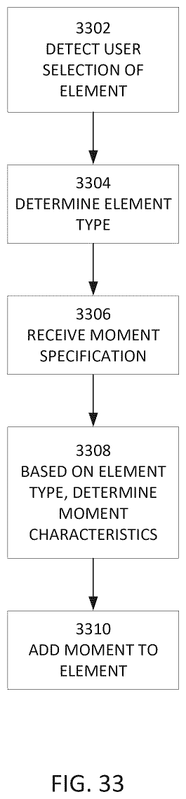

FIG. 33 illustrates an example process of adding a moment (e.g., an anchor) to a webpage element. At block 3302, a user selection of a webpage element is detected. As similarly described elsewhere herein, an element may comprise an image or text. For example, JavaScript and the Document Object Model (DOM) may be used to detect the selection of a webpage element (e.g., by listening for a click event). At block 3304, the type of element selected may be determined (e.g., using the event.target property of an event object, which refers to the exact DOM element that triggered the event (such as a click); based on the element tag name, attributes, and/or class names; using the nodeName property; and/or the like).

At block 3306, the user specification for the moment is received over a network from a user interface or accessed from memory. For example, the moment specification may specify the anchor type, shape, size, color, and/or the like. At block 3308 a mapping of element type to moment (e.g., anchor) characteristics may be accessed from memory or otherwise. The mapping may specify such characteristics as anchor drop placement (e.g., to the left, right, above, below, at a specified offset from the element), size (e.g., font size, pixel height and width, etc.), shape (e.g., circular, square, rectangular, triangular, etc.), and/or alignment (e.g., where the anchor may be automatically aligned vertically or horizontally with the element, such as a button element). At block 3310, the moment anchor may then be automatically presented in real time (e.g., as a preview) in accordance with such mapped presentation characteristics. Controls may be presented to the user enabling the user to approve, modify, or reject one or more of the moment anchor characteristics via corresponding controls.

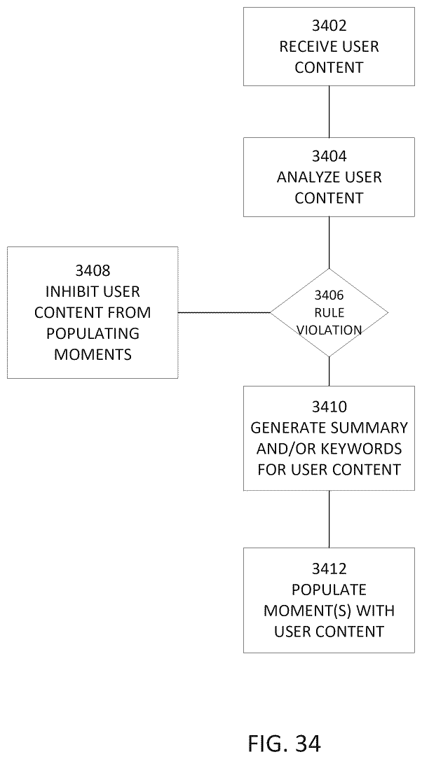

FIG. 34 illustrates an example process for receiving, analyzing, and utilizing user-submitted content (e.g., content provided by a purchaser or user of a product or service, such as a hotel or restaurant guest). At block 3402, a user interface (such as that illustrated in FIG. 34) is provided to a user device via which the user can upload or provide a link to content, such as image content (e.g., still or video images). The images may be uploaded from the user's device or from a system remote from the user device.

At block 3404, the uploaded images may be analyzed using a model, such as a CNN-based learning model, to determine, at block 3406, whether the images contain prohibited subject matter that violate a content rule, such as violent or sexually explicit subject matter. If an image is determined to include prohibited subject matter that violates the content rule, at block 3408, the image may be filtered out so that it is not stored in a library of content that is usable in moments (although it may be stored in a separate archive) and is inhibited from being used to populate moments. Such analysis may similarly be applied by the process illustrated in FIG. 38A.

A deep learning network, such as a CNN, may be trained on large datasets of labeled images to recognize and classify images into various categories, such as violence, nudity, or explicit content. In particular, a CNN model may be employed to learn features from these images, such as objects, patterns, colors, textures, and relationships between objects. Once trained, the model can analyze a new image and predict the probability of it belonging to a certain class (e.g., whether it contains violent or sexually explicit content).

Optionally, an object detection model may be utilized to detect specific objects within an image, such as weapons, blood, or adult content and to provide bounding boxes around them. For example, object detector models, such as like YOLO (You Only Look Once) that provides real-time object detection, or Faster R-CNN (a region-based object detector that can be used for more accurate detection at the expense of speed), may be trained to detect objects associated with violent or explicit behavior, such as guns, knives, blood, or explicit body parts. When an image is analyzed, the object detection model may output bounding boxes for detected objects and generate associated confidence scores. If prohibited objects are detected with a confidence score greater than a specified threshold, the image may be flagged for review or inhibited from being used.

Optionally, models may be trained to understand the overall context and composition of the image. Semantic segmentation may be used to analyze a given pixel in an image and label it as part of a specific category (e.g., skin, weapons, etc.). For example, semantic segmentation models, such as UNet or Mask R-CNN, may be used to segment the image into meaningful parts (such as human skin, objects, backgrounds). Using contextual clues, such as a high proportion of skin detection or a specific arrangement of objects, the system can assess whether an image is inappropriate, and classify the image accordingly.

If a given user-provided image does not include prohibited subject matter it may be analyzed to generate, at block 3410, a summary of the image subject matter and/or keywords corresponding to the image (e.g., using summary generation and/or keyword generation techniques described herein). The summary and/or keywords may be compared to corresponding summaries and keywords (or other tags) of moments, and if there is a match, the user-provided content (e.g., still or video images) may be used, at block 3412, to populate the moment.

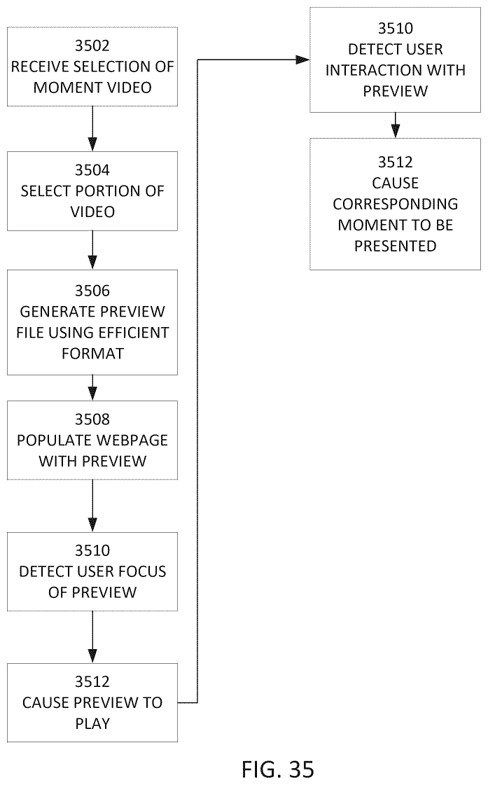

FIG. 35 illustrates an example process for generating a preview video that is more compact, utilizes less network bandwidth, and loads quicker than a full, high resolution video in a less efficient format. At block 3502, a moment video may be selected (e.g., by a user via a user interface or by an automated program). The moment video may be in a first format (e.g., MP4). At block 3504, one or more portions of the selected video may then be selected to be used to generate the video. For example, an initial portion, a middle portion, and/or an end portion of the video may be selected. Optionally, a portion of the video may be randomly selected. For example, a given portion may be 3 seconds, 5 seconds, 7 seconds, or 10 seconds long. At block 3506, the selected video portion(s) may be converted to a more compact, compressed preview version, such as a GIF as described elsewhere herein. At block 3508, a webpage may be populated using the preview video. For example, a button or anchor may be populated with the preview.

At block 3510, the webpage may be rendered by a browser on a user device, and the user's interaction with the webpage may be monitored, where the webpage may comprise a still image corresponding to the preview (e.g., the first frame of the preview). If it is detected that the user is focused on the preview (e.g., by hovering over the preview with a cursor or pointing device or by clicking on the preview image), at block 3512, the preview may begin playing. Optionally instead, the preview may begin playback upon loading. At block 3510, if it is detected that the user has interacted with the preview (e.g., by clicking on the preview or an adjacent link), at block 3512, the corresponding moment is displayed on the user device.

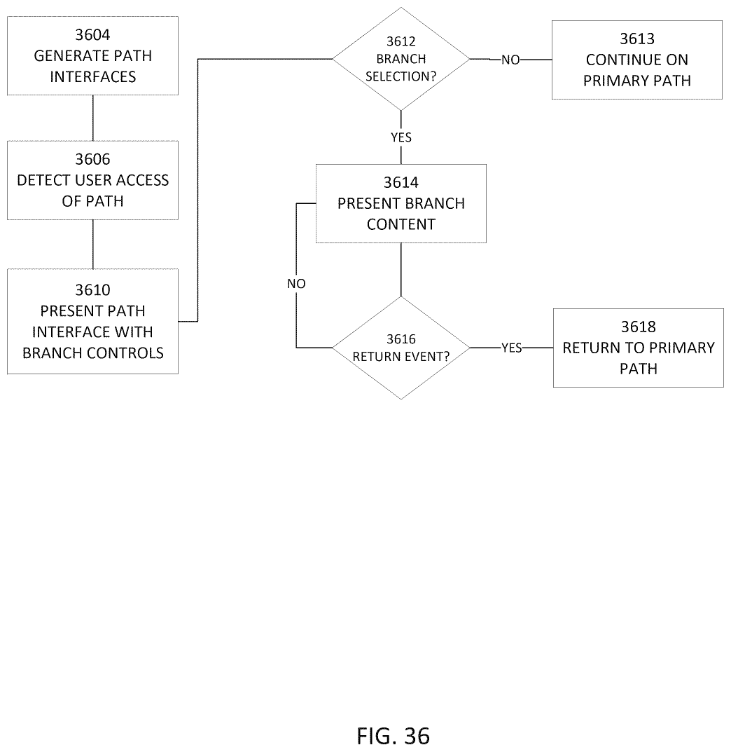

FIG. 36 illustrates an example process for generating and utilizing a path, comprising a primary sequence and branches. At block 3604, a path may be defined, and path interfaces may be generated that enable a user to select branches off the primary sequence. As similarly discussed elsewhere herein, a path designer may design a path (a primary sequence) through a series of user interfaces (e.g., screens comprising text content, image content, previews, moments, and/or the like). The path designer may specify branches that may be selected by a user via a branch control that will result in different user interfaces/content being presented to the user (e.g., another part of a page, an email/phone number capture user interface, videos, previews, other content described herein, and/or the like).

To manage the path, including the branch content, unique IDs or tags may be assigned to each branch (e.g., branch user interface/item of content). Branch controls, such as buttons, links, video previews/buttons, call to action cards (e.g., comprising an image, text, and/or instructions to the user to take a certain action), and/or other controls may be provided that correspond to an optional branch, wherein activation of such control (e.g., by clicking or hovering on the control) will navigate the user browser to the corresponding branch.

At block 3606, a user may access the path (e.g., via a website associated with an entity, such as a hotel) via a user device. As the user is navigated through the path, at block 3610, a given path user interface presented to the user via the user device may include one or more branch controls. At block 3612, a determination is made as to whether the user activated a branch control to select a branch. If the user did not select the branch control, at block 3613, the user will continue to be navigated through the primary sequence (e.g., if the user does not select the branch control within a specified period of time, in which case the branch control may optionally be removed from the display). If the user did select the branch control, the process may proceed to block 3614, and the corresponding branch user interface and content may be presented to the user.

At block 3616, a determination is made whether a return event has occurred. For example, once the branch content is viewed the user may be navigated back to the primary sequence at the point the user has previously entered the branch. If a return event has occurred, at block 3618, the user may be navigated back to the primary sequence. Otherwise, the user may continue navigating and/or viewing and interacting with content on the branch.

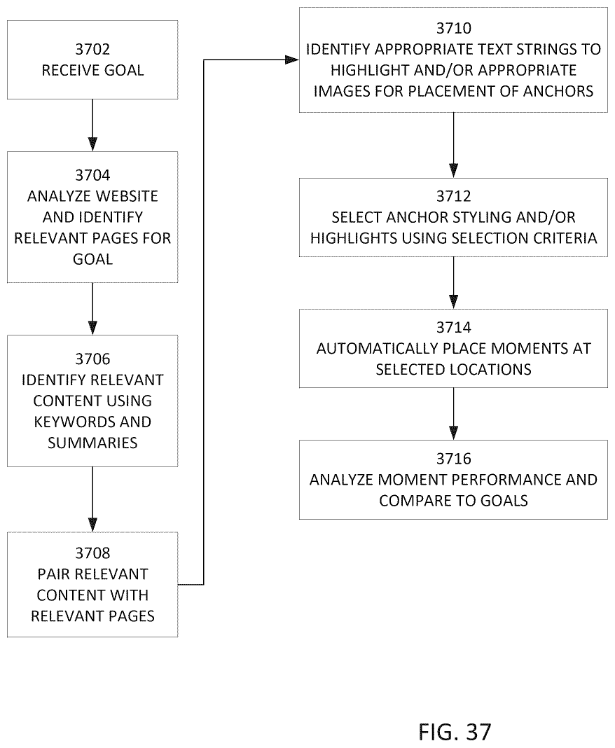

FIG. 37 illustrates an example process of automatically generating and placing moments so as to achieve a goal.

At block 3702, one or more goals may be received from a user acting as a goal specifier. As similarly discussed elsewhere herein, an example goal may relate enhancing user engagement with a certain webpage, webpage element, and/or moment, and/or increasing a certain rate of conversions (e.g., where a goal may relate to “increase engagement and conversion in wedding bookings”). The goals may be received from the specifying user via a user interface. The user interface may enable the specifying user to specify the goal(s) via free form text and/or via menu selections.

Optionally, an automated program (e.g., a wizard) may guide the user in specifying goals in distinct acts. As discussed elsewhere herein, the goals may include different types of goals. Certain goals may comprise conversion goals focused on actions such as form submissions, purchases, reservations, or signups. Certain goals may comprise engagement goals that track interactions with specific content, such as moments, playing videos, clicks on buttons, webpage scrolling, and/or the like. Certain goals may comprise behavioral goals, such as user behaviors (e.g., goals related to time spent on a page or the number of returning visitors).

A given goal type may be represented in the user interface by a corresponding icon and a brief description to clarify what the goal tracks. Once the goal type is chosen, the user can specify the details of the goal. Optionally, a field may be provided via which a user can name the goal (e.g., “Increase reservations during the spring”). An interface may be provided (e.g., menu or checkbox options) via which the user may specify what action will count as a conversion (e.g., “Button Click”, “Reservation Submission”, and/or the like). Optionally, the webpage may be presented at the same time as the goal specification user interface, enabling the user to point or click directly on the webpage (e.g., in a preview window) to select specific elements such buttons or forms, related to the goals.

Optionally, input fields may be provided via which the user can specify target numbers for the desired number of conversions (e.g., “40 reservations”).

By way of further example, with respect to specifying engagement goals, the user interface may enable the user to select webpage content to track engagement with, such as videos, images, or specific text sections (E.G., using a drag-and-drop selector or element highlighter). A menu may be provided via which a user may specify an engagement type to track (e.g., “play,” “clicks,” “hover,” “scroll,” or “time spent”) on specified elements.

By way of further example, with respect to specifying behavioral goals, the user interface may enable the user to specify (e.g., via a slider or input field) the desired minimum time a user should spend on a page (e.g., “at least 30 seconds”). By way of further example, a user interface (e.g., a slider or menu) may enable the user to specify a page scroll depth (e.g., the percentage of the page to be scrolled (e.g., 50%, 100%)).

Optionally, the user interface enables the user to specify the conditions under which a given goal should be tracked. Optionally, the user interface may enable the user to specify the target audience for a goal, such as, all visitors; new, first time visitors; returning visitors who have previously visited the site or page; visitors from specific geographies or using specific device types (e.g., mobile, desktop, and/or the like).

At block 3704, a learning engine may access website content to identify relevant webpages and relevant webpage elements with respect to the input goal. By way of illustrative example, if the goal is “increase engagement and conversion in wedding bookings”, webpages with images of weddings or text that includes the phrase “wedding” may be identified, and the element may be identified which includes the image of the wedding or the text that includes the phrase “wedding”. The corresponding webpage may be classified (e.g., as being primarily images or primarily text), and based on the classification, a determination may be made as to whether to use text emphasis or a separate anchor to indicate the availability of a moment. In addition, an approximate placement of the anchor/highlighting relative to the identified text or image element may be made.

At block 3706, content (e.g., for a moment) relevant to the identified webpage(s)/webpage element(s) and/or goal may be identified using techniques described herein (e.g., by comparing meta, such as keywords and/or summaries, associated with the content or based on the subject matter of the content with generated summaries and keywords for the identified webpages). The content may comprise image and/or text content. At block 3708, matching content may be paired with the corresponding webpage.

At block 3710, appropriate placement of anchors (e.g., images, icons, text emphasis/underlining, pins, and/or the like) may be determined. For example, the default placement for a given anchor-type or moment type may be utilized. At block 3712, anchor/highlighting styles may be determined (e.g., size, shape, color, and/or icon representation). For example, a best performing style for a given website subject matter (e.g., hotel, restaurant, clothing retailer, etc.) may be determined based on historical user-interaction data, and may be selected for the anchor/highlighting. The historical data may indicate which style best achieved similar goals as currently specified.

At block 3714, using the selected styling, the anchor/highlighting and the corresponding moment may then be placed. At block 3716, the performance of the anchor/highlighting and the corresponding generated moments may then be compared against the goal, and a comparison/deviation of the actual performance and the goal may be generated and transmitted to one or more designated destinations (e.g., the entity that set the goal). Optionally, real-time feedback on how the goal is performing may be provided via a goal analytics dashboard. For example, the dashboard may display metrics related to the goal, such as conversion rate, click-through rate, or interaction time. Graphs may be generated that display trends over time, showing how the goal is progressing over one or more periods of time (e.g., hourly, daily, weekly, monthly, and/or other time period). If the goal is audience-specific, the dashboard may indicate how different visitor segments (e.g., new vs. returning visitors) are interacting with the page and the element and anchors thereon.

An aspect of the present disclosure relates to adding a new user experience to an existing element on a user interface, such as a user interface presented by a webpage. For example, image panning, image zooming, and video playback may be added to an existing webpage element. Optionally, a moment (e.g., a video, still image, text, and/or other content type) may be added to a webpage using a <div> element, where the <div> acts as a container, and the content may be directly included or styled as a background. For an image, the background-image CSS property may be applied to the <div> by specifying the image's URL (e.g., background-image: url(‘image.jpg’);). Additional properties such as background-size, background-position, and background-repeat may be utilized to control how the image is displayed within the <div>. Optionally, an image may be added inside the <div> as an <img> tag, enabling the image to scale and flow naturally within the container. For videos, the <div> may include a <video> tag, where the src attribute may be utilized to specify the video file, and attributes such as controls, autoplay, and/or loop. CSS may optionally be used to style the <div> or the <video> tag itself, controlling aspects such as size, alignment, and/or responsiveness.

By way of illustration, to add a pan and zoom effect to an image on a webpage, a CSS (Cascading Style Sheet) may be utilized for styling and JavaScript may be utilized for interactivity. The image may be placed inside a container that hides content overflowing its boundaries. CSS may be utilized to apply a transition effect to the image, enabling smooth zooming when a user interacts with the image, such as by hovering over the image with a cursor or pointing device, or by clicking on the image. Optionally, zooming may be implemented using mouse wheel events or pinch gestures on touch devices (e.g., a track pad), where the image may be scaled proportionally while maintaining the image's aspect ratio. To provide panning functionality, JavaScript may be utilized to track the user's pointer movements (e.g., mouse movements or touch gestures) and dynamically adjust the position of the image within the container.

By way of further example, the new, added experience, may comprise video playback, the animation of a still image (e.g., move, rotate, scale, fade, parallax scroll, morph shapes, and/or the like), and/or the presentation of a gallery of still images and/or video images. By way of illustration, the gallery may be populated by comparing tags of images from an image library with keywords (e.g., selected as described elsewhere herein) associated with a webpage or content thereon, and add one or more of the closest matching images to the gallery. Optionally, the images may be presented in the gallery as thumbnails. The gallery may be a user-navigable gallery, wherein the user can browse amongst the images, sequence through the images, place the images in expanded or full screen mode (e.g., by clicking on the image or activating a full screen control), and/or play videos.

Optionally, the added experience may comprise audio content, such as the playback of music or sounds. By way of illustration, the audio content may be selected by comparing tags of audio content from an audio content library with keywords (e.g., selected as described elsewhere herein) associated with a webpage or content thereon, and selecting the closest matching audio content for playback.

By way of further example, the new, added experience, may comprise user and/or professional reviews relevant to the webpage or content thereon. By way of illustration, the professional reviews may be selected by comparing tags or text of reviews from a review database with keywords (e.g., selected as described elsewhere herein) associated with a webpage or content thereon, and add one or more of the closest matching reviews to the webpage. The user may then scroll through and read the reviews.

By way of further example, the new, added experience, may comprise the addition of relevant stories or pathways, which may be selected or generated based on keywords (e.g., selected as described elsewhere herein).

An aspect of the present disclosure relates to enabling the scheduling of moments and scheduling changes to moments. For example, a user interface may be provided enabling a user to schedule moments and changes to moments (such as call to actions, images, text, graphics, and/or the like). By way of illustration, the user interface may enable a user to specify a date/time when a moment (and associated anchor) is to go live on a webpage or website and when the moment is to be no longer available on the webpage. By way of further example, the user interface may enable the user to schedule the date/time of changes to a moment. Such changes may include changes in: moment content, moment colors, moment call to action language, and/or moment placement. Optionally, a call to action may be associated, via a user interface, with an existing image of content on a webpage.

Certain aspects will now be described with reference to the figures.

Referring now to FIG. 38A, an example webpage keywording process is illustrated. At block 3802A, a browser may access a webpage served by a web server. At block 3804A, text from the webpage may be accessed. For example, text may be scrapped from the webpage, wherein an HTTP request may be sent to the webpage's URL to retrieve the raw HTML content. Once the HTML is obtained, a parsing library may be utilized to navigate and extract specific elements of the HTML structure. For example, HTML includes various tags such as <p> for paragraphs, <h1> to <h6> for headers, and <div> or <span> for container elements, which can be targeted based on attributes such as class or id to locate the desired text. Scraping may also comprise handling dynamic content loaded by JavaScript, using tools to simulate a browser environment and to execute scripts. The extracted text is optionally cleaned and processed to remove unwanted HTML tags, scripts, and/or advertisements before being stored or analyzed as described elsewhere herein.

At block 3806A, images from the webpage may be accessed. Scraping images from the webpage may involve identifying (e.g., via <img> tags, which may contain the src attribute that specifies the image's URL) and downloading image files embedded in the webpage's HTML structure. The images may be stored and analyzed.

At block 3808A, descriptive/summary tags may be selected for the webpage. As similarly discussed elsewhere herein, optionally, a summary may be automatically generated, and keywords may be automatically selected related to the webpage content. Keyword generation may utilize one or more techniques, such as those described herein (TF-IDF, NER, LDA, synonym detection, and/or the like). An LLM may be configured to evaluate the content and relevance of words in generating a summary and/or in determining keywords (e.g., based on user intent or target audience). Keyword weighting may be utilized as described elsewhere herein and may be utilized to rank the keywords.

As described elsewhere herein, images may be analyzed in generating a webpage and/or website summary and in identifying keywords. For example, an image may be processed (e.g., resized and/or normalized) and transformed into a numerical representation (a tensor) suitable for an LLM model to work with. Object detection models (e.g., YOLO, Faster R-CNN, and/or the like) may be utilized to extract the image's key features and to classify the objects. The model may assign labels such as “plate,” “bed,” “surfboard,” etc., based on the objects it detects. Models such as ViTs or CNNs may be utilized to grasp the broader context of an image. Models trained to recognize entire scenes by detecting common patterns in landscapes and other background elements may be utilized to analyze images and in labeling content.

Based on the classification, the learning model may generate keywords by mapping the objects and features detected in the image to relevant labels. For example, an image with a wine glass on a table may cause the model to generate keywords such as “wine glass,” “wine,” “furniture,” and/or “restaurant.”

The model may assign a confidence score to a given keyword based on how certain it is about the presence of specific objects or contexts in the image. Optionally, if the confidence score is less than a certain threshold, the corresponding keyword is not utilized as a keyword, while if the confidence score satisfies the threshold, the corresponding keyword is used as a keyword.

At block 3810A vector embeddings may be generated corresponding to the keyword tags. Generating vector embeddings from keywords used to describe webpage content may comprise transforming textual data into numerical representations that capture semantic meaning. Preprocessing may optionally be performed on the keywords, comprising tokenization (e.g., splitting phrases into individual words), normalization (converting text to lowercase and removing punctuation), and/or stemming/lemmatization to reduce words to their base forms. An embedding model may then be used to convert the keywords into dense vectors. For example, word-level embeddings may be generated, which can be aggregated (e.g., by averaging) to represent the entire keyword set. Optionally, models such as BERT, Sentence-BERT, or the Universal Sentence Encoder may be used to directly process phrases or lists of keywords to create contextualized embeddings for the entire set. These vector embeddings may be used to encapsulate semantic relationships between words, making them usable for tasks such as search relevance, classification, and/or clustering. By leveraging embeddings, keywords describing webpage content can be represented in a machine-readable format that is useful for matching moment content to the webpages, generating summaries, and for other processes.

At block 3812A, the vector embeddings may be stored in a searchable database, optionally in association with the webpage content used to generate the vector embedding, for later use (e.g., to automatically find other relevant content by finding matching vector embeddings, to be displayed on or accessed via a webpage as a moment). For example, vector searching may be performed to find semantically similar matching words with respect to webpage content and content to be used as a moment interactive element (e.g., an interactive element that presents a user with text and/or video content, such as described elsewhere herein). Such content may comprise images, text, audio, a call to action, and/or the like. A corresponding anchor may be automatically or manually placed on the webpage in association with the relevant text or image as discussed elsewhere herein. By way of further example, the data scraped from the website may be utilized and/or the keywords may be utilized to determine where to place an anchor/moment.

FIG. 38B illustrates an example content keywording process for content provided by a user (e.g., an administrator/designer). At block 3802B, a user uploads content, such as video content that may be utilized in a moment. For example, an upload user interface may be provided via which a user can insert a link to content to be uploaded, drag or drop the content into a drop field, or navigate to and select the content to be uploaded.

At block 3804B, as described elsewhere herein, images may be analyzed in generating a webpage and/or website summary and in identifying keywords. For example, the image may be processed (e.g., resized and/or normalized) and transformed into a numerical representation (a tensor) that an LLM model can work with. Object detection models (e.g., YOLO, Faster R-CNN, and/or the like) may be utilized to extract the image's key features and to classify the objects. The model may assign identifying descriptive labels such as “pool,” “bed,” “skis,” etc., based on the objects it detects. Models such as ViTs or CNNs may be utilized to grasp the broader context of an image. Models trained to recognize entire scenes by detecting common patterns in landscapes and other background elements may be utilized to analyze images and in labeling content.

Based on the classification, the learning model may generate keywords by mapping the objects and features detected in the image to relevant labels. For example, an image of a person on skis may generate keywords such as “skis,” “skier,” “person,” or “skiing.”

The model may assign a confidence score to a given keyword based on how certain it is about the presence of specific objects or contexts in the image. Optionally, if the confidence score is less than a certain threshold, the corresponding keyword is not utilized as a keyword, while if the confidence score satisfies the threshold, the corresponding keyword is used as a keyword.

At block 3806B vector embeddings may be generated corresponding to the keyword tags. As similarly described elsewhere herein, generating vector embeddings from keywords used to describe the uploaded content may comprise transforming textual data into numerical representations that capture semantic meaning. Preprocessing may be performed on the keywords, comprising tokenization, and/or stemming/lemmatization. An embedding model may then be used to convert the keywords into dense vectors. For example, word-level embeddings may be generated, which can be aggregated (e.g., by averaging) to represent the entire keyword set. Optionally, models such as BERT, Sentence-BERT, or the Universal Sentence Encoder may be used to directly process phrases or lists of keywords to create contextualized embeddings for the entire set. These vector embeddings may be used to encapsulate semantic relationships between words, making them usable for tasks such as search relevance, classification, or clustering.

At block 3808B, the vector embeddings may be stored in a searchable database, optionally in association with the content used to generate the vector embedding, for later use. For example, a search may be performed to find uploaded content that is suitable for use in a moment to be displayed in conjunction with a webpage. By way of illustration, vector searching may be performed to find video content (e.g., the uploaded video content) with object similarity with respect to webpage content to be used as a moment. A corresponding anchor may be automatically placed on the webpage in association with the relevant uploaded content. By way of further example, the analysis of the uploaded video may be utilized and/or the keywords generated using the uploaded video may be utilized to determine where to place an anchor/moment.

In order to reduce the amount of computer resources needed to search for content to be used as a moment, a process may generate recommendations of content to be used as a moment. FIG. 38C illustrates an example process for generating suggestions for content to be used in a moment, such as a moment associated with a webpage.

At block 3802C, an editor is launched. The editor may be configured to create moments and/or to specify anchors (e.g., anchor style, anchor placement, etc.), such as described elsewhere herein. The editor may be provided via a browser or via a dedicated application. At block 3804C, a query may be submitted. The query may be generated in response to a user request provided via a user interface control (such as described elsewhere herein) that content suggestions be generated for a specified webpage, webpages, paths, or the like. The query may comprise keywords generated using the processes discussed above with respect to FIGS. 38A and 38B. The query may be for a specific item of webpage content. Optionally, the query may include location information (e.g., the geographic coordinates, the location type (e.g., beach, ski lodge, city name, etc.), or the like). Optionally, the user interface may comprise a search field via which the user may enter query text terms, and a search engine may then find content matching the query text terms.

The query may be submitted to a database storing the vector embeddings generated using the processes illustrated in FIGS. 38A and 38B.

At block 3806C, vector embeddings that match the query may be identified. The matches may optionally be ranked based on the relative closeness of the matches. The content corresponding to the matched vector embeddings may be accessed from memory. The matching content may be presented to the user as suggestions via a user interface in ranked order. The content suggestions may optionally be associated with a placement suggestion as to where to place the moment (e.g., an anchor corresponding to the moment).

At block 3808C, a user selection of suggested content for the moment is received via the user interface. For example, the selection may be provided by the user via a click action on the suggested moment content or via a control or checkbox associated with the suggested moment content. Optionally, using generated keywords or the vector embeddings for the webpage, the uploaded content, and/or other page information (e.g., the webpage color, the amount of text, the text font, the number of images, the size of images, the percentage of the webpage occupied images, and/or the like) suggestions may be generated for moment content placement and/or styling as similarly described elsewhere herein. Optionally, using generated keywords for the webpage, the uploaded content, and/or other page information, a learning model may be used to generate suggested calls to actions (e.g., call to action text, images, and/or audio track). Optionally, a call to action may be associated with an existing image of content on a webpage via a user interface.

At block 3808C, the user selection of the suggested moment content may be stored in memory in association with the webpage and/or the moment anchor and anchor position.

Certain example user interfaces will now be described. Suggestions for the anchor/moment content, anchor/moment placement, the anchor/moment styling, the call to action content, the call to action placement, and/or the call to action styling may be automatically generated using techniques described herein and displayed via respective user interfaces.

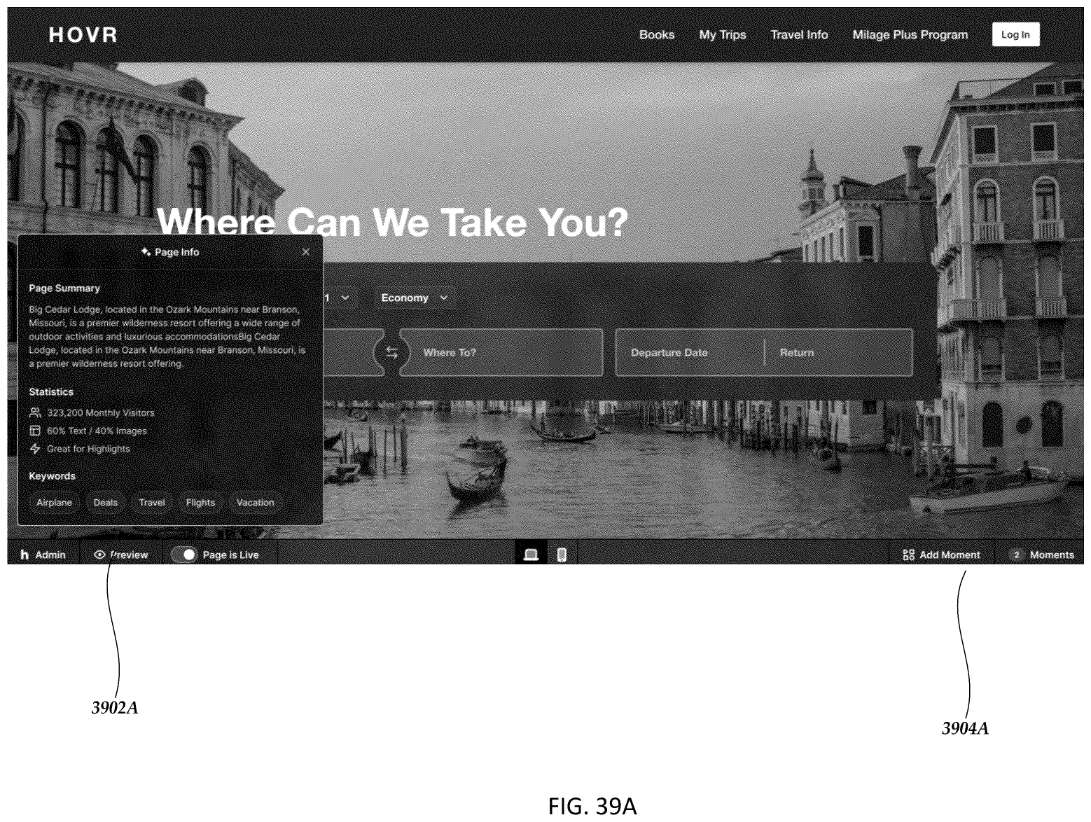

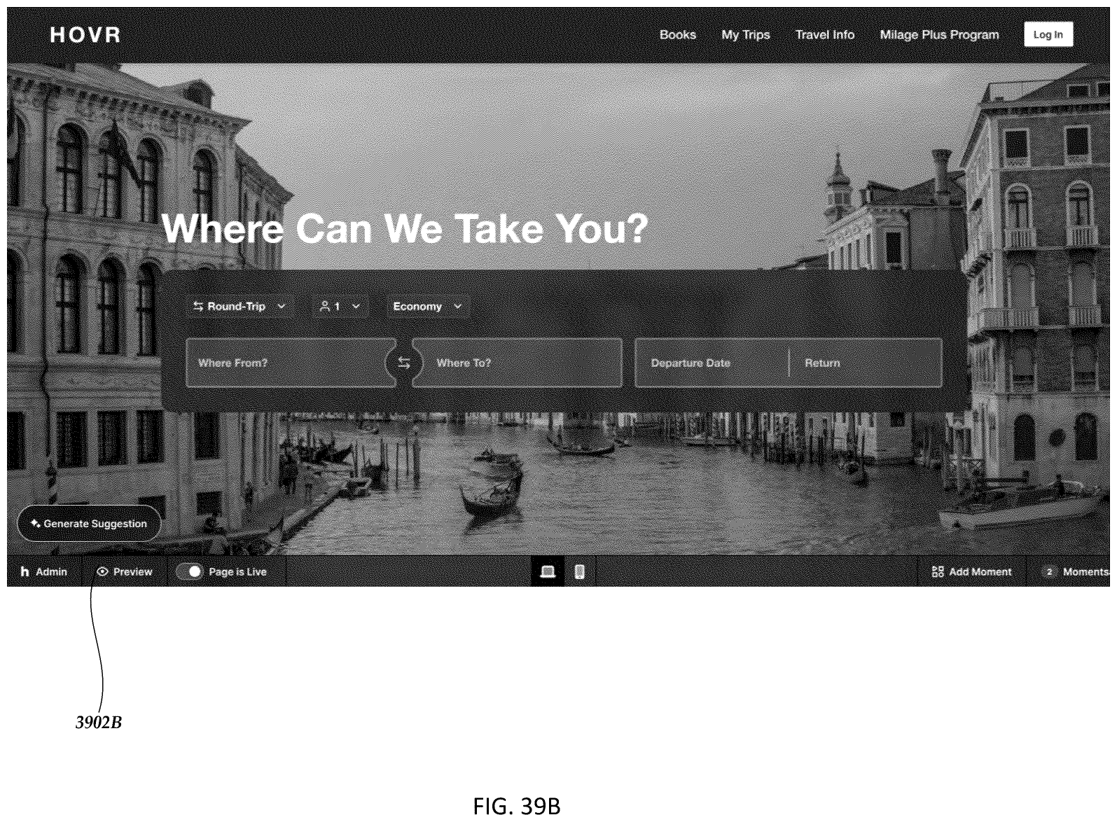

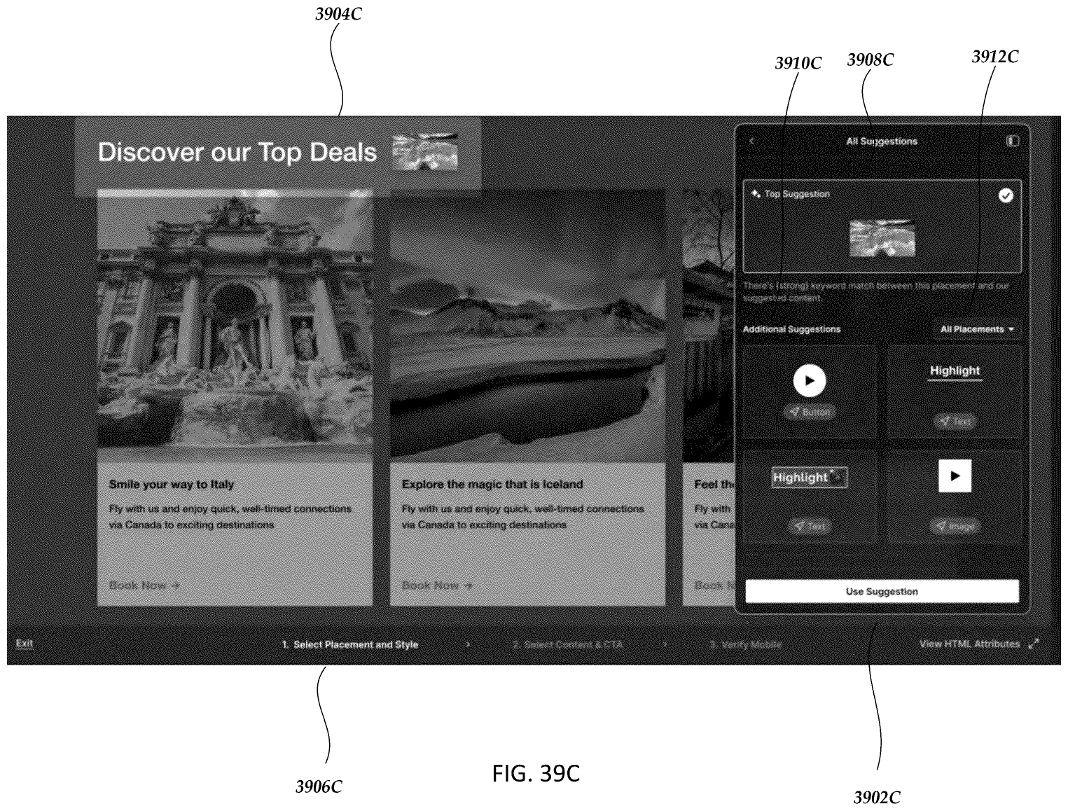

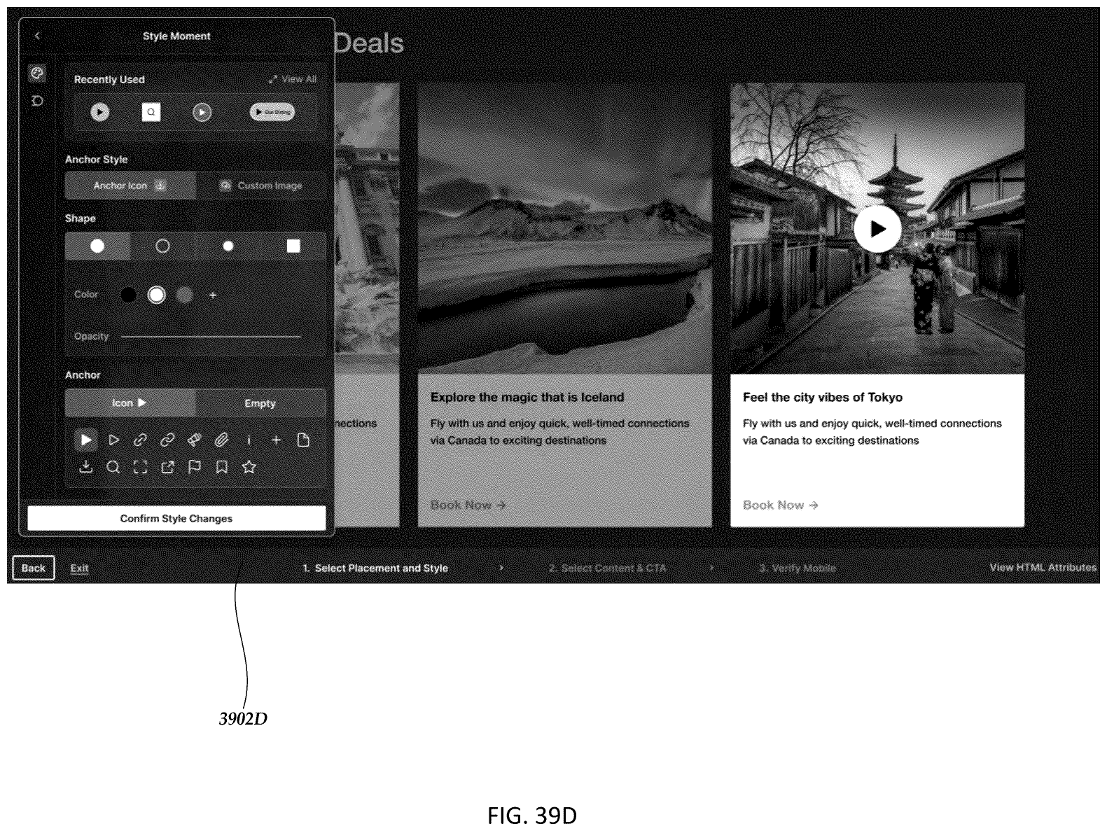

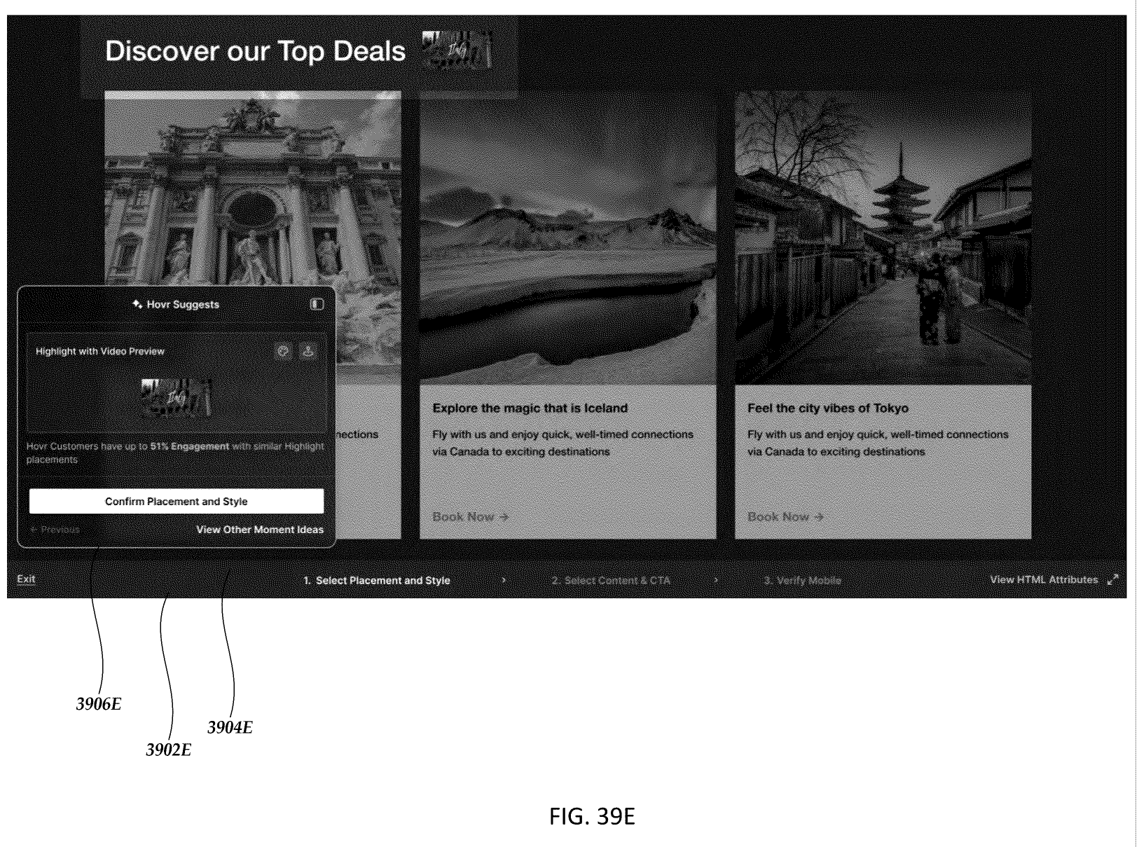

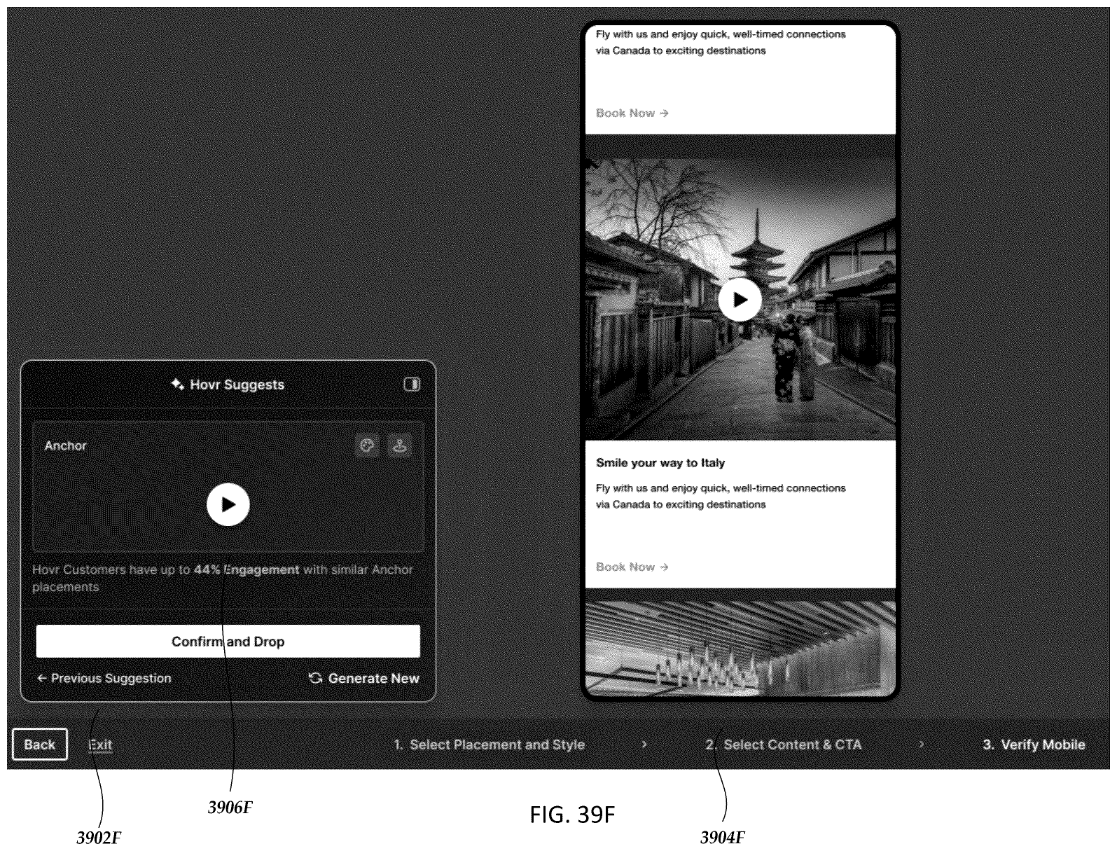

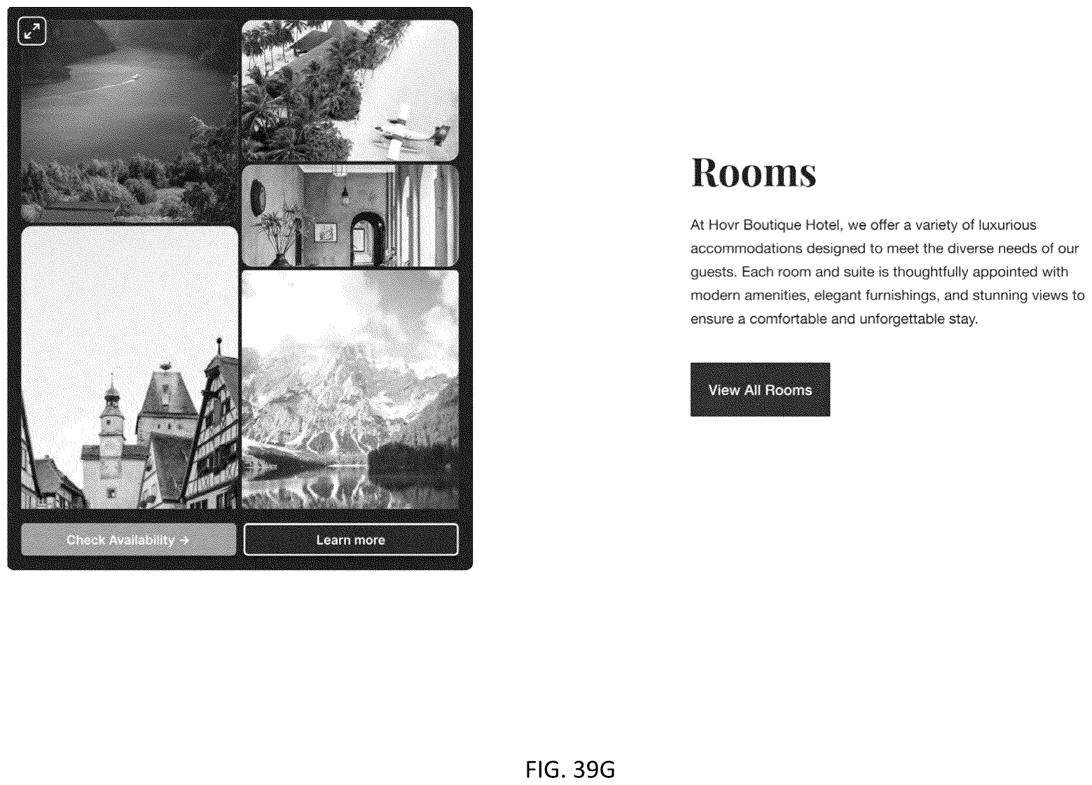

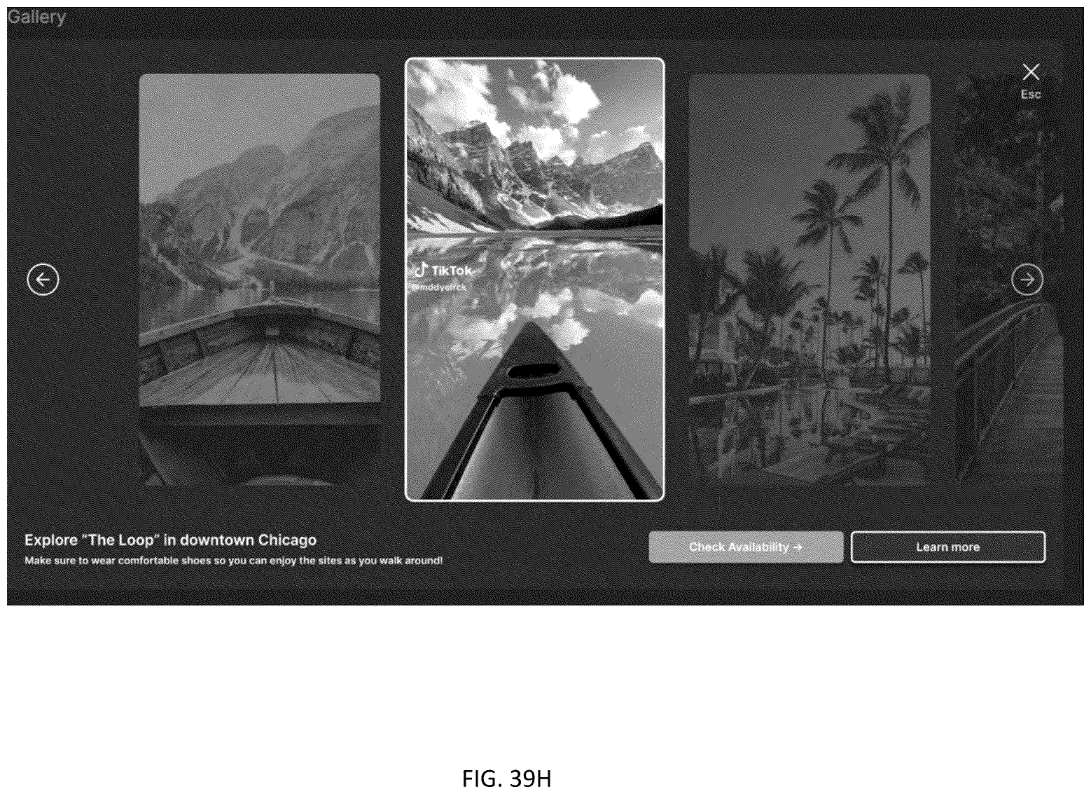

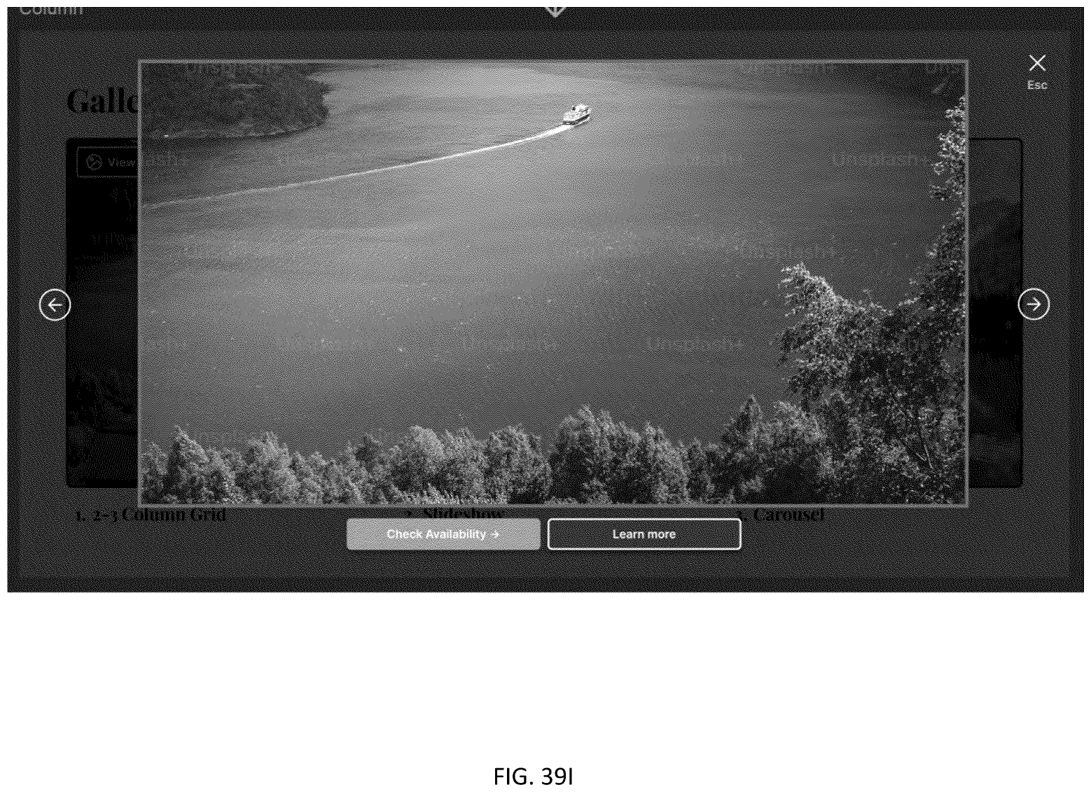

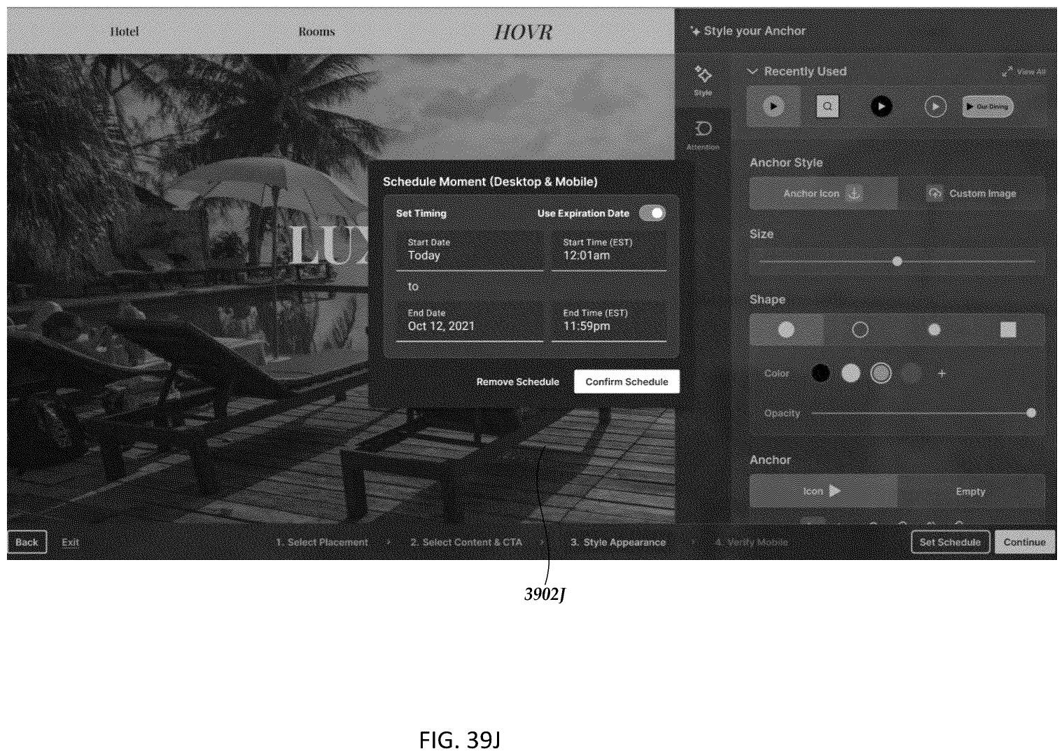

FIG. 39A illustrates an example webpage. The example webpage is for a trip booking function (wherein the user can specify whether the trip is a one way trip or round trip, the travel class (e.g., economy, business, first class), a departure location, a destination location, a departure date, and an arrival date). A webpage summary pane 3902A is presented that includes a webpage summary generated as similarly discussed elsewhere herein with respect to FIG. 34 and elsewhere. Advantageously, the summary reads as if it was human generated, rather than computer generated making the summary more pleasant to read and more natural sounding. In addition, keywords, generated as described elsewhere herein, are presented. Optionally, page statistics are determined by accessing historical user views of the webpage and analyzing the percentage of the page that is populated by images and the percentage of the page that is populated by text, are presented. For example, the determination as to what percentage of a webpage is text and what percentage is images may be performed by analyzing the webpage's HTML and/or CSS content, as described elsewhere herein. As similarly described elsewhere herein, the percentage of the page that is populated by images and the percentage of the page that is populated by text may be used in determining what type of anchor/moment is to be recommended, and then such recommendation may be presented. An add moment control 3904A is provided that when activated by a user enables a moment to be added to the webpage.

FIG. 39B illustrates the example webpage of FIG. 39A in association with the editor. A generate suggestions control 3902B is provided that when activated initiates the moment content suggestion process, such as that illustrated in FIG. 38C.

FIG. 39C illustrates moment content and placement suggestions rendered in user interface 3902C presented via a pop-up window overlaying webpage 3906C. In this example, the content suggestion selection confirmation user interface 3902C includes a frame 3908C for the selected content suggestion video and a suggested placement 3904C. Optionally, the user interface may display an associated suggested primary call to action (e.g., comprising call to action text and an associated URL), and an associated secondary call to action (comprising call to action text and an associated URL). Optionally, the user interface may enable a call to action to be associated with an existing item of webpage content (e.g., an existing image or existing text). Optionally, the user interface may enable the user to override suggestions and to manually specify moment content and placement.

In this example, the user interface 3902C displays alternative suggestions 3910C which may be used as anchors/moments (e.g., play icons, underlining of webpage text, outlining of webpage text). A “placements” drop down menu 3912C is provided via which the user can specify whether all placement types are to be included in the suggestions, or whether the placements should be filtered so that only certain types of placement suggestions are to be displayed. The user can accept the suggested anchor/moment content, select one of the other suggested items of content and/or placements, or request additional suggestions by activating corresponding controls. The user's acceptance of the suggested item of content and/or placement, or the selection and acceptance of one of the alternate suggested items of content and/or placements will be stored with an association with the webpage.

A confirm content control is provided which when activated causes the user's selection to be confirmed and stored in memory. In response to the user selecting the confirm content control, the style user interface 3902D illustrated in FIG. 39D may be presented.

The style user interface 3902D illustrated in FIG. 39D enables the user to specify the desired style. Recently used moment/anchor styles may be presented. A choice of anchor styles is presented. A choice of anchor shapes is presented. A choice of anchor colors is presented. An anchor opacity selection control (e.g., a slider) is provided which may be utilized by a user to specify the opacity. A selection of anchor icons is presented. Thus, a user can select amongst the various choices to specify the anchor style. Optionally, the user interface may enable the user to override style suggestions and to manually specify moment/anchor style.

Optionally, a color suggestion may be generated and presented to the user. For example, the colors currently used on the page may be determined by analyzing the webpage HTML and CSS files to identify color specifications for the page. For example the CSS styles, where colors may be defined using color properties like color, background-color, border-color, and gradients (e.g., linear-gradient, radial-gradient), may be analyzed. The color values may appear in various formats, such as named colors (e.g., green), hexadecimal codes (e.g., #FF0000), RGB (A) values (e.g., rgb(255, 0, 0)), or HSL(A) values (e.g., hsl(0, 100%, 50%)). Optionally, color extraction tools or browser extensions may be utilized that analyze the rendered webpage and extract colors visible on the screen (e.g., from images, gradients, and/or dynamic content). A palette of unique colors used and their use frequencies may be determined using such tools or extensions. Once the colors and frequencies are determined, such information may be used to suggest a compatible color (e.g., a color that will be visually pleasing and easily visible).

For example, to determine compatible colors for anchors/moments being added to a webpage, the webpage's existing color scheme and overall design aesthetic may be determined using the color data obtained from the webpage. A color scheme may include primary, secondary, and/or accent colors, and/or neutral tones such as white, black, and/or grays. Color theory principles and/or a color wheel data structure may then be used to ensure color compatibility. A harmonious color scheme may be utilized. For example, a color suggestion for an anchor/moment may include an analogous color that is adjacent, on the color wheel, to a color of an existing webpage element (where the existing webpage element may optionally be adjacent to the anchor/moment being added using techniques described herein). By way of further example, a complementary color may be suggested (e.g., a color that is opposite the existing webpage element on the color wheel. By way of further example, the same color as the color of an existing webpage color may be suggested, with a suggested variation in saturation and/or lightness. The suggested color may be selected to ensure sufficient contrast and accessibility to make the anchor/moment easily readable and accessible to those with eyesight issues. Optionally, several colors may be suggested in a ranked order, where the ranking is determined by how closely they satisfy the color suggestion techniques described herein and/or a ranking of the color suggestions techniques. For example, the color suggestions may include a complementary color, an analogous color, and a monochromatic color, where the complementary color may be ranked first, the analogous color ranked second, and the monochromatic color ranked third.

Optionally, for text being added (e.g., as part of an anchor/moment, call to action, or the like) a font and/or font size may be suggested. To determine the appropriate fonts and font sizes for adding new text (e.g., as part of an anchor/moment, call to action, or the like) to an existing webpage, the typography currently in use may be analyzed to ensure consistency in font and/or font size. The webpage's CSS files may be examined, and the font-family declarations may be identified to determine the primary font and any secondary fonts (where a secondary font may be used with less frequency than the primary font). The font-size property may be analyzed to determine the sizing hierarchy for various text elements, such as headings and body text. Additional properties, such as font-weight, line-height, and letter-spacing, may also be optionally analyzed to determine the overall typographic style. When the new text is added, the font and font sizes may optionally be matched to those already in use for similar content, and complementary styles may optionally be created if needed to maintain the visual harmony and readability of the webpage.

Referring now to FIG. 39E, the example select placement and style user interface 3902E enables the user to specify placement and style that are to be used to present the selected moment content/anchor. For example, the style may optionally be specified so as to conform with a website's branding style. The select placement and style user interface 3902E may provide a recommended style and/or placement. A suggested style and/or placement recommendation may be generated by a learning engine trained using historical user interactions with moment content. Optionally, the anchor/moment styling and placement interfaces described elsewhere herein may be utilized to specify the styling and placement of the moment content anchor. In this example, a highlighting style is recommended. Optionally, the recommended styling may be based on a particular website branding style/design guidelines and/or based on its historical effectiveness. A frame from the selected moment content to be used as an anchor is presented with a highlighting border. Text is provided indicating the historical success rate percentage of this type of styling in achieving the desired user engagement (e.g., acting on the call to action). Such historical success rate percentage may be accessed from memory. A control 3904E is provided via which the user can request that other moment suggestions be presented. In response to the user activating the control 3904E, additional styling and/or placement recommendations may be generated and presented. A confirm placement and style control 3906E is provided, which when activated, causes the corresponding placement and style to be stored in memory in association with the selected moment content. Such placement and style may be utilized with respect to providing the anchor/moment on the webpage.

FIG. 39F illustrates an example anchor placement recommendation 3902F for a mobile device, wherein the webpage 3904F is presented formatted in portrait mode with an aspect ratio suitable for a mobile device display. In this example, the selected anchor is a play control icon 3906F, and the recommended position is centered over a frame of a video moment, where in response to the user activating the playback anchor, the video moment will play back. Text is provided indicating the historical success rate percentage of this type of placement in achieving the desired user engagement (e.g., acting on the call to action). Optionally, the user interface may prompt the user to confirm that the format is for a mobile device (e.g., a portrait display) or for laptop/desktop display (e.g., a landscape display).

FIG. 39G illustrates a fill-in content example. In this example, fill-in content replaced existing content (e.g., an existing image) with one or more moments, where the moments may provide interactivity. In this example, a single image has been replaced with a gallery of images, which may comprise still images and/or videos. Optionally, if a user clicks on a given gallery image, the image may expand to a larger size (e.g., full screen or a portion of the full screen obscuring some or all of the gallery) and/or if the image corresponds to a video, the video may play.

FIG. 39H illustrates another example of fill-in content, where a sequence of images (e.g., in the form of a carousel of images) related to a travel destination are presented that the user can scroll through. The sequence of images may replace a single image on the original webpage. The sequence of images may include still and/or video images. Where the images are video images, a given video image may begin playing as the user scrolls through the images. For example, when a video image is rotated to a center position, it may automatically begin playing. Optionally, instead, a play control may be presented in association with a given video image, wherein in response to a user activating the play control, the video begins playing.

FIG. 39I illustrates another example of fill-in content, wherein a given webpage image is overlaid over the webpage.

FIG. 39J illustrates an example moment scheduling user interface 3902J. The user interface enables a user to specify a start date, start time, end date, and end time for a moment associated with a webpage. Thus, if an end user accesses the webpage between the start date/start time and end date/end time the anchor for the moment will be visible and the moment accessible. Outside of the start date/start time and end date/end time, the moment will not be accessible to the end user. As similarly described elsewhere herein, the scheduling user interface 3902J may be configured to enable the user to schedule the date and time of changes to the moment. Such changes may include changes in: moment content, moment colors, moment call to action language, and/or moment placement.

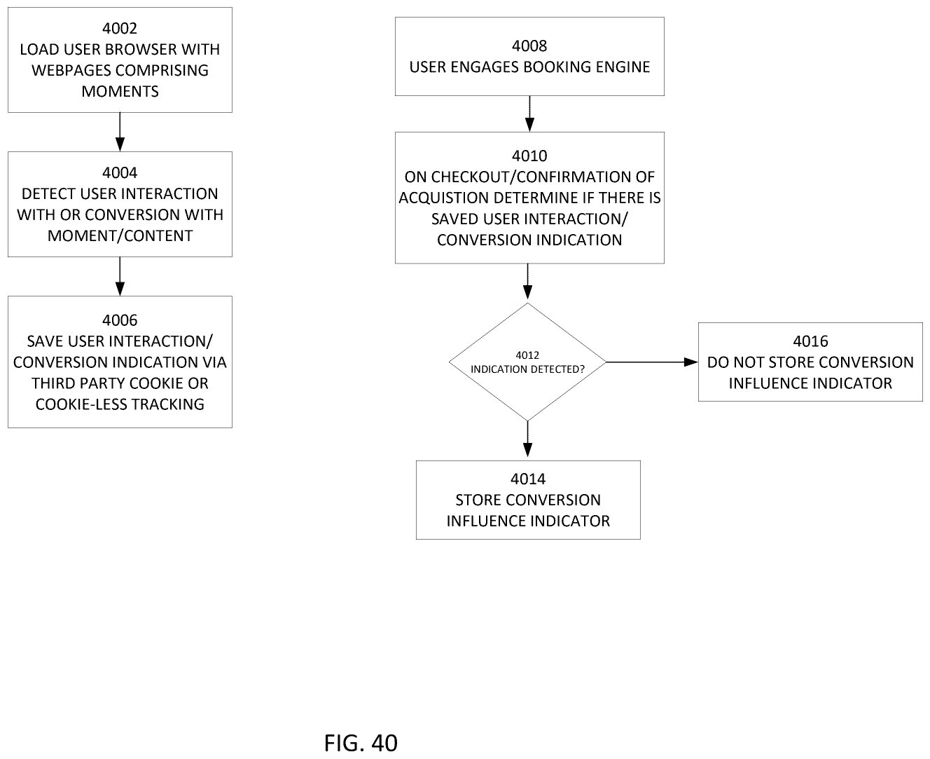

FIG. 40 illustrates an example process for determining whether a direct conversion, such as those described herein, is to be attributed to a moment added to a webpage using techniques described herein. At block 4002, a web server loads a web browser client hosted on a user device with one or more webpages populated with one or more moments. At block 4004, a user interaction with a moment and/or a user conversion via a moment on a webpage is detected. At block 4006, the user interaction and/or conversion are stored via a third party cookie and/or cookie-less tracking. Cookie-less tracking refers to methods of monitoring user behavior and interactions online without relying on traditional browser cookies. The techniques used for cookie-less tracking may vary from browser-type to browser-type.

In this example, at block 4008, the same user accesses a booking engine, such as a hotel or travel booking engine, via a booking user interface. At block 4010, when the user completes and pays for a reservation, the user moment interaction/conversion indication stored at block 4006 are accessed, and at block 4012, a determination is made as to whether such an indication was detected. In response to detecting the indication and the reservation purchase, at block 4014 a value may be stored indicating that the purchase was influenced by the moment. Hence, the provider of the moment service may receive a benefit (e.g., a commission payment) for the reservation purchase. If a user moment interaction/conversion indication was not detected, at block 4016, a determination is made that such an influence indication is not to be stored.

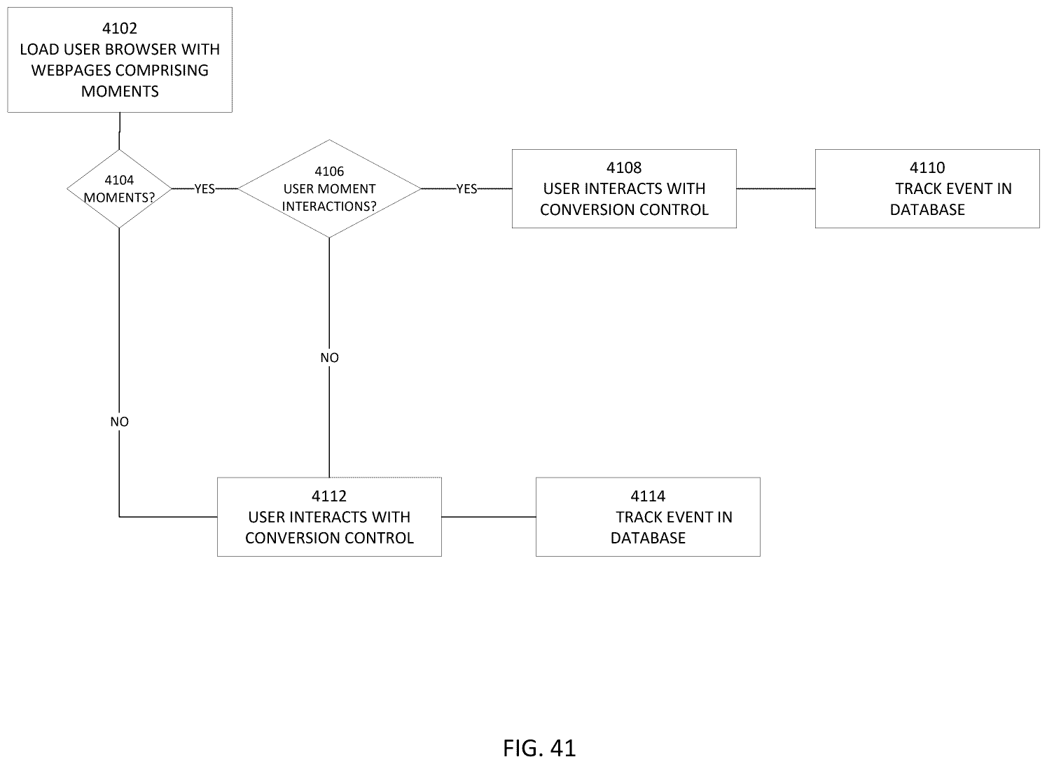

FIG. 41 illustrates an example process for determining whether an indirect conversion via a moment, such as those described herein, is to be attributed to a moment. The various acts may be performed during the same user session. At block 4102, a web server loads a webpage to a web browser client hosted on a user device. At block 4104, a determination is made as to whether the webpage has one or more moments (e.g., moments added using techniques described herein). If the webpage has moments, at block 4106, a determination is made as to whether the user has interacted with the webpage moment. If the user has interacted with the moment, at block 4108, a determination is made as to whether the user performed a conversion action (e.g., activated a conversion control, such as a hotel reservation control, made a purchase, or the like). In response to the user performing a conversion action, at block 4110, a conversion indication may be stored in memory in association with an indication that the conversion was performed after (e.g., at least partly in response) to the user interacting with the moment. That is, the conversion may be attributed at least in part as a result of the user consuming the moment, and hence the moment service provider may receive such attribution and a corresponding benefit.

If the webpage does not include a moment or if the user does not consume the moment, the process proceeds to block 4112. In response to the user performing a conversion action, at block 4114, a conversion indication may be stored in memory, without an indication that the conversion was performed after (e.g., at least partly in response) to the user interacting with the moment. That is, the conversion will not be attributed to the user consuming a moment and hence the moment service provider may not receive such attribution and a corresponding benefit.

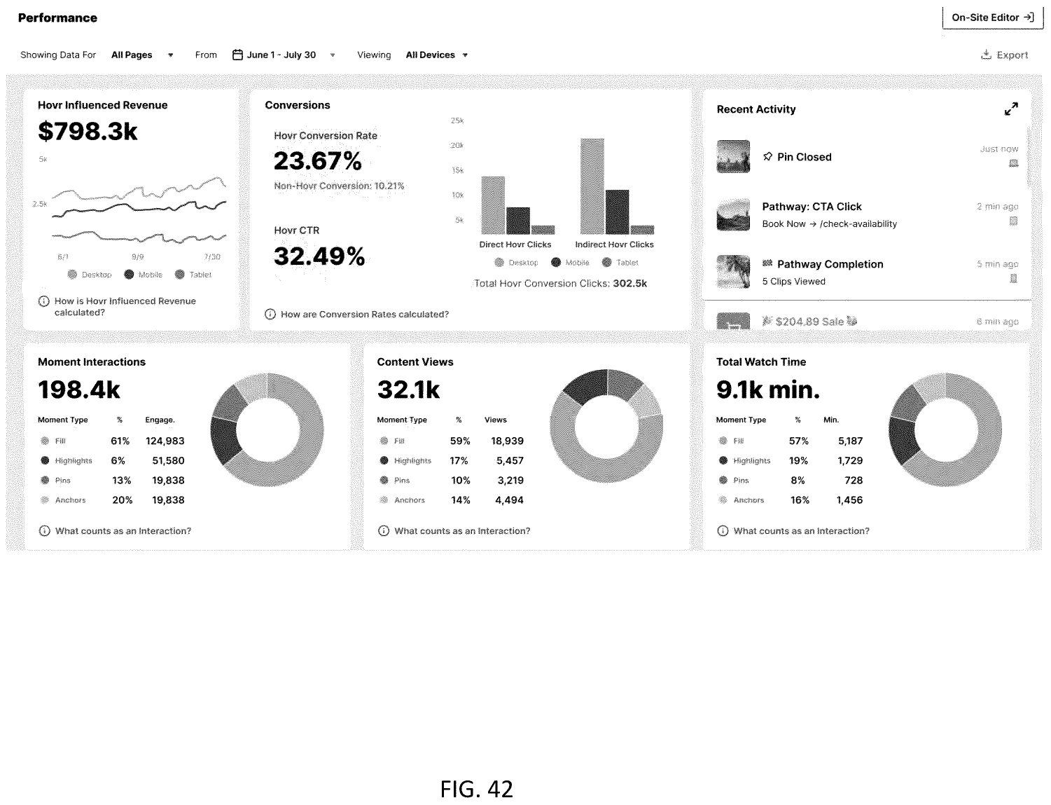

FIG. 42 illustrates an example analytics user interface. The example user interface provides information on what conversion can be wholly or partially attributed to a moment added via one or more of the techniques and user interfaces described herein. The determinations may be made using one or more techniques described herein, such as those described with reference to FIGS. 40 and 41.

For example, the user interface may provide textual and graphical representations indicating the revenue over a specified time period that was influenced by moments added to a site's webpages via the services described herein provided by a moment service provider. The user interface may break down the revenue to that obtained via different types of platforms (e.g., mobile phone, tablet, desktop, etc.). The user interface may provide conversions provided via moments added to a website using user interfaces and techniques described herein, and those conversions achieved without the use of such moments. The user interface may also provide information on the click through rates achieved via the moments. The user interface may also provide data on the total number of user interactions with moments, the types of moments/anchors users interacted with, the number of and the percentage of the total interactions with a given moment/anchor type (e.g., fill, highlights, pins, anchors), the number of moment content views, the content views by moment type, and the number of and the percentage of the total content views with a given moment/anchor type (e.g., fill, highlights, pins, anchors). In addition, the user interface may provide the content views by moment type, and the number of and the percentage of the total content views with a given moment/anchor type (e.g., fill, highlights, pins, anchors). Additionally, the user interface may provide the total watch time, the watch time by moment type, and the percentage of the total watch time for a given moment/anchor type (e.g., fill, highlights, pins, anchors). A recent activity pane may provide information on recent user interactions with moments (e.g., pin closed, pathway: CTA click, pathway completion, etc.).

Optionally, a user interface may be provided that enables a user to specify what actions on a given webpage or website are to be tracked. Such tracking may be specified for moments and/or for specified items of existing webpage content (such as on webpages without moments). For example, the user interface may be able to specify the types of existing website content (e.g., text, images, graphics, and/or the like) the user interacted with, the number of existing webpage content views, the number and/or percentage of existing webpage content views by content type, the total watch time for a given content type, the types of interactions with content (e.g., impressions, clicks, and/or the like), are to be tracked.

Optionally, some or all of the moments, webpage content, and/or webpage domain may be hosted on different or the same system (e.g., the same system server(s)), such as the multimedia communication server system 100A operated by provider of the moment services disclosed herein or hosted by a server of the owner of the website. Advantageously, this provides an entity, such as an owner of a website, with complete or near complete control over the appearance and branding of their content, as well as the controls provided in association with the content. Optionally, the system may enable transactions, such as hotel reservations to be conducted. By contrast, when an entity has their content hosted on a conventional third-party content sharing site, disadvantageously the branding of the third-party content sharing site may be added to opening frames of the entity's content. Further, the third-party content sharing site may disadvantageously enable advertisements of competitors to be displayed in association with the entity's content. Still further, after the entity's video content is played by the third-party content sharing site, another entity's (e.g., a competitor entity's) video content may be displayed.

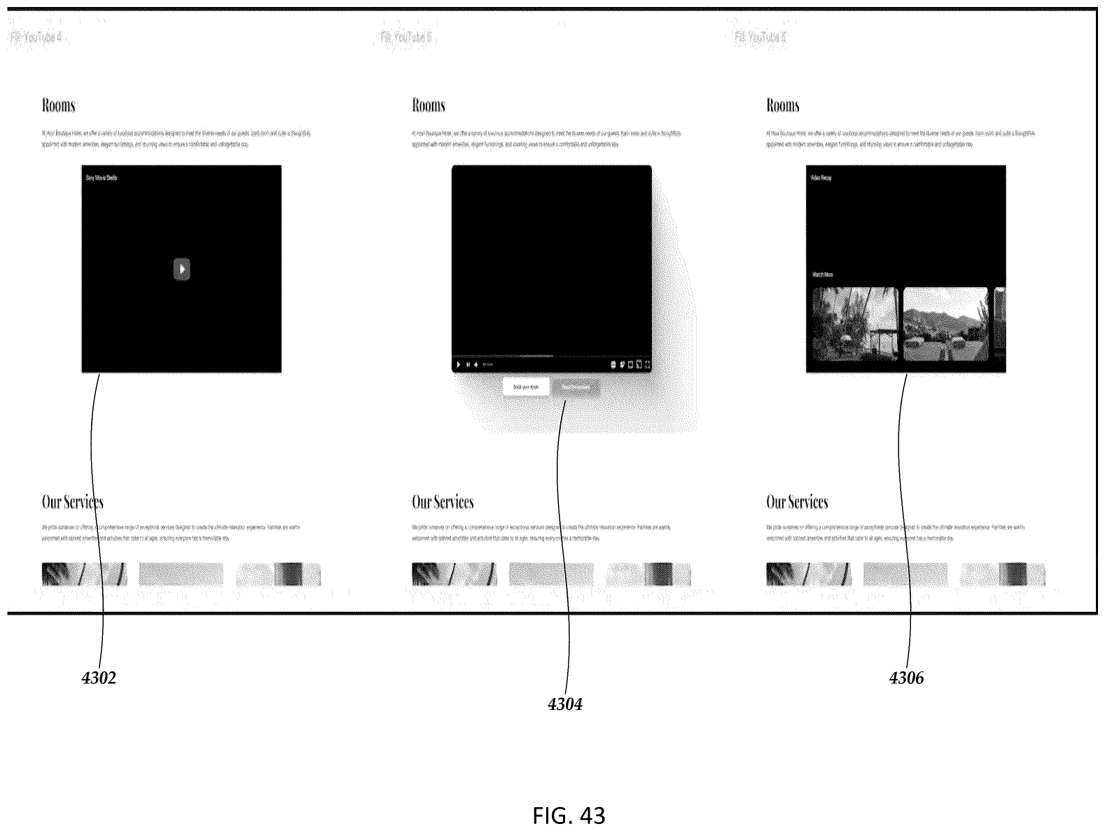

FIG. 43 illustrates examples of a sequence of user interfaces 4302, 4304, 4306 used to present video content hosted by the operator of the moment service provider and hosted by the owner of the website. Advantageously, the video content does not include third party branding (such as that of a video sharing site) and does not sequence to videos associated with third parties (e.g., competitors). The video content may be displayed in association with 4304 conversion control 4304 (“Book your room”). Once a video is played, additional videos 4306 associated with the website owner may be displayed.

Certain optional aspects will now be described that may be utilized in any combination.

An aspect of the present disclosure relates to a system comprising: a network interface; at least one processing device operable to: access, via the network interface, a first webpage; analyze the first webpage; use the analysis of the first webpage to generate one or more keywords reflective of content of the first webpage; use the analysis of the first webpage to determine an amount of text and an amount of images on the first webpage; use the keywords to identify relevant moment content; provide a moment content suggestion comprising the identified relevant moment content for display on a user device; use the determined amount of text and the determined amount of images to identify a suitable anchor; provide an anchor suggestion comprising the identified suitable anchor for display on the user device; receive a user selection of the identified relevant moment content; receive a user selection of the identified suitable anchor; cause the user selected identified suitable anchor to be displayed via the first webpage on at least one device; and at least partly in response to a user interaction with the first webpage, comprising the user selected identified suitable anchor, cause a rendering of the identified relevant moment content.

Optionally, analyzing the first webpage comprises using Term Frequency-Inverse Document Frequency (TF-IDF), Named Entity Recognition (NER), Latent Dirichlet Allocation (LDA) TF-IDF, NER, LDA, and/or synonym detection. Optionally, the system is configured to: evaluate content and relevance of words in the first webpage; generate a summary of the first webpage using the evaluation of the content and relevance of words in the first webpage; and cause the summary of the first webpage to be rendered on the user device. Optionally, the system is configured to: identify an existing image on a second webpage; and cause a zoom and/or animation operation to be performed on the existing image on the second webpage at least partly in response to a user interaction. Optionally, the system is configured to: generate vector embeddings corresponding to the keywords; and use the vector embeddings to identify relevant moment content. Optionally, the system is configured to generate a placement location suggestion for the relevant moment content and/or the suitable anchor on the first webpage. Optionally, the system is configured to determine if a first conversion action by at least one user is attributable to the relevant moment content displayed via the first webpage.

An aspect of the present disclosure relates to a computer implemented method, the method comprising: accessing content of a first webpage; analyzing the content of the first webpage; using the analysis of the content of the first webpage to generate one or more keywords reflective of content of the first webpage; using the keywords to identify relevant moment content; providing a moment content suggestion comprising the identified relevant moment content for display on a user device; receiving a user selection of the identified relevant moment content; and at least partly in response to a user interaction with the first webpage, causing a rendering of the identified relevant moment content.

Optionally, analyzing content of the first webpage comprises using Term Frequency-Inverse Document Frequency (TF-IDF), Named Entity Recognition (NER), Latent Dirichlet Allocation (LDA) TF-IDF, NER, LDA, and/or synonym detection. Optionally, the method further comprises: evaluating relevance of words in the first webpage; generating a summary of the first webpage using the evaluation of the relevance of words in the first webpage; and causing the summary of the first webpage to be rendered on the user device. Optionally, the method further comprises: identifying an existing image on a second webpage; and causing a zoom and/or animation operation to be performed on the existing image on the second webpage. Optionally, the method further comprises: generating vector embeddings corresponding to the keywords; and using the vector embeddings to identify relevant moment content. Optionally, the method further comprises generating a placement location suggestion for the relevant moment content on the first webpage. Optionally, the method further comprises determining if a first conversion action by at least one user is attributable to the relevant moment content displayed via the first webpage. Optionally, the method further comprises: determining an amount of text and an amount of images on the first webpage; using the determined amount of text and the determined amount of images to identify a suitable anchor; providing an anchor suggestion comprising the identified suitable anchor for display on the user device; receiving a user selection of the identified suitable anchor; and causing the user selected identified suitable anchor to be displayed via the first webpage on at least one device.

An aspect of the present disclosure relates to a non-transitory computer readable storage medium storing computer-executable instructions that, when executed, are configured to cause a computer system comprising one or more processing devices to perform operations, comprising: accessing content of a first webpage; analyzing the content of the first webpage; using the analysis of the content of the first webpage to generate one or more keywords reflective of content of the first webpage; using the keywords to identify relevant moment content; providing a moment content suggestion comprising the identified relevant moment content for display on a user device; receiving a user selection of the identified relevant moment content; and at least partly in response to a user interaction with the first webpage, causing a rendering of the identified relevant moment content.

Optionally, analyzing content of the first webpage comprises using Term Frequency-Inverse Document Frequency (TF-IDF), Named Entity Recognition (NER), Latent Dirichlet Allocation (LDA) TF-IDF, NER, LDA, and/or synonym detection.

Optionally, the operations further comprise: evaluating relevance of words in the first webpage; generating a summary of the first webpage using the evaluation of the relevance of words in the first webpage; and causing the summary of the first webpage to be rendered on the user device. Optionally, the operations further comprise: identifying an existing image on a second webpage; and causing a zoom and/or animation operation to be performed on the existing image on the second webpage. Optionally, the operations further comprise generating vector embeddings corresponding to the keywords; and using the vector embeddings to identify relevant moment content. Optionally, the operations further comprise generating a placement location suggestion for the relevant moment content on the first webpage. Optionally, the operations further comprise determining if a first conversion action by at least one user is attributable to the relevant moment content displayed via the first webpage. Optionally, the operations further comprise: determining an amount of text and an amount of images on the first webpage; using the determined amount of text and the determined amount of images to identify a suitable anchor; providing an anchor suggestion comprising the identified suitable anchor for display on the user device; receiving a user selection of the identified suitable anchor; and causing the user selected identified suitable anchor to be displayed via the first webpage on at least one device.

An aspect of the present disclosure relates to systems and methods configured to access over a network interface a webpage, analyze the webpage, use the analysis to generate keywords reflective of content of the webpage, and determine an amount of text and images on the webpage. The keywords are used to identify relevant moment content. A moment content suggestion comprising the identified relevant moment content is generated and provided for display on a user device. The determined amount of text and images are used to identify a suitable anchor. An anchor suggestion is provided for display on the user device. In response to receiving a user selection of suggested relevant moment content and a suggested suitable anchor, the user-selected anchor is caused to be displayed via the webpage on a device. In response to an interaction with the webpage, comprising the user-selected identified suitable anchor, a rendering of the user-selected relevant moment content is performed.

An aspect of the present disclosure relates to systems and methods configured to receive an indication that a moment (e.g., a general purpose anchor, a highlight anchor, a product anchor, a hotspot, a slide, a trigger, etc.) is to be positioned at a first location on a webpage, via code embedded in the webpage. A content specification associated with the moment is received. An interaction rule associated with the moment is received that specifies that content specified by the content specification is to be displayed at least partly in response to a specified user interaction with the webpage. Code is automatically generated configured to cause the moment to be located at the first location when accessed by a user browser, wherein, at least partly in response to a user browser accessing the first webpage, and the first user interacting with the webpage in a manner that satisfies the interaction rule, the content specified by the content specification is rendered.

Thus, an optional aspect of the present disclosure is a system comprising a network interface at least one processing device operable to: provide a user interface enabling one or more anchors to be added to an existing first webpage via a browser, without utilizing a browser extension, via code embedded in the first webpage; receive, via the user interface enabling one or more anchors to be added to the first webpage, an addition of a first anchor at a first location of the first webpage; receive a content specification associated with the first anchor; receive an interaction rule associated with the first anchor, wherein the interaction rule comprises a rule that content specified by the content specification is to be displayed at least partly in response to a specified user interaction with the first webpage; store an association of the first anchor, the interaction rule, and the content specified by the content specification; automatically generate code configured to cause the anchor to be located at the first location of the first webpage when accessed by a first user browser; and at least partly in response to activation of a publication control, enable the automatically generated code to be accessible in the first webpage by a plurality of user browsers, wherein, at least partly in response to a first user browser of a first user device accessing the first webpage, and the first user interacting with the first webpage in a manner that satisfies the interaction rule, the content specified by the content specification is rendered.

Optionally, the addition of the first anchor at the first location of the first webpage is performed at least in part by visually emphasizing text in the first webpage. Optionally, the addition of the first anchor at the first location of the first webpage is performed, at least in part, by defining a size of the first anchor, wherein the first anchor comprises a hotspot. Optionally, the specified user interaction with the first webpage comprises scrolling to or past the first location. Optionally, the specified user interaction with the first webpage comprises hovering a cursor over the first location.

Optionally, the system is configured to provide a user interface via which the user can enable or disable a display of a given anchor and/or content specified by a given content specification associated with the given anchor for a first user device type when the first webpage is accessed by a user device of the first user device type; receive, via the user interface via which the user can enable or disable the display of the given anchor and/or content specified by the given content specification associated with the given anchor for the given user device, an instruction to disable the display of the given anchor and/or content specified by the given content specification associated with the given anchor for the specified user device type; enable the first webpage to be rendered by the user device of the first user device type without the given anchor and/or content specified by the given content specification associated with the given anchor being rendered in the first webpage; enable the first webpage to be rendered by a user device of a second user device type, different than the first user device type, with the given anchor and/or content specified by the given content specification associated with the given anchor being rendered in the first webpage.

Optionally, the code embedded in the first webpage that enables the user interface enabling one or more anchors to be added to the existing first webpage comprises a script tag including a locator of a file that stores code enabling the one or more anchors to be added to an existing first webpage. Optionally, the system is configured to enable the user to add the first anchor via a user interface that enables the user to highlight webpage text. Optionally, the first anchor comprises a hotspot, emphasized text, or a product anchor. Optionally, the system is configured to enable the user to customize the first anchor via a user interface that enables the user to set an anchor size, shape, color, and/or icon representation.

An optional aspect relates to a computer implemented method, the method comprising: providing a user interface enabling one or more moments to be added to an existing first webpage via a browser; receiving, via the user interface enabling one or more moments to be added to the first webpage, an addition of a first moment at a first location of the first webpage; receiving a content specification associated with the first moment; receiving an interaction specification associated with the first moment, wherein the interaction specification comprises a rule that content specified by the content specification is to be displayed at least partly in response to a specified user interaction with the first webpage; automatically generating code configured to cause the moment to be located at the first location of the first webpage; and wherein, at least partly in response to a first user browser of a first user device accessing the first webpage, and the first user interacting with the first webpage in a manner that satisfies the interaction specification, the content specified by the content specification is provided via the first user browser.

Optionally, the addition of the first moment at the first location of the first webpage is performed at least in part by visually emphasizing text in the first webpage. Optionally, the addition of the first moment at the first location of the first webpage is performed, at least in part, by defining dimensions of the first moment, the first moment comprising a hotspot. Optionally, the specified user interaction with the first webpage comprises scrolling to or past the first location. Optionally, the specified user interaction with the first webpage comprises hovering a cursor over the first moment.

Optionally, the method further comprises: providing, via a computer system, a user interface via which the user can enable or disable a display of a given moment and/or content specified by a given content specification associated with the given moment for a first user device type when the first webpage is accessed by a user device of the first user device type; receiving, via the user interface via which the user can enable or disable the display of the given moment and/or content specified by the given content specification associated with the given moment for the given user device, an instruction to disable the display of the given moment and/or content specified by the given content specification associated with the given moment for the specified user device type; enabling the first webpage to be rendered by the user device of the first user device type without the given moment and/or content specified by the given content specification associated with the given moment being presented via the first webpage; and enabling the first webpage to be rendered by a user device of a second user device type, different than the first user device type, with the given moment and/or content specified by the given content specification associated with the given moment being presented via the first webpage.

Optionally, the code embedded in the first webpage that enables the user interface enabling one or more moments to be added to the existing first webpage comprises a script tag including a locator of a file that stores code enabling the one or more moments to be added to an existing first webpage. Optionally, the method further comprises enabling the user to add the first moment via a user interface that enables the user to highlight webpage text. Optionally, the first moment comprises a hotspot, emphasized text, or a product anchor. Optionally, the method further comprises providing a user interface that enables a moment type to be selected from a plurality of moment types, the plurality of moment types comprising an anchor represented by an icon and a highlight anchor. Optionally, the method further comprising enabling the user to customize the first moment via a user interface that enables the user to set a moment size, shape, color, and/or icon representation. Optionally, the user interface enabling one or more anchors to be added to the existing first webpage via the browser is generated without utilizing a browser extension, via code embedded in the first webpage. Optionally, the content specified by the content specification comprises image content and a URL.

An aspect of the present disclosure relates to a system comprising: a network interface; at least one processing device operable to: access a first webpage via the network interface; determine an element type of a first element of the first webpage; receive a user selection of the first element of the first webpage; based at least in part on the determined element type of the first element and the user selection of the first element, automatically add a first anchor with a first set of characteristics to the first webpage in association with the first element, wherein the first set of characteristics comprises size, shape, color, alignment, and/or positioning; receive a content specification comprising a specification of a first video; store an association of the first anchor and the content specified by the content specification; automatically generate code configured to cause the first anchor to be located at the first location of the first webpage when accessed by a first user browser; and at least partly in response to activation of a publication control, enable the automatically generated code to be accessible in the first webpage by a plurality of user browsers, wherein, at least partly in response to a first user browser of a first user device accessing the first webpage, and the first user interacting with the first anchor, the content specified by the content specification is rendered.

Optionally, the automatically generated code is inserted into a DOM (Document Object Model) of the first webpage. Optionally, the addition of the first anchor at the first location of the first webpage is performed at least in part by visually emphasizing text in the first webpage. Optionally, the system is configured to: select a first portion of the first video, wherein the first video is in a first format; generate a preview video using the first portion of the first video, whereon generating the preview video comprises converting the first portion of the first video to a second format having a smaller size then the first portion of the first video in the first format; cause the preview video to be displayed on the first webpage; enable the preview video to be played in response to a first user interaction with the preview video; and cause the first video to be played in response to a second user interaction with the preview video. Optionally, the system is configured to: receive a user-provided image; use a neural network comprising an input layer, convolutional layers, a pooling layer, and an output layer, to classify the user-provided image with a first classification; use the first classification to determine if the user-provided image violates a first rule; at least partly in response to determining, using the first classification, that the user-provided image violates the first rule, inhibit the user-provided image from being added to a first library. Optionally, the system is configured to: provide to a first device and user interface enabling: a primary sequence of interfaces to be defined, a first branch option from the primary sequence, and return criteria for returning to the primary sequence from the first branch option; cause the primary sequence to begin on a second user device; receive, from the second user device, a selection of the first branch option; at least partly in response to the selection of the first branch option, cause the first branch to be displayed on the second user device; determine if the return criteria are satisfied; and at least partly in response to determining that the return criteria are satisfied, causing an interface from the primary sequence to be displayed on the second user device. Optionally, the system is configured to: provide a goal enabling a first goal to be defined, the first goal related to user interaction with a website; access content from the website; filter out, from the content from the first website, a script, tag, and/or style sheet text; analyze a plurality of webpages of the website using natural language processing, and generate keywords and/or summaries for respective webpages in the plurality of webpages; select, based at least in part on the generated keywords and/or summaries and the goal, at least a second webpage; pair an item of content with the second webpage;

place an anchor on the second webpage, the anchor associated with the paired item of content; and enable the paired item of content to be displayed on a user device in response to a corresponding user action.

An aspect of the present disclosure relates to a computer implemented method, the method comprising: accessing a first webpage; determine an element type of a first element of the first webpage; receiving over a network a user selection of the first element of the first webpage; based at least in part on the determined element type of the first element and the user selection of the first element, automatically adding a first anchor with a first set of characteristics to the first webpage in association with the first element, wherein the first set of characteristics comprises size, shape, color, alignment, and/or positioning; receiving a content specification comprising a specification of a first video; storing in memory an association of the first anchor and the content specified by the content specification; automatically generating code configured to cause the first anchor to be located at the first location of the first webpage when accessed by a first user browser; and at least partly in response to activation of a publication control, enabling the automatically generated code to be accessible in the first webpage by a plurality of user browsers, wherein, at least partly in response to a first user browser of a first user device accessing the first webpage, and the first user interacting with the first anchor, the content specified by the content specification is rendered.

Optionally, the automatically generated code is inserted into a DOM (Document Object Model) of the first webpage. Optionally, the addition of the first anchor at the first location of the first webpage is performed at least in part by visually emphasizing text in the first webpage. Optionally, the method further comprises: selecting a first portion of the first video, wherein the first video is in a first format; generating a preview video using the first portion of the first video, whereon generating the preview video comprises converting the first portion of the first video to a second format having a smaller size then the first portion of the first video in the first format; causing the preview video to be displayed on the first webpage; enabling the preview video to be played in response to a first user interaction with the preview video; and causing the first video to be played in response to a second user interaction with the preview video. Optionally, the method further comprises: receiving a user-provided image; using a neural network comprising an input layer, convolutional layers, a pooling layer, and an output layer, to classify the user-provided image with a first classification; using the first classification to determine if the user-provided image violates a first rule; at least partly in response to determining, using the first classification, that the user-provided image violates the first rule, inhibiting the user-provided image from being added to a first library. Optionally, the method further comprises: providing to a first device and user interface enabling: a primary sequence of interfaces to be defined, a first branch option from the primary sequence, and return criteria for returning to the primary sequence from the first branch option; causing the primary sequence to begin on a second user device; receiving, from the second user device, a selection of the first branch option; at least partly in response to the selection of the first branch option, causing the first branch to be displayed on the second user device; determining if the return criteria are satisfied; and at least partly in response to determining that the return criteria are satisfied, causing an interface from the primary sequence to be displayed on the second user device. Optionally, the method further comprises: providing a goal enabling a first goal to be defined, the first goal related to user interaction with a website; accessing content from the website; filtering out, from the content from the first website, a script, tag, and/or style sheet text; analyzing a plurality of webpages of the website using natural language processing, and generate keywords and/or summaries for respective webpages in the plurality of webpages; selecting, based at least in part on the generated keywords and/or summaries and the goal, at least a second webpage; pairing an item of content with the second webpage; placing an anchor on the second webpage, the anchor associated with the paired item of content; and enabling the paired item of content to be displayed on a user device in response to a corresponding user action.

An aspect of the present disclosure relates to a non-transitory computer readable storage medium storing computer-executable instructions that, when executed, are configured to cause a computer system comprising one or more processing devices to perform operations, comprising: access a first webpage; determine an element type of a first element of the first webpage; receive a user selection of the first element of the first webpage; based at least in part on the determined element type of the first element and the user selection of the first element, add a first anchor with a first set of characteristics to the first webpage in association with the first element, wherein the first set of characteristics comprises size, shape, color, alignment, and/or positioning; store an association of the first anchor and specified content; generate code configured to cause the first anchor to be located at the first location of the first webpage when accessed by a first user browser; and at least partly in response to activation of a publication control, enable the generated code to be accessible in the first webpage by one or more user browsers, wherein, at least partly in response to a first user browser of a first user device accessing the first webpage, and the first user interacting with the first anchor, the content specified by the content specification is rendered.

Optionally, the generated code is inserted into a DOM (Document Object Model) of the first webpage. Optionally, the addition of the first anchor at the first location of the first webpage is performed at least in part by visually emphasizing text in the first webpage. Optionally, the operations further comprise: select a first portion of the first video, wherein the first video is in a first format; generate a preview video using the first portion of the first video, whereon generating the preview video comprises converting the first portion of the first video to a second format having a smaller size then the first portion of the first video in the first format; cause the preview video to be displayed on the first webpage; enable the preview video to be played in response to a first user interaction with the preview video; and cause the first video to be played in response to a second user interaction with the preview video. Optionally, the operations further comprise: receive a user-provided image; use a neural network comprising an input layer, convolutional layers, a pooling layer, and an output layer, to classify the user-provided image with a first classification; use the first classification to determine if the user-provided image violates a first rule; at least partly in response to determining, using the first classification, that the user-provided image violates the first rule, inhibit the user-provided image from being added to a first library. Optionally, the operations further comprise: provide to a first device and user interface enabling: a primary sequence of interfaces to be defined, a first branch option from the primary sequence, and return criteria for returning to the primary sequence from the first branch option; cause the primary sequence to begin on a second user device; receive, from the second user device, a selection of the first branch option; at least partly in response to the selection of the first branch option, cause the first branch to be displayed on the second user device; determine if the return criteria are satisfied; and at least partly in response to determining that the return criteria are satisfied, causing an interface from the primary sequence to be displayed on the second user device. Optionally, the operations further comprise: provide a goal enabling a first goal to be defined, the first goal related to user interaction with a website; access content from the website; filter out, from the content from the first website, a script, tag, and/or style sheet text; analyze a plurality of webpages of the website using natural language processing, and generate keywords and/or summaries for respective webpages in the plurality of webpages; select, based at least in part on the generated keywords and/or summaries and the goal, at least a second webpage; pair an item of content with the second webpage; place an anchor on the second webpage, the anchor associated with the paired item of content; and enable the paired item of content to be displayed on a user device in response to a corresponding user action.

Optionally, the method further comprises providing for display a user interface comprising a plurality of content items from which a given content item may be selected to be associated with a given moment added to a given webpage, the user interface, comprising the plurality of content items from which a content item may a given content item may be selected to be associated with the given moment added to the given webpage, displayed at a same time as the given webpage.

Thus, certain systems and methods are described herein that enable users concurrently accessing network resources to communicate and share content, securely and selectively. Certain systems and methods are described herein that enable moments, such as anchors, to be associated with webpage elements, thus enabling moments to be easily added to a webpage and enabling end users to intuitively access content associated with such moments.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The systems described herein may optionally include displays, user input devices (e.g., touchscreen, keyboard, mouse, voice recognition, etc.), network interfaces, etc.

The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications/alerts and user interfaces described herein may be provided via a Web page, a dedicated or non-dedicated phone application, computer application, a short messaging service message (e.g., SMS, MMS, etc.), instant messaging, email, push notification, audibly, a pop-up interface, and/or otherwise.

The user terminals described herein may be in the form of a mobile communication device (e.g., a cell phone), laptop, tablet computer, interactive television, game console, media streaming device, head-wearable display, networked watch, etc. The user terminals may optionally include displays, user input devices (e.g., touchscreen, keyboard, mouse, voice recognition, etc.), network interfaces, etc.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system comprising:
a network interface;
at least one processing device operable to:
access, via the network interface, a first webpage;
analyze the first webpage;
use the analysis of the first webpage to generate one or more keywords reflective of content of the first webpage;
use the analysis of the first webpage to determine an amount of text and an amount of images on the first webpage;
use the keywords to identify relevant moment content;
provide a moment content suggestion comprising the identified relevant moment content for display on a user device;
use the determined amount of text and the determined amount of images to identify a suitable anchor;
provide an anchor suggestion comprising the identified suitable anchor for display on the user device;
receive a user selection of the identified relevant moment content;
receive a user selection of the identified suitable anchor;
cause the user selected identified suitable anchor to be displayed via the first webpage on at least one device; and
at least partly in response to a user interaction with the first webpage, comprising the user selected identified suitable anchor, cause a rendering of the identified relevant moment content.

2. The system as defined by claim 1, wherein analyzing the first webpage comprises using Term Frequency-Inverse Document Frequency (TF-IDF), Named Entity Recognition (NER), Latent Dirichlet Allocation (LDA) TF-IDF, NER, LDA, and/or synonym detection.

3. The system as defined by claim 1, wherein the system is configured to:
evaluate content and relevance of words in the first webpage;
generate a summary of the first webpage using the evaluation of the content and relevance of words in the first webpage; and
cause the summary of the first webpage to be rendered on the user device.

4. The system as defined by claim 1, wherein the system is configured to:
identify an existing image on a second webpage; and
cause a zoom and/or animation operation to be performed on the existing image on the second webpage at least partly in response to a user interaction.

5. The system as defined by claim 1, wherein the system is configured to:
generate vector embeddings corresponding to the keywords; and
use the vector embeddings to identify relevant moment content.

6. The system as defined by claim 1, wherein the system is configured to generate a placement location suggestion for the relevant moment content and/or the suitable anchor on the first webpage.

7. The system as defined by claim 1, wherein the system is configured to determine if a first conversion action by at least one user is attributable to the relevant moment content displayed via the first webpage.

8. A computer implemented method, the method comprising:
accessing content of a first webpage;
analyzing the content of the first webpage;
using the analysis of the content of the first webpage to generate one or more keywords reflective of content of the first webpage;
using the keywords to identify relevant moment content;
providing a moment content suggestion comprising the identified relevant moment content for display on a user device;
receiving a user selection of the identified relevant moment content; and
at least partly in response to a user interaction with the first webpage, causing a rendering of the identified relevant moment content.

9. The method as defined by claim 8, wherein analyzing content of the first webpage comprises using Term Frequency-Inverse Document Frequency (TF-IDF), Named Entity Recognition (NER), Latent Dirichlet Allocation (LDA) TF-IDF, NER, LDA, and/or synonym detection.

10. The method as defined by claim 8, the method further comprising:
evaluating relevance of words in the first webpage;
generating a summary of the first webpage using the evaluation of the relevance of words in the first webpage; and
causing the summary of the first webpage to be rendered on the user device.

11. The method as defined by claim 8, the method further comprising:
identifying an existing image on a second webpage; and
causing a zoom and/or animation operation to be performed on the existing image on the second webpage.

12. The method as defined by claim 8, the method further comprising:
generating vector embeddings corresponding to the keywords; and
using the vector embeddings to identify relevant moment content.

13. The method as defined by claim 8, the method further comprising generating a placement location suggestion for the relevant moment content on the first webpage.

14. The method as defined by claim 8, the method further comprising determining if a first conversion action by at least one user is attributable to the relevant moment content displayed via the first webpage.

15. The method as defined by claim 8, the method further comprising:
determining an amount of text and an amount of images on the first webpage;
using the determined amount of text and the determined amount of images to identify a suitable anchor;
providing an anchor suggestion comprising the identified suitable anchor for display on the user device;
receiving a user selection of the identified suitable anchor; and
causing the user selected identified suitable anchor to be displayed via the first webpage on at least one device.

16. A non-transitory computer readable storage medium storing computer-executable instructions that, when executed, are configured to cause a computer system comprising one or more processing devices to perform operations, comprising:
accessing content of a first webpage;
analyzing the content of the first webpage;
using the analysis of the content of the first webpage to generate one or more keywords reflective of content of the first webpage;
using the keywords to identify relevant moment content;
providing a moment content suggestion comprising the identified relevant moment content for display on a user device;
receiving a user selection of the identified relevant moment content; and
at least partly in response to a user interaction with the first webpage, causing a rendering of the identified relevant moment content.

17. The non-transitory computer readable storage medium as defined by claim 16,
wherein analyzing content of the first webpage comprises using Term Frequency-Inverse Document Frequency (TF-IDF), Named Entity Recognition (NER), Latent Dirichlet Allocation (LDA) TF-IDF, NER, LDA, and/or synonym detection.

18. The non-transitory computer readable storage medium as defined by claim 16, the operations further comprising:
evaluating relevance of words in the first webpage;
generating a summary of the first webpage using the evaluation of the relevance of words in the first webpage; and
causing the summary of the first webpage to be rendered on the user device.

19. The non-transitory computer readable storage medium as defined by claim 16, the operations further comprising:
identifying an existing image on a second webpage; and
causing a zoom and/or animation operation to be performed on the existing image on the second webpage.

20. The non-transitory computer readable storage medium as defined by claim 16, the operations further comprising:
generating vector embeddings corresponding to the keywords; and
using the vector embeddings to identify relevant moment content.

21. The non-transitory computer readable storage medium as defined by claim 16, the operations further comprising generating a placement location suggestion for the relevant moment content on the first webpage.

22. The non-transitory computer readable storage medium as defined by claim 16, the operations further comprising determining if a first conversion action by at least one user is attributable to the relevant moment content displayed via the first webpage.

23. The non-transitory computer readable storage medium as defined by claim 16, the operations further comprising:
determining an amount of text and an amount of images on the first webpage;
using the determined amount of text and the determined amount of images to identify a suitable anchor;
providing an anchor suggestion comprising the identified suitable anchor for display on the user device;
receiving a user selection of the identified suitable anchor; and
causing the user selected identified suitable anchor to be displayed via the first webpage on at least one device.
